(19) United States
(12) Patent Application Publication
(10) Pub. No.: US 2024/0116351 A1
(43) Pub. Date: Apr. 11, 2024

(54) RETROFITTABLE IMPROVEMENTS FOR AUTOMOBILES

(71) Applicant: Carbyne Enterprises, Inc., Seattle, WA (US)

(72) Inventor: Thomas Q. Gurski, Seattle, WA (US)

(21) Appl. No.: 18/464,972

(22) Filed: Sep. 11, 2023

Related U.S. Application Data
(63) Continuation of application No. PCT/US2022/020008, filed on Mar. 11, 2022.
(60) Provisional application No. 63/160,670, filed on Mar. 12, 2021.

(51) Int. Cl. B60K 1/04; B60B 35/00; B60B 35/16; B60K 17/02; B60K 17/16; B60L 50/60; B60L 58/12

(52) U.S. Cl. CPC B60K 1/04; B60B 35/004; B60B 35/16; B60K 17/02; B60K 17/16; B60L 50/60; B60L 58/12

(57) ABSTRACT

Provided herein is an auxiliary hybrid system (AHS) that may be configured to provide electrical propulsion to vehicle or increase range to electric vehicles. In some embodiments, a system is disclosed including: at least one energy storage device configured to store power for a vehicle having at least one differential pinion and at least one axle tube; at least one power conversion device; at least one power conversion controller configured to regulate power flow between the at least one energy storage device and the at least one power conversion device; an input device configured to receive input from a user and configured to translate the input into instructions for the power conversion controller; and a drivetrain configured to transmit power between the at least one power conversion device and the vehicle's at least one differential pinion and configured to connect to the vehicle's axle tube.

### CROSS-REFERENCE TO RELATED APPLICATIONS

The application is a continuation of international application no. PCT/US2022/020008, entitled “RETROFITTABLE IMPROVEMENTS FOR AUTOMOBILES” filed Mar. 11, 2022, which claims the benefit of U.S. Provisional Patent Application No. 63/160,670, entitled “RETROFITTABLE IMPROVEMENTS FOR AUTOMOBILES” filed Mar. 12, 2021, which is incorporated herein by reference in its entirety.

### TECHNICAL FIELD

This application relates generally to vehicles, and more specifically to systems that can be retrofitted to a known vehicle to achieve various improvements.

### BACKGROUND

In an effort to conserve resources and reduce environmental impact, a growing effort has been made to produce electric vehicles (EV), which use electric energy taken from a power grid and stored in an onboard battery, or plug-in hybrid electric vehicles (PHEV), which use a combination of such battery power and an alternate power source, typically an internal combustion engine. Although sales of EVs and PHEVs have been increasing greatly in recent years, sales projections suggest that there will be insufficient market penetration on a fast enough timeline to achieve the necessary emissions reductions to prevent severe effects of climate change. Reasons for this include: the global economy is likely incapable of supporting production of enough new vehicles to turn over a large enough fraction of the exiting global fleet, especially considering that EVs and PHEVs are more expensive than their conventional counterparts; EVs generally have a smaller range than their conventional counterparts; recharging is significantly slower than refilling a fuel tank; charging infrastructure is immature relative to refueling stations; and there is limited selection of EVs and PHEVs on the market. Additionally, the environmental impact of producing a new vehicle and scrapping an existing vehicle can take years to be undone by the more environmentally favorable operation of the vehicle. Furthermore, if enough electric vehicles were to be produced to appreciably mitigate climate change, global battery demand would significantly exceed projected battery production. Converting exiting vehicles into PHEVs addresses all of these issues, but there is currently no aftermarket conversion available for performing such a conversion.

It would be desirable to provide a system for use in converting a conventional internal combustion engine-powered vehicle into a plug-in hybrid electric vehicle to increase its fuel efficiency. It would also be desirable to provide such a conversion system in an economical manner that will allow the owner to realize a savings in the operation of the vehicle.

Consumers often base their automobile purchases on occasional fringe needs, for example the need to carry large amounts of cargo, or to drive very long distances. A trailer provides additional cargo capacity, and, if fitted with a range-extending generator, can provide additional range to an electric vehicle. Trailers are under-utilized for these purposes largely because they are difficult to maneuver and require special driving techniques, especially when reversing.

It would be desirable to provide a trailer system that could carry cargo, components of a retrofittable hybrid system, or a range-extending generator, that is compact and easy to maneuver.

Vehicles are often limited in their cargo-carrying ability by the additional weight that their suspension systems can handle. This limitation also presents issues for the components that must be carried by a vehicle in order to perform a PHEV conversion.

It would be desirable to provide a supplemental suspension system that would enable a vehicle to carry additional weight with minimal adverse effects on handling.

Many retrofittable improvements to an automobile require a secure mounting point to an unsprung portion of the vehicle's suspension. Vehicles with a solid rear axle, due to the commonality of solid rear axle layout and construction, provide an opportunity for a system to provide such a mounting point.

It would be desirable to provide an axle clamp assembly that would enable a variety of retrofittable improvements to be connected to a vehicle's solid rear axle.

### SUMMARY

Provided herein is an auxiliary hybrid system (AHS) that may be configured to provide electrical propulsion to an e.g., internal combustion-powered vehicle through the use of a battery and electric motor. Alternatively, the AHS may be configured to increase range of electric vehicles through the use of an internal combustion-powered generator. In either embodiment, the AHS is added to a vehicle without removal of the vehicles' standard drivetrain, allowing the vehicle to operate conventionally when the AHS is not engaged. The AHS is compatible with a wide range of vehicles with a minimum of vehicle-specific parts.

In a first embodiment, a system is disclosed including: at least one energy storage device configured to store power for a vehicle having at least one differential pinion and at least one axle tube; at least one power conversion device; at least one power conversion controller configured to regulate power flow between the at least one energy storage device and the at least one power conversion device; an input device configured to receive input from a user and configured to translate the input into instructions for the power conversion controller; and a drivetrain configured to transmit power between the at least one power conversion device and the vehicle's at least one differential pinion and configured to connect to the vehicle's axle tube.

In a second embodiment, a system is disclosed including: at least one energy storage device configured to store power for a vehicle having a front differential pinion and a frame; at least one power conversion device; a power conversion controller configured to regulate power flow between the at least one energy storage device and the at least one power conversion device; an input device configured to receive input from a user and configured to translate the input into instructions for the power conversion controller; and a drivetrain configured to transmit power between the at least one power conversion device and the vehicle's front differential pinion and configured to connect to the vehicle's frame.

In a third embodiment, a system is disclosed including: at least one energy storage device configured to store power for a vehicle having one or more wheels; at least one swing arm, wherein the at least one swing arm includes at least one power conversion device configured to transmit power between the one or more wheels and the at least one energy storage device; at least one power conversion controller configured to regulate power flow between the at least one energy storage device and the at least one power conversion device; and an input device configured to receive input from a user and configured to translate the input into instructions for the power conversion controller.

In a fourth embodiment, a system is disclosed including: at least one energy storage device configured to store power for a vehicle having one or more wheels; at least one power conversion device; at least one swing arm, wherein the at least one swing arm is configured to transmit power between the one or more wheels and the at least one energy storage device; at least one power conversion controller configured to regulate power flow between the at least one energy storage device and the at least one power conversion device; an input device configured to receive input from a user and configured to translate the input into instructions for the power conversion controller, and one or more clutches configured to transmit power between the at least one swing arm and at least one wheel when in a first position and configured to interrupt power transmission between the at least one swing arm and at least one wheel when in a second position.

In a fifth embodiment, a system is disclosed including: at least one energy storage device configured to store power for a vehicle having one or more wheels; at least one power conversion device; at least one swing arm, wherein the at least one swing arm is configured to transmit power between the one or more wheels and the at least one energy storage device; at least one power conversion controller configured to regulate power flow between the at least one energy storage device and the at least one power conversion device; an input device configured to receive input from a user and configured to translate the input into instructions for the power conversion controller; a drive-side coupling configured transmit power between the at least one swing arm and a wheel-side coupling, the drive-side coupling including at least one attachment mechanism located thereon; and a wheel-side coupling configured to transmit power between the drive-side coupling and a vehicle wheel, the wheel-side coupling including at least one attachment mechanism located thereon.

In a sixth embodiment, a system is disclosed including: at least one energy storage device configured to store power for a vehicle having one or more wheels; a left swing arm and a right swing arm configured to transmit power between the one or more wheels and a power conversion device; a rear drive including a power conversion device, the power conversion device being configured to transmit power between the at least one energy storage device and a differential; a differential configured to divide power flow between the left swing arm and right swing arm; at least one power conversion controller configured to regulate power flow between the at least one energy storage device and the power conversion device; and an input device configured to receive input from a user and configured to translate the input into instructions for the power conversion controller, wherein the power conversion device and differential are parallel to and aligned with each other.

In a seventh embodiment, a system is disclosed including: at least one energy storage device configured to store power for a vehicle having at least one rear axle; at least one wheel configured to be substantially aligned with the rear axle of the vehicle and configured to provide traction against a ground surface; at least one power conversion device configured to transmit power between the at least one wheel and the at least one energy storage device; at least one power conversion controller configured to regulate power flow between the at least one energy storage device and the at least one power conversion device; and an input device configured to receive input from a user and configured to translate the input into instructions for the power conversion controller.

In an eighth embodiment, a system is disclosed including: a power source configured to provide electrical energy to a vehicle having a traction battery; at least one sensor configured to take a current measurement at the vehicle's traction battery and configured to communicate the current measurement to a controller, wherein the controller is configured to vary the electrical energy provided by the power source.

In a ninth embodiment, a system is disclosed including: a trailer frame configured to carry a load for a vehicle; at least one wheel connected to the trailer frame; and a steering mechanism configured to exert a steering torque on the at least one wheel, and configured to align the direction of rotation of the at least one wheel with the direction of travel of the at least one wheel; wherein the trailer frame is configured to connect to the vehicle and configured to minimize relative yaw between the vehicle and the trailer frame.

In a tenth embodiment, a system is disclosed including: a rear anchor configured to connect to a rear frame section of a vehicle; at least one resilient member configured to exert a substantially upward force on the rear anchor; and a preload adjustment mechanism configured to enable a user to adjust the upward force exerted by the resilient member on the rear anchor.

In an eleventh embodiment, a system for connecting at least one auxiliary component to a vehicle having at least one axle tube, is disclosed, system including: at least one axle clamp; and at least one transverse bar configured to connect to the at least one axle clamp, wherein the axle clamp is configured to connect to the at least one axle tube of the vehicle in a plurality of locations.

In a twelfth embodiment, a system is disclosed including: an inboard portion configured to connect to a vehicle having at least one axle that is split into an inboard end and an outboard end, wherein the inboard portion is connected to the inboard end of the axle; an outboard portion configured to connect to the outboard end of the vehicle's axle; at least one bearing configured to align the inboard portion and the outboard portion and configured to allow relative rotation of the inboard portion and the outboard portion; and a sliding clutch configured to transmit torque between the inboard portion and the outboard portion when in a first position and configured to interrupt torque when in a second position.

### BRIEF DESCRIPTION OF THE DRAWINGS

FIG. 1 is a plan view of an Auxiliary Hybrid System (AHS) with a single motor configured to deliver power to the differential of a vehicle with a live rear axle in accordance with an embodiment of the disclosure.

FIG. 2 is a side cross-section view of a portion of a drivetrain of an AHS in accordance with an embodiment of the disclosure.

FIG. 3 is an isometric view of a portion of a drivetrain of an AHS in accordance with an embodiment of the disclosure.

FIG. 4 is an isometric view of a portion of a drivetrain of an AHS in accordance with an embodiment of the disclosure.

FIG. 5 is an isometric view of a portion of a drivetrain of an AHS in accordance with an embodiment of the disclosure.

FIG. 6 is a front view of a portion of a drivetrain of an AHS in accordance with an embodiment of the disclosure.

FIG. 7 is an isometric view of a portion of a drivetrain of an AHS and an alignment system in accordance with an embodiment of the disclosure.

FIG. 8 is a plan view of an AHS with a single motor configured to deliver power to the differential of a vehicle with a live rear axle in accordance with an embodiment of the disclosure.

FIG. 9 is a cross-section view of a portion of a drivetrain of an AHS in accordance with an embodiment of the disclosure.

FIG. 10 is an isometric view of a portion of a drivetrain of an AHS in accordance with an embodiment of the disclosure.

FIG. 11 is a front view of a portion of a drivetrain of an AHS in accordance with an embodiment of the disclosure.

FIG. 12 is an isometric view of a portion of a drivetrain of an AHS in accordance with an embodiment of the disclosure.

FIG. 13 is a side view of a portion of a drivetrain of an AHS in accordance with an embodiment of the disclosure.

FIG. 14 is an isometric view of a portion of a drivetrain of an AHS in accordance with an embodiment of the disclosure.

FIG. 15 is an isometric view of a portion of a drivetrain of an AHS in accordance with an embodiment of the disclosure.

FIG. 16 is an isometric view of a portion of a drivetrain of an AHS in accordance with an embodiment of the disclosure.

FIG. 17 is an isometric cutaway view of a power splitter, in accordance with an embodiment of the disclosure.

FIG. 18 is an isometric view of a portion of a power splitter, in accordance with an embodiment of the disclosure.

FIG. 19 is an isometric view of a u-joint interface, in accordance with an embodiment of the disclosure.

FIG. 20 is an isometric view of a u-joint interface, in accordance with an embodiment of the disclosure.

FIG. 21 is an isometric view of a portion of an AHS, in accordance with an embodiment of the disclosure.

FIG. 22 is a front view of a portion of an AHS, in accordance with an embodiment of the disclosure.

FIG. 23 is an isometric view of a portion of an AHS, in accordance with an embodiment of the disclosure.

FIG. 24 is an isometric view of an axle clamp assembly, a portion of an AHS, and a portion of a Supplemental Suspension System (SSS) in accordance with an embodiment of the disclosure.

FIG. 25 is an isometric view of a power splitter and a portion of an axle clamp assembly, in accordance with an embodiment of the disclosure.

FIG. 26 is an isometric view of a differential input assembly, in accordance with an embodiment of the disclosure.

FIG. 27 is an isometric cutaway of a power splitter, in accordance with an embodiment of the disclosure.

FIG. 28 is an isometric view of portion an AHS, in accordance with an embodiment of the disclosure.

FIG. 29 is an isometric view of a portion of an AHS, in accordance with an embodiment of the disclosure.

FIG. 30 is a plan view of a rear drive an AHS in accordance with an embodiment of the disclosure.

FIG. 31 is an isometric cutaway view of a portion of a rear drive, in accordance with an embodiment of the disclosure.

FIG. 32 is a side cross-section view of a rear drive, in accordance with an embodiment of the disclosure.

FIG. 33 is an isometric view of a portion of an AHS, in accordance with an embodiment of the disclosure.

FIG. 34 is a side cross-section view of a portion of a rear drive, in accordance with an embodiment of the disclosure.

FIG. 35 is a side cross-section view of a portion of a rear drive, in accordance with an embodiment of the disclosure.

FIG. 36 is a side cross-section view of a portion of a rear drive, in accordance with an embodiment of the disclosure.

FIG. 37 is a side cross-section view of a portion of a rear drive, in accordance with an embodiment of the disclosure.

FIG. 38 is an isometric cutaway of a portion of an AHS, in accordance with an embodiment of the disclosure.

FIG. 39 is an isometric cutaway of a portion of the system shown in FIG. 38, in accordance with an embodiment of the disclosure.

FIG. 40 is an isometric cutaway of a portion of an AHS, in accordance with an embodiment of the disclosure.

FIG. 41 is an isometric view of a portion of an AHS, in accordance with an embodiment of the disclosure.

FIG. 42 is a side cross-section view of a rear drive, in accordance with an embodiment of the disclosure.

FIG. 43 is an isometric view of a portion of an AHS, in accordance with an embodiment of the disclosure.

FIG. 44 is a side cross-section view of a portion of an AHS, in accordance with an embodiment of the disclosure.

FIG. 45 is an isometric view of a portion of an AHS, in accordance with an embodiment of the disclosure.

FIG. 46 is an isometric view of an AHS installed in a vehicle, in accordance with an embodiment of the disclosure.

FIG. 47 is an isometric view of an AHS installed in a vehicle, in accordance with an embodiment of the disclosure.

FIG. 48 is an isometric view of an AHS installed on a vehicle, and a reference frame, in accordance with an embodiment of the disclosure.

FIG. 49 is a top cross-section view of a portion of a swing arm in accordance with an embodiment of the disclosure.

FIG. 50 is an isometric cutaway view of a portion of a swing arm in accordance with an embodiment of the disclosure.

FIG. 51 is a side view of a portion of a swing arm in accordance with an embodiment of the disclosure.

FIG. 52 is a side view of a portion of a swing arm in accordance with an embodiment of the disclosure.

FIG. 53 is an isometric view of a portion of a swing arm in accordance with an embodiment of the disclosure.

FIG. 54 is a side view of a portion of a swing arm in accordance with an embodiment of the disclosure.

FIG. 55 is a front cross-section view of a portion of a swing arm in accordance with an embodiment of the disclosure.

FIG. 56 is an isometric view of a wheel-side coupling in accordance with an embodiment of the disclosure.

FIG. 57 is an isometric view of a portion of a wheel-side coupling in accordance with an embodiment of the disclosure.

FIG. 58 is a front cross section view of a wheel-side coupling in accordance with an embodiment of the disclosure.

FIG. 59 is an isometric cutaway view of a portion of an AHS, in accordance with an embodiment of the disclosure.

FIG. 60 is an isometric cutaway view of a portion of a rear drive, in accordance with an embodiment of the disclosure.

FIG. 61 is a top cross-section view of a swing arm, in accordance with an embodiment of the disclosure.

FIG. 62 is a top cross-section view of a portion of a swing arm, in accordance with an embodiment of the disclosure.

FIG. 63 is an isometric view of an AHS, in accordance with an embodiment of the disclosure.

FIG. 64 is an isometric cutaway view of a portion of an AHS, in accordance with an embodiment of the disclosure.

FIG. 65 is an isometric view of an AHS, in accordance with an embodiment of the disclosure.

FIG. 66 is an isometric cutaway view of a portion of an AHS, in accordance with an embodiment of the disclosure.

FIG. 67 is an isometric view of an input device as a pedal, in accordance with an embodiment of the disclosure.

FIG. 68 is an isometric view of an input device as a pedal in accordance with an embodiment of the disclosure.

FIG. 69 is an isometric view of an input device as a pedal, in accordance with an embodiment of the disclosure.

FIG. 70 is a schematic of an auxiliary heater system, in accordance with an embodiment of the disclosure.

FIG. 71 is a schematic of an auxiliary heater system, in accordance with an embodiment of the disclosure.

FIG. 72 shows an exemplary of a climate control system, in accordance with an embodiment of the disclosure.

FIG. 73 is a schematic of a portion of a vehicle's electrical system.

FIG. 74 is a schematic of an engine defeat system, in accordance with an embodiment of the disclosure.

FIG. 75 is a schematic of an AHS, in accordance with an embodiment of the disclosure.

FIG. 76 is a plan view of a vehicle and trailer with trailer wheel steering system in accordance with an embodiment of the disclosure.

FIG. 77 is a plan view of a vehicle and trailer with trailer wheel steering system in accordance with an embodiment of the disclosure.

FIG. 78 is a side cross-section view of a trailer with a trailer wheel steering system in accordance with an embodiment of the disclosure.

FIG. 79 is an isometric view of a trailer, in accordance with an embodiment of the disclosure.

FIG. 80 is an isometric cutaway view of a trailer, in accordance with an embodiment of the disclosure.

FIG. 81 is an isometric view of a portion of a trailer, in accordance with an embodiment of the disclosure.

FIG. 82 is an isometric cutaway view of a portion of a trailer, in accordance with an embodiment of the disclosure.

FIG. 83 is an isometric view of a portion of a trailer, in accordance with an embodiment of the disclosure.

FIG. 84 is an isometric view of a trailer, in accordance with an embodiment of the disclosure.

FIG. 85 is an isometric view of a trailer, in accordance with an embodiment of the disclosure.

FIG. 86 is an isometric view of a portion of a trailer, in accordance with an embodiment of the disclosure.

FIG. 87 is an isometric view of a portion of a trailer, in accordance with an embodiment of the disclosure.

FIG. 88 is a side cutaway view of a portion of a trailer, in accordance with an embodiment of the disclosure.

FIG. 89 is a side cutaway view of a portion of a trailer, in accordance with an embodiment of the disclosure.

FIG. 90 is an isometric view of a trailer, in accordance with an embodiment of the disclosure.

FIG. 91 is an isometric view of a portion of a trailer, in accordance with an embodiment of the disclosure.

FIG. 92 is an isometric view of a trailer in accordance with an embodiment of the disclosure.

FIG. 93 is an isometric view of a portion of a trailer, in accordance with an embodiment of the disclosure.

FIG. 94 is an isometric view of a portion of a trailer, in accordance with an embodiment of the disclosure.

FIG. 95 is an isometric view of a system including an AHS and a trailer, in accordance with an embodiment of the disclosure.

FIG. 96 is an isometric view of a portion of system including an AHS and a trailer, in accordance with an embodiment of the disclosure.

FIG. 97 is an isometric view of portion of a system including an AHS and a trailer, in accordance with an embodiment of the disclosure.

FIG. 98 is an isometric view of a system including an AHS and a trailer, in accordance with an embodiment of the disclosure.

FIG. 99 is an isometric view of a portion of the system shown in FIG. 98, in accordance with an embodiment of the disclosure.

FIG. 100 is an isometric view of a portion of the system shown in FIG. 99, in accordance with an embodiment of the disclosure.

FIG. 101 is an isometric view of an AHS, in accordance with an embodiment of the disclosure.

FIG. 102 is a side view of an AHS, in accordance with an embodiment of the disclosure.

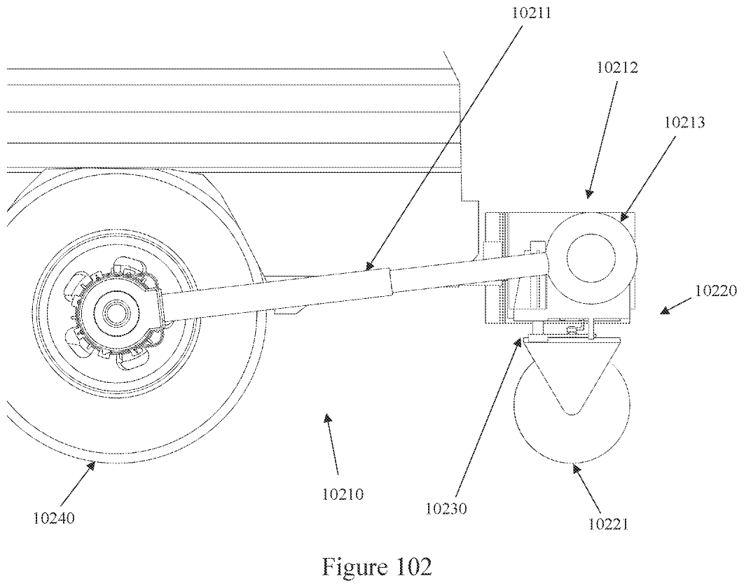

FIG. 103 is an isometric view of a supplemental suspension system, in accordance with an embodiment of the disclosure.

FIG. 104 is an isometric, cutaway, exploded view of a portion of supplemental suspension system, in accordance with an embodiment of the disclosure.

FIG. 105 is an isometric view of a portion of a supplemental suspension system, in accordance with an embodiment of the disclosure.

FIG. 106 is an isometric cutaway view of a portion of a supplemental suspension system, in accordance with an embodiment of the disclosure.

FIG. 107 is an isometric view of a portion of an AHS and a supplemental suspension system, in accordance with an embodiment of the disclosure.

FIG. 108 is an isometric view of a portion of an AHS and a portion of a supplemental suspension system, in accordance with an embodiment of the disclosure.

FIG. 109 is an isometric view of a system including an AHS and a supplemental suspension system, in accordance with an embodiment of the disclosure.

FIG. 110 is an isometric cutaway view of a rear drive, an SSS, and a portion of an axle clamp assembly.

FIG. 111 is an isometric view of a supplemental suspension system in accordance with an embodiment of the disclosure.

FIG. 112 is an isometric view of a supplemental suspension system and a portion of an AHS in accordance with an embodiment of the disclosure.

FIG. 113 is an isometric view of a supplemental suspension system and a portion of an AHS in accordance with an embodiment of the disclosure.

FIG. 114 is a side view of a supplemental suspension system and a portion of an AHS in accordance with an embodiment of the disclosure.

FIG. 115 is an isometric cutaway view of a supplemental suspension system and a portion of an AHS in accordance with an embodiment of the disclosure.

FIG. 116 is a side cutaway view of a supplemental suspension system and a portion of an AHS in accordance with an embodiment of the disclosure.

FIG. 117 is an isometric cutaway view of a supplemental suspension system and a portion of an AHS in accordance with an embodiment of the disclosure.

FIG. 118 is an isometric cutaway view of a supplemental suspension system and a portion of an AHS in accordance with an embodiment of the disclosure.

FIG. 119 is an isometric view of a system including an AHS and a supplemental suspension system, in accordance with an embodiment of the disclosure.

FIG. 120 is an isometric view of a system including an AHS and a supplemental suspension system, in accordance with an embodiment of the disclosure.

FIG. 121 is an isometric view of a portion of an AHS, in accordance with an embodiment of the disclosure.

FIG. 122 is an isometric view of an AHS, SSS, and axle clamp assembly, in accordance with an embodiment of the disclosure.

FIG. 123 is a schematic of a range extender, in accordance with an embodiment of the disclosure.

FIG. 124 is an isometric cutaway view of an axle-disconnect in accordance with an embodiment of the disclosure.

FIG. 125 is an isometric cutaway view of a portion of an axle-disconnect in accordance with an embodiment of the disclosure.

FIG. 126 is an isometric cutaway view of an axle-disconnect in accordance with an embodiment of the disclosure.

FIG. 127 is an isometric cutaway view of an axle-disconnect, in accordance with an embodiment of the disclosure.

FIG. 128 is an isometric cutaway view of a portion of an axle-disconnect, in accordance with an embodiment of the disclosure.

### DETAILED DESCRIPTION OF THE EMBODIMENTS

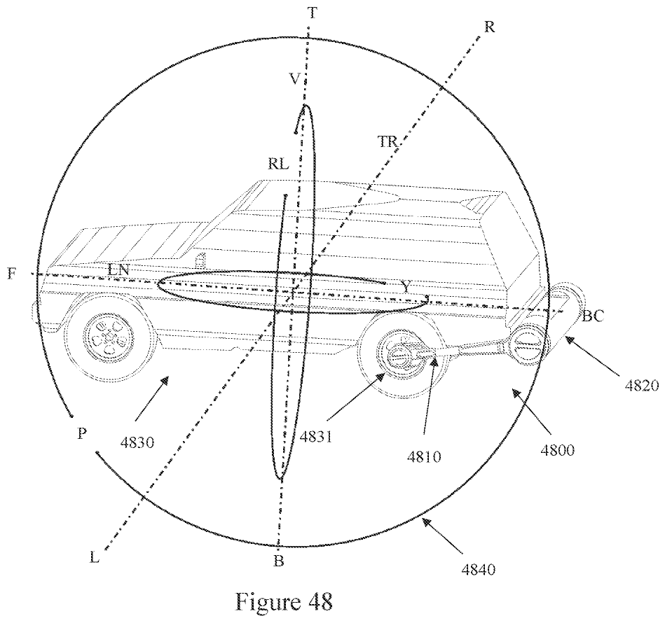

Referring briefly to FIG. 48, FIG. 48 provides a reference frame 4840. Any element described herein may be include a position and an orientation provided in terms of reference frame 4840. Reference frame 4840 includes a top T, a bottom B, a left L, a right R, a front F, and a back BC. Reference frame 4840 includes a longitudinal direction LN between front F and back BC, a transverse direction TR between left L and right R, and a vertical direction V between top T and bottom B. Reference frame 4840 includes pitch rotation P about the transverse direction TR, a yaw rotation Y about the vertical direction V, and a roll rotation RL about the longitudinal direction LN. Herein, forward refers to being towards the front F in the longitudinal direction LN, and rearward or backward refers to being towards the back BC in the longitudinal direction LN. Upward refers to being towards the top T in the vertical direction V, and downward refers to being towards the bottom B in the vertical direction V.

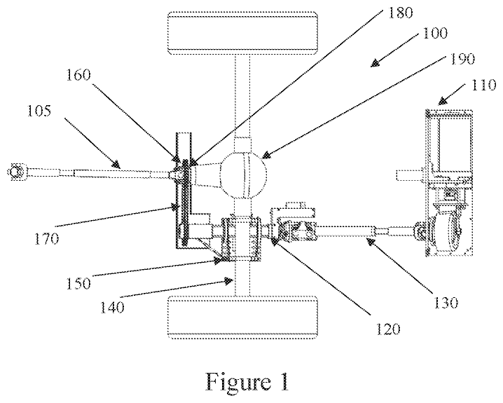

FIG. 1 provides a top view of an embodiment of an AHS 100. In AHS 100, a rear drive 110 may be connected to the body or frame of a vehicle (not shown). The connection between rear drive 110 and vehicle body or frame (not shown) may be via a trailer hitch receiver (not shown). Power may be transferred between the rear drive 110 and a parallel shaft assembly 120 via a driveshaft 130. Parallel shaft assembly 120 may be rigidly connected to the vehicle's axle tube 140 via axle clamp assembly 150. Power may be transferred between parallel shaft assembly 120 and a differential input assembly 160 via a chain 170, a belt (not shown), or a plurality of gears (not shown). Differential input assembly 160 may be connected to an input 180 of the vehicle's differential 190. A vehicle's driveshaft 105 may be connected to the differential input assembly 160.

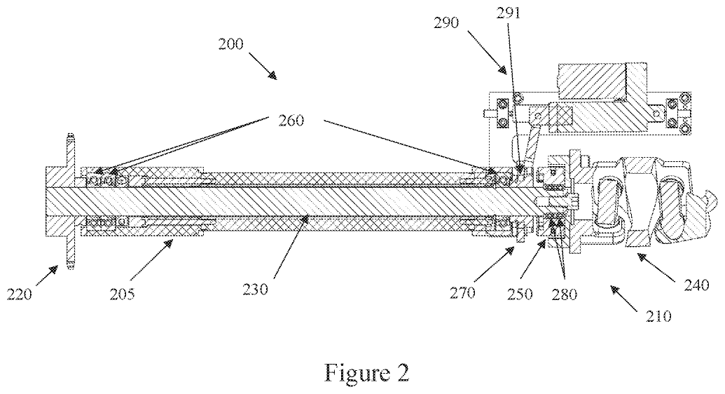

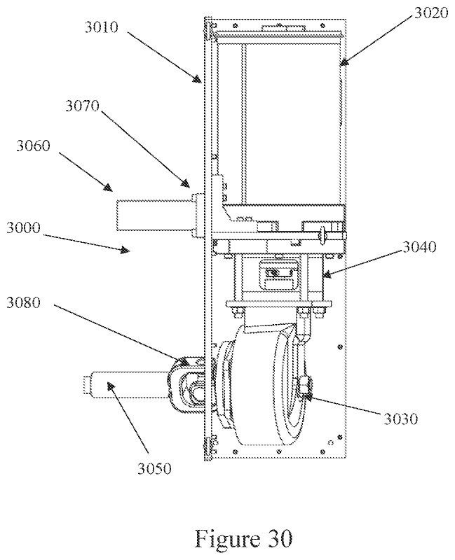

FIG. 2 provides a horizontal longitudinal cross-section of parallel shaft assembly 200 (also shown as 120 in FIG. 1). Parallel shaft assembly 200 may transfer power between driveshaft 210 (also shown as 3050 in FIG. 30) and a drive sprocket 220 via a parallel shaft 230. Driveshaft 210 may include a constant velocity (CV) joint 240, which may be of the double cardan joint type, as shown. Driveshaft 210 may also include a universal joint (not shown), as are known in the art. Driveshaft 210 may be connected to parallel shaft 230 with a quick disconnect coupling 250 that may allow driveshaft 210 to be quickly and easily removed. Parallel shaft 230 may be supported by bearings 260 inside shaft housing 205. A clutch 270 may allow interruption of power transfer between driveshaft 210 and parallel shaft 230, such that power is stopped or impeded between driveshaft 210 and parallel shaft 230. Also, this interruption of power transfer may reduce parasitic forces when operating the vehicle under its conventional power source by preventing back-driving of driveshaft 3050, transmission 3030, and power conversion device 3020, shown in FIG. 30. Clutch 270 may be of a dog clutch type as shown but may alternatively be of a spline type (not shown). When clutch 270 is disengaged, driveshaft 210 may be able to rotate freely relative to parallel shaft 230 on one or more bearings 280. Clutch 270 may be engaged and disengaged by an actuator assembly 290.

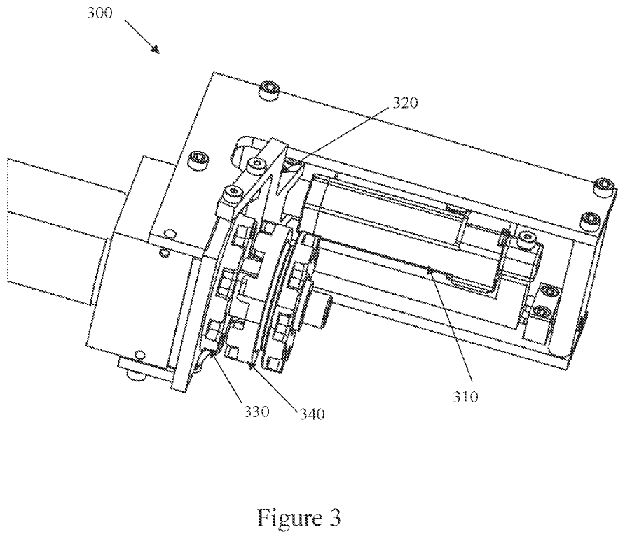

FIG. 3 provides an isometric view of actuator assembly 300, shown as 290 in FIG. 2. An actuator 310 may act on a bell crank 320 such that a sliding clutch 330 can be alternately engaged or disengaged (as shown) with a fixed clutch 340. Rotation of sliding clutch 330 relative to bell crank 320 may be achieved by bearings 280, shown in FIG. 2. Relative rotation may also be achieved by a shift fork mechanism commonly used in automotive manual transmissions and transfer cases. Actuator 310 may also act on sliding clutch 330 via such a sliding shift fork.

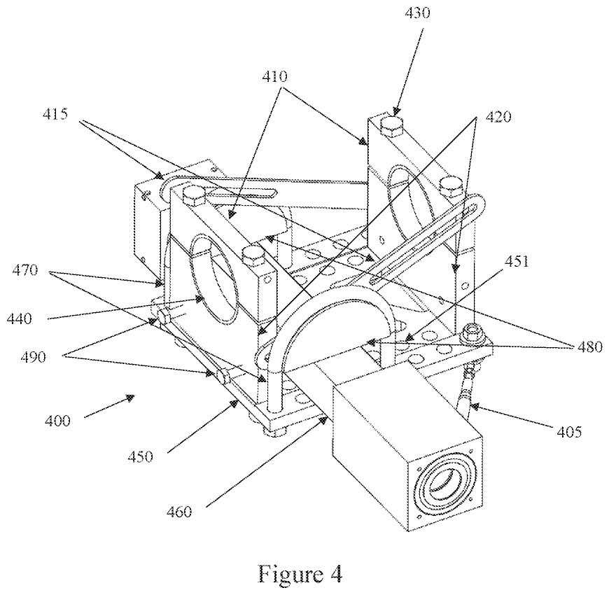

FIG. 4 shows an isometric view of axle clamp assembly 400, shown as 150 in FIG. 1. A pair of upper clamps 410 and lower clamps 420 may clamp onto a vehicle's axle tube (not shown). Clamping force may be provided by one or more screws 430. One or more shims 440 may allow clamping onto axle tubes of varying diameter. A clamp plate 450 may be rigidly connected to lower clamps 420. Shaft housing 460, shown as 205 in FIG. 2, may be rigidly connected to clamp plate 450 with u-bolts 470. Clamp plate 450 may include a plurality of holes 451 for lower clamps 420 and u-bolts 470 to interface in a plurality of positions. Clamping force between shaft housing 460 and u-bolts 470 may be transferred by saddles 480. As configured, axle clamp assembly 400 may allow shaft housing 460 to be positioned in a plurality of positions relative the vehicle's differential (not shown), both laterally and longitudinally. This may allow parallel shaft assembly (not shown) to interface with vehicles with rear drivetrains of varying dimensions and configuration. The plurality of holes 451 may allow coarse lateral positioning of both the clamp plate 450 on the axle tube (not shown) and the lower clamps 420 on the clamp plate 450. Fine lateral positioning and longitudinal positioning may be achieved by the relative positioning of shaft housing 460 with u-bolts 470 and/or saddles 480. Jack screws 490 may facilitate fine lateral positioning by acting on shaft housing 460 and may help resist movement of shaft housing 460 due to chain tension. A turnbuckle 405 may provide additional rigidity to axle clamp assembly 400 by rigidly connecting clamp plate 450 with a distal point of shaft housing 460. One or more braces 415 may provide additional rigidity to axle clamp assembly 400 by rigidly connecting upper clamps 410 to lower clamps 420 e.g., in a diagonal manner.

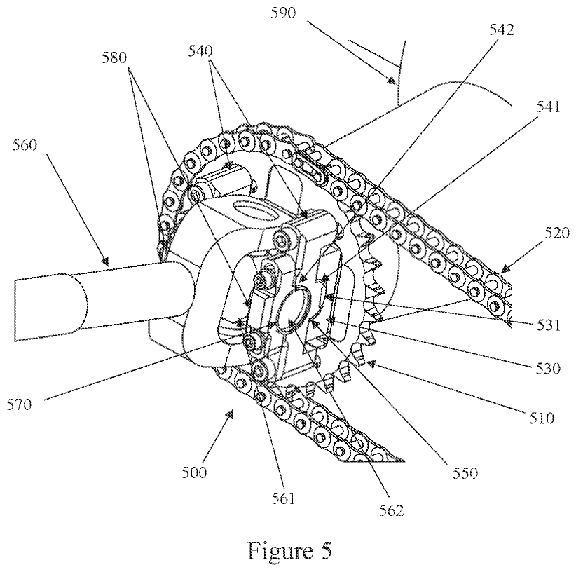

FIG. 5 provides an isometric view of differential input assembly 500 (shown as 160 in FIG. 1), the vehicle's prop shaft 560, and the vehicle's differential 590. Power may be transferred between the parallel shaft assembly (not shown) and a driven sprocket 510 via a chain 520. Driven sprocket 510 may alternatively be a pulley (not shown) driven by a belt (not shown), or alternatively a gear (not shown) driven by a gear (not shown) in the parallel shaft assembly (not shown). Power may be transferred between the driven sprocket 510 and a vehicle differential yoke 530 via one or more yoke bridges 540. Yoke bridge 540 may include a substantially cylindrical protrusion 541 for interfacing with a universal joint seat 531 of the differential yoke 530. One or more shims 550 may enable yoke bridges 540 to interface with universal joint seats 531 of varying diameter. Power may also be transferred between a universal joint 561 of the vehicle's driveshaft 560 and yoke bridges 540. In some embodiments, yoke bridge 540 may include a substantially cylindrical cavity 542 for interfacing with universal joint 561. One or more straps 580 may rigidly connect universal joint caps 562 to yoke bridges 540. One or more shims 570 may enable yoke bridges 540 and straps 580 to interface with universal joint caps 562 of varying diameter. As configured, when differential input assembly 500 is installed in a vehicle, the resulting position of the drive shaft universal joint 561 is close to its normal position in the differential yoke 530, and driveshaft 560 may not need to be shortened as would be required if the resulting position resulted in a loss of adequate stroke in the driveshaft spline (not shown).

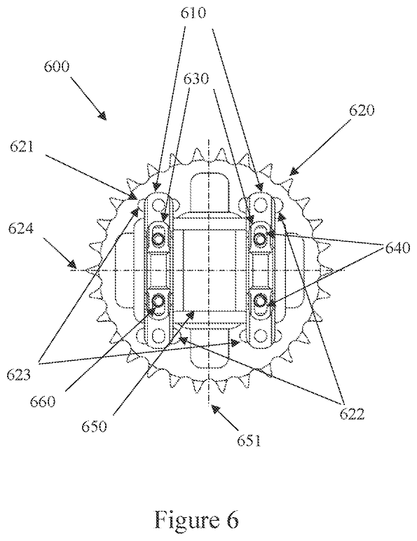

FIG. 6 provides a front view of a portion of differential input assembly 600. Assembly 600 includes a driven sprocket 620, that may include one or more slots 621, some of which may be loose slots 622 and tight slots 623 that may enable yoke bridges 610 to be rigidly connected to driven sprocket 620 via screws and nuts (not shown). The nuts may be of the t-slot type and may interface with slots 620. As configured, yoke bridges 610 may be able to accommodate universal joints (not shown) of varying widths. In some embodiments, tight slots 623 may create a tight fit with the screws (not shown) that connect yoke bridges 610 to driven sprocket 620 such that yoke bridges 610 are precisely aligned with a horizontal centerline 624 of driven sprocket 620. Alternatively, tight slots 623 may create a tight fit with a feature, such as a post (not shown) or pin (not shown), on yoke bridges 610. Loose slots 622 may create a loose fit with the screws (not shown) so as not to over-constrain the positioning of yoke bridges 610. Yoke bridges 610 and straps 630 may include slots 640 that may enable yoke bridges 610 and straps 630 to be rigidly connected to differential yoke 650 via screws (not shown) that may thread into differential yoke 650. Slots 640 may allow yoke bridges 610 and straps 630 to accommodate differential yokes 650 with varying bolt patterns. The screws (not shown) connecting yoke bridges 610 and straps 630 to differential yoke 650 may create tight fit with slots 640 to precisely align yoke bridges 610 and straps 630 with a vertical centerline 651 of differential yoke 650. One or more sleeves 660 may enable this tight fit when the screws (not shown) are smaller diameter than the width of the slot 640.

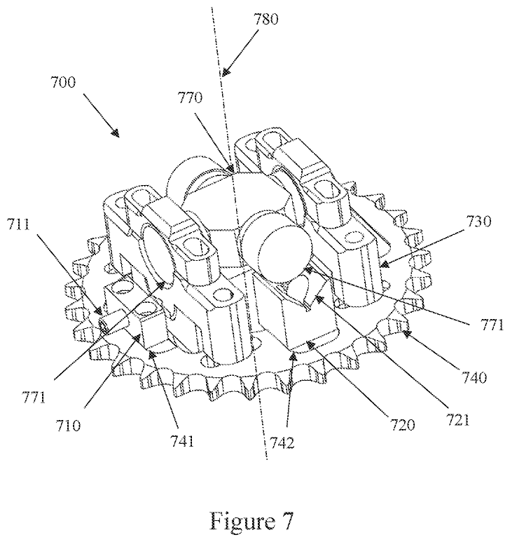

FIG. 7 provides an isometric view of differential input assembly 700, sprocket alignment tool 710 and universal joint alignment tool 720. To prevent vibration, the components of differential input assembly 700 and universal joint 770 should be substantially aligned with the axis of rotation of the differential pinion (not shown) during installation. One or more yoke bridges 730 may be aligned as described above. To align driven sprocket 740, sprocket alignment tool 710 may be placed against one or more sprocket alignment features 741 of driven sprocket 740. Sprocket alignment feature 741 of driven sprocket 740 may be precisely located relative to its centerline. A screw 711 may be advanced in increments while adjusting the position of driven sprocket 740, such that when placed against sprocket alignment feature 741 on either side of driven sprocket 740, a consistent and small gap may be achieved on either side, substantially centering driven sprocket 740. A taller sprocket alignment block (not shown) may be used in a similar manner to center a universal joint 770 by positioning screw 711 such that it contacts a universal joint cap 771 when advanced.

In another embodiment, universal joint alignment tool 720 may be precisely positioned relative to the centerline of driven sprocket 740 by a universal joint alignment feature 542 on driven sprocket 740. A V-shaped feature 721 on universal joint alignment tool 720 may interface with a universal joint cap 771 and may allow universal joint 770 to be substantially aligned with the centerline 780 of driven sprocket 740.

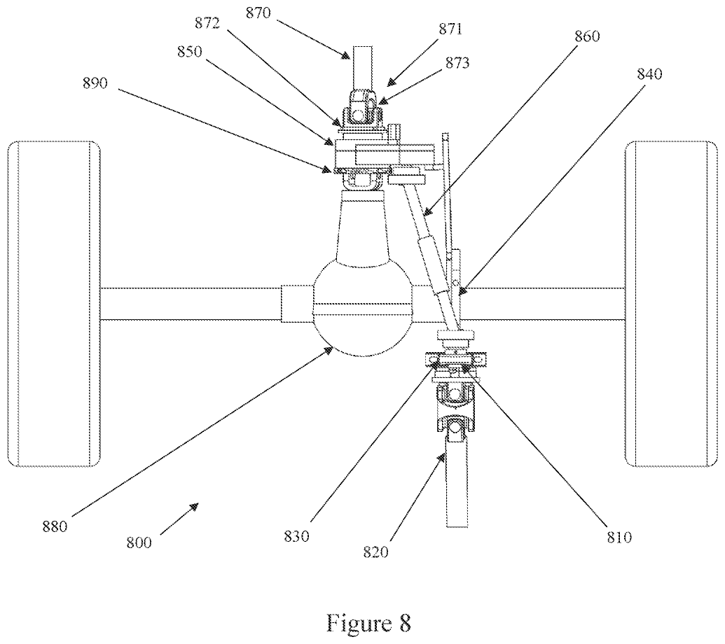

FIG. 8 provides a bottom view of an AHS 800 and an axle clamp assembly 840. Power may be transferred between the rear drive (not shown) and a parallel shaft 810 by a driveshaft 820. Parallel shaft 810 may be supported by a bearing block 830, which may be rigidly connected to axle clamp assembly 840. Power may be transferred between parallel shaft 810 and a power splitter 850 by a driveshaft 860. Power may be transferred between a vehicle's prop shaft 870 and power splitter 850. Power may be transferred between power splitter 850 and a vehicle's differential 880 by a differential input assembly 890.

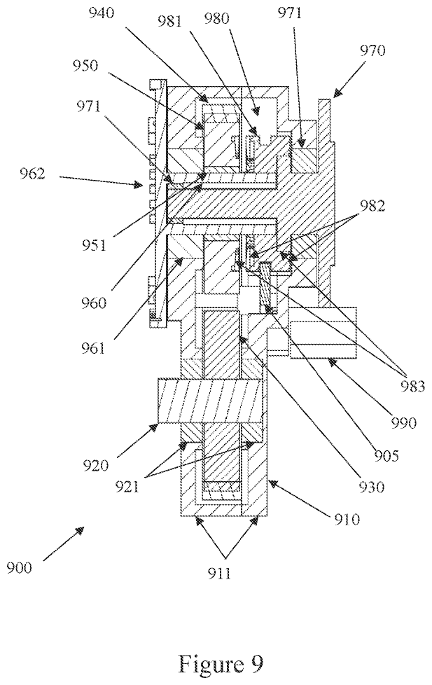

FIG. 9 provides a horizontal longitudinal cross section of a power splitter 900 (shown as 850 in FIG. 8). The components of power splitter 900 may be contained within a case 910. Case 910 may include two or more sub-cases, 911. Power may be transferred between driveshaft (shown as 860 in FIG. 8) and a hybrid input shaft 920, which may be supported by one or more bearings 921. An input sprocket 930 may be rigidly connected to hybrid input shaft 920. A chain 940 may transfer power between input sprocket 930 and a driven sprocket 950. Chain 940, input sprocket 930, and driven sprocket 950 may be a roller chain, inverted tooth chain, or any other type of chain, or may be a belt.

Referring now to another embodiment, a pair of gears (not shown) may replace chain 940, input sprocket 930, and driven sprocket 950, as is common in automotive transfer cases.

Referring back to the embodiment shown in FIG. 9, driven sprocket 950 may be connected to a rear shaft 960 by one or more bearings 951, allowing relative rotation of driven sprocket 950 to rear shaft 960. Rear shaft 960 may be supported by one or more bearings 961. A front shaft 970 may transfer power between power splitter 900 and the vehicle's driveshaft (shown as 870 in FIG. 8) and may be supported by bearings 971. A clutch 980 may allow driven sprocket 950 to be rotationally connected or disconnected to rear shaft 960. Clutch 980 may allow front shaft 970 to be rotationally connected or disconnected to rear shaft 960. Clutch 980 may allow front shaft 970 and driven sprocket 950 to be simultaneously rotationally connected or disconnected to rear shaft 960. In some embodiments, clutch 980 may include a sliding clutch 981, which may be splined to rear shaft 960 such that relative rotation is prevented but sliding motion is allowed. Sliding clutch 981 may include one or more torque transmitting features 982 that interface with one or more torque transmitting features 983 of driven sprocket 950 and front shaft 970. Torque transmitting features 982 and 983 may be dogs or splines, as is common in the art. In some embodiments, a flange 962 of rear shaft 960 may transfer power between power splitter 900 and differential input assembly (shown as 890 in FIG. 8).

Power splitter 900 may alternately allow transfer of power between the vehicle's differential (shown as 880 in FIG. 8) and either power the conversion device (shown as 3020 in FIG. 30) or the vehicle's prop shaft (shown as 870 in FIG. 8). Power splitter 900 may also simultaneously allow transfer of power between the vehicle's differential (shown as 880 in FIG. 8) and power conversion device (shown as 3020 in FIG. 30) and the vehicle's prop shaft (shown as 870 in FIG. 8). Power splitter 900 may also be configured to include a neutral position where there is no power connection between the vehicle's differential (shown as 880 in FIG. 8) and either the power conversion device (shown as 3020 in FIG. 30) or the vehicle's prop shaft (shown as 870 in FIG. 8). It is to be understood that this functionality is generally equivalent to a single-speed transfer case in a four-wheel-drive vehicle.

Movement of sliding clutch 981 may be controlled by an actuator 990 acting through a shift fork 905. Clutch 980 may include one or more synchronizers (not shown), as is common in automotive manual transmissions and transfer cases, to allow smooth engagement of sliding clutch 981 with driven sprocket 950, front shaft 970, or a combination of the components.

Front shaft 970 may be rotationally connected to rear shaft 960 via a one-way clutch (not shown). The one-way clutch may be of a roller, sprag, axial-pawl, or similar type of clutch. This may allow the vehicle to be powered simultaneously with its conventional drivetrain and power conversion device (shown as 3020 in FIG. 30), while preventing back-driving, e.g., forced rotation, of the conventional drivetrain.

In some embodiments, power splitter 900 may also include an oil pump (not shown), as is common in automotive transfer cases, for providing lubrication and/or cooling to the internal components. The oil pump may be located on the front shaft or rear shaft.

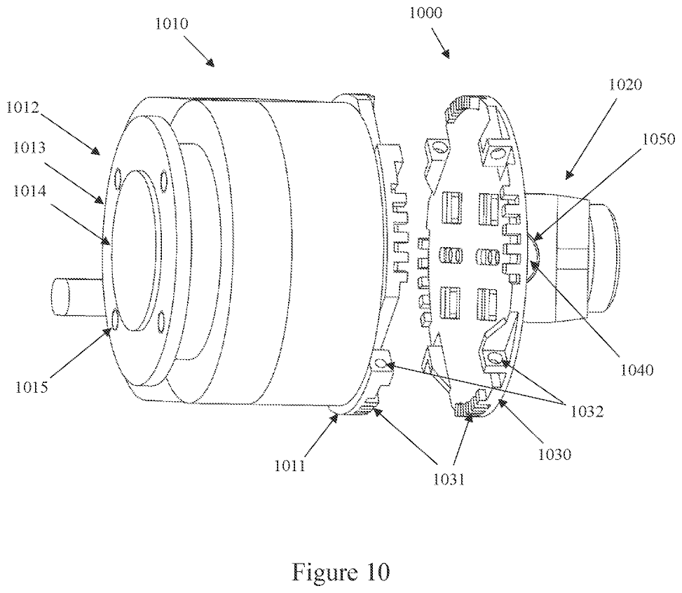

FIG. 10 provides a front isometric view of a differential input assembly 1000 (shown as 890 in FIG. 8), a power splitter 1010, and a yoke 1020 of the vehicle's differential (not shown). A flange 1030 may interface with a rear shaft flange 1011, such that when coupled together, power may be transferred between them. One or more yoke blocks 1040 may be rigidly connected to flange 1030 and may interface with the yoke 1020 in a manner similar to a universal joint, e.g., via a hemicylindrical cavity and a hemicylindrical protrusion. One or more shims 1050 may enable yoke blocks 1040 to interface with yokes 1020 intended for varying universal joint diameters by increasing the diameter of the yoke blocks 1040 to match that of yokes 1020. Flange 1030 and flange 1011 may include torque transmitting features 1031, such as teeth, to increase the amount of power that can be transmitted between them. Flange 1030 and flange 1011 may also include one or more screw holes 1032 for rigidly connecting them together with screws (not shown). The screw holes 1032 may be oriented circumferentially, as shown, to provide easier access for installation of screws (not shown).

Referring now to FIG. 8 and FIG. 10, flange 1013 of front shaft 1012 may include a pilot 1014 and one or more bolt holes 1015 and may be rigidly connected to a rear assembly 871 of a vehicle's prop shaft 870. As shown, rear assembly 871 may be added to the vehicle's prop shaft 870. The rear assembly 871 may be added by e.g., cutting the vehicle's prop shaft 870 and welding on the rear assembly 871. In some embodiments, cutting the vehicle's prop shaft 870 may remove enough length from the prop shaft 870 to allow installation of power splitter 1010. The vehicle's prop shaft 870 may be cut in the tubular section (not shown). Rear assembly 871 may include a flange 872 with features (not shown) that interface with flange 1013. Rear assembly 871 may also include a universal joint 873 or constant velocity (CV) joint (not shown).

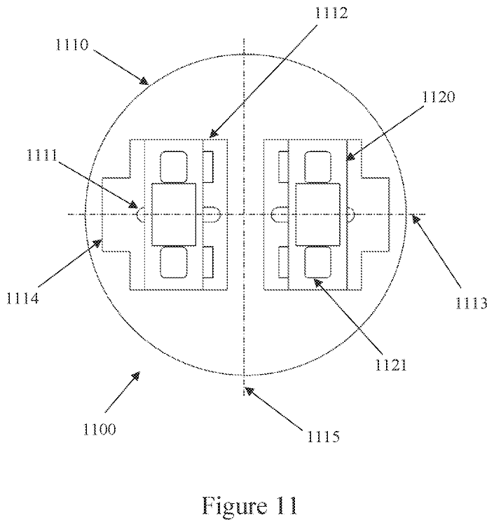

FIG. 11 provides a rear view of differential input assembly 1100. Assembly 1100 includes a flange 1110, which may include one or more slots 1111 that enable one or more yoke blocks 1120 to be rigidly connected to flange 1110 in a plurality of positions and may align yoke blocks 1120 with a horizontal centerline 1113 of flange 1110. Flange 1110 may include one or more torque transmitting features 1112, such as a pocket, which may interface with yoke blocks 1120, may increase the amount of power that can be transferred between them, and may align yoke blocks 1120 with the horizontal centerline 1113 of flange 1110. Yoke blocks 1120 may include one or more slots 1121, which may allow rigid connection to one or more differential yoke strap holes (not shown) with one or more screws (not shown) in a manner compatible with varying bolt hole patterns. Flange 1110 may include a tool seat 1114 that may allow accurate positioning of a tool (not shown), similar to sprocket alignment tool (shown as 710 in FIG. 7), that may enable yoke blocks 1120 to be aligned with respect to a vertical centerline 1115 of flange 1110.

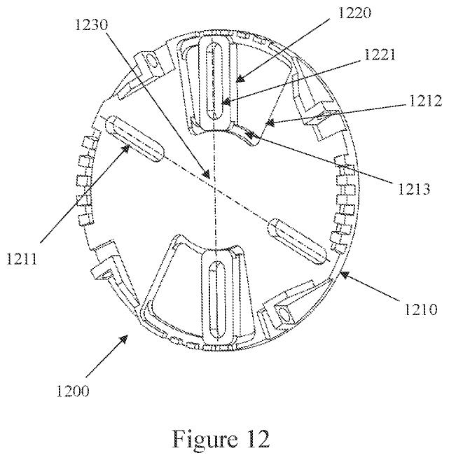

FIG. 12 provides an isometric view of another embodiment of a differential input assembly 1200 configured for vehicles with a flanged differential pinion shaft (not shown), in contrast to the yoke-style differential pinion shaft described above. Assembly 1200 includes a flange 1210 that may be rigidly connected to a differential pinion shaft flange (not shown) with one or more screws (not shown). One or more slots 1211 may enable rigid connection with differential pinion shaft flanges of varying bolt patterns. One or more clamps 1220, which may include one or more slots 1221, may enable flange 1210 to be rigidly connected to differential pinion shaft flanges of varying bolt patterns, some of which may be rectangular (as opposed to square patterns). Clamps 1220 may be located inside of cutouts 1212 in flange 1210, thereby allowing clamps 1220 to be positioned at a plurality of angles 1230 with respect to slots 1211. In some embodiments, cutouts 1212 may include one or more shoulders 1213 that interface with clamps 1220.

Referring now to FIG. 10, in another embodiment of power splitter 1010, front shaft 1012 may include a flange (not shown) similar to rear shaft flange 1011, that may enable the vehicle's prop shaft (not shown) to be rigidly connected to power splitter 1010 via an assembly (not shown) such as differential input assembly 1000. In some embodiments, the assembly (not shown) may be connected to the universal joint (561 in FIG. 5) of the vehicle's prop shaft. As configured, yoke blocks (not shown) such as yoke blocks 1040, may include a convex cylindrical portion for interfacing with a universal joint 561 in FIG. 5) of the vehicle's prop shaft. The vehicle's prop shaft may alternatively be connected to power splitter 1010 via an assembly (not shown) such as differential input assembly 1200, shown in FIG. 12, which may be connected to the vehicle prop shafts with a flanged differential interface (1100 in FIG. 11).

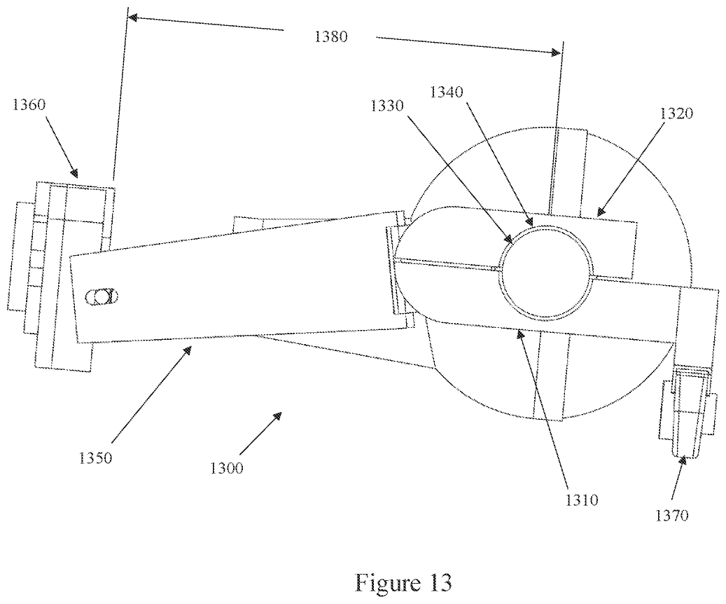

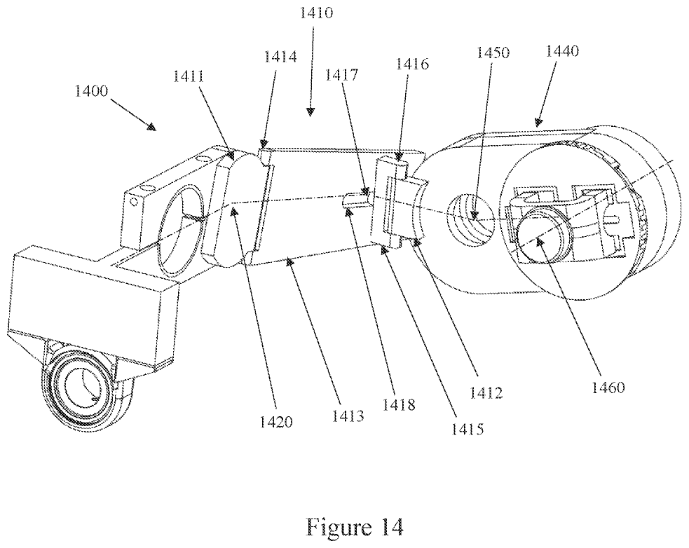

FIG. 13 provides a side view of axle clamp assembly 1300 (shown as 840 in FIG. 8) and FIG. 14 provides an isometric view of axle clamp assembly 1400. A lower clamp 1310 and an upper clamp 1320 may clamp onto a vehicle axle tube 1330 with one or more screws (not shown). One or more shims 1340 may allow clamping onto axle tubes 1330 of varying diameter. A bearing block 1370 (shown as 830 in FIG. 8) may be rigidly connected to axle clamp assembly 1300. A clocking arm 1350 may rigidly connect a power splitter 1360 to lower clamp 1310, upper clamp 1320, or both. A clocking arm 1410 may include an elevation block 1411 that may allow clocking arm 1410 to be connected in a plurality of angles 1420 to lower clamp 1310 and an upper clamp 1320. Clocking arm 1410 may include an arm 1413 which may be rotationally connected to an elevation block 1411 at a hinge 1414. Clocking arm 1410 may include a pivot block 1412, which may be rigidly connectable to a power splitter 1440 in a plurality of angles 1450. Clocking arm 1410 may include a connector block 1415 which may be rotationally connected to pivot block 1412 at hinge a 1416. Connector block 1415 may be rigidly connected to arm 1413. Connector block 1415 may include a pin 1417, which may interface with a slot 1418 in arm 1413, such that power splitter 1360 can be located at varying distances 1380 from the axle tubes 1330. As configured, clocking arm 1410 may allow power splitter 1440 to be positioned in a plurality of angles about a differential axis 1460 and optionally maintained in that position as power is transferred through power splitter 1440. Clocking arm 1410 may be rigidly connected to power splitter 1440 with lower clamp 1310 and upper clamp 1320 positioned in a plurality of locations on the vehicle's axle tube 1330.

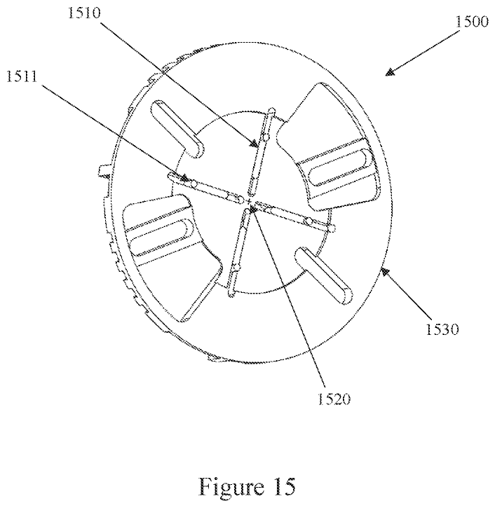

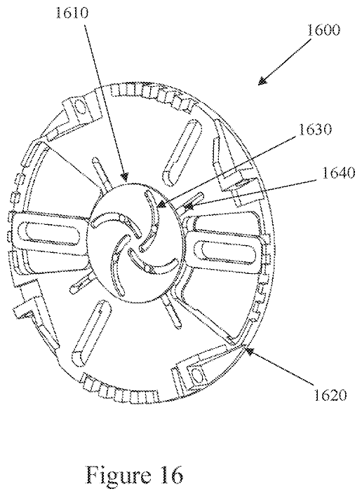

FIG. 15 and FIG. 16 provide rear and front isometric views, respectively, of another embodiment of a differential input assembly 1500 and 1600. Differential input assembly 1500 may include one or more moveable pilots 1510 which may include one or more protrusions 1511. Protrusions 1511 may interface with a pilot feature (not shown) on a differential pinion shaft flange (not shown). For example, the interface may be with the inside of a female pilot feature or the outside of a male pilot feature. An adjustment mechanism 1610 may be rotationally connected to a flange 1620 and may include one or more features 1630 that interact with one or more movable pilots 1640 such that rotation of adjustment mechanism 1610 may cause moveable pilots 1640 to move inward or outward simultaneously. Protrusions 1511 on two or more moveable pilots 1510 may preferably be substantially equidistant from a centerline 1520 of a flange 1530, such that when interfacing with the pilot feature of a differential pinion shaft flange, the centerline 1520 of flange 1530 is substantially aligned with the axis of rotation. As configured, differential input assembly 1500, 1600 may be installed on differential pinion shaft flanges with pilot features of varying diameters.

It is understood that the interface between a power splitter and a differential pinion shaft flange provided in the FIG. 15 and FIG. 16 discussions may also be applied to an interface between a power splitter and a vehicle driveshaft having a flange.

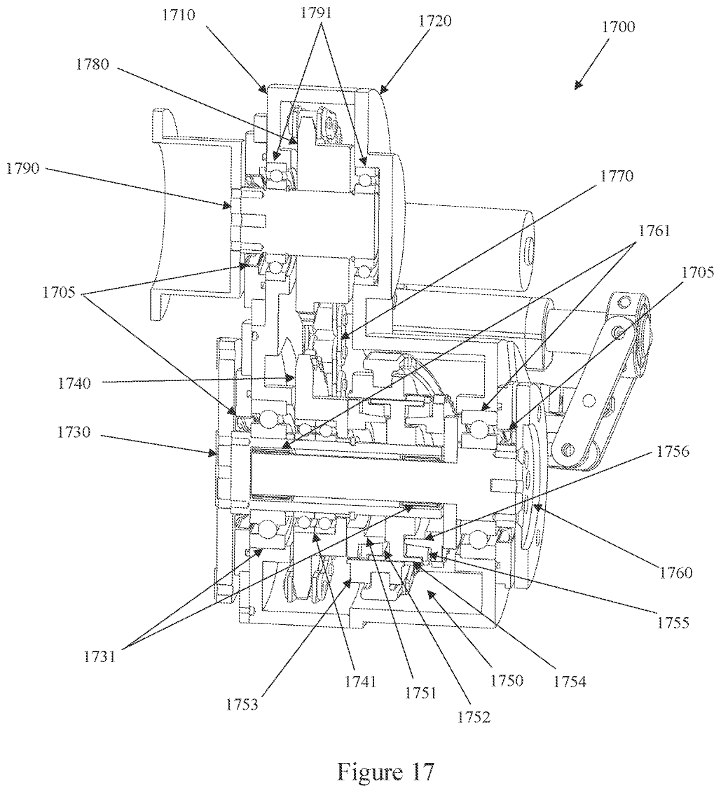

FIG. 17 provides an isometric cutaway view of a power splitter 1700, (described in FIG. 9) which may include a rear housing 1710 and a front housing 1720. Power splitter 1700 may include an output shaft 1730 which may transfer power to and from the vehicle's differential (not shown) and may be supported by one or more bearings 1731. An output sprocket 1740 may be rotatingly connected to output shaft 1730 by one or more bearings 1741. In some embodiments, synchronizer 1750 may include first synchronizer cone 1751, which may be rigidly connected to output sprocket 1740 and may be configured to engage with a first blocking ring 1752 and to transfer power to and from a synchronizer sleeve 1753, when synchronizer sleeve 1753 is in a first position as shown. Synchronizer sleeve 1753 may be slidingly connected to a synchronizer hub 1754, which may be rigidly connected to output shaft 1730. A second blocking ring 1755 and a second synchronizer cone 1756 may be configured to engage with synchronizer sleeve 1753 and to transfer power to and from a front shaft 1760 when synchronizer sleeve 1753 is in a second position (not shown). In some embodiments, front shaft 1760 may be supported by one or more bearings 1761. As configured, when synchronizer sleeve 1753 is in a first position, power may be transferred between output shaft 1730 and output sprocket 1740 and interrupted between output shaft 1730 and front shaft 1760. Accordingly, when synchronizer sleeve 1753 is in a second position (not shown), power may be transferred between output shaft 1730 and front shaft 1760 and interrupted between output shaft 1730 and output sprocket 1740. As used herein, power interruption refers to the cessation or prevention of the flow of power from one element to another. In some embodiments, synchronizer 1750 may be configured such that friction between first and second blocking rings 1752, 1755 and first and second synchronizer cones 1751, 1756 causes their rotational speed to match that of synchronizer hub 1754 and synchronizer sleeve 1753, which may enable smooth engagement of synchronizer sleeve 1753 with first or second synchronizer cone 1751, 1756. In some embodiments, the function and construction of synchronizer 1750 is similar to that of synchronizers commonly used in automotive manual transmissions and transfer cases.

Still referring to FIG. 17, a chain 1770 may be engaged with output sprocket 1740 and may be configured to transfer power between output sprocket 1740 and an input sprocket 1780. Input sprocket 1780 may be rigidly connected to a hybrid input shaft 1790, which may be supported by one or more bearings 1791.

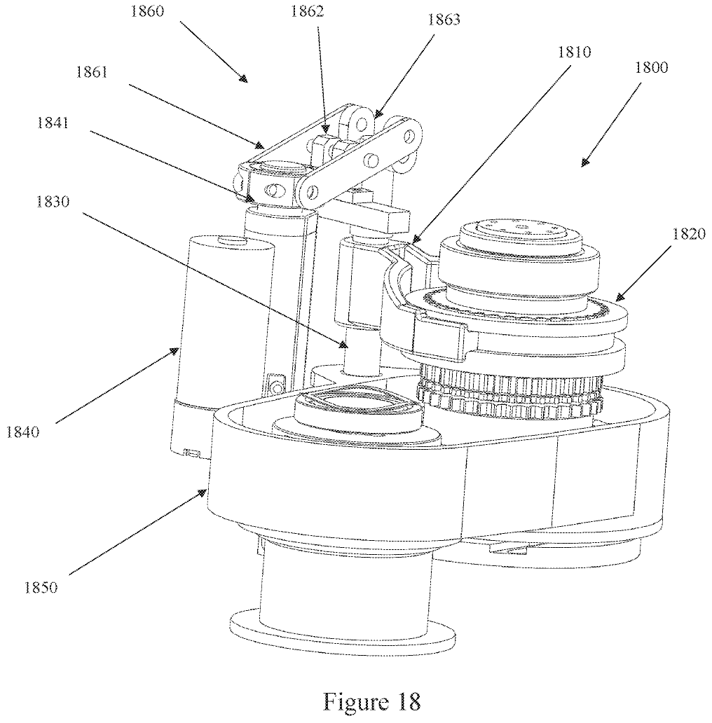

FIG. 18 provides an isometric view of a simplified power splitter 1800. Power splitter includes a fork 1810 that may be rotatingly connected to a synchronizer sleeve 1820 and rigidly connected to a fork shaft 1830. As configured, when fork shaft 1830 is moved axially, fork 1810 may cause synchronizer sleeve 1820 to move between a first position (not shown) and a second position as shown. It should be appreciated that any number of positions may be moved between, including, for example, a third position corresponding to neutral.

In some embodiments, a linear actuator 1840 may be rotatingly connected to a front housing 1850 and a linkage assembly 1860. Linkage assembly 1860 may include one or more pivot links 1861 which may be rotatingly connected to a fulcrum 1862. Fulcrum 1862 may be rigidly connected to rear housing (not shown). Pivot links 1861 may be rotatingly connected to one or more drop links 1863, which may be rotatingly connected to fork shaft 1830. As configured, when actuator shaft 1841 of linear actuator 1840 extends and retracts, synchronizer sleeve may be moved between the first and second positions, previously described. It is understood that automotive transmissions and transfer cases employ a number of common mechanisms for moving a synchronizer sleeve or dog clutch between multiple positions, and that the use of any such mechanism is within the scope of this disclosure.

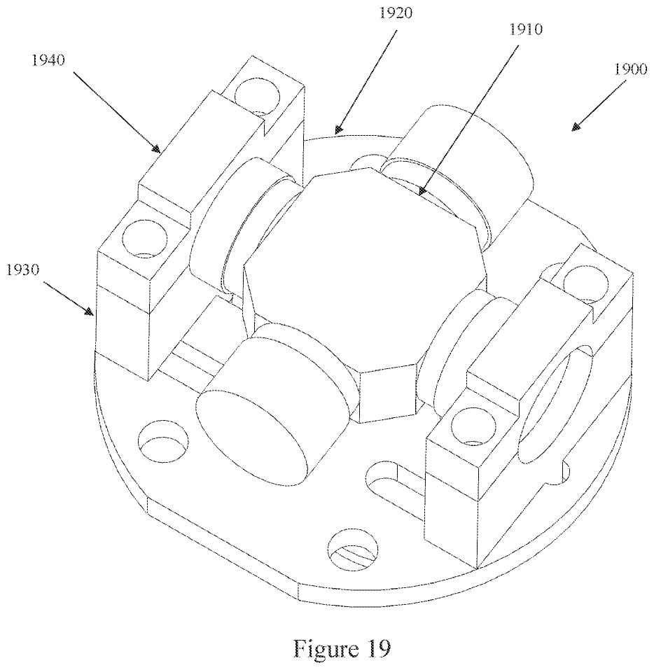

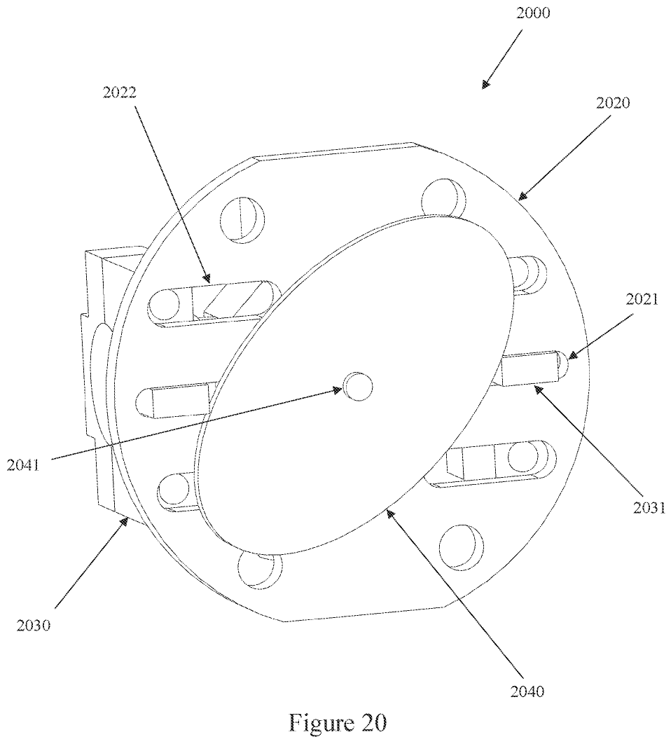

Referring now to FIG. 19 and FIG. 20, FIG. 19 provides a front isometric view and FIG. 20 provides a rear isometric view of u-joint interface 1900, 2000. U-joint interface 1900 may include u-joint flange 1920. In some embodiments, one or more u-joint saddles 1930 may be rigidly connected to u-joint flange 1920 and may interface with a u-joint 1910 of a driveshaft (not shown). One or more u-joint caps 1940 may be rigidly connected to u-joint saddles 1930. U-joint saddles 1930 and u-joint caps 1940 may have varying diameters to be compatible with u-joints of varying geometry. Alternatively, shims (not shown) may be included to provide compatibility with u-joints of varying geometry. U-joint saddles 2030 may be positionable on a u-joint flange 2020 via a tab 2031, which may be slidingly connected to a slot 2021, and one or more screws (not shown), which may engage with slots 2022 to engage with u-joint saddle 2030. In some embodiments, an alignment tool 2040 may rotatingly engage with u-joint flange 2020 at a pivot 2041 during installation and may be symmetric about pivot 2041 and of varying radii. In some embodiments, alignment tool 2040 may also be affixed to u-joint interface 1900, 2000 and not removed following installation. Tabs 2021 of two opposing u-joint saddles 2030 may be brought into contact with alignment tool 2040 simultaneously as alignment tool 2040 is rotated to an appropriate radius, which may position u-joint saddles 2030 symmetrically about pivot 2041. As configured, u-joint flange 2020 may be alignable with u-joint 1910.

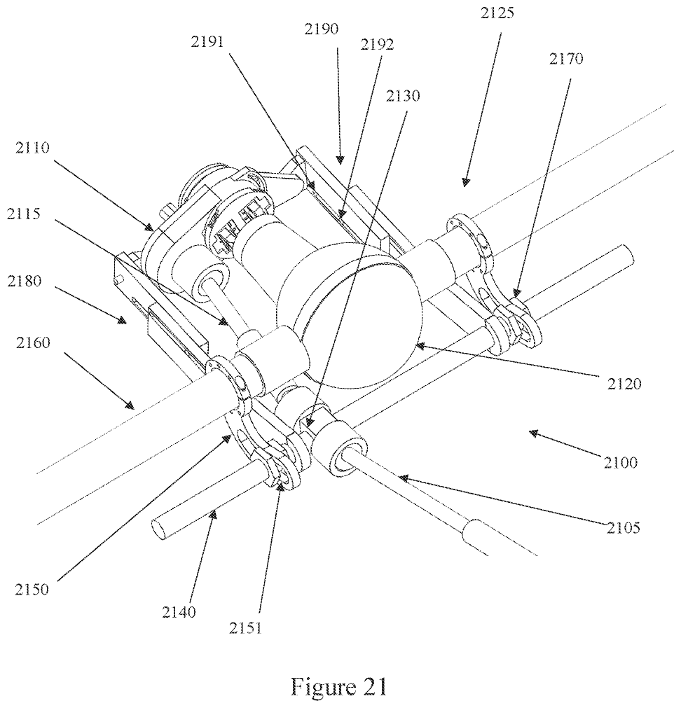

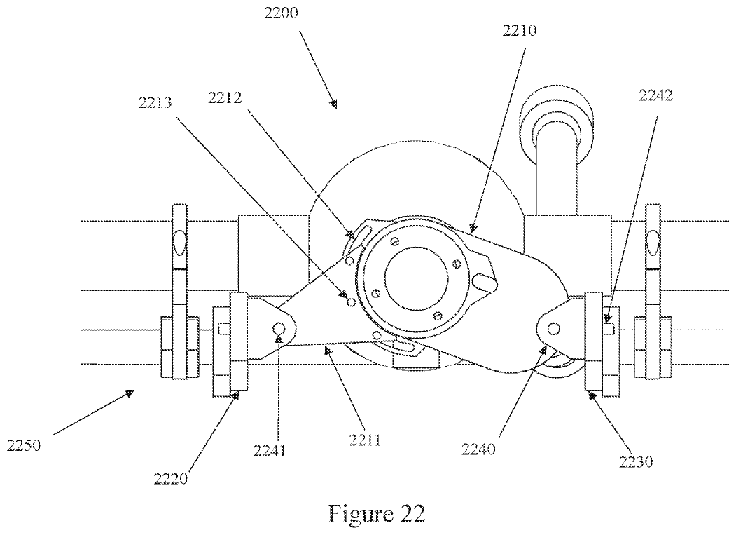

Referring now to FIG. 21 and FIG. 22, FIG. 21 provides another embodiment of an AHS 2100 and an axle clamp assembly 2125. In this embodiment, a power splitter 2110 may be connected to the vehicle's differential 2120 and driveshaft (not shown) in a manner similar to that described above for FIG. 8 and may function similarly. A parallel shaft 2130 may be connected to a transverse bar 2140 and may be positionable at a number of transverse positions and at a number of pitch angles. Transverse bar 2140 may be connected to a vehicle's axle tube 2160 by one or more axle clamps 2150, which may be positionable at a number of transverse positions and at a number of pitch angles. Axle clamps 2150 may include a slot 2151 that may allow transverse bar 2140 to be positionable at varying distances from axle tubes 2160. Slots 2151 may be curved, as shown. Transverse bar 2140 may be positioned transversely relative to axle clamps 2150 by one or more bar clamps 2170. Bar clamps 2170 may be connected to transverse bar 2140 by e.g., threading or clamping. Rotation of power splitter 2110 about the pinion axis (not shown) may be prevented by a first linkage 2180. Rotation of power splitter 2110 about the pinion axis may be further prevented by a second linkage 2190. First linkage 2180 and/or second linkage 2190 may be rigidly connected to transverse bar 2140 and may be positionable at a number of transverse positions and at a number of pitch angles. First linkage 2180 and/or second linkage 2190 may clamp to transverse bar 2140. First linkage 2180 and/or second linkage 2190 may be extensible to allow varying distance from axle tube 2160 to power splitter 2110 from vehicle to vehicle and may be achieved with one or more slots 2191 and one or more pins 2192, as shown. Transverse bar 2140 may be configured to be shortened as much as possible after installation, for example by telescoping, to minimize the chance of interference with other components.

FIG. 22 provides a front view of an AHS 2200 and an axle clamp assembly 2250. AHS 2200 includes a power splitter 2210, which may include an ear 2211. Ear 2211 may be positionable at a number of roll angles, which may be achieved via one or more slots 2212 and one or more screw holes 2213. Power splitter may be rigidly connected to first linkage 2220 and/or second linkage 2230 via one or more brackets 2240. Brackets 2240 may be connected to power splitter 2210 at one or more pivots 2241, which may allow varying roll angles, so as to accommodate the angle between power splitter 2210 and first linkage 2220 and/or second linkage 2230. Brackets 2240 may be rigidly connected to first linkage 2220 and/or second linkage 2230 via one or more studs 2242 as shown, or by one or more screws (not shown).

As configured, axle clamps 2150 may be positioned on the axle tubes 2160 in a position and at an angle where they do not interfere with vehicle components such as brake lines (not shown) or shock absorbers (not shown). Power splitter 2110, 2210 may be positionable at a roll angle, such that it does not interfere with vehicle components such as the exhaust system (not shown) or fuel tank (not shown), and to most closely align with a parallel shaft 2130. Transverse bar 2140 may be positionable in the longitudinal vertical plane such that it and one or more axle clamps 2150, parallel shaft 2130, first linkage 2180, 2220, and second linkage 2190, 2230 do not interfere with vehicle components, and such that parallel shaft 2130 aligns with rear drive (not shown). Parallel shaft 2130 may be positionable such that the angle formed with a first driveshaft 2105 and a second driveshaft 2115 may be minimized and may be close to equal.

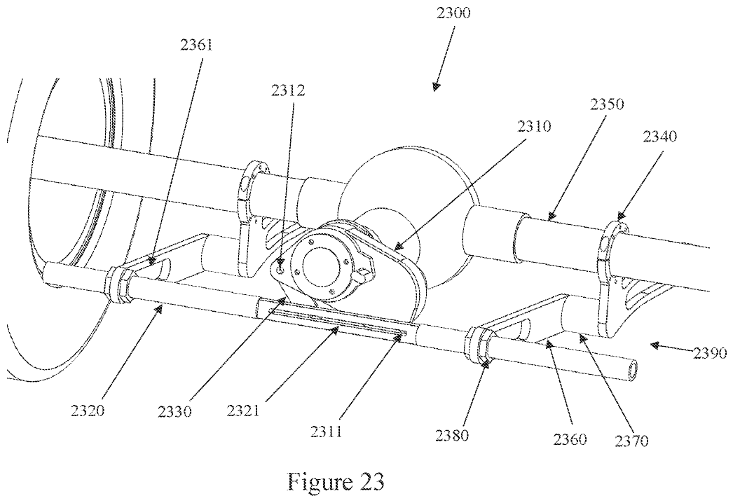

FIG. 23 provides a portion of another AHS 2300 (as provided in FIG. 21 discussion) and an axle clamp assembly 2390. In this example, rotation of a power splitter 2310 about the pinion axis (not shown) may be prevented by a transverse bar 2320. Transverse bar 2320 may be rigidly connected to power splitter 2310 at a hole 2311, for example with one or more screws (not shown). Hole 2311 may interface with a slot 2321 in transverse bar 2320, which may allow varying roll angles of power splitter 2310. Rotation of power splitter 2310 may be further prevented by a drop link 2330, connected to one or both power splitter 2310 and transverse bar 2320, for example with one or more screws (not shown). Drop link 2330 may be rotationally connected to power splitter 2310 at a pivot 2312 and may interface with a slot 2320, such that varying roll angles of power splitter 2310 may be tolerated or accommodated. In another example (not shown), the direct connection between power splitter 2310 and transverse bar 2320 may be replaced by a second drop link (not shown). One or more axle clamps 2340 may be rigidly connected to an axle tube 2350, as provided in FIG. 21 discussion. One or more forward linkages 2360 may be rigidly connected to one or more axle clamps 2340 and may be configured to have an adjustable pitch angle to allow varying positions of power splitter 2310. Forward linkages 2360 may be connected to axle clamps 2340 with one or more spacers 2370 such that forward linkages 2360 may be positionable in locations that prevent interference with vehicle components such as a fuel tank (not shown) or exhaust system (not shown). Spacers 2370 may be provided in varying lengths to accommodate vehicles of varying configurations. Transverse bar 2320 may interface with forward linkages 2360 at slots 2361 to allow varying positions of power splitter 2310. Transverse bar 2320 may be rigidly connected to forward linkages 2360 with one or more bar clamps 2380, as provided in FIG. 21 discussion.

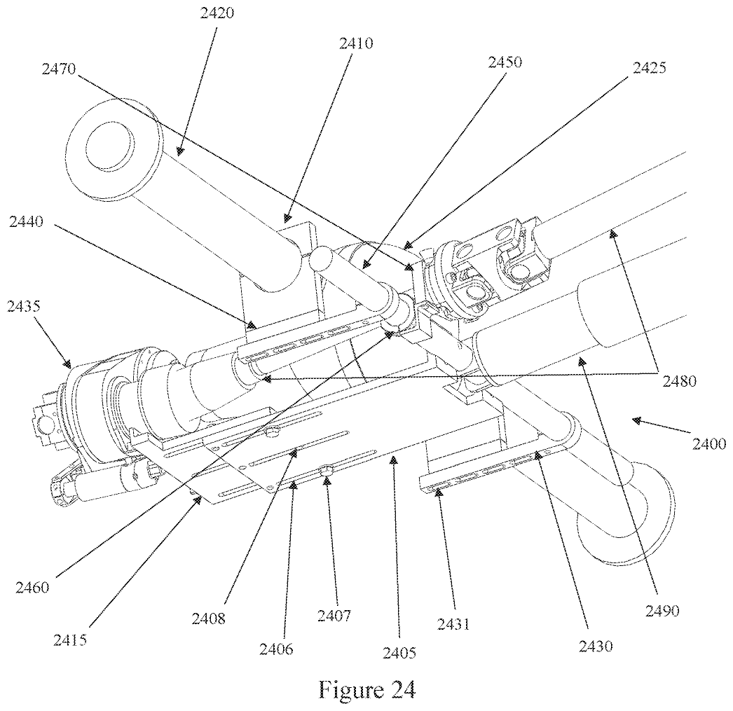

FIG. 24 provides a bottom isometric view of an axle clamp assembly 2400. Assembly 2400 includes an axle clamp 2410, which may be configured to be rigidly connected to a vehicle's axle tube 2420. In some embodiments, one or more rear linkages 2430 may be rigidly connected to axle clamp 2410 or may be connected to axle clamp 2410 with one or more spacers 2440. Rear linkages 2430 may be longitudinally positionable with respect to axle clamps 2410 via one or more slots 2431. Axle clamps 2410 may include a plurality of holes (not shown) for locating rear linkages 2430 in a plurality of positions. Rear linkages 2430 may be configured to clamp around transverse bar 2450. One or more bearing clamps 2460 may be configured to clamp around transverse bar 2450 and may be rotatingly connected to one or more bearing blocks 2470. Bearing blocks 2470 may be configured to support one or more driveshafts 2480. A supplemental suspension system (SSS) 2490 may be rotatingly connected to transverse bar 2450. As configured, axle clamps 2410 may be placed at a location on the vehicle's axle tubes 2420 free of any vehicle components (not shown), and rear linkages 2430 and transverse bar 2450 may be positionable in an optimal location with respect to components of the vehicle while affording maximum ground clearance, for example, as high above the ground as possible without incurring risk of collision with vehicles components when the suspension is at maximum compression.

A rear clocking linkage 2405 may be configured to be rigidly connected to transverse bar 2450 at a plurality of vertical positions, for example via one or more slots (not shown). A front clocking linkage 2415 may be configured to be rigidly connected to rear clocking linkage 2405 at a plurality of longitudinal positions, for example, via one or more slots 2406 and one or more screws 2407 and/or one or more pins 2408. As configured, front and/or rear clocking linkages 2405, 2415 may be positionable against the underside of the vehicle's differential 2425 and front clocking linkage 2415 may be positionable such that it can engage with power splitter 2435.

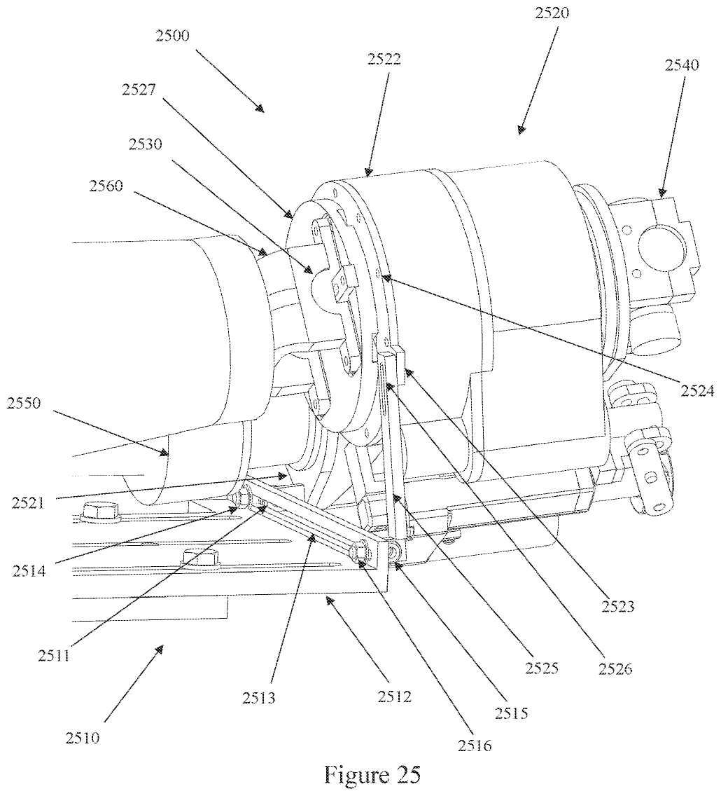

FIG. 25 provides a rear isometric view of a system 2500 including a portion of an axle clamp assembly 2510, a power splitter 2520, a differential input assembly 2530, and a u-joint interface 2540. Power splitter 2520 may include a first clocking pivot 2521, which may be rotatingly connected to a rear housing 2522. Power splitter 2520 may include a second clocking pivot 2523, which may be rotatingly connected to rear housing 2522, and which may be configured to be rigidly connected to rear housing 2522 in a plurality of positions, for example with one or more holes 2524 and one or more screws (not shown). Holes 2524 in second clocking pivot 2523 may have different angular spacing than holes (not shown) in rear housing 2522, which may enable fine adjustment of second clocking pivot's 2523 position, similar to a Vernier scale. First clocking pivot 2521 may be rotatingly connected to a first anchor 2511, for example, with a screw (not shown) and may be configured to be rigidly connected, for example by tightening the screw. First anchor 2511 may be slidingly connected to front clocking linkage 2512, for example with a slot 2513, and may be configured to be rigidly connected, for example by tightening a first nut 2514. Second clocking pivot 2523 may be configured to be rigidly connected to drop link 2525 at a plurality of positions, for example with a slot 2526 and a screw (not shown). Drop link 2525 may be rotatingly connected to a second anchor 2515, for example with a screw (not shown) and may be configured to be rigidly connected, for example by tightening the screw. Second anchor 2515 may be slidingly connected to front clocking linkage 2512, for example, with a slot 2513, and may be configured to be rigidly connected, for example, by tightening a second nut 2516. As configured, power splitter 2520 may be positionable at a plurality of roll angles to provide clearance with vehicle components, such as exhaust systems (not shown) or a fuel tank (not shown), and to align with one or more driveshafts 2550, and once positioned may be held rigidly in place and be capable of resisting roll due to application of external torque.

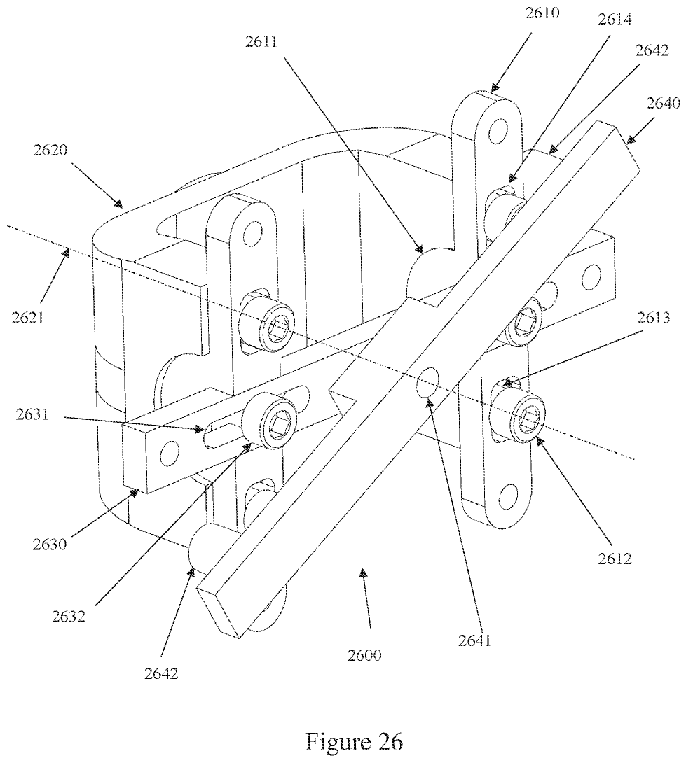

Referring now also to FIG. 26, differential input assembly 2530, 2600 may be configured to engage with a differential yoke 2560, 2620 and an output flange 2527 of power splitter 2520. Differential input assembly 2600 may include one or more yoke mounts 2610, which may include a cylindrical portion 2611, and may have varying diameters to be compatible with differential yokes 2620 of varying geometry. One or more screws 2612 may rigidly connect yoke mounts 2610 to differential yoke 2620, and one or more sleeves 2613 may be configured to align one or more slots 2614 of yoke mounts 2610 equidistantly from a differential yoke centerline 2621. A yoke plate 2630 may engage with yoke mounts 2610 and may be compatible with differential yokes 2620 of varying geometry with one or more slots 2631 and one or more screws 2632. In some embodiments, an alignment tool 2640 may be configured to rotatingly engage with yoke plate 2630 at a pivot 2641 and may include two or more protrusions 2642. As configured, alignment tool 2640 may allow a user to align pivot 2641 with the yoke centerline 2621 by placing one or more protrusions 2642 in contact with two yoke mounts 2610. Alignment tool 2640 may be affixed to differential input assembly 2530, 2600 or a separate device engaged only during installation. As configured, differential input assembly 2530, 2600 may engage and be aligned with differential yokes 2620 of varying width, u-joint diameter, screw size, and screw position and to rigidly connect to power splitter 2520.

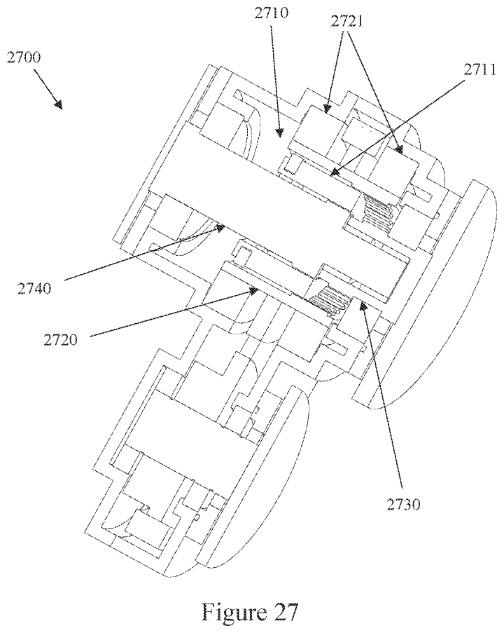

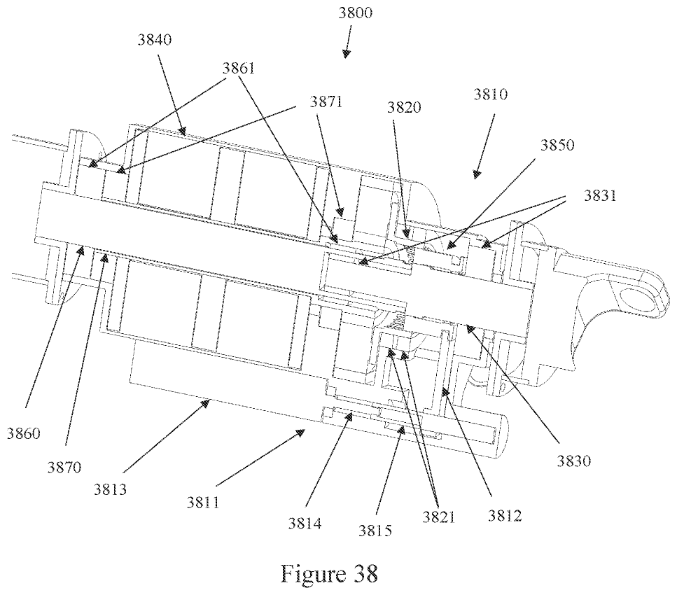

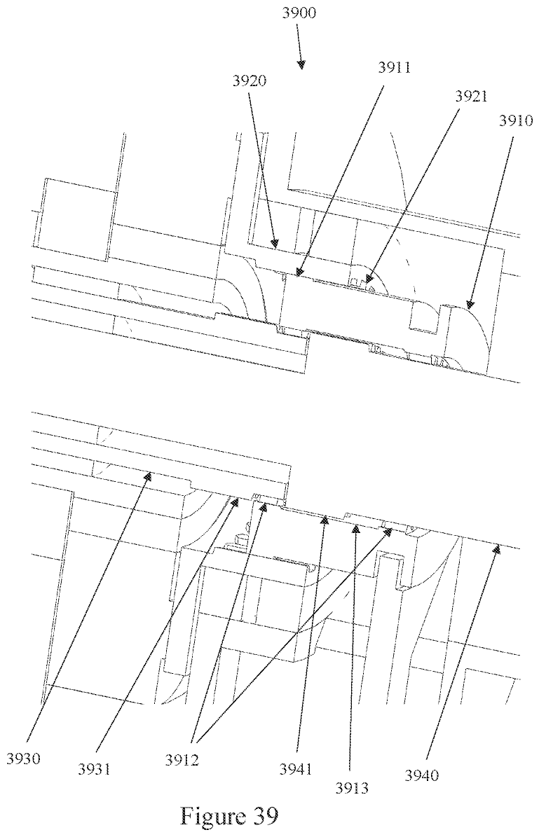

FIG. 27 provides an isometric cutaway of a power splitter 2700 (as provided in FIG. 17 discussion), with a clutch assembly 2710 (as provided in FIG. 38 and FIG. 39 discussions). In this exemplary configuration, a sliding clutch 2711 may be configured to transmit power between an output sprocket 2720 and an output shaft 2730 when in EV mode; between a front shaft 2740 and an output shaft 2730 when in engine mode; between front shaft 2740 and output sprocket 2720 when in generator mode; and may be only connected to output sprocket 2720 to enable rev-matching in neutral mode. Sliding clutch 2711 may be connected to output sprocket 2720, output shaft 2730, and front shaft 2740 when in hybrid mode. Output sprocket 2720 may be supported by one or more bearings 2721. As configured, the vehicle (not shown) may be capable of operating in all of the modes described in FIG. 38. It is understood that the terms “mode” and “state” as described herein may be used interchangeably.

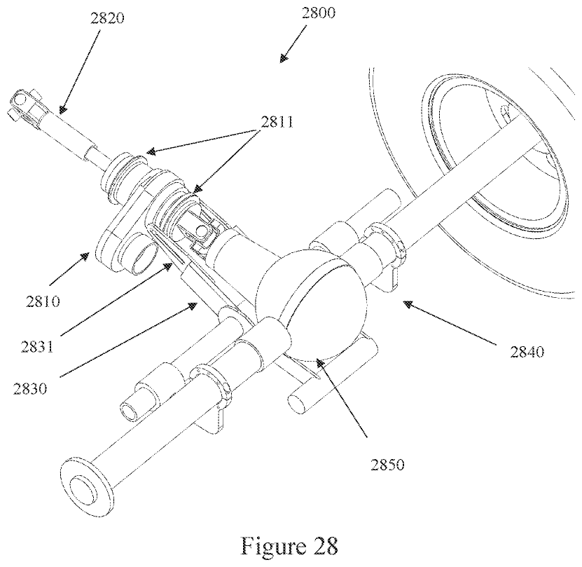

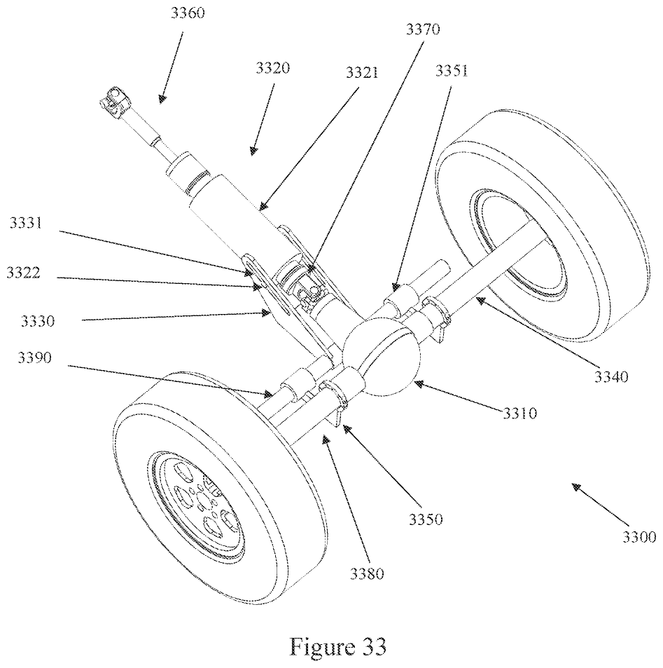

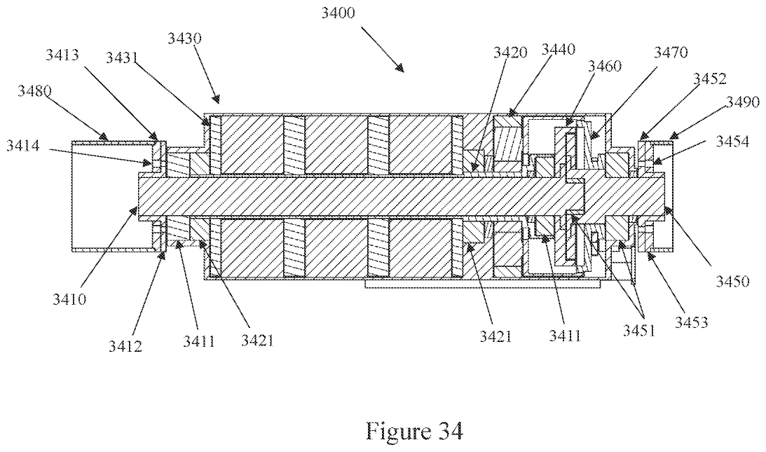

Referring now to FIG. 8, FIG. 24, FIG. 28, FIG. 33, and FIG. 34, FIG. 28 provides an isometric view of an example of an AHS 2800, which may include a power splitter 2810, as provided in FIG. 8 discussion. Power splitter 2810 may include one or more flanges 2811, which may enable power splitter 2810 to be installed in line with a vehicle's driveshaft 2820, in the manner provided in FIG. 34 discussion. AHS 2800 may include a linkage 2830, which may connect to power splitter 2810, and prevent roll as provided in FIG. 33 discussion. Linkage 2830 may include one or more extensible arms 2831, which may allow linkage 2830 to connect to power splitter 2810 when installed on vehicles of varying dimensions. For example, one vehicle may have a dimension between the axle tube and the front of the differential of 8 inches, and another may be 10 inches. The present disclosure allows both of these vehicle to use the same AHS. In some embodiments, AHS 2800 may include an axle clamp system 2840, which may connect to linkage 2830 and to one or more driveshafts (not shown) as provided in FIG. 24 discussion. As configured, power splitter 2810 may transmit power between a rear drive (not shown), the vehicle's engine (not shown), and the vehicle's differential 2850, as provided in FIG. 8 discussion, and may be able to articulate with movement of the vehicle's differential 2850, e.g., by changing its angle of connection.

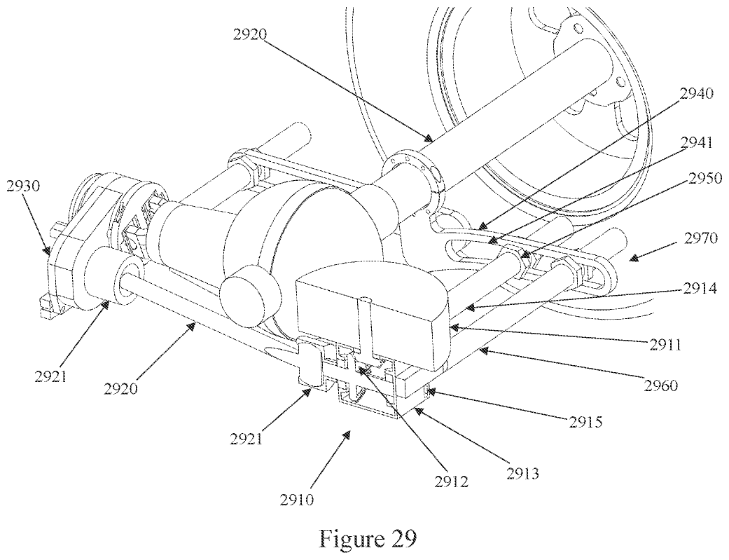

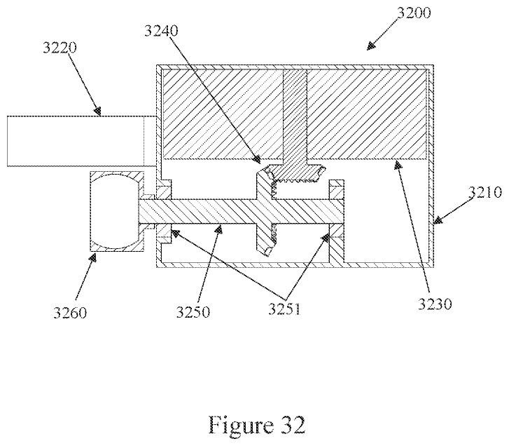

FIG. 29 provides a cutaway view of another example of an AHS 12300, as provided in FIG. 21 discussion, and an axle clamp assembly 2970. In this exemplary configuration, a rear drive 2910 may be rigidly connected to a vehicle's axle tube 2920. Rear drive 2910 may include a power conversion device 2911. In some embodiments, power conversion device 2911 may be an electric motor or an axial flux motor. Rear drive 2910 may include a gear set 2912, as provided in FIG. 32 discussion. Rear drive 2910 may include an output shaft 2913 which may be substantially longitudinally oriented. Driveshaft 2920 may transfer power between rear drive 2910 and a power splitter 2930 and may include one or more constant velocity (CV) joints 2921. Rear drive may include a rear chassis 2913. Rear drive may also include one or more first transverse bars 2914, which may be rigidly connected to rear chassis 2913. One or more first transverse bars 2914, may be rigidly connected to one or more axle clamps 2940 and may interface with one or more slots 2941. First transverse bars 2914 may be rigidly connected to one or more axle clamps 2940 by one or more bar clamps 2950, as provided in FIG. 21 discussion. Rear chassis 2913 may be further connected to axle clamps 2940 by one or more second transverse bars 2960, which may connect to axle clamps 2940 in a similar manner to first transverse bars 2914. Second transverse bar 2960 may be rigidly connectable to rear chassis 2913 at multiple vertical locations, for example by one or more slots 2915 and screws (not shown). As configured, rear drive 2910 may be positionable in multiple longitudinal and transverse positions by adjustment of the connection between first transverse bars 2914 and axle clamps 2940, avoiding interference with vehicle components. The pitch angle of rear drive 2910 may be varied by adjustment of the connection between rear chassis 2913 and second transverse bar 2960, which may allow optimal or desired alignment of constant velocity joints 2921. In some embodiments, rear drive 2910 may be configured to occupy the space normally containing the vehicle's spare tire (not shown), e.g., for vehicles where the spare tire is located above and behind the rear axle. The spare tire may be relocated elsewhere in the vehicle or may be removed and replaced with flat tire repair devices (not shown).

It is understood that second transverse bar 2960 may not be necessary if sufficient resistance to pitching can be attained with first transverse bar 2914 alone. While FIG. 29 shows power conversion device 2911 as having a substantially vertical rotation and gear set 2912 as being configured as a right-angle gear set, it is understood that power conversion device 2911 may have instead a longitudinal rotation and gear set 2912 may be configured to maintain a longitudinal rotation. In such embodiments, gear set 2912 may be an epicyclic gear set (not shown), or a parallel gear set (not shown).

FIG. 30 provides a top view of a rear drive 3000, (shown as 110 in FIG. 1). Rear drive 3000 may include a chassis 3010, connected to a power conversion device 3020, which converts stored energy into rotational kinetic energy. For example, power conversion device 3020 may be an electric motor. In some embodiments, mechanical power may be transferred between power conversion device 3020 and a transmission 3030. Transmission 3030 may be a right-angle transmission. Transmission 3030 may be connected to chassis 3010 or power conversion device 3020 via a connection assembly 3040. Connection assembly 3040 may allow the orientation of transmission 3030 to be adjusted such that the output of transmission 3030 may be made colinear or nearly colinear with driveshaft 3050. Power may be transferred between transmission 3030 and driveshaft 3050. Rear drive 3000 may be mounted to a hitch receiver (not shown) of the vehicle (not shown) via a receiver post 3060. Receiver post 3060 may be connected to chassis 3010 via one or more bolts 3070. A plurality of holes (not shown) in chassis 3010 may allow receiver post 3060 to be connected to chassis 3010 in a plurality of positions such that the vertical and horizontal position of rear drive 3000 relative to the vehicle (not shown) can be varied. By varying the vertical position of rear drive 3000 relative to the vehicle (not shown), ground clearance of rear drive 3000 can be maximized without encroaching on the functionality of the vehicle's tailgate, hatch, or cargo doors. By varying the horizontal position of rear drive 3000 relative to the vehicle (not shown), the output of transmission 3030 can be made collinear or nearly collinear with driveshaft 3050. In some embodiments, driveshaft 3050 may include a universal joint 3080. In another embodiment, driveshaft 3050 may include a constant velocity joint, such as a double cardan joint (not shown), in place of a universal joint.

Rear drive 3000 may include a hitch receiver (not shown) configured to connect a trailer (not shown) to rear drive 3000 by engaging with a trailer hitch (not shown). Rear drive 3000 may alternatively include a trailer hitch (not shown) or trailer hitch ball (not shown) configured to connect a trailer to rear drive 3000. It is understood that any rear drive or rear chassis may include such a means of connecting a trailer to a vehicle equipped with an Auxiliary Hybrid System, Supplemental Suspension System, or a trailer configured with a trailer wheel steering system, as disclosed herein.

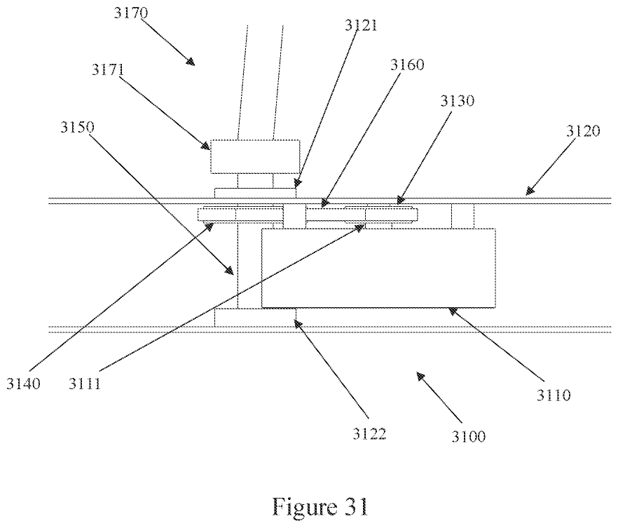

FIG. 31 provides a top cutaway view of another example of a rear drive 3100 (previously described in FIG. 30). As shown, a motor 3110 may be rigidly connected to chassis 3120. A drive sprocket 3130 may be rigidly connected to shaft 3111 of motor 3110. Driven sprocket 3140 may be rigidly connected to an output shaft 3150. Power may be transferred between motor 3110 and output shaft by a chain 3160. A driveshaft 3170 may transfer power between output shaft 3150 and a parallel shaft (shown as 810 in FIG. 8). Driveshaft 3170 may include a constant velocity joint 3171 to accommodate or tolerate the resulting angle when connected to parallel shaft. Output shaft 3150 may be supported by one or more bearings (not shown) which may be mounted in bores 3121 and 3122 of chassis 3120.

In some embodiments, motor 3110 may be of the axial flux type, which may allow a shorter length than motors of the radial flux type. Drive sprocket 3130 and driven sprocket 3140 may be of different sizes so that torque is increased from motor 3110 to output shaft 3150. Instead of a drive sprocket 3130, driven sprocket 3140, and a chain 3160, pulleys and a belt (not shown) or a gear train (not shown) may also be utilized to transfer power between motor 3110 and output shaft 3150.

FIG. 32 provides a side cross section of another example of a rear drive 3200 configured to transfer power between an energy storage device (not shown) and a vehicle's differential (not shown). Rear drive 3200 may include a rear chassis 3210, configured to be rigidly connected to the frame of the vehicle (not shown). Rear drive 3200 may include a receiver post 3210 rigidly connected to rear chassis 3210 and configured to be connected to a trailer hitch receiver (not shown). Receiver post 3220 may be positionable in a number of vertical and transverse positions relative to rear chassis 3210, which may enable rear chassis 3210 to be optimally positioned relative to the vehicle (not shown). Rear drive may include a power conversion device 3230, which may be an electric motor. In some embodiments, power conversion device 3230 may be an electric motor or an axial flux motor. Rear drive 3200 may include a gear set 3240, which may translate the substantially vertical axis rotation of power conversion device 3230 into a substantially longitudinal axis rotation of an output shaft 3250. Gear set 3240 may include bevel, spiral bevel, or hypoid gears. Gear set 3240 may be configured to increase the torque transmitted from power conversion device 3230 to output shaft 3250. Output shaft 3250 may be rigidly connected to a constant velocity joint 3260 which may transmit power to a driveshaft (not shown) as provided in FIG. 21 discussion. In another embodiment, constant velocity joint 3260 may be a universal joint. Output shaft 3250 may be supported by one or more bearings 3251. Chassis 3210 may be configured to contain batteries and/or electronics (not shown). Chassis 3210 may optionally include a mounting point for a supplemental suspension system.

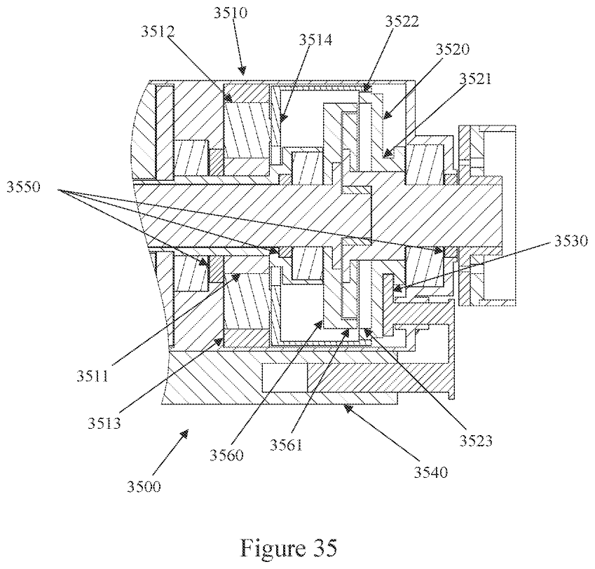

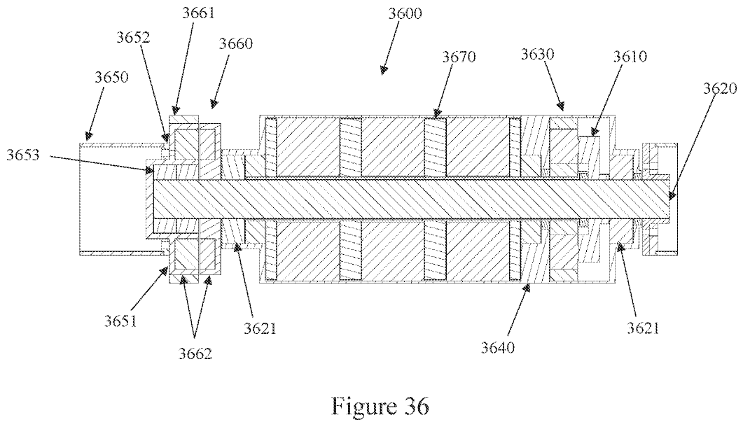

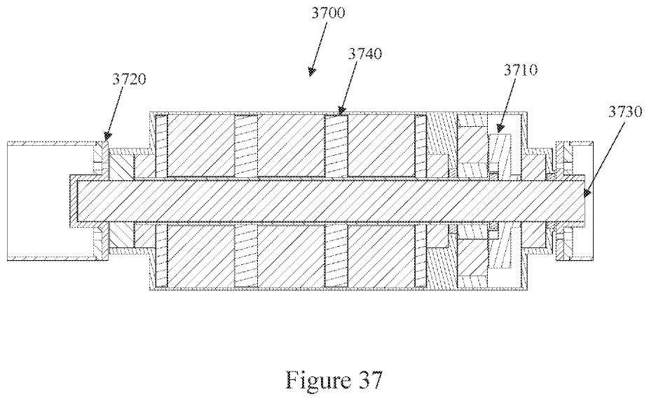

Referring now to FIG. 33, FIG. 34, FIG. 35, FIG. 36, and FIG. 37, FIG. 33 provides a top isometric view of another example of an AHS 3300 and an axle clamp assembly 3380. In this embodiment, power may be transferred between the energy storage device (not shown) and a vehicle's differential 3310 by a coaxial drive unit (CDU) 3320. A housing 3321 of CDU 3320 may be prevented from rotating about a longitudinal axis by linkage 3330, which may include one or more slots 3331. Housing 3321 may include one or more features 3322 that may be slidingly connected to linkage 3330, which may allow the pitch angle between CDU 3320 and differential 3310 to change as the differential 3310 translates with the vehicle's suspension (not shown). Linkage 3330 may be connected to one or more axle tubes 3340 with one or more axle clamps 3350, as provided in FIG. 4 discussion. Axle clamps 3350 may include an interface 3351 that may slidingly and/or rotatingly be connected to a transverse bar 3390. Linkage 3330 may rotatingly connect to transverse bar 3390. As configured, axle clamps 3350 may be rigidly connected to axle tubes 3340 in a location and at an angle convenient for avoiding components (not shown) mounted to the axle (such as brake line and shock absorber brackets) while still providing a rigid mounting interface for linkage 3330.

In some embodiments, CDU 3320 may be rigidly connected to a forward portion of the vehicle's driveshaft 3360, which may transfer power between the vehicle's engine, transmission, or transfer case (not shown) and CDU 3320. CDU 3320 may be rigidly connected to a rearward portion of the vehicle's driveshaft 3370, which may transfer power between CDU 3320 and the vehicle's differential 3310. In some embodiments, As configured, vehicle-specific interfaces to the vehicle's differential 3310 and engine, transmission, and/or transfer case may not need to be included with CDU 3320.

FIG. 34 provides a side cross-section of CDU 3400. CDU may include input shaft 3410 which may transfer torque between CDU 3400 and the vehicle's engine, transmission, or transfer case (not shown). CDU 3400 may include a coaxial shaft 3420, which may be rigidly connected to one or more rotors 3431 of one or more power conversion devices 3430. In some embodiments, power conversion devices 3430 may be electric motors. For example, power conversion devices 3430 may be axial flux motors stacked together, as shown. A coaxial shaft 3420 may be connected to a gear set 3440, which may be a planetary gear set as shown. Gear set 3440 may transfer power between coaxial shaft 3420 and an output shaft 3450. In some embodiments, gear set 3440 may increase the torque provided by power conversion device 3430 and transferred to output shaft 3450. For example, a torque increase in the range of 150% to 900% may be achieved, with an increase of approximately 300% being preferred for some embodiments. Input shaft 3410 may transfer power between the vehicle's engine, transmission, or transfer case and output shaft 3450. A one-way clutch 3460 may enable transmission of torque in a forward driving direction from input shaft 3410 to output shaft 3450. One-way clutch 3460 may prevent transmission of torque from output shaft 3450 to input shaft 3410 in a direction that would cause rotation of the vehicle's engine, transmission, or transfer case when driving forward. One-way clutch may be a roller, sprag, axial-pawl, or similar type. When in a first position, as shown, a sliding clutch 3470 may transfer torque between output shaft 3450 and gear set 3440 but not between output shaft 3450 and input shaft 3410. When in a second position (not shown), sliding clutch 3470 may transfer torque between output shaft 3450 and both gear set 3440 and input shaft 3410. When in a third position (not shown), sliding clutch 3470 may transfer torque between output shaft 3450 and input shaft 3410 but not between output shaft 3450 and gear set 3440. Sliding clutch 3470 may alternatively be configured such that the second position is a neutral position in which it does not transfer torque between output shaft 3450 and either input shaft 3410 or gear set 3440. While three positions have been described for the sliding clutch, any number of positions may be available and utilized.

In some embodiments as configured, a vehicle may be propelled by CDU 3400 without causing rotation of the vehicle's engine, transmission, or transfer case when sliding clutch 3470 is in the first position. When sliding clutch 3470 is in the third position, the vehicle may be propelled by the conventional drivetrain (not shown) without causing rotation of power conversion device 3430 or gear set 3440, and engine braking may be enabled. In one embodiment, when sliding clutch 3470 is in the second position, propulsion can be provided by both the vehicle's conventional drivetrain and CDU 3400.

In some embodiments, input shaft 3410 may be supported by one or more bearings 3411. Coaxial shaft 3420 may be supported by one or more bearings 3421. Output shaft 3450 may be supported by one or more bearings 3451.

Input shaft 3410 may be rigidly connected to an input flange 3412, which may be rigidly connected to a weld flange 3413. Weld flange 3413 may be connected to input flange 3412 with screws (not shown) via holes 3414. Weld flange 3413 may be rigidly connected to forward driveshaft tube 3480, for example by welding.

In some embodiments, output shaft 3450 may be rigidly connected to output flange 3452, which may be rigidly connected to weld flange 3453. Weld flange 3453 may be connected to output flange 3452 with screws (not shown) via holes 3454. Weld flange 3453 may be rigidly connected to a rearward driveshaft tube 3490, for example by welding.

Weld flanges 3413 and 3453 of varying sizes may be provided to accommodate driveshaft tubes 3460, 3480 of varying size. As configured, CDU 3400 may be installed on a vehicle by cutting out a length of the tubular portion of the vehicle's driveshaft (not shown), selecting the appropriate weld flanges 3413, 3453, connecting them to input flange 3412 and output flange 3452 respectively, and welding CDU 3400 to weld flanges 3413, 3453 as described above. Weld flanges 3413 and 3453, input flange 3412, and output flange 3452 may be configured with a larger diameter, as shown in FIG. 38, which may enable access to screws (not shown) for easier installation and removal of CDU 3400.

FIG. 35 provides a section view of a portion of CDU 3500. As shown, a gear set 3510 may include sun gear 3511, one or more planet gears 3512, and a ring gear 3513. Planet gears 3512 may be rotationally connected to a carrier 3514. Carrier 3514 may transfer torque between a sliding clutch 3520 and gear set 3510 when sliding clutch 3520 is in a first and/or second position, as described above, via a splined interface 3522. Sliding clutch 3520 may include a synchronizer (not shown) which may enable smoother engagement of splined interface 3522, as is common in automotive manual transmissions. Sliding clutch 3520 may include a spline 3523, which may transfer torque between sliding clutch 3520 and a spline 3561 on a one-way clutch 3560, when sliding clutch 3520 is in the third and/or second position, as described above. Sliding clutch 3520 may include a synchronizer (not shown), which may enable smoother engagement of spline 3523 and spline 3561, as is common in automotive manual transmissions.

Sliding clutch 3520 may be moved between the first, second, and third positions described above by a selector fork 3530, which may interface with a slot 3521 in sliding clutch 3520. Selector fork 3530 may be moved by an actuator 3540. In some embodiments, actuator 3540 may be a linear actuator as shown, or a rotary actuator. Actuator 3540 may be electrically, hydraulically, or pneumatically powered. Selector fork 3530 or sliding clutch 3520 may include detents (not shown) to precisely position sliding clutch 3520 in one or more of the three positions described above. One or more springs (not shown) may be included between selector fork 3530 and actuator 3540 to enable the detents to precisely position sliding clutch 3520 while accommodating any inaccuracy in the positioning of actuator 3540.

CDU 3500 may include oil or other lubricant (not shown), which may be contained by one or more oil seals 3550. CDU 3500 may also include an oil pump (not shown), as is common in automotive transfer cases, for providing lubrication and/or cooling to the internal components. The oil pump may be located on the input shaft 3410, the output shaft 3450, the coaxial shaft 3420, or the gear set 3440, for example.

FIG. 36 provides a cross-section view of another example of a CDU 3600. As shown, a carrier 3610 may be rigidly connected to an output shaft 3620 such that torque is transmitted between gear set 3630 and output shaft 3620. In this example, output shaft 3620 may be rotationally connected to a housing 3640 by one or more bearings 3621.

A forward portion of the vehicle's driveshaft 3650 may be rigidly connected to input shaft 3651 via weld flange 3652 as provided in FIG. 34 discussion. Input shaft 3651 may be rotationally connected to output shaft 3620 by one or more bearings 3653.

CDU 3600 may include a one-way clutch 3660 between input shaft 3651 and output shaft 3620, as provided in FIG. 34 discussion. One-way clutch 3660 may include a sliding clutch 3661 that may allow one-way operation of one-way clutch 3660 when in a first position as shown. When in a second position (not shown), sliding clutch 3661 may rotationally couple input shaft 3651 to output shaft 3620, such that torque may be transmitted in both directions. Sliding clutch 3661 may interface with input shaft 3651 and output shaft 3620 via splines 3662. Sliding clutch 3661 may be moveable between first and second position by a user. Sliding clutch 3661 may include one or more detents or locks (not shown) to maintain sliding clutch in a desired position.

As configured, CDU 3600 may propel a vehicle without causing rotation of the vehicle's engine, transmission, or transfer case. CDU 3600 may enable the vehicle to be propelled by both CDU 3600 and the vehicle's engine. CDU 3600 may allow the vehicle to be propelled by the vehicle's engine alone, but only in a forward direction and without engine braking, when sliding clutch 3661 is in a first position. CDU 3600 may allow the vehicle to be propelled by the vehicle's engine alone, in both forward and reverse direction and with the possibility of engine-braking, when sliding clutch 3661 is in a second position. In such configuration, power conversion device 3670 always turns when the vehicle is moving.

FIG. 37 provides a cross-section of another example of a CDU 3700. In this example, both a carrier 3710 and an input flange 3720 may be rigidly connected to a common shaft 3730. As configured, power may always be transmittable between the vehicle's differential (not shown) and both the power conversion device 3740 and the vehicle's engine, transmission, or transfer case (not shown). This configuration may therefore be appropriate for vehicles that will always be driven with the engine running. This configuration may also be appropriate for vehicles that are tolerant of back-driving of the conventional drivetrain, either due to the inherent design the drivetrain or through the installation of a lubrication pump as previously described.

FIG. 38 provides an isometric cutaway of a further example of a CDU 3800, which includes a clutch assembly 3810. Clutch assembly 3810 may include a sliding clutch 3850. Clutch assembly 3810 may be configured to operate in a plurality of modes, which may include an EV mode as shown, at least one neutral mode (not shown), a generator mode (not shown), an engine mode (not shown), and a hybrid mode. In EV mode, a sliding clutch 3850 may connect a gear set output 3820 to an output shaft 3830 and may enable power to be transmitted between an electric motor 3840 and the vehicle's differential (not shown) without causing rotation of the vehicle's engine (not shown), transmission (not shown), or transfer case (not shown). In neutral mode, sliding clutch 3850 may be only connected to gear set output 3820 and may enable electric motor 3840 to provide rev-matching, where the rotational velocity of sliding clutch 3850 is matched to that of output shaft 3830 or input shaft 3860 for smooth engagement. CDU 3800 may include one or more speed sensors (not shown) which provide feedback to enable rev-matching. Speed sensors may be configured to measure the speed of electric motor 3840, input shaft 3860, output shaft 3830, and/or gear set output 3820. In generator mode, sliding clutch 3850 may connect input shaft 3860 to gear set output 3820 and may enable the vehicle's engine (not shown) to provide rotation of electric motor 3840 without movement of the vehicle (not shown), which may enable electric motor 3840 to provide electrical power for external loads (not shown), such as power tools, recreational equipment, or home backup power. In engine mode, sliding clutch 3850 may connect input shaft 3860 to output shaft 3830, which may enable power to be transmitted between the vehicle's engine and differential without rotation of electric motor 3840, thereby reducing parasitic power loss. In hybrid mode, sliding clutch 3850 may be connected to input shaft 3860, output shaft 3830, and gear set output 3820, which may enable a combination of power from the vehicle's engine and electric motor 3840 to be used for propulsion. This may allow a reduction in power, size, and mass of the CDU 3800 and for more efficient operation when using the vehicle's engine, for example, through the use of regenerative braking.

Clutch assembly 3810 may include an actuator 3811 and a shift fork 3812, which may be configured to move sliding clutch 3850 between a plurality of corresponding operating modes. Actuator 3811 may include an electric motor 3813, a lead screw 3814, and a lead nut 3815, which may be configured to cause linear movement of shift fork 3812 upon rotation of electric motor 3813. Clutch assembly 3810 may include one or more sensors (not shown), such as position or rotation sensors, which may provide feedback of the position of sliding clutch 3850.

In some embodiments, input shaft 3860 may be supported by one or more bearings 3861. Output shaft 3830 may be supported by one or more bearings 3831. A coaxial shaft 3870 may be connected to electric motor 3840, as previously described, and may be supported by one or more bearings 3871. Gear set output 3820 may be supported by one or more bearings 3821.

FIG. 39 provides a more detailed view of a clutch assembly 3900. As shown, a sliding clutch 3910 may include one or more external splines 3911 which may interface with one or more internal splines 3921 of a gear set output 3920 and transmit torque depending on mode. Sliding clutch 3910 may include internal splines 3912, which may interface with one or more input splines 3931 of an input shaft 3930 and with one or more output splines 3941 of an output shaft 3940 and transmit torque depending on mode. Internal splines 3912 of sliding clutch 3910 may include an interrupted section 3913, which may allow transition between clutch modes in the fewest number of steps. It is understood that any of the splines described herein may be interrupted and that the location of the splines may be configured differently than shown to allow or promote varying clutch mode sequences.

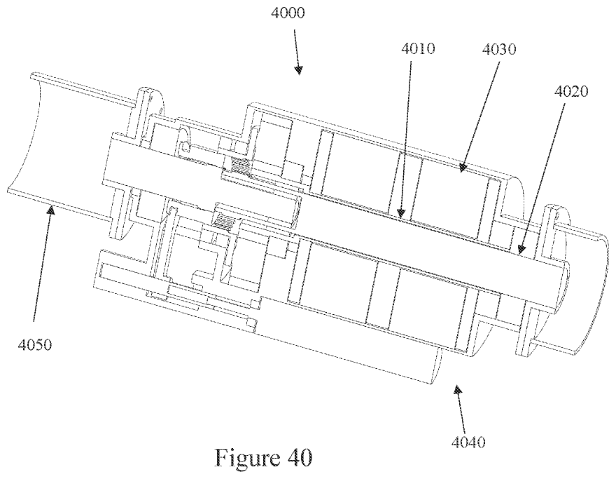

FIG. 40 provides another embodiment of a CDU 4000, where a concentric shaft 4010 is concentric to an output shaft 4020. This embodiment places an electric motor 4030 at a differential end 4040 of CDU 4000, which may allow a larger diameter motor due to fewer vehicle components typically occupying the space in front of the differential (not shown) compared to the forward portion of a vehicle's driveshaft 4050.

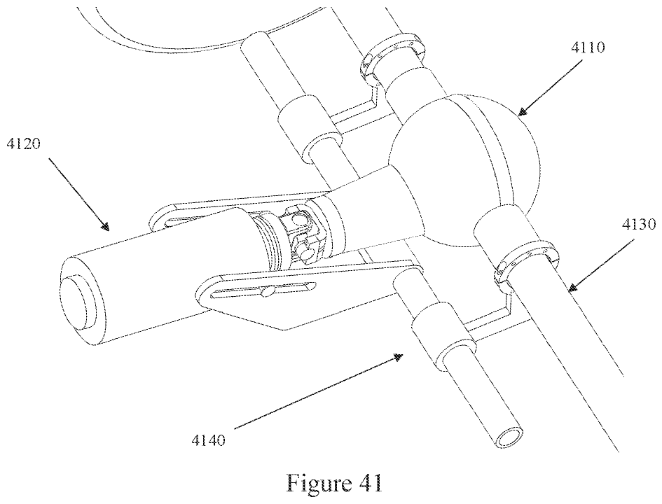

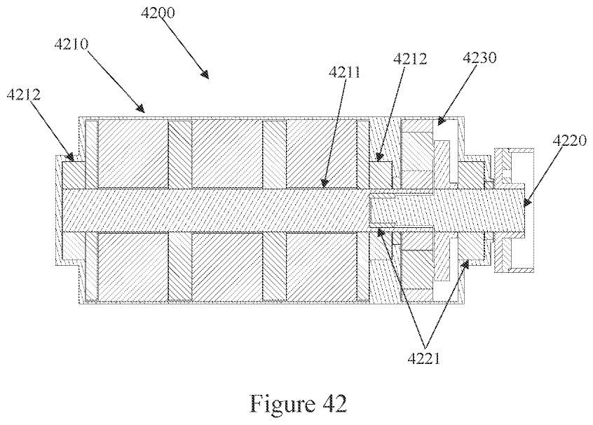

Referring now to FIG. 41 and FIG. 42, FIG. 41 provides a further example of an AHS 4100 (as provided in FIG. 33 discussion) and an axle clamp assembly 4140. In this exemplary configuration, power to a vehicle's rear differential 4110 may be supplied exclusively by a power unit 4120. If the vehicle is a four-wheel-drive vehicle, power may be supplied to the vehicle's front axle (not shown) by the vehicle's conventional drivetrain (not shown). Power unit 4120 may connect to the vehicle's differential 4110 and an axle tube 4130, as provided in FIG. 33 and FIG. 34 discussions.

FIG. 42 provides a cross-section view of power unit 4200, which may include one or more power conversion devices 4210. Power conversion devices 4210 may be electric motors, axial flux motors, multiple electric motors stacked together, or multiple axial flux motors stacked together, as shown. Power conversion device 4210 may include a shaft 4211. Power unit 4200 may include an output shaft 4220, which may be connected to shaft 4211 by a gear set 4230, as provided in FIG. 35 discussion. Gear set 4230 may be configured to increase the torque transmitted from power conversion device 4210 to output shaft 4220. Shaft 4211 may be supported by one or more bearings 4212. Output shaft 4220 may be supported by one or more bearings 4221.

As configured, AHS 4100 may propel a vehicle on power from an energy storage device (not shown) alone. Power unit 4200 may deliver more torque to the vehicle's differential 4110 than power conversion device 4210 may be capable of by itself.

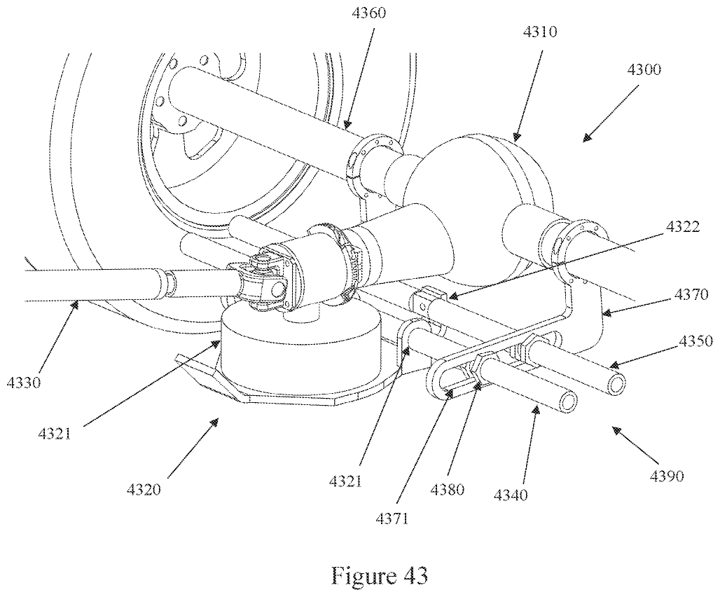

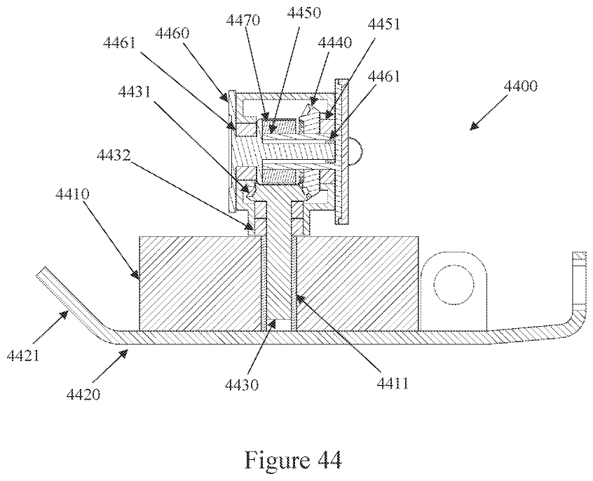

Referring now to FIG. 43 and FIG. 44, FIG. 43 provides an axle clamp assembly 4390 and an AHS 4300, configured to transfer power between an energy storage device (not shown) and a vehicle's differential 4310. As shown, a power unit 4320 may be rigidly connected to the vehicle's differential 4310 and a driveshaft 4330, as provided in FIG. 10 discussion. Power unit 4320 may be configured to transfer power between a power conversion device 4321 and the vehicle's differential 4310. Power unit 4320 may be configured to transfer power between the vehicle's driveshaft 4330 and the vehicle's differential 4310. Power unit 4320 may be supported and located in the vertical direction by a first transverse bar 4340, which may prevent rotation about a substantially vertical axis. Power unit 4320 may be further supported by second transverse bar 4350 which, in combination with first transverse bar 4340, may prevent pitch movement. First transverse bar 4340 and/or second transverse bar 4350 may prevent or reduce damage to power unit 4320 in the event of impact with a foreign or external body. First transverse bar 4340 may be rotationally connected to power unit 4320 at one or more pivots 4321. Second transverse bar 4350 may be rigidly connected to power unit 4320 at a tab 4322, which may include a slot (not shown), which may allow the pitch angle of power unit 4320 to be accommodated or tolerated. First transverse bar 4340 and second transverse bar 4350 may be rigidly connected to the vehicle's axle tubes 4360 by one or more axle clamps 4370 as provided in FIG. 33 discussion. First transverse bar 4340 and second transverse bar 4350 may interface with one or more axle clamps 4370 at one or more slots 4371 and may be transversely located by one or more bar clamps 4380, as provided in FIG. 21 discussion.

FIG. 44 provides a side cross-section view of a power unit 4400. As shown, a power conversion device 4410 may be mounted to a baseplate 4420. In some embodiments, power conversion device 4410 may be an electric motor or an axial flux motor. A pinion shaft 4430 may be slidably connected to a shaft 4411 of power conversion device 4410 and may be configured to transfer torque between shaft 4411 and a pinion gear 4431. Pinion shaft 4430 may connect to shaft 4411 via a spline (not shown). A ring gear 4440 may be rigidly connected to an output shaft 4450 and may translate the substantially vertical axis rotation of pinion shaft 4430 into a substantially longitudinal axis rotation of output shaft 4450. Pinion gear 4431 and ring gear 4440 may be configured to increase the torque transmitted from power conversion device 4410 to output shaft 4450. Pinion gear 4431 and ring gear 4440 may be bevel, spiral bevel, hypoid or similar gears. Output shaft 4450 may be connected to the vehicle's differential (not shown), as provided in FIG. 10 discussion. An input shaft 4460 may be connected to the vehicle's driveshaft (not shown), as provided in FIG. 10 discussion. A one-way clutch 4470 may be configured to transmit torque from the vehicle's driveshaft to the output shaft 4450 and to interrupt transmission of torque from output shaft 4450 to the vehicle's drive shaft, as provided in FIG. 34 discussion.

In another embodiment, a sliding clutch (not shown) may be capable of locking rotation of input shaft 4460 to output shaft 4450, as provided in FIG. 35 discussion.

In some embodiments, pinion shaft may be supported by one or more bearings 4432. Input shaft 4460 may be supported by one or more bearings 4461. Output shaft 4450 may be supported by one or more bearings 4451. Baseplate 4420 may include an angled section 4421, which may reduce the likelihood or severity of damage that may result from impact with a foreign or external body.

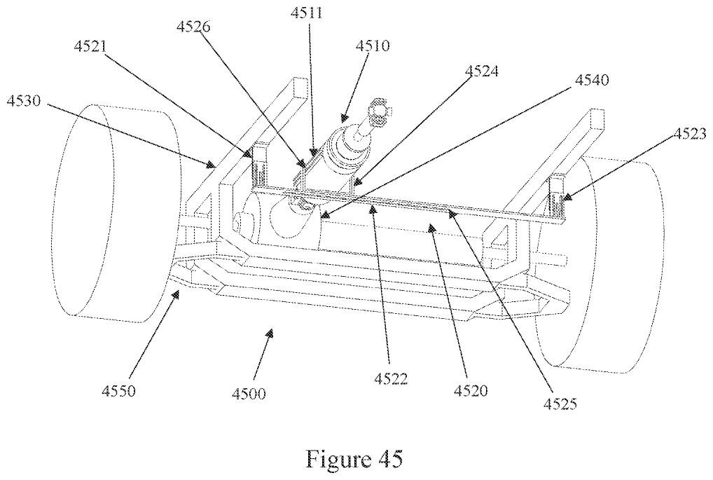

Referring now to FIG. 45, another example of an AHS 4500, (as provided in FIG. 33, FIG. 34, FIG. 35, FIG. 36, FIG. 37, FIG. 41, and FIG. 42 discussions), includes a CDU 4510 configured to be connected to and transfer power to and from a front differential 4540 of a vehicle. If the vehicle has a solid front axle (not shown), rotation of the CDU 4510 may be prevented, as provided in FIG. 33 and FIG. 41 discussions. If the vehicle has independent front suspension, (as shown in FIG. 45), rotation of CDU 4510 may be prevented by an anti-rotation assembly 4520. Anti-rotation assembly 4520 may include one or more frame mounts 4521, which may be configured to rigidly connect to the vehicle frame 4530, e.g., by bolting, screwing, riveting, or welding. Anti-rotation assembly 4520 may include a transverse bar 4522, which may be configured to rigidly connect to one or more frame mounts 4521 at a plurality of vertical positions, for example using screws (not shown) in one or more slots 4523. Transverse bar 4522 may be extensible (not shown) to accommodate frames 4530 of varying width. A fork 4524 may rigidly connect to transverse bar 4522 in a plurality of transverse positions, for example with one or more screws (not shown) in one or more slots 4525. CDU 4510 may include one or more channels 4511, which may interface with one or more pins 4526 of fork 4524 in a plurality of longitudinal positions and may be configured to prevent rotation of CDU 4510 about its longitudinal axis. As configured, anti-rotation assembly 4520 may be positionable at a location on the vehicle's frame 4530 that avoids interference with vehicle components, and fork 4524 may be positionable to be transversely centered on CDU or power unit 4510.

In a preferred embodiment of the AHS 4500, a CDU 4510 may include a one-way clutch (not shown), which may enable the vehicle to be propelled by CDU 4500 alone via the front differential 4540 without backdriving the vehicle's transfer case (not shown). When four-wheel-drive is engaged on the vehicle, the vehicle's conventional drivetrain may be capable of transmitting power through CDU 4510 to the vehicle's front differential 4540. The one-way clutch may be lockable via a sliding clutch (not shown), to allow engine braking. For vehicles that are intolerant of backdriving the conventional drivetrain from the rear axle (not shown), a standalone driveshaft disconnect (not shown), as is commercially available for a variety of vehicles, may be installed on the rear driveshaft (not shown).

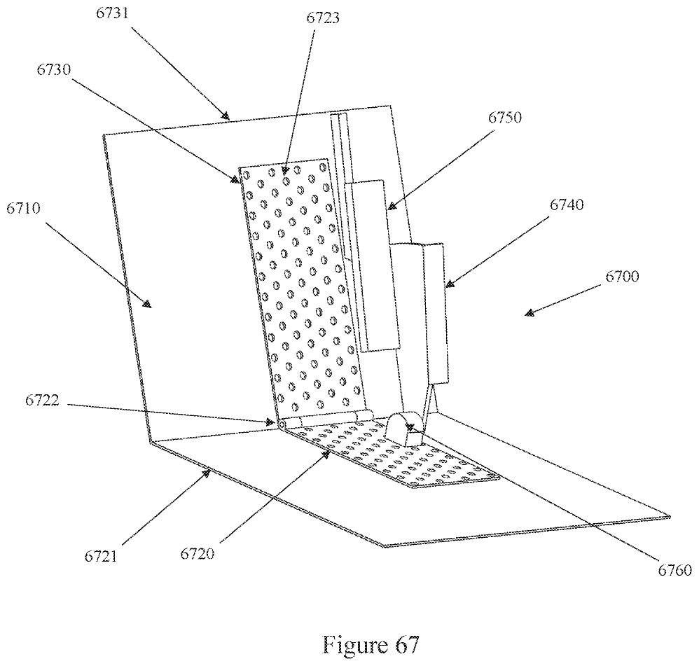

In another embodiment of AHS 4500, the power unit 4510 is not connected to the vehicle's transfer case (not shown), and drive to the front differential 4540 may be by AHS 4500 alone. For four-wheel-drive operation, the conventional drivetrain (not shown) powering the rear axle (not shown) may be active and may operate in the parallel hybrid mode, described for FIG. 67. The AHS 4500 may be configured to reduce the amount of power sent to the power unit 4510 if front wheel slip is detected, which may result in more power being sent to the rear axle (not shown) by the conventional drivetrain. Front wheel slip may be detected by a discrepancy between the power unit 4510 speed and the vehicle speed. Vehicle speed may be determined by an inertial sensor (not shown), such as an accelerometer, or AHS 4500 may be configured to interface with the vehicle's Onboard Diagnostic System (OBD system) (not shown) and may be capable of reading wheel speed sensor data (not shown) from the vehicle's rear axle. OBD wheel speed sensor data may also be used to determine front wheel speed. AHS 4510 may also be configured to operate in a four-wheel-drive mode where the vehicle would be nominally propelled by the conventional drivetrain via the rear axle and the power unit 4510 would receive power when rear wheel slip is detected. Rear wheel slip may be detected by any of the above-described methods. In order to maintain charge of the AHS battery (not shown) when the battery is nearly depleted to allow continued four-wheel-drive operation, a small amount of regenerative braking torque may be applied by power unit 4510 when rear wheel slip is not detected to supply electrical energy to the AHS battery (not shown).

While the discussions herein for the CDU has generally been described with the CDU located on the rear of a vehicle (e.g., the rear axle), it should be appreciated that any teachings for the CDU are also applicable to situations when the CDU is located on the front of a vehicle (e.g., front axle).

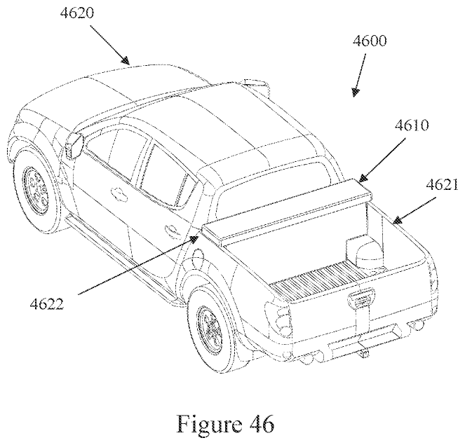

FIG. 46 provides another embodiment of an AHS 4600. A rear unit 4610 may be installed in a bed 4621 of a pickup truck 4620. Rear unit 4610 may include at least one energy storage device (not shown). The rear unit 4610 may include at least one power conversion controller (not shown). The rear unit 4610 may include a charger (not shown). In some embodiments, the rear unit may be configured to be installed at a forward end 4622 of the bed 4621.

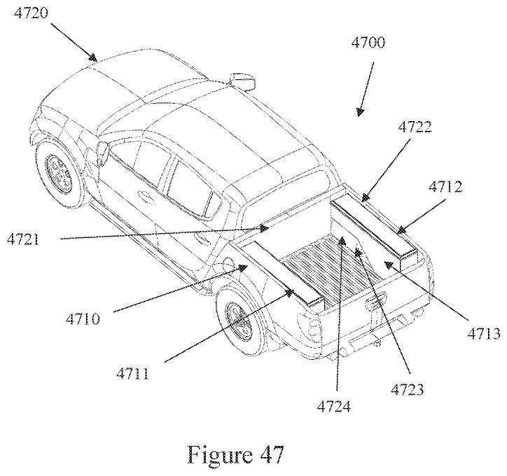

FIG. 47 provides another embodiment of an AHS 4700, as provided in the FIG. 46 discussion. In this embodiment, the rear unit 4710 may comprise a first portion 4711 and a second portion 4712, both of which may be configured to positioned against a side 4722 of a bed 4721 of the pickup truck 4720. The first portion 4711 and second portion 4712 may be configured to reside at least partially above one or more wheel wells 4723 of the bed 4721. The first portion 4711 and second portion 4712 may be configured to minimize the transverse protuberance of an inboard surface 4713 beyond the inboard surface 4724 of the wheel wells 4723.

FIG. 48 provides another embodiment of an AHS 4800, which includes at least one swing arm 4810 and a rear unit 4820 and may be configured to provide propulsion to a vehicle 4830. Swing arm 4810 may be connected a vehicle wheel 4831 and may be configured to transmit power between at least one energy storage device (not shown) and a wheel 4831. Rear unit 4820 may include the at least one energy storage device (not shown).

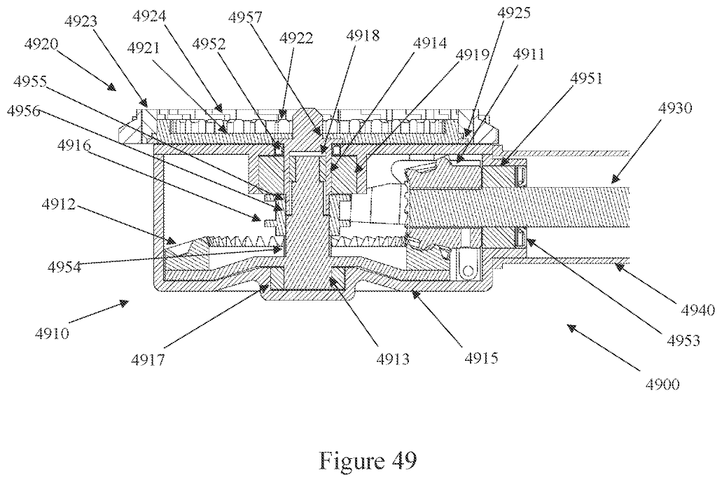

FIG. 49 provides a top cross-section a wheel end of a swing arm 4900. Swing arm 4900 may include a second gearbox 4910, a drive-side coupling 4920, a driveshaft 4930, and a torque tube 4940. Second gearbox 4910 may include a pinion gear 4911, a ring gear 4912, an input shaft 4913, an output shaft 4914, a housing 4915, and a sliding clutch 4916.

In some embodiments, power may be transferred between driveshaft 4930 and pinion gear 4911. Power may be transferred between pinion gear 4951 and ring gear 4912 such that the substantially longitudinal rotation of pinion gear 4951 is translated to the substantially transverse rotation of ring gear 4912. Ring gear 4912 may be rigidly connected to input shaft 4913. Sliding clutch 4916 may be configured such that it may slide axially with respect to input shaft 4913. With sliding clutch 4916 in a first position as shown, torque may be transmitted between input shaft 4913, sliding clutch 4916, and output shaft 4914. With sliding clutch 4916 in a second position (not shown), torque transfer between sliding clutch 4916 and output shaft 4914 may be interrupted, thereby preventing the back-driving of the second gearbox 4910. Input shaft 4913 may include one or more torque transmitting features 4954 for torque transfer with sliding clutch 4916. Torque transmitting features 4954 may be splines as shown, dogs (not shown), other suitable types of features, or combinations thereof. Output shaft 4914 may include one or more torque transmitting features 4955 for torque transfer with sliding clutch 4916. Torque transmitting features 4955 may be splines as shown, dogs (not shown), other suitable types of features, or combinations thereof. Sliding clutch 4916 may include one or more torque transmitting features 4956 for torque transfer with input shaft 4913 and output shaft 4914. Torque transmitting features 4956 may be splines as shown, dogs (not shown), other suitable types of features, or combinations thereof.

Driveshaft 4930 may be supported by one or more driveshaft bearings 4951. Input shaft 4913 may be supported by one or more input shaft bearings 4917. Input shaft may also be supported by one or more input shaft pilot bearings 4918. Output shaft 4914 may be supported by one or more output shaft bearings 4919. Second gearbox 4910 may optionally be sealed to contain lubricant and exclude dust, moisture, and other contaminants by driveshaft seal 4953 and output shaft seal 4952.

Output shaft 4914 may be rigidly connected to drive-side coupling 4920. Drive-side coupling 4920 may include a coupling plate 4921 which may include one or more torque transmitting features 4922, which may be configured to interface with torque transmitting features of a wheel-side coupling (not shown) for torque transfer. Torque transmitting features 4922 may be dogs as shown, splines (not shown), other suitable types of features, or combinations thereof.

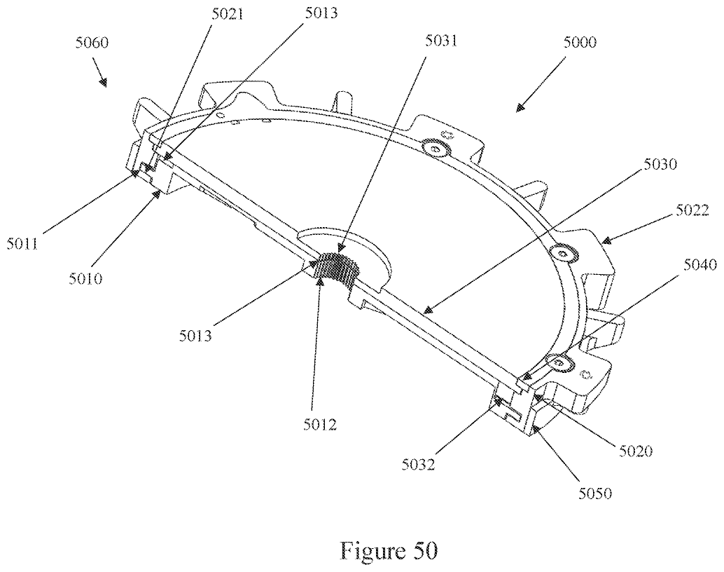

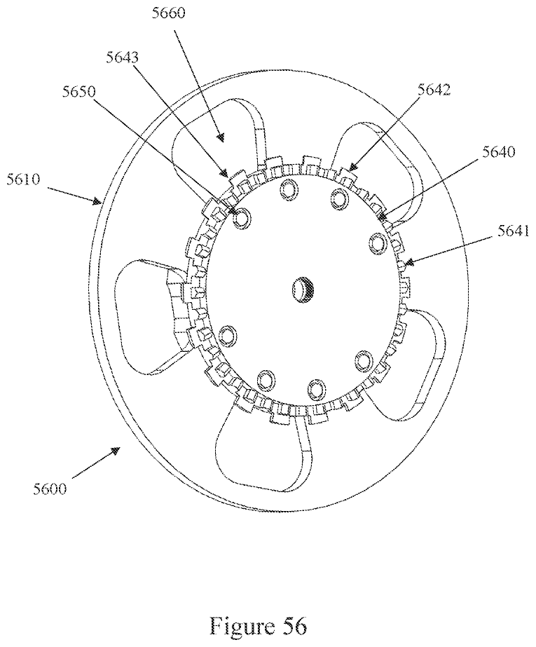

Referring now to FIG. 49 and FIG. 50, which provide an isometric cutaway of drive-side coupling 4720, 5000 and a portion of wheel-side coupling 5010. In some embodiments, drive-side coupling 4920, 5000 may include an attachment mechanism 5060, which may include a retention ring 4923, 5020 which may be rotationally connected to a coupling plate 4921, 5030. Retention ring 4923, 5020 may include one or more engagement features 4924, 5021, which may be configured to interface with one or more engagement features 5011 on wheel-side coupling 5010 to provide axial retention of drive-side coupling 4920, 5000 on wheel-side coupling 5010. Engagement features 4924, 5021, 5011 may be located near the outside or periphery of drive-side coupling 4920, 5000 and wheel-side coupling 5010 to more effectively react torque from the swing arm (not shown). A capture ring 4925, 5040 may provide axial retention of retention ring 4923, 5020 to coupling plate 4921, 5030. A lock ring 4926, 5050 may be rotationally connected to retention ring 4923, 5020 and may be configured to prevent rotation of retention ring 4923, 5020 with respect to coupling plate 4921, 5030 when in a first position (as shown) and may thereby prevent unintentional disengagement of drive-side coupling 4920, 5000 from wheel-side coupling 5010. When in a second or third position (not shown), lock ring 4926, 5050 may allow rotation of retention ring 4923, 5020 with respect to coupling plate 4921, 5030, thereby allowing engagement and disengagement of drive-side coupling 4920, 5000 and wheel-side coupling 5010. Engagement features 5011 may include a ramped portion (see e.g., reference numeral 5643 in FIG. 56) for smoother engagement with retention ring 4923, 5020.

Coupling plate 5030 may include one or more torque transmitting features 5031 which may interface with one or more torque transmitting features 4957 of output shaft 4914 for transfer of torque. Torque transmitting features 5031 may be splines (as shown), dogs, other suitable types of features, or combinations thereof.

Wheel-side coupling 5010 may include one or more torque transmitting features 5012 which may interface with one or more torque transmitting features 4957 of output shaft 4914 for transfer of torque and to rotationally align one or more torque transmitting features 5013 of wheel-side coupling 5010 with torque transmitting features 5032, 4922 of coupling plate 5030, 4921. Torque transmitting features 4957 may be splines and may include tapered ends (not shown) to aid alignment with wheel-side coupling 5010. Torque transmitting features 5012 may be splines and may include tapered ends 5013 to aid alignment with output shaft 5014. It is understood that this exemplary configuration of a sliding clutch with internal splines having tapered ends and a shaft with external splines having tapered ends is functionally similar to a synchronizer in a typical automotive manual transmission. Retention ring 5020 may include one or more protrusions 5022 which may enable a user to more easily rotate retention ring 5020 during engagement and disengagement with wheel-side coupling 5010.

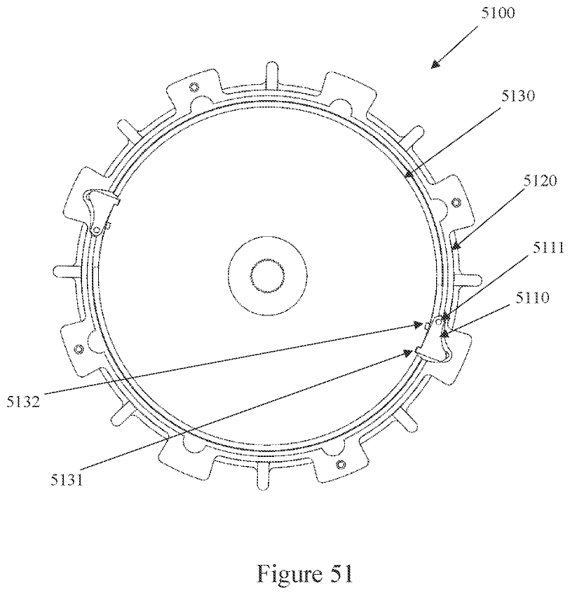

FIG. 51 provides a side view of a portion of drive-side coupling 5100. Drive-side coupling 5100 may include one or more pawls 5110, which may be rotationally connected to a retention ring 5120 at a pivot 5111. Pawls 5110 may engage one or more first detent features 5131 and one or more second detent features 5132 of a coupling plate 5130 when in a first position as shown and may disengage first detent features 5131 and second detent features 5132 when in a second position (not shown). When in a first position, pawl 5110 may prevent rotation of retention ring 5120 with respect to coupling plate 5120 and when in a second position may allow rotation. When pawls 5110 are engaged with first detent features 5131, engagement features (see reference numeral 5021 in FIG. 50) of retention ring 5120 may be positioned to engage with retention features (see reference numeral 5011 in FIG. 50) of wheel-side coupling (see reference numeral 5010 in FIG. 50). When pawls 5110 are engaged with second detent features 5132, engagement features (see reference numeral 5021 in FIG. 50) of retention ring 5120 may be positioned such that they do not engage with retention features (see reference numeral 5011 in FIG. 50) of wheel-side coupling (see reference numeral 5010 in FIG. 50). As configured, drive-side coupling 5100 may be maintained in a state to be engageable and disengageable with wheel-side coupling (see reference numeral 5010 in FIG. 50) when retention ring 5120 is rotated to place pawls 5110 in a position to engage with second detent features 5132 and may be maintained in an engaged state with wheel-side coupling (see reference numeral 5010 in FIG. 50) when retention ring 5120 is rotated to place pawls 5110 in a position to engage with first detent features 5131.

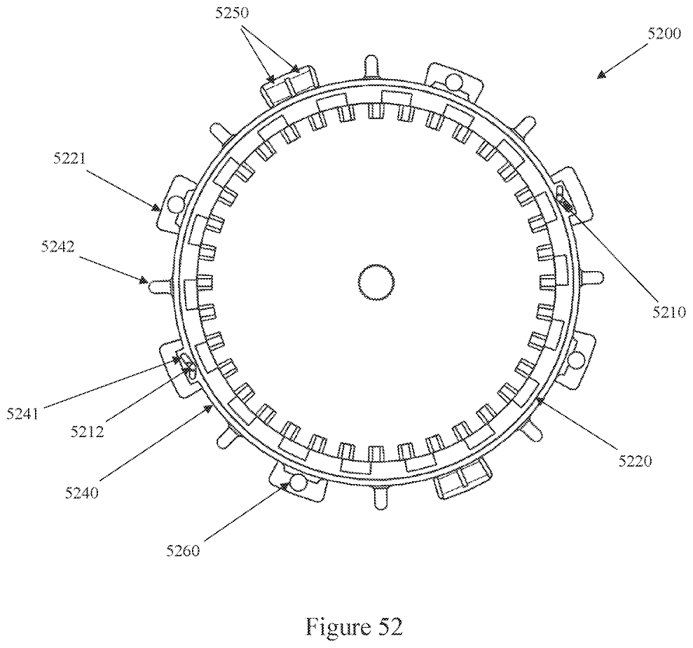

FIG. 52 provides an opposite side view to FIG. 51 of a portion of a drive-side coupling 5200. As shown, one or more pawls 5210 may include a protrusion 5212 that may engage with a cam feature 5241 of a lock ring 5240 such that when lock ring 5240 is rotated relative to a retention ring 5220, pawls 5210 are moved between a first and second position, as described above. Cam feature 5241 may be configured such that when lock ring 5240 is in a first position as shown, pawls 5210 are placed in a first position described above. Cam feature 5241 may be configured such that when lock ring 5240 is in a second position clockwise from the first position, pawls 5210 are placed in a second position described above. Cam feature 5241 may be configured such that when lock ring 5240 is in a third position, counterclockwise from the first position, pawls 5210 are placed in a second position described above. Lock ring 5240 may include one or more protrusions 5242 that may enable a user to easily rotate lock ring 5240 relative to retention ring 5220. Protrusions 5242 may be configured such that a user may be able to squeeze one of them and a protrusion 5221 of retention ring 5220 together with one hand while rotating retention ring 5220. Protrusions 5242 may be configured such that a user may be able to squeeze one of them and a protrusion 5221 of retention ring 5220 together with one hand while rotating retention ring 5220 either clockwise or counterclockwise. As configured, retention ring 5220 may be maintained in a position to either allow or disallow engagement with wheel-side coupling (not shown) while lock ring 5240 is in a first position. As configured, retention ring 5220 may be free to rotate between engagement states while lock ring 5240 is in a second or third position. One or more springs 5250 may bias lock ring 5240 to assume its first position and consequently bias pawls 5210 to assume their first position, described above. As configured, when rotating retention ring 5220 between its first and second positions, lock ring 5240 need only be rotated by the user to initiate rotation, after doing which the user may release lock ring 5240. As the user continues rotate retention ring 5220, pawls 5210 will automatically engage with first or second detent features (see reference numeral 5131 in FIG. 51) under the influence of one or more springs 5250, and then will be biased to stay engaged, preventing unintended disengagement during use. In some embodiments, springs 5250 may be compression springs, tension spring, leaf springs, torsion springs, or the like. Springs 5250 may be metal, plastic, or elastomeric. Drive-side coupling 5200 may include one or more lock ring retainers 5260 configured to prevent axial movement of lock ring 5240 with respect to retention ring 5220.

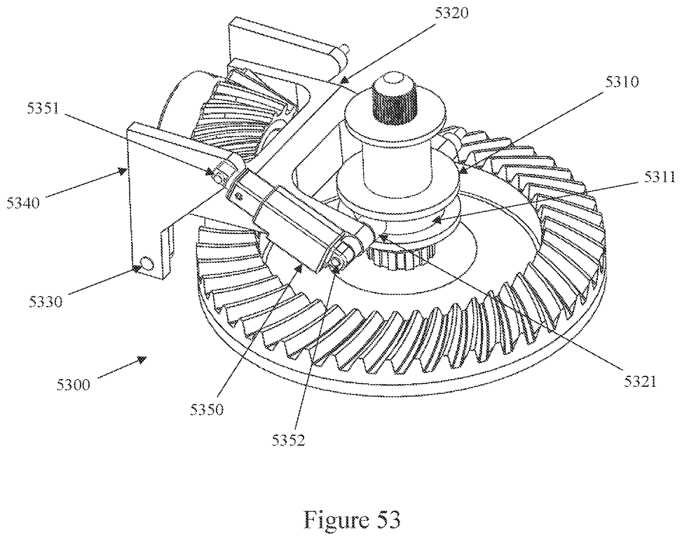

FIG. 53 provides an isometric view of a portion of the internal components of a second gearbox 5300. As shown, a sliding clutch 5310 is in a first position, as described above. Clutch 5310 may be configured such that movement of a clutch linkage 5320 from a first position to a second position may cause sliding clutch 5310 to move into a second position, described above. In some embodiments, clutch linkage 5320 may be a bell crank and may be rotationally connected to one or more pivots 5330. Pivot 5330 may be connected to housing (see reference numeral 4915 in FIG. 49) or may be connected to one or more brackets 5340. In other embodiments, clutch linkage 5320 may be a linear slide (not shown) instead of a bell crank. Clutch linkage 5320 may include one or more protrusions 5321 that may interface with a slot 5311 of sliding clutch 5310. Protrusions 5321 may be bearings as shown or may have a round cross-section and be rotationally connected to bell crank 5320. Protrusions 5321 may also be rigidly connected to bell crank 5320 and may include a low friction material, such a copper alloy or plastic, to reduce drag torque, heat generation, and wear. As configured, protrusions 5321 may impart minimal drag on sliding clutch when in contact. Clutch linkage 5320 may be moved between a first and second position by an actuator 5350. Actuator 5350 may be a linear actuator, as shown. In some embodiments, actuator 5350 may be connected to a pivot 5351. Pivot 5351 may be rigidly connected to bracket a 5340 as shown, or to housing (see reference numeral 4915 in FIG. 49). Actuator 5350 may be connected to a pivot 5352, which may be rigidly connected to clutch linkage 5320. Actuator 5350 may be a rotary actuator (not shown) which may act directly on clutch linkage 5320 at pivot 5330, or may act through a cam, linkage, rack and pinion, or any other common mechanism for converting rotational motion into linear motion (not shown). Actuator 5350 may be electrically, hydraulically, or pneumatically powered.

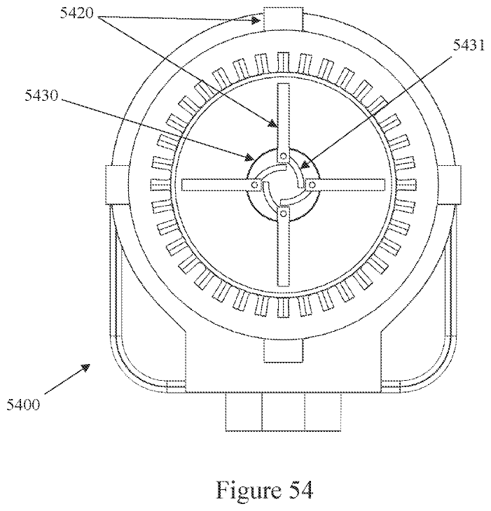

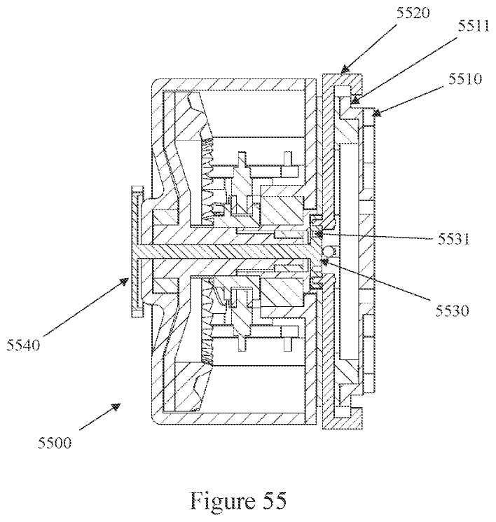

Referring now to FIG. 54 and FIG. 55, which provide a further embodiment of a drive-side coupling 5400, 5500, FIG. 54 shows a side view and FIG. 55 shows a front cross-section and includes a portion of a wheel-side coupling 5510. In this embodiment, one or more locks 5420, 5520 may be configured to engage with an undercut 5511 of wheel-side coupling 5510 when in a first position (not shown) and may prevent separation of drive-side coupling 5400, 5500 from wheel-side coupling 5510. When one or more locks 5420, 5520 are in a second position as shown, they may be free of undercut 5511 and may allow drive-side coupling 5400, 5500 to be separated from wheel-side coupling 5510. Locks 5420, 5520 may engage with a shaft 5430, 5530 such that when shaft 5430, 5530 is rotated, locks 5420, 5520 move between the first and second positions, described above. Locks 5420, 5520 may engage with cam features 5431, 5531 of shaft 5430, 5530 which may cause movement between the first and second positions, described above. A knob 5540 may be rigidly connected to shaft 5430, 5530 and may allow a user to easily rotate shaft 5430, 5530 to engage or disengage drive-side coupling 5400, 5500 from wheel-side coupling 5510. Shaft 5430, 5530 may include detent features (not shown) that bias it to remain in a position whereby locks 5420, 5520 are engaged with undercut 5511 and therefore may prevent unintentional disengagement of locks 5420, 5520.

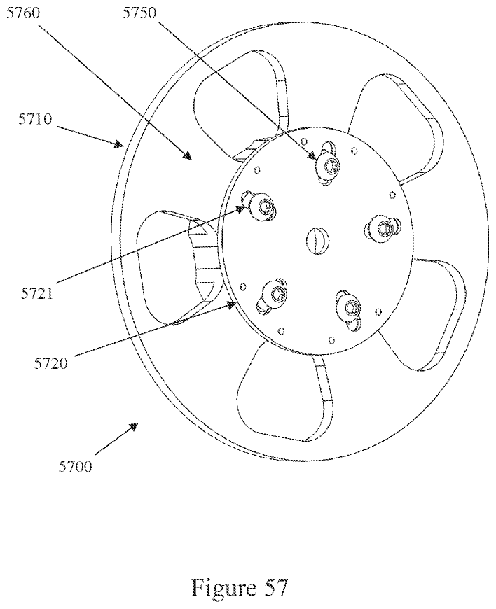

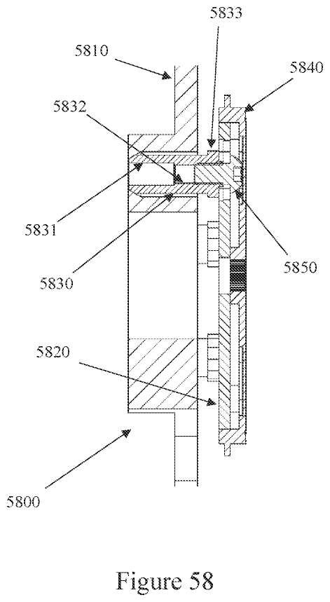

FIG. 56, FIG. 57, and FIG. 58 provide a further embodiment of a wheel-side coupling 5600, 5700, 5800 and a portion of a wheel 5610, 5710, 5810. FIG. 56 and FIG. 57 show an isometric view. FIG. 58 shows a front cross section. In these figures, a first attachment mechanism 5760 may include a lug nut plate 5720, 5820, which may be rigidly connected to a wheel 5720 with one or more lug nuts 5830 interfacing with one or more slots 5721 and one or more coupling screw 5750. Lug nut plate 5720, 5820 may be configurable with different thicknesses to position drive-side coupling (not shown) an appropriate or desired distance from wheel a 5610, 5710, 5810. Multiple lug nut plates 5720, 5820 may be stacked together (not shown) to position drive-side coupling (not shown) an appropriate or desired distance from wheel 5610, 5710, 5810. A wheel-side coupling 5600, 5700, 5800 may include a coupling plate 5640, 5840 which may include one or more torque transmitting features 5641 and a second attachment mechanism 5660, which may include one or more engagement features 5642, as described above. Coupling plate 5640, 5840 may be rigidly connected to lug nut plate 5720, 5820 with one or more screws 5650 or other typical means. As configured, vehicles with varying lug nut bolt patterns and wheel geometry may be accommodated with different configurations or quantities of lug nut plate 5720, 5820, which may be inexpensive to fabricate. A single coupling plate 5640, 5840, which may be more expensive to fabricate, may be used per wheel. Lug nut 5830 may include a threaded portion 5831 configured to interface with the wheel studs (not shown) as described above and a different threaded portion 5832 configured to interface with one or more coupling screws 5500, 5850. As configured, coupling screws 5750, 5850 may be a consistent size and thread regardless of wheel stud size and thread. Lug nuts 5830 may include a larger flange 5833 which may increase the stiffness of the interface with lug nut plate 5820 and may better resist the torque applied by drive-side coupling (not shown). Flange 5833 may have a hexagonal or 12-point shape (not shown) to allow installation and removal with a tool (not shown).

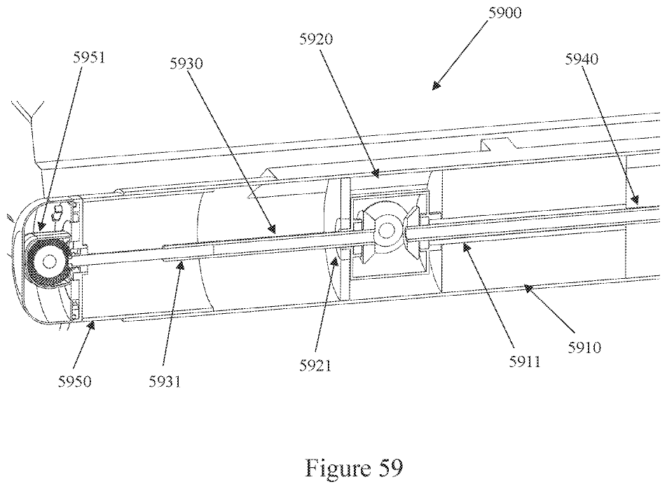

FIG. 59 provides a rear cutaway of a portion of an exemplary drive 5900. Rear drive 5900 may include a motor 5910, which may include shaft 5911. Shaft 5911 may be hollow as shown, or partially hollow. Shaft 5911 may be rigidly connected to a differential 5920, which may split motor torque between a left axle 5930 and a right axle 5940. Left axle 5930 may include a telescoping section 5931 which may enable an outboard portion 5950 of rear drive 5900 to slide inward and outward to accommodate vehicles of varying width. Outboard portion 5950 of rear drive 5900 may include a right-angle gearbox 5951, as previously described. It is understood that rear drive 5900 may include a similar configuration on the right side as the left. Differential 5920 may be supported by an outboard bearing 5921. Differential 5720 may be supported by an inboard bearing (not shown). Shaft 5911 may be connected to differential 5920 with a shaft coupling (not shown) which may transmit torque while tolerating misalignment of shaft 5911 and differential 5920.

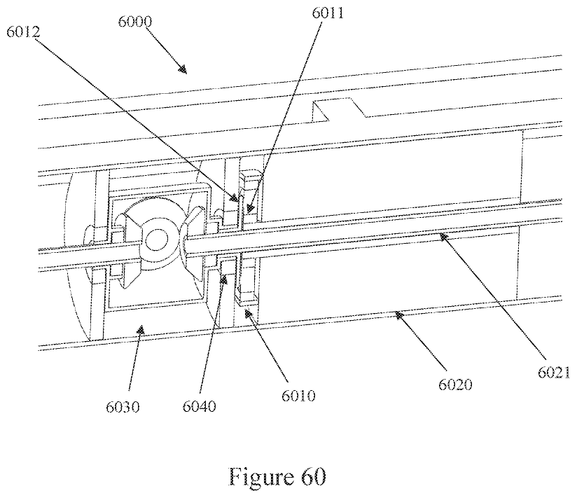

FIG. 60 provides a rear cutaway of another example of a rear drive 6000. Rear drive 6000 may be similar to rear drive 5900 described in FIG. 59, but includes a gear set 6010 between a motor 6020 and a differential 6030. Gear set 6010 may increase the torque provided by motor 6020. Gear set 6010 may be an epicyclic gear, as shown, or any other suitable gear. An input 6011 of gear set 6010 may be rigidly connected to a shaft 6021. An output 6012 of gear set 6010 may be rigidly connected to differential 6030. Output 6012 may be a planet carrier, as shown. Differential 6030 may be supported by a bearing 6040. As configured, rear drive 6000 may provide numerically smaller gear reductions elsewhere in the hybrid system, which may be smaller, lighter, and easier to package.

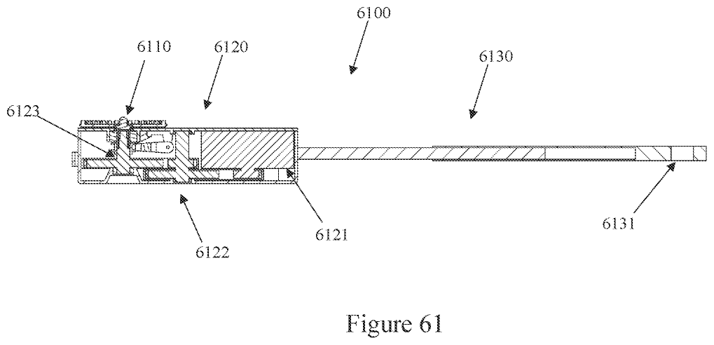

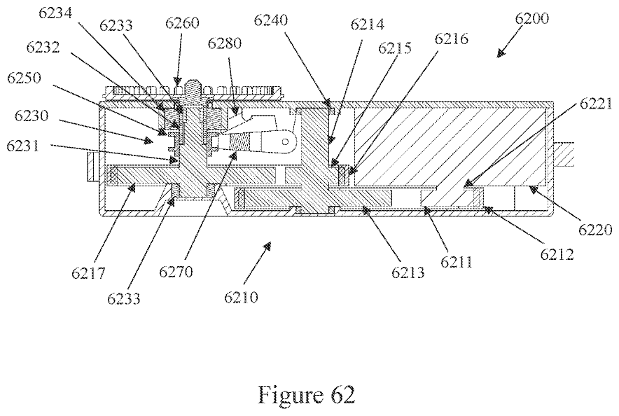

Referring now to FIG. 61 and FIG. 62, FIG. 61 provides a cross-section view of another example of a swing arm 6100. Swing arm 6100 may include a drive-side coupling 6110, as described previously, which may be configured to connect to and transfer power between a wheel-side coupling (not shown). Swing arm 6100 may include a power unit 6120 configured to transfer power from an energy storage device (not shown) to drive-side coupling 6110. Power unit 6120 may include a power conversion device 6121, which may be an electric motor or axial flux electric motor. Power unit 6120 may include a drivetrain 6122 configured to increase torque from the power conversion device 6121. Power unit 6120 may include an output shaft 6123 configured to transfer power from drivetrain 6122 to drive-side coupling 6110. Swing arm 6100 may include a reaction arm 6130 configured to connect power unit 6120 to a rear chassis (not shown) and prevent rotation of swing arm 6100 about a vehicle's axle (not shown). Reaction arm 6130 may be extensible as shown to accommodate vehicles of varying geometry. Reaction arm 6130 may include a pivot 6131 configured to rotationally connect swing arm 6100 to rear chassis to accommodate varying height differences between vehicle axles and rear chassis. Pivot 6131 may also be configured to enable swing arm 6100 to be transversely positionable relative to rear chassis to accommodate vehicles of varying track width. Pivot 6131 may also be configured to accommodate varying roll angles of reaction arm 6130 due to wheel camber, for example, with a spherical joint (not shown).

FIG. 62 provides further detail of a power unit 6200. As shown, a drivetrain 6210 may include: a motor sprocket 6211 which may be connected to a shaft 6221 of a power conversion device 6220; a first chain 6212 which may interface with a motor sprocket 6211; an intermediate input sprocket 6213, which may interface with first chain 6212, an intermediate shaft 6214 which may be rigidly connected to an intermediate input sprocket 6213, an intermediate output sprocket 6215 which may be rigidly connected to intermediate shaft 6214; a second chain 6216 which may interface with intermediate output sprocket 6215, and an output sprocket 6217 which may interface with second chain 6216 and may be rigidly connected to an output shaft 6230. As configured, drivetrain 6210 may be capable of transmitting and increasing torque from power conversion device 6220 to intermediate shaft 6214 and transmitting and further increasing torque from intermediate shaft 6214 to output shaft 6230.

In another example of drivetrain 6210, intermediate shaft 6214, intermediate input sprocket 6213, intermediate output sprocket 6215, and second chain 6216 may be eliminated and first chain 6212 may connect directly to output sprocket 6217.

Intermediate shaft 6214 may be supported by one or more bearings 6240. Output shaft 6230 may include an input half 6231 and an output half 6232, which may be rigidly connected to wheel-side coupling 6260. Sliding clutch 6250 may be slidably connected to input half 6231 and output half 6232 and may be configured to transmit torque between them when in a first position as shown. Sliding clutch 6250 may be configured to interrupt transmission of torque between input half 6231 and output half 6232 when in a second position (not shown). As configured, power may be transmittable between power conversion device 6220 and a drive-side coupling 6260 when a sliding clutch 6050 is in the first position and output half 6032 may be free to rotate with the vehicle's wheel (not shown) without causing rotation of input half 6031, drivetrain 6010, or power conversion device 6020 when in the second position. In some embodiments, sliding clutch 6215 may be caused to move between the first and second positions by a clutch linkage 6270 which may be acted upon by an actuator 6280, as previously described for FIG. 53.

In some embodiments, input half 6231 may be supported by one or more bearings 6233. Output half 6232 may be supported by one or more bearings 6234.

In another example, sliding clutch 6250, clutch linkage 6270, and actuator 6280 may be eliminated and output shaft 6230 may be a single piece (not shown). In such embodiments, drivetrain 6210 and power conversion device 6220 always turn when the vehicle's wheel turns.

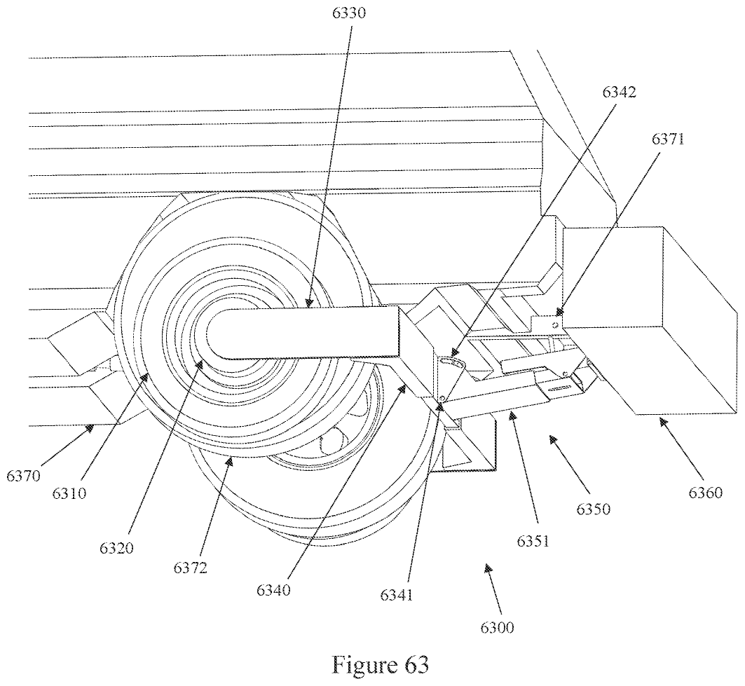

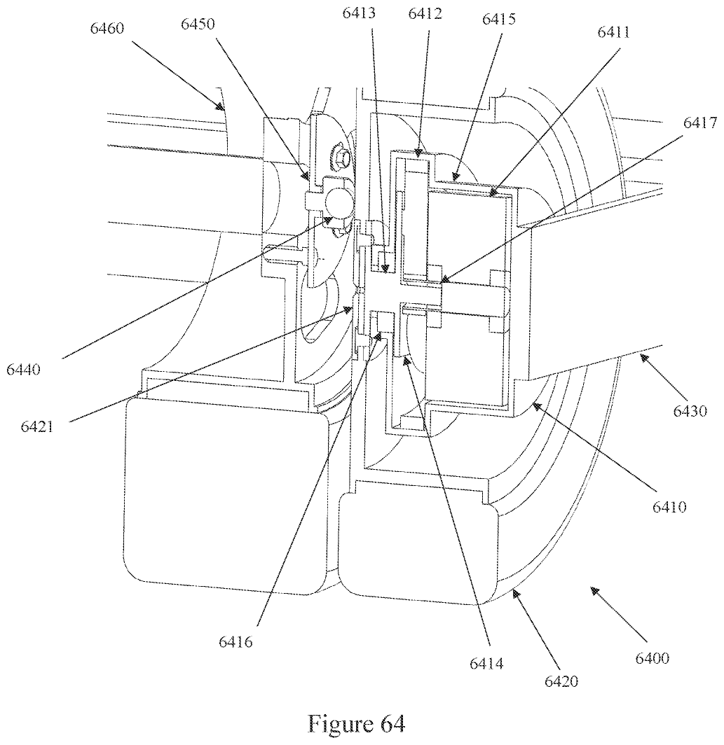

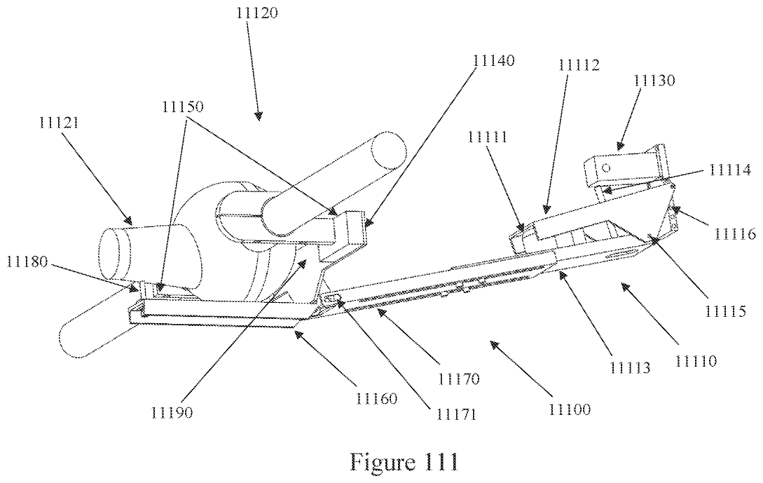

Referring now to FIG. 63 and FIG. 64, FIG. 64 shows another example of an AHS 6300, which may include one or more wheels 6310 configured to provide propulsion and braking via tractive action against an external surface such as the ground. Power may be transmitted to the wheel 6310 by a power unit 6320, which may be coaxial with the wheel 6310 as shown, and which may be connected to a swing arm 6330. Swing arm 6330 may be connected to a beam 6340, which may be extensible to accommodate vehicles of varying width, for example, by telescoping. Beam 6340 may be connected to a suspension system 6350 and may be configured to accommodate varying pitch angles of a suspension arm 6351. Beam 6340 may connect to suspension arm 6351 at a pivot 6341 and a slot 6342, and the connection may become rigid when fasteners (not shown) are engaged. Suspension system 6350 may be configured as provided in FIG. 111 discussion. A rear chassis 6360 may include an energy storage device (not shown) and may be configured to connect to a trailer hitch receiver 6371. As configured, a significant portion of the weight of a vehicle 6370 and AHS 6300 may be borne by the wheels 6310, providing significant tractive force. By extending or retracting suspension arm 6351, the wheels 6310 may be aligned with one or more rear wheels 6372 of vehicle 6170, which may reduce the amount of weight removed from the front wheels (not shown) of vehicle 6170 and reduce tire scrub when vehicle 6370 is turning.

FIG. 64 provides a cutaway of AHS 6400. As shown, a power unit 6410 may include a power conversion device 6411, which may be electric motor or an axial flux electric motor. Power conversion device 6411 may transmit power to and from a gear set 6412. Gear set 6412 may be an epicyclic gear set, as shown, and may be configured to increase the torque provided by power conversion device 6411. An output shaft 6413 of the gear set 6412 may be connected to a planet carrier 6414 of gear set 6412. Output shaft 6413 may be connected to a hub 6414, which may be configured to connect to a wheel 6420. Power unit 6410 may include a housing 6415, which may be rigidly connected to swing arm 6430. Power conversion device 6411 may be rigidly connected to housing 6415. Output shaft 6413 may be rotatingly connected to housing 6415 by one or more bearings 6416 and to power conversion device 6411 by one or more bearings 6417. To prevent unintended transverse movement of wheel 6420, wheel 6420 may be configured to engage with a roller 6440 when subjected to lateral forces. Roller 6440 may be spherical and may be connected to a wheel-side coupling 6450, which may be connected to the vehicle wheel 6460, as provided in FIG. 57 and FIG. 58 discussions. Wheel 6420 may include a cover 6421 configured to provide a smooth surface for roller 6440 to engage with.

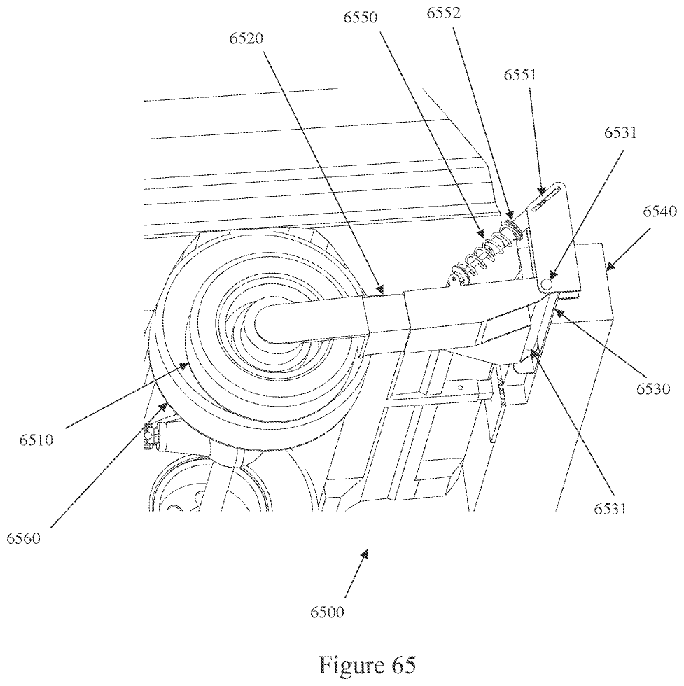

FIG. 65 provides a further example of an AHS 6500 with one or more traction wheels 6510. Swing arm 6520 may be rotatingly connected to a suspension mount 6530, which may be connected to and transversely positionable relative to rear chassis 6540. Suspension mount 6530 may connect to swing arm 6520 at pivots 6531. A resilient member such as a spring and/or a spring/damper 6550 may be connected to swing arm 6520 and suspension mount 6530. Swing arm 6520 may be extensible such that the wheel 6510 may be aligned with the rear wheels 6560 of the vehicle, for example by telescoping as shown. The lateral stiffness of swing arm 6520 and the distance between pivots 6531 may provide sufficient resistance to lateral movement of wheel 6510 under cornering forces. Pivots 6531 may create an axis of rotation at an angle to the transverse axis, which may cause a favorable change in camber of wheel 6510 as the suspension articulates under cornering forces. Spring/damper 6550 may have a positionable interface 6551 with suspension mount 6530 which may enable adjustment of the nominal pitch angle of swing arm 6520. Spring/damper 6550 may include an adjustable spring perch 6552 which may enable the nominal spring force on wheel 6510 to be adjusted.

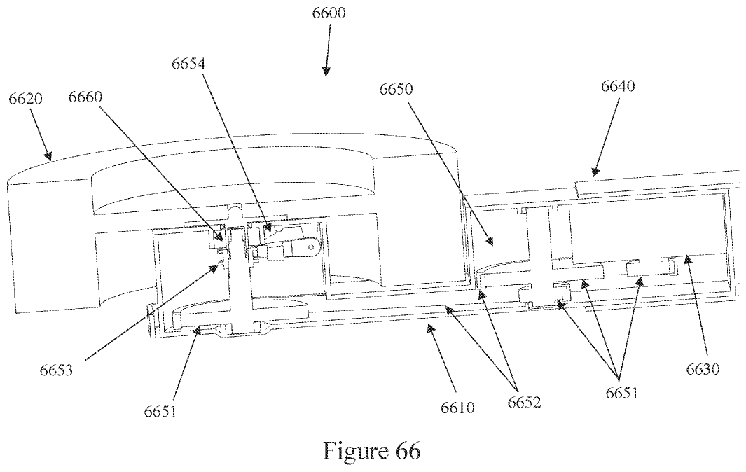

FIG. 66 provides a cutaway of another example of a power unit 6610 of an AHS 6600 with one or more traction wheels 6620. As shown, power conversion device 6630 may be located inside a swing arm 6640. A drivetrain 6650 may transmit power between power conversion device 6630 and an output shaft 6660. Output shaft 6660 may be connected to a wheel 6620. Drivetrain 6650 may be configured to increase the torque delivered by power conversion device 6630. Drivetrain 6650 may include two or more pulleys or sprockets 6651 engaged with one or more chains or belts 6652. In some embodiments, drivetrain 6650 may include gears (not shown) instead of pulleys/sprockets and belts/chains. Drivetrain 6650 may include a clutch 6653 that may be configured to transmit torque between drivetrain 6650 and output shaft 6660 when in a first position as shown, and to interrupt transmission of torque when in a second position (not shown). Clutch 6653 may be moved between first and second positions by a mechanism 6654, as provided in FIG. 53 discussion.

In another example of an AHS (not shown) with one or more swing arms each including a traction wheel, one or more power conversion devices (not shown) may be located in a rear drive (not shown), as provided in FIG. 59 discussion, and power may be transmitted to a wheel (not shown) by a driveshaft (not shown) and one or more right-angle gearboxes (not shown), as provided in FIG. 49 discussion.

FIG. 67 provides an isometric view of an example throttle 6700 in a vehicle's driver-side foot well 6710. Throttle 6700 may include a floor mount 6720 which may be rigidly connected to floorboard 6721. Throttle 6700 may include a firewall mount 6730 which may be rigidly connected to a firewall 6731. Floor mount 6720 and firewall mount 6730 may be rotationally connected to each other at a pivot 6722. Throttle 6700 may include a pedal 6740, which may be positionable such that it is to the right of vehicle's accelerator pedal 6750. Pedal 6740 may be connected to pedal position sensor 6760 such that when pedal 6740 is depressed by an operator, a signal may be provided to a motor controller (not shown) that may request a specific torque from the hybrid motor (not shown) for propelling or arresting the vehicle. As configured, the system may operate in either a purely electric mode or parallel hybrid mode, whereby the hybrid motor provides propulsion until pedal 6740 is depressed to the point of being substantially coplanar with vehicle's accelerator pedal 6750. Further depression of both pedal 6740 and vehicle's accelerator pedal 6750 may cause an increased throttle response from the vehicle's engine (not shown) which may result in propulsion being provided by both the hybrid motor and vehicle's engine. Floor mount 6720 and firewall mount 6730 may include a plurality of holes 6723 which may allow rigid connection to the floorboard 6721 and firewall 6730, respectively, with one or more screws (not shown), rivets (not shown), or other fasteners (not shown), without compromising other vehicle systems such as brake lines (not shown) or cooling lines (not shown). Holes 6723 may also allow pedal position sensor 6760 to be rigidly connected in a plurality of positions to optimally position pedal 6740 relative to vehicle's accelerator pedal 6750.

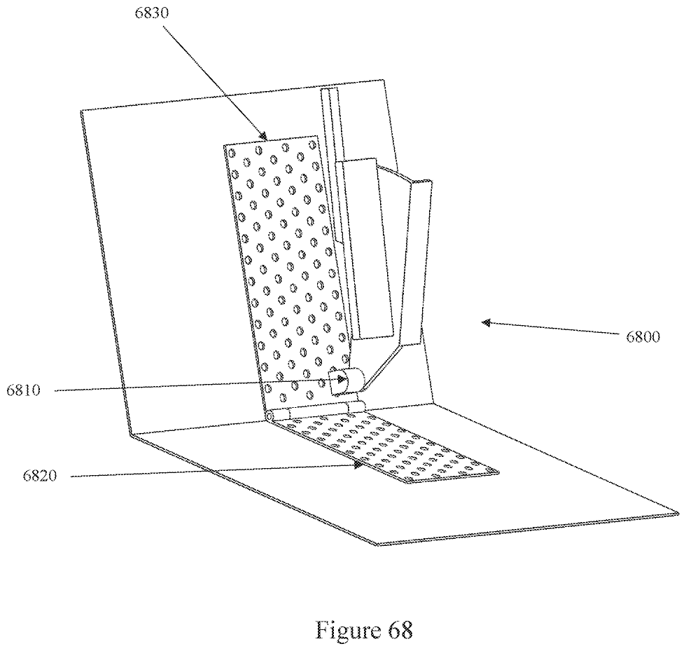

FIG. 68 provides an isometric view of an exemplary throttle 6800, where a pedal position sensor 6810 may be rigidly connected to a firewall mount 6830.

Referring now to both FIG. 67 and FIG. 68, floor mount 6720, 6820 may be rotationally connected to a firewall mount 6730, 6830 with one or more springs (not shown) such that firewall mount 6730, 6830 may be rigidly connected to the vehicle's firewall 6731 and floor mount 6720, 6820 may be pressed against floorboard 6721 e.g., by spring force. As configured, a plurality of holes (not shown) may not need to be drilled in floorboard 6721 to rigidly connect throttle 6700, 6800 to the vehicle. Alternatively, floor mount 6720, 6820 may be rigidly connected to floorboard 6721 and firewall mount 6730, 6830 may be pressed against firewall 6731 e.g., by spring force. As configured, holes (not shown) may not need to be drilled in firewall 6731 to rigidly connect throttle 6700, 6800 to the vehicle. Floor mount 6720, 6820 may include a notch (not shown) to provide clearance for a floor-mounted vehicle accelerator pedal (not shown).

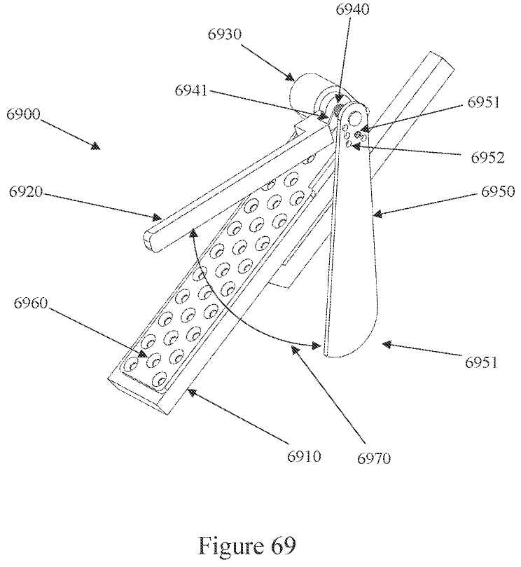

FIG. 69 provides an isometric view of an exemplary throttle 6900. Throttle 6900 may be rigidly connected to a vehicle's accelerator pedal 6910. Throttle 6900 may include a pedal 6920 which may be connected to throttle position sensor 6930 such that when pedal 6920 is depressed by an operator, a signal may be provided to a motor controller (not shown), as described previously. Pedal 6920 may be biased towards upwards rotation by a spring 6940. A spring anchor 6950 may be rotationally connected to throttle position sensor and may be pressed against the vehicle's floorboard (not shown), firewall (not shown), or any other structure of the foot well (not shown), at its distal end 6951 by spring 6940. Spring 6940 may be a torsion spring. Spring 6940 may include a pedal leg 6941 that may exert a torque on pedal 6920. Spring 6940 may include an anchor leg (not shown) which may exert a torque on spring anchor 6950. Spring anchor 6950 may include a stop 6951 which may interface with anchor leg of spring 6940 for transmission of torque. Stop 6951 may be positionable in a plurality of positions such that the nominal angle 6970 between pedal 6920 and spring anchor 6950 and the preload of spring 6940 can be adjusted to accommodate vehicles of varying geometry. Stop 6951 may be a screw, set screw, pin, or the like. Stop 6951 may be connectable to spring anchor 6950 in a plurality of holes 6952 to achieve the adjustability, previously described. Throttle 6900 may be connectable to the vehicle's accelerator pedal 6910 with screws (not shown) which may interface with a plurality of holes 6960. Holes 6960 may allow throttle 6900 to positionable relative to vehicle's accelerator pedal 6910 in an optimal position. In another example, throttle 6900 may be connectable to vehicle's accelerator pedal 6910 with clamping features (not shown), as is common for pedal attachments for disabled drivers.

As configured, throttle 6900 may be operated by a user without imparting significant force on vehicle's accelerator pedal 6910 until pedal 6920 is fully depressed, at which point further depression will elicit an increased throttle response from the vehicle's engine (not shown). Throttle 6900 may therefore be capable of operating in a purely electric mode or in a parallel hybrid mode described above.

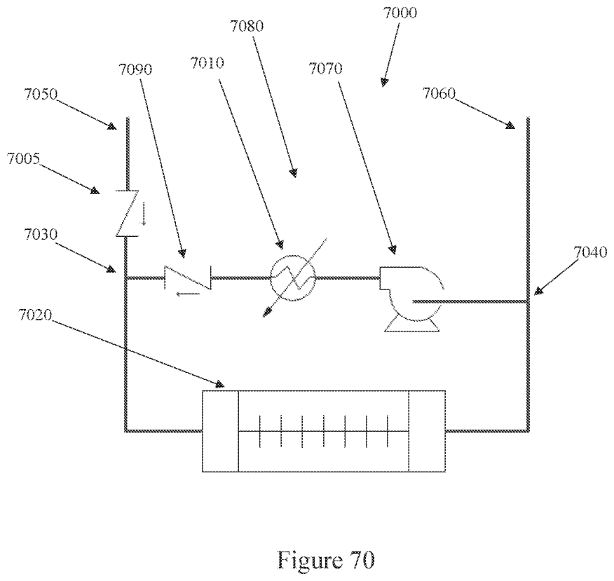

FIG. 70 provides a schematic of an auxiliary heating system 7000. Since heat is usually provided by the engine coolant, in order to provide heat for the cabin and defrosting for the windshield, an additional source of heat may be desired or required. In this embodiment, thermal energy may be supplied by a heater 7010 to a vehicle's heater core 7020. The auxiliary heating system 7000 may be installed by fitting tees 7030 and 7040 to a vehicle's heater core supply line 7050 and a return line 7060, respectively. Coolant (not shown) may be circulated by a pump 7070. A heater check valve 7090 may prevent flow of coolant from passing through an auxiliary heater circuit 7080 when the engine is running. An engine check valve 7005 may prevent flow of coolant from pump 7070 from flowing towards the engine (not shown).

Heater 7010 may be a resistive heater powered by a hybrid battery (not shown) or a vehicle's electrical system (not shown). Heater 7010 may be a heat pump powered by the hybrid battery or the vehicle's electrical system (not shown) and may be able to provide cooling as well as heating. Heater 7010 may be a fired heater, and may burn liquefied petroleum gas, such as propane or butane, or any other fuel supplied by an additional reservoir (not shown). Heater 7010 may alternatively burn fuel from the vehicle's fuel system (not shown), such as gasoline or diesel.

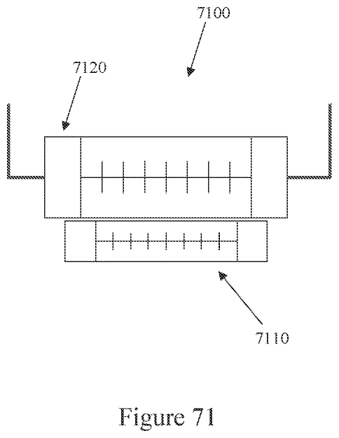

FIG. 71 provides another example of an auxiliary heating system 7100. In this example, a heater 7110 may be affixed to a vehicle's heater core 7120 such that air circulated through the vehicle's heater core 7120 may also pass through the heater 7110 and be heated. The heater 7110 may be a resistive heater. Power for the heater may be supplied by the hybrid battery (not shown) or the vehicle's electrical system (not shown).

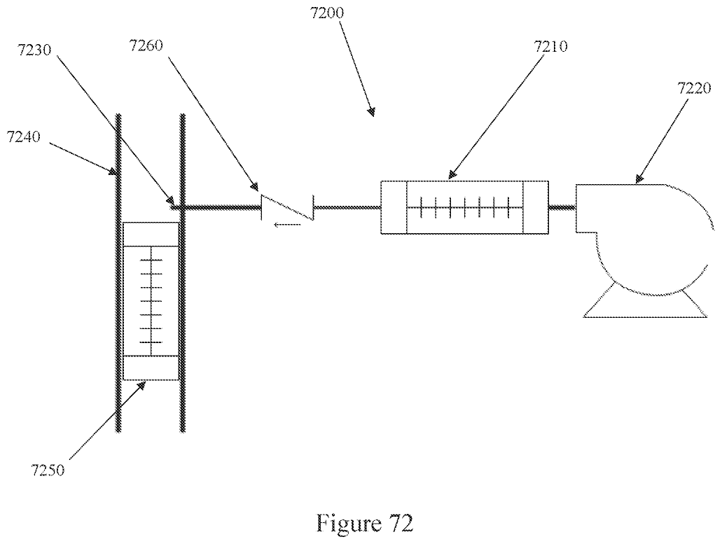

FIG. 72 provides an example of a climate control system 7200, which may include an electric heater 7210 and an air blower 7220 and may be configured to be mounted in the passenger compartment (not shown) or engine compartment (not shown) of a vehicle. The heater 7210 may be a heat pump and may be configured to provide both heating and cooling. The blower 7220 may be configured to send heated or cooled air through a hose 7230 to a vehicle's climate control ducting 7240, for example either directly upstream or downstream of a vehicle's heater core 7250. The climate control system 7200 may include a one-way valve 7260 which may prevent air from flowing from the duct 7240 to the heater 7210. As configured, heated and/or cooled air may be circulated to the passenger compartment by the vehicle's climate control system (not shown).

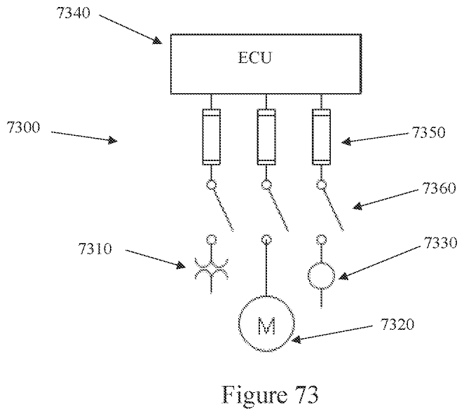

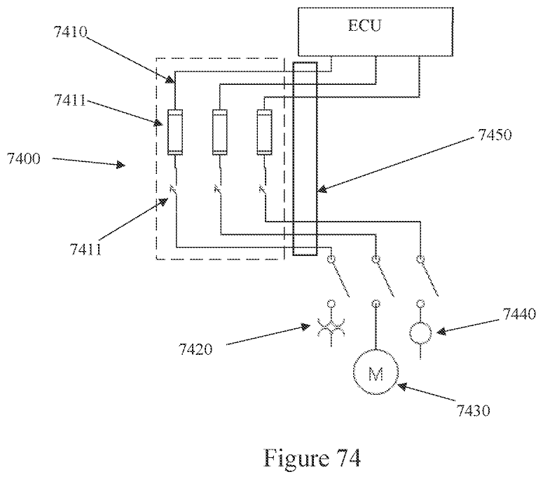

Some modern vehicles include no provision for the user to force the engine to shut down while leaving necessary accessories, such as power steering and brakes, functional. Referring now to FIG. 73 and FIG. 74, such vehicles may be fitted with an engine defeat system 7400, shown in FIG. 74, which may enable a user to force the engine (not shown) to shut down while maintaining operation of necessary accessories.

FIG. 73 provides a schematic of an exemplary typical vehicle electrical architecture 7300 as it pertains to control of an ignition system 7310, a fuel pump 7320, and starter motor solenoid 7330. In such a system, an electronic control unit 7340 may provide communications with the ignition system 7310, fuel pump 7320, and starter motor solenoid 7330. Such communications may include electrical signals, currents, voltages, or the like. Electronic control unit 7340 may provide electrical energy to one or more fuses 7350, each of which may direct that energy to a relay 7360 which, when energized, may provide electrical energy to the ignition system 7310, fuel pump 7320, or starter motor solenoid 7330.

FIG. 74 provides an engine defeat system 7400. Engine defeat system 7200 may include one or more bypass circuits 7410 configured to allow a user to interrupt the delivery of electrical energy to an ignition system 7420, a fuel pump 7430, or a starter motor solenoid 7440. Each bypass circuit 7410 may include a switch 7411, which may, when actuated, interrupt the continuity of bypass circuit 7410. Switch 7411 may be configured to be actuated be either the user or by an AHS controller (not shown). Bypass circuit 7411 may include a fuse 7412, which may be the same fuse that was present in the circuit before the addition of engine defeat system 7400. Bypass circuit 7410 may be configured to interface with a vehicle's fuse box 7450 and may be further configured to plug in to a fuse receptacle (not shown) for the circuit being bypassed, as is commonly done for bypassing circuits on vehicles to be towed, such as behind a recreational vehicle.

It is understood that engine defeat system 7400 may include one, two, three, or more bypass circuits, and any combination of circuits described in this disclosure. Additionally, circuits not described in this disclosure may optionally be included, such as a circuit powering an electronic fuel injection system or other fuel system components. It is understood that specific vehicle electrical architectures may differ somewhat from that shown herein and that any such differences are within the scope of this disclosure.

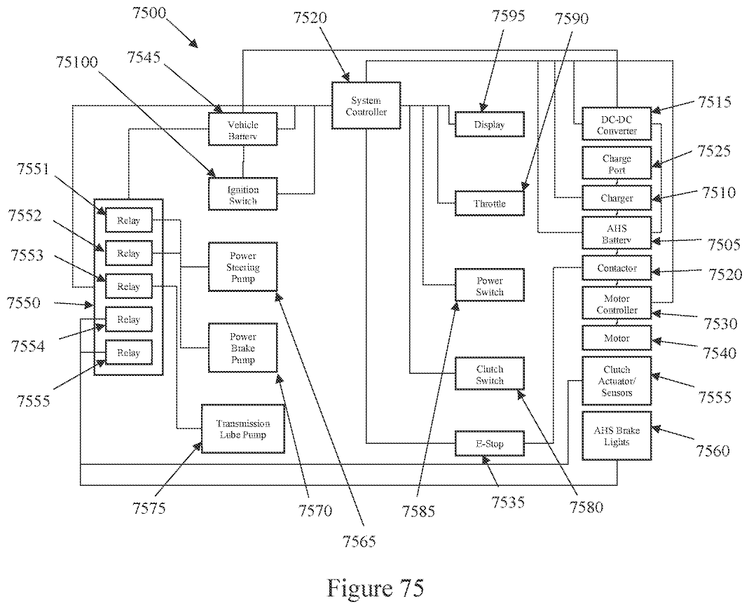

FIG. 75 provides an exemplary control system 7500 of an AHS (shown previously in FIG. 41). In this example, an AHS battery 7505 may be configured to: receive electrical energy from a charger 7510; deliver electrical energy to a DC-DC converter 7515; deliver electrical energy to a contactor 7520; and/or to communicate information to a system controller 7525, such as electrical current into and out of battery 7505, battery temperature, battery cell temperature, battery voltage, and battery cell voltage. AHS battery 7505 may include a battery management system (BMS, not shown), configured to measure and communicate such information, as is common in electric vehicles.

Charger 7510 may be configured to: deliver electrical energy to AHS battery 7505; receive electrical energy from a charge port 7525; and communicate with system controller 7525. Charge port 7525 may be configured to receive electrical energy from an offboard electric vehicle charger (not shown), as is common in the automotive industry. Charge port 7525 may be configured to conform to an existing automotive charge port standard, such as SAE J1772.

Contactor 7520 may be configured to allow transmission of electrical energy from the AHS battery 7505 to a motor controller 7530 when in a first state, and to interrupt transmission when in a second state. Contactor 7520 may be configured to communicate with system controller 7525 and to receive instructions or a signal to change from the second state to the first. Emergency stop (E-Stop) 7535 may be configured to interrupt transmission of the communication or signal from system controller 7525 to contactor 7520 when activated by a user. Emergency stop 7535 may be a button and may be configured to conform to an existing standard for emergency stop buttons, such as EN ISO 7950.

Motor controller 7530 may be configured to: receive electrical energy from contactor 7520; provide electrical energy to one or more motors 7540; receive information from motor 7540, such as motor temperature and angular velocity; receive information from system controller 7520, such as commanded motor current or angular velocity; and communicate to system controller 7520 information such as motor temperature, current, and angular velocity, and motor controller temperature, and the like.

DC-DC converter 7515 may be configured to receive electrical energy from the AHS battery 7505 and provide electrical energy at an appropriate voltage (for example, approximately 14 Volts) to a vehicle's battery 7545 and/or electrical system (not shown). DC-DC converter 7515 may be configured to receive instructions or signals from system controller 7520, for example a command to begin charging, and to communicate information to system controller 7520, such as output voltage and current. As configured, DC-DC converter 7515 may provide power to a relay bank 7550, the system controller 7520, and other components, and to maintain or increase the state of charge of vehicle battery 7545.

Relay bank 7550 may include one or more relays 7551, 7552, 7553, 7554, 7555 and may be configured to receive instructions or signals from system controller 7520, such as signals to actuate one or more relays 7551, 7552, 7553, 7554, 7555. Relay bank 7550 may be configured to receive electrical energy from the vehicle battery 7545 and distribute it to one or more relays 7551, 7552, 7553, 7554, 7555.

Clutch actuator/sensors 7565 may be configured to receive electrical power from one or more relays 7555 and to actuate one or more drivetrain clutches (not shown), as described previously, and to communicate the state of the actuator 7565 or clutch to system controller 7520. One or more AHS brake lights 7560 may be configured to receive electrical energy from relay 7554 and may be connected to a rear drive (not shown) or rear chassis (not shown), to indicate deceleration. System controller 7520 may be configured to activate relay 7554 whenever significant regenerative braking torque is applied by motor 7540.

An optional power steering pump 7565 may be configured to receive electrical power from relay 7551, which may be configured to be activated by system controller 7520. An optional power brake pump 7570 may be configured to receive electrical power from relay 7552, which may be configured to be activated by system controller 7520. An optional transmission lubrication (lube) pump 7575 may be configured to receive electrical power from relay 7553, which may be configured to be activated by system controller 7520.

Clutch switch 7580 may be configured to communicate with system controller 7520 and may be configured to allow a user to force drivetrain clutches (not shown) into a desired state. A power switch 7585 may be configured to communicate with system controller 7520 and may be configured to either activate the system 7500 or put it into a standby state when actuated by a user. A throttle 7590 may be configured to communicate with system controller 7520 and may be configured to receive a desired torque input from a user for motor 7540. Display 7595 may be configured to communicate with system controller 7520 and to provide information to a user. A display 7595 may include a touchscreen, button, or other input device (not shown) that may enable a user to choose the information being displayed or to provide additional instructions to system controller 7520.

System controller 7520 may be configured to receive electrical energy from the vehicle battery 7545 to power the low-voltage components of the system, such as system controller 7520, display 7595, and/or parts of the motor controller 7530. System controller 7520 may be configured to receive electrical energy from the vehicle's ignition switch 75100, which may be used to enable operation of the system 7500. System controller 7520 may include at least one processor (not shown) configured to provide instructions to the system controller 7520.

In some embodiments, input devices such as the throttle and/or display and control electronics from the control system may be configured to communicate with various systems such as the motor of the AHS. Such communication may be implemented as software and executed by a general-purpose computer. For example, such a general-purpose computer may include a control unit/controller or central processing unit (“CPU”), coupled with memory, EPROM, and control hardware. The CPU may be a programmable processor configured to control the operation of the computer and its components. For example, CPU may be a microcontroller (“MCU”), a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration. Such operations, for example, may be stored and/or executed by memory unit.

In some embodiments, the methodologies described herein are modules that may be configured to operate as instructed by a general process computer. In the case of a plurality of modules, the modules may be located separately or one or more may be stored and/or executed by the memory unit.

While not specifically shown, the general computer may include additional hardware and software typical of computer systems (e.g., power, cooling, operating system) is desired. In other implementations, different configurations of a computer can be used (e.g., different bus or storage configurations or a multi-processor configuration). Some implementations include one or more computer programs executed by a programmable processor or computer. In general, each computer may include one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

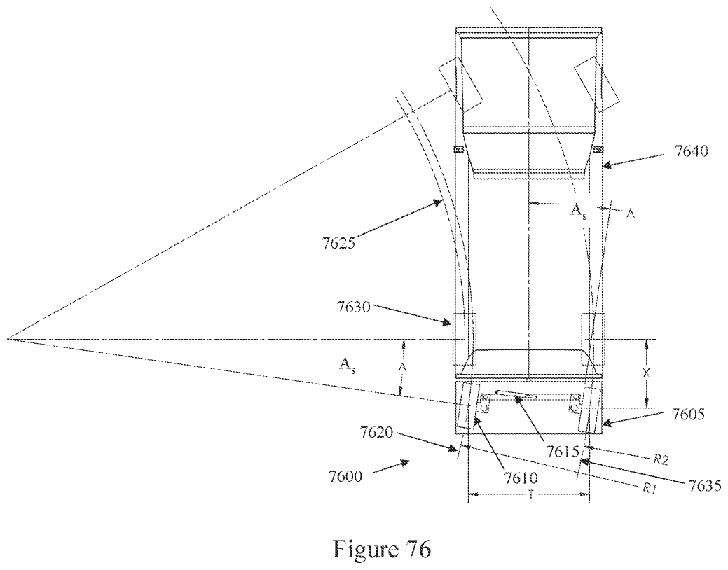

FIG. 76 provides an exemplary trailer wheel steering system 7600. In this embodiment, a frame 7605 of the trailer wheel steering system 7600 may be prohibited from rotating about a vertical axis (yaw) relative to the vehicle 7640. To prevent tire scrub when the vehicle 7640 is turning while allowing the trailer wheels 7610 to support lateral cornering loads, wheels 7610 may be steered by an actuator 7615 to an angle Aₛ that places them on an inner arc of travel 7620 and an outer arc of travel 7635 that are concentric or nearly concentric with the arc of travel 7625 of the rear wheels 7630 of the vehicle 7640. The steering system 7600 may be of any type common in vehicle steering systems, such as rack and pinion, recirculating ball, or steering gear. The actuator 7615 may be an electric motor, an electric linear actuator, a hydraulic piston, a hydraulic rotary actuator, or any other type of actuator capable of producing mechanical power from an energy source. The steering angle Aₛ necessary to place the wheels on the desired arc of travel may be computed by a processor (not shown) using input from a wheel speed sensor (not shown) on each of the trailer wheels 7610. The steering angle calculation may use the following variables: the rotational speed V1 of a first trailer wheel, the rotational speed V2 of a second trailer wheel, the radius R1 of the arc of travel of a first trailer wheel, the radius R2 of the arc of travel of a second trailer wheel, the steering angle Aₛ of one or more trailer wheels, the distance X between the rear axle of the vehicle and the axle or axles of the trailer wheels, and the track width T of the trailer. Because the ratio of trailer wheel speeds V1 and V2 is approximately equal to the ratio of the radii R1 and R2 of their desired arcs of travel 7620 and 7635, a desired steering angle Aₛ can be computed geometrically based on the direction of wheel travel, the rotational speeds of the two trailer wheels, the distance X, and the track width T of the trailer. The calculation may use the following equation:

$${A}_{S} = {sin}^{- 1} \{ \frac{X \cdot ( V 2 - V 1 )}{V 1 \cdot T} \}$$

The calculation may also use the following equation as an approximation:

$${A}_{S} = \frac{X \cdot ( V 2 - V 1 )}{V 1 \cdot T}$$

The force delivered by the actuator 7615 may be reduced or eliminated when driving at low speeds when cornering forces are small thereby reducing any effects on maneuverability and reducing power consumption.

In some embodiments, the wheel speed sensors (not shown) may be of any type commonly used in vehicles for anti-lock brake systems, traction control, and other uses, such as that described in U.S. Pat. No. 3,500,091.

The trailer wheel steering system 7600 may also be able to compute the steering angle by extracting the vehicle's steering wheel angle from the vehicle's On Board Diagnostic (OBD) system (not shown), which typically have an electrical interface accessible from the passenger compartment. Also accessible via the OBD system is the vehicle's wheel speed sensors, which may be used in a similar calculation to that provided above for wheel speed sensors (not shown) on the trailer wheels 7610.

The trailer wheel steering system 7600 may use measurements of the vehicle-trailer combination, such as the vehicle's wheelbase and the distance between the vehicle's rear wheels and the wheels of the trailer, to make the calculated steering angle more accurate with respect to the desired arc of travel. This trailer wheel steering system 7600 may be applied to any trailer connected to a vehicle where the frame of the trailer is not allowed to rotate about its vertical axis relative to the vehicle.

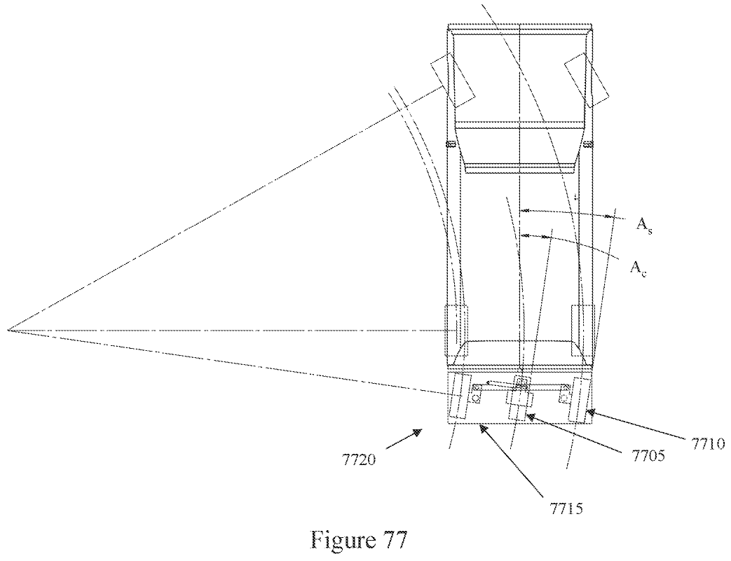

In some embodiments, the trailer wheel steering system 7600 may also be able to determine a desired steering angle Aₛ by using a caster wheel 7705, as shown in FIG. 77. As is easily appreciated, a caster wheel 7705 will naturally assume a direction of travel that reduces or eliminates tire scrub. By measuring the rotation angle A_{c} of the caster wheel 7705, the same steering angle Aₛ can be applied to one or more steered wheels 7710. In some embodiments, caster wheel 7705 may be connected to the trailer frame 7715 with a suspension system (not shown), as previously described. The caster wheel's suspension system (not shown) may utilize a spring (not shown) with a lower spring rate than that of the steered wheel 7710 or wheels such that the majority of the weight of the trailer 7720 is borne by the steered wheel 7710 or wheels, allowing it or them to react the majority of the trailer cornering forces when the vehicle 7640 turns without losing traction.

The trailer wheel steering system 7600 may be able to determine a desired steering angle Aₛ by measuring direction of relative movement of the ground. This may be measured by an optical sensor (not shown) of a type commonly used in computer mice. It may also be measured by a roller ball (not shown) in contact with the ground and a 2-axis speed measurement system (not shown), also commonly used in computer mice.

The trailer wheel steering system 7600 may be able to determine a desired steering angle Aₛ by measuring the rate of yaw of the trailer wheel steering system 7600 using a gyroscopic sensor (not shown) commonly used in inertial navigation systems.

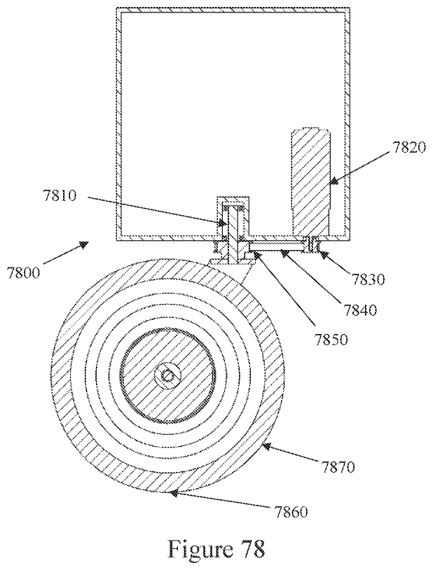

Also referring now to FIG. 78, in some embodiments, the trailer wheel steering system 7800 may, instead of determining a steering angle Aₛ, determine the torque about the caster kingpin 7810 of a caster wheel 7870 required to counteract a portion or the entirety of the torque imparted by cornering forces on the wheel 7870. Such a trailer wheel steering system 7800, shown in vertical longitudinal cross section in FIG. 78, may allow the caster wheel 7870 to naturally assume the steering angle Aₛ that minimizes tire scrub while still allowing the wheel 7870 to bear the cornering forces. The torque about the caster kingpin 7810 may be provided by an actuator 7820, such as an electric motor 7820 or gear motor 7820. The torque provided by an electric motor 7820 may be varied by controlling the electric current delivered to the motor. The torque may be transmitted from actuator 7820 to caster kingpin 7810 by a drive pulley 7830, a belt 7840, and a driven pulley 7850. The trailer wheel steering system 7800 may allow the caster wheel 7870 to rotate through 360 degrees, allowing appropriate steering angle when reversing. The torque delivered by the actuator 7820 may be reduced or eliminated when driving at low speeds when cornering forces are small, thereby reducing any effects on maneuverability and reduce power consumption. Actuator 7820 may provide damping to the trailer wheel steering system 7800 that may reduce or eliminate caster wobble. The amount of torque may be determined using an accelerometer (not shown) that measures lateral acceleration. The torque may be calculated by using the lateral acceleration, mass of the trailer system, location of the center of mass of the trailer system relative to the connection to the vehicle and the caster axis, the amount of caster in the caster wheel 7870, and the number of caster wheels 7870. The caster wheels 7870 may be positioned such that the contact patch 7860 is laterally aligned or nearly aligned with the center of mass (not shown) of the trailer system 7880, thereby limiting the cornering forces transmitted to the vehicle 7640. The trailer wheel steering system 7800 may also include a steering damper (not shown) to prevent caster wobble, as is commonly used on motorcycles. The trailer wheel steering system 7800 may also include one or more springs (not shown) configured to provide a centering torque on the caster wheels, which may also prevent caster wobble. It is understood that a steering damper and/or centering spring or springs may be included in any trailer wheel steering system presented herein.

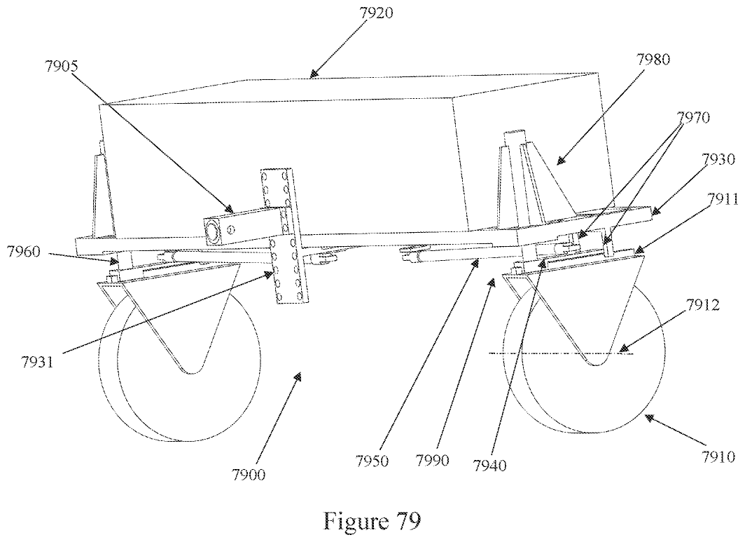

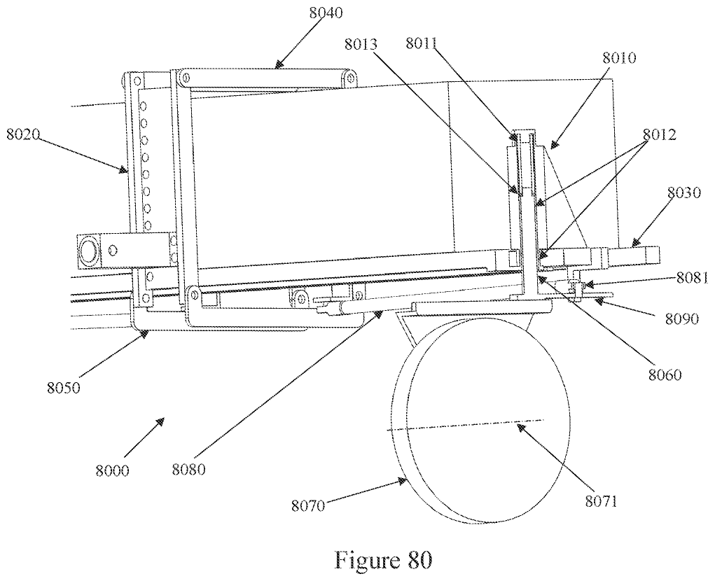

FIG. 79 shows another embodiment of a trailer 7900 with a trailer wheel steering system 7990, as provided in the FIG. 78 discussion. In this embodiment, one or more caster wheels 7910 may be free to assume a steering angle (shown as Aₛ in FIG. 77) that minimizes tire scrub as the vehicle (not shown) drives around a corner. A counterweight 7920 may be connected to the rear chassis 7930 and be configured to slide transversely when subjected to lateral acceleration when cornering. Counterweight 7920 may be configured to apply a steering torque to the caster wheels 7910 to allow the caster wheels 7910 to bear all or a portion of the cornering forces on the trailer 7900. The counterweight 7920 may be connected to a steering arm 7940 by a tie rod 7950. The steering arm 7940 may be connected to a kingpin 7960 and be configured to steer the caster wheel 7910. The steering arm 7940 may be slidingly connected to a caster wheel fork 7911 such that the wheel axis 7912 may be positioned behind the kingpin 7960 (as shown) when the vehicle is moving forward and ahead of the kingpin 7960 (as shown in FIG. 80) when the vehicle (not shown) is moving backwards. As configured, the need for the caster wheel 7910 to turn past 90 degrees when the vehicle transitions from forward to reverse and vice versa may be eliminated, and the range of steering angle may be limited by one or more stops 7970, which may be configured to limit travel of the steering arm 7940. Kingpin 7960 may be slidingly and rotatingly connected to a suspension system 7980, which may enable the caster wheel 7910 to travel vertically with respect to the rear chassis 7930 in response to terrain. Rear chassis 7930 may include a mount plate 7931, which may be configured to connect to a receiver post 7905 in a plurality of vertical positions. Receiver post 7905 may be configured to connect to a trailer hitch receiver (not shown) of the vehicle (not shown). As configured, the rear chassis 7930 may be rigidly connectable to vehicles (not shown) with varying trailer hitch receiver heights. Trailer 7900 may include a steering damper (not shown), as is commonly employed on motorcycles, configured to prevent undesired oscillations of the caster wheels (known as caster wobble). Steering damper may be a linear damper (not shown) or a rotary damper (not shown).

The counterweight 7920 may include one or more energy storage devices (not shown), a charger (not shown) for the energy storage device, one or more power conversion devices (not shown), and/or a power conversion controller (not shown). The fraction of the cornering loads borne by the caster wheels 7910 may be tailored by adjustment of the ratio of the mass of the counterweight 7920 to the total mass of the trailer 7900 and the ratio of the length of the steering arm 7940 to the trail of the caster wheel 7910, where trail is defined as the distance between the theoretical intersection (not shown) of the kingpin 7960 with the road (not shown) and the point (not shown) where the caster wheel 7910 contacts the road (not shown).

FIG. 80 provides a cutaway of a trailer 8000 with an exemplary mount plate mount plate 8020. In this embodiment, mount plate 8020 may be connected to the rear chassis 8030 by one or more upper control arms 8040 and one or more lower control arms 8050. As configured, rear chassis 8030 may be capable of moving vertically with respect to the vehicle (not shown), while maintaining pitch orientation.

Suspension system 8010 may include a spring 8011 configured to exert a substantially downward force on kingpin 8060. Suspension system 8010 may include one or more bushings 8012, which may be configured to allow vertical translation and yaw rotation of kingpin 8060. In some embodiments, one or more thrust bearings 8013 may reduce friction and allow rotation of kingpin 8060 with less drag torque.

As shown in FIG. 80, caster wheel 8070 is positioned as when the vehicle is traveling backwards, with the wheel axis 8071 forward of the kingpin 8060.

Tie rod 8080 may include one or more spherical joints 8081, which may accommodate steering rotation and vertical translation of steering arm 8090.

It is understood that there are many common mechanisms and connectors or connection members capable of translating a lateral force on a counterweight into a steering torque on a wheel and that tie rods acting on steering arms is one representative example. Other examples include: a master hydraulic cylinder, the piston being connected to the counterweight, and fluidically connected to a slave hydraulic cylinder, the piston of the slave hydraulic cylinder being connected to a steering arm; a gear rack connected to the counterweight and in communication with a pinion gear connected to the kingpin or a component of the suspension system, the component of the suspension system being slidingly connected to the kingpin; a belt or chain connected to the counterweight and in communication with a pulley or sprocket connected to the kingpin or component of the suspension system, the component of the suspension system being slidingly connected to the kingpin.

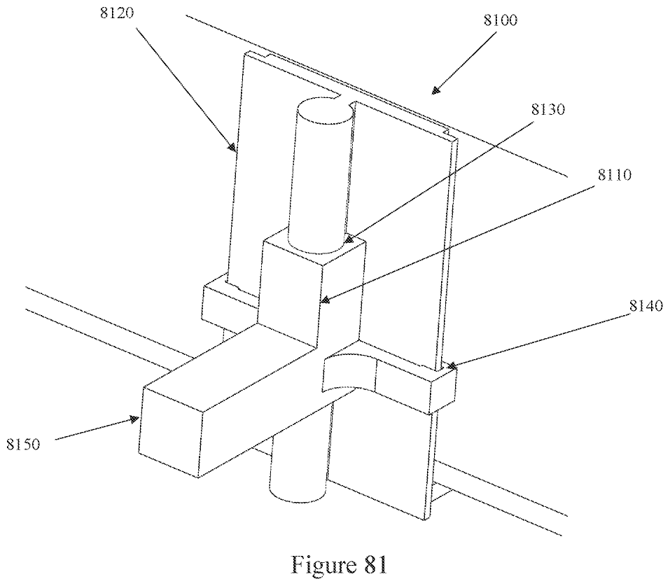

FIG. 81 provided a trailer 8100 with another exemplary mount plate 8110. Mount plate 8110 may slidably connect to a frame 8120 with a first linear bearing 8130 that may be configured to prevent relative pitch, roll, transverse translation, and/or longitudinal translation. Mount plate 8110 may also connect to the frame 8120 with one or more additional linear bearings 8140 which may be configured to prevent relative yaw. In some embodiments, receiver post 8150 may be rigidly connected to mount plate 8110.

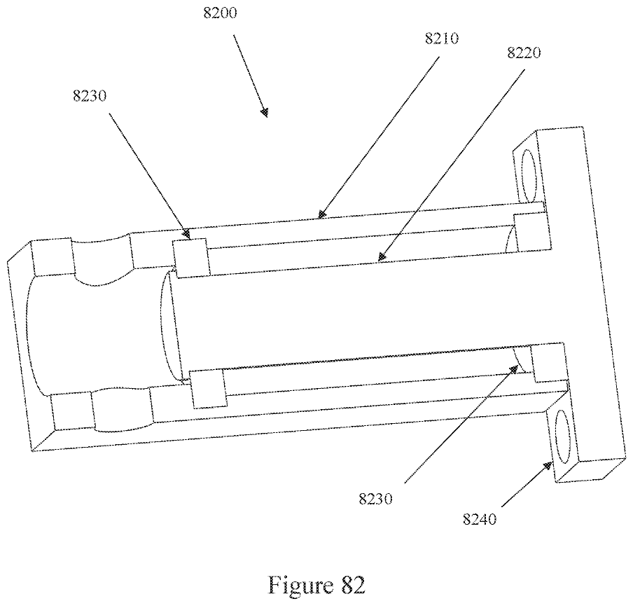

FIG. 82 provides a cutaway of another exemplary receiver post 8200, which may include a receiver protrusion 8210, a shaft 8220, and one or more bearings 8230. The receiver protrusion 8210 may be configured to be inserted into a trailer hitch receiver (not shown). The bearings 8230 may rotationally connect shaft 8220 to receiver protrusion 8210. Shaft 8220 may connect to a flange 8240 configured to connect to a mount plate (not shown) in one or a plurality of vertical positions, or shaft 8220 may connect directly to a mount plate in one or a plurality of vertical positions. As configured, receiver post 8200 may enable the frame (not shown) of a trailer (not shown) to roll relative the vehicle (not shown).

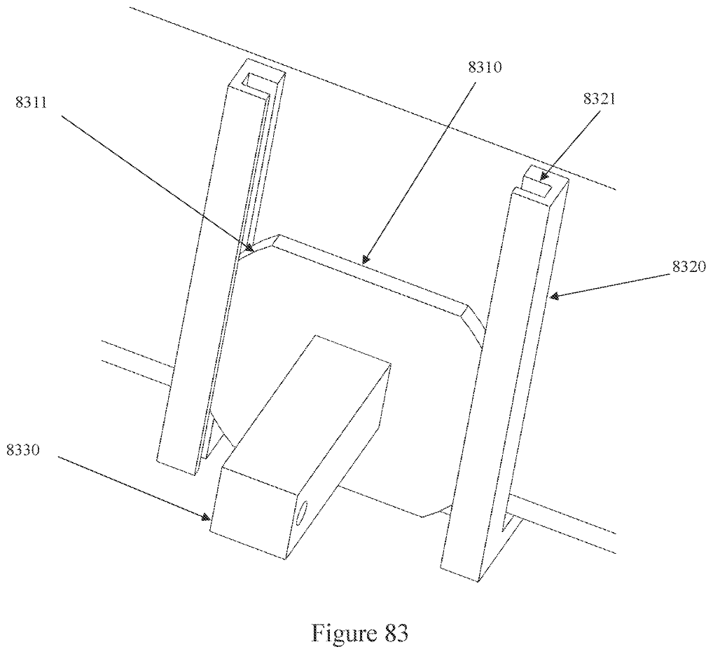

FIG. 83 provides another embodiment of a mount plate 8310, which may be slidingly and rotatingly connected to frame 8320. Mount plate 8310 may include one or more circular sections 8311 that may engage with one or more channels 8321 of frame 8320. A receiver post 8330 may be rigidly connected to mount plate 8310. As configured, transverse translation, longitudinal translation, yaw, and pitch of frame 8320 relative to the vehicle (not shown) may be prevented, while relative vertical translation and roll may be allowed.

It is understood that any combination of trailer wheel steering system examples and AHS examples described herein is within the scope of the disclosure. The trailer may include any combination of rear drive, power conversion device, energy storage device, battery, power conversion controller, and energy storage device charger. The trailer may be connected to one or more swing arms configured to transmit power to one or more wheels of a vehicle, or a drivetrain configured to transmit power to a differential of a vehicle. The trailer may include a range-extending generator, fuel cell, or battery configured to provide electrical power to an electric vehicle.

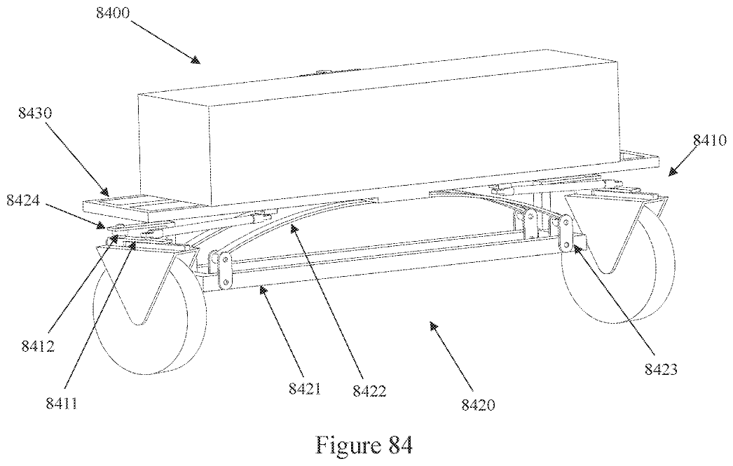

Referring now to FIG. 84, FIG. 84 provides another example of a trailer 8400 with a trailer wheel steering system 8410. In this example, a suspension system 8420 includes a subframe 8421 and one or more springs 8422, which may be leaf springs as shown. Springs 8422 may be rigidly connected to the trailer frame 8430 and may be connected to the subframe 8421 with one or more shackles 8423, as is common in automotive suspension systems. Springs 8422 may also be connected to trailer frame 8430 with elastomeric isolators (not shown) or may be rigidly connected (not shown). Subframe 8421 may include one or more caster perches 8424 which may be connected to a steering arm 8411 by a bearing 8412, which may be a thrust bearing as shown. Suspension system 8420 may include a Panhard rod (not shown) configured to prevent transverse translation of subframe 8421, as is common in automobile suspension systems. Suspension system 8420 may include one or more radius rods (not shown) configured to prevent longitudinal translation of subframe 8421, as is common in automobile suspension systems.

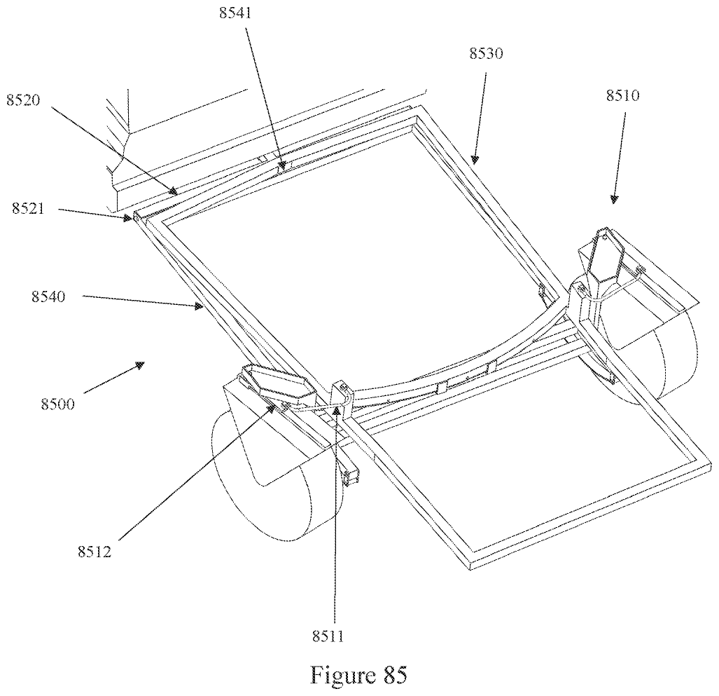

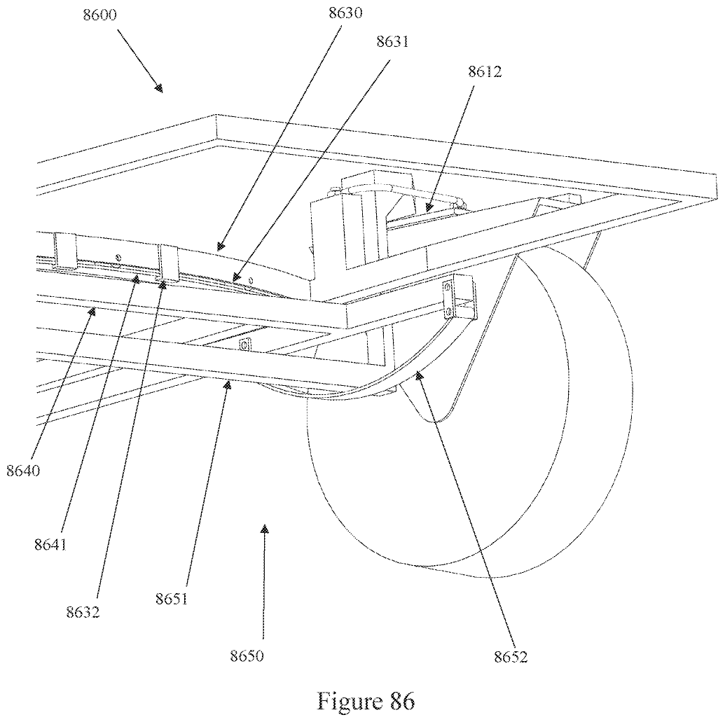

FIG. 85 and FIG. 86 show another example of a trailer 8500, 8600 with a trailer wheel steering system 8510. In this example, trailer frame 8540 may be rotatingly connected to hitch 8520 at one or more hinges 8521, which may be configured to allow relative pitch between the trailer frame 8510 and the hitch 8520 and to prevent relative yaw. Counterweight 8530 may be rotatingly connected to trailer frame 8540 at pivot 8541 which may be configured to allow relative yaw between counterweight 8530 and trailer frame 8540. Counterweight 8530 may be configured to carry cargo. The trailer wheel steering system 8510 may include one or more tie rods 8511 configured to exert a torque on steering arm 8512 when counterweight 8530 is subjected to lateral acceleration.

Referring now to FIG. 86, counterweight 8630 may include one or more rollers 8631, which may roll on track 8641 of trailer frame 8640 and may be configured to support a majority of the weight of counterweight 8630 and any cargo (not shown). Counterweight 8630 may include one or more tabs 8632 which may extend under track 8641 and may be configured to prevent vertical separation of counterweight 8630 and trailer frame 8640. A suspension system 8650 may include a subframe 8651 which may be connected to the trailer frame 8640 by one or more springs 8652, which may be leaf springs as shown. Subframe 8651 may be connected to steering arms 8612 as provided in the FIG. 84 discussion.

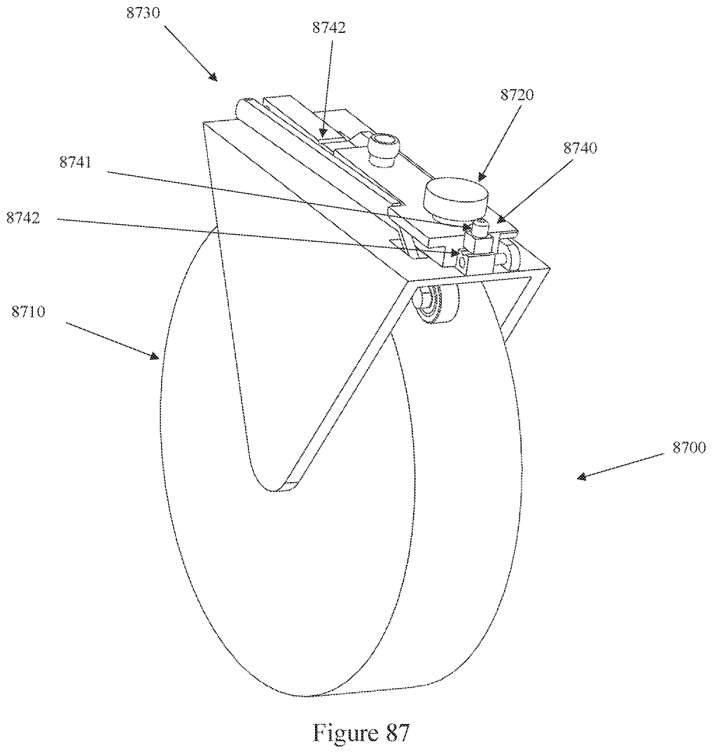

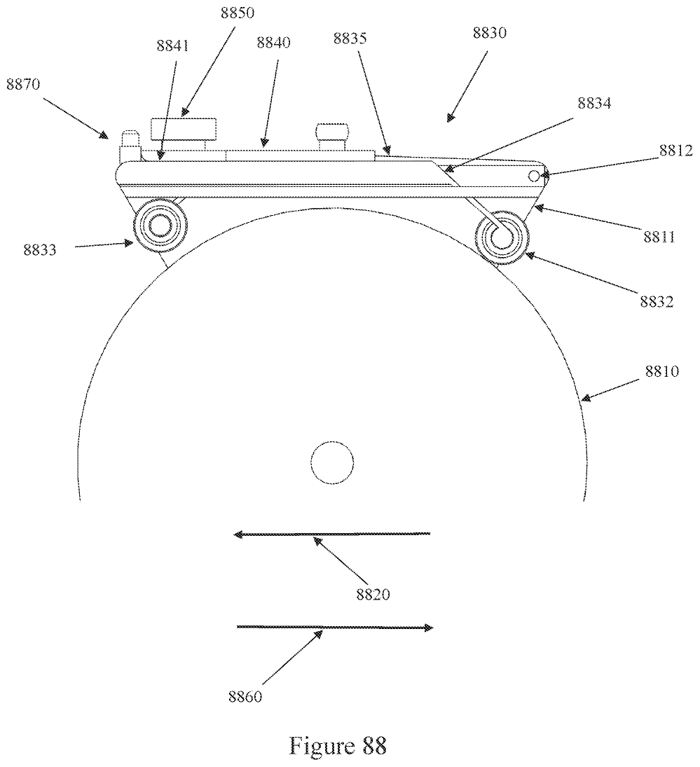

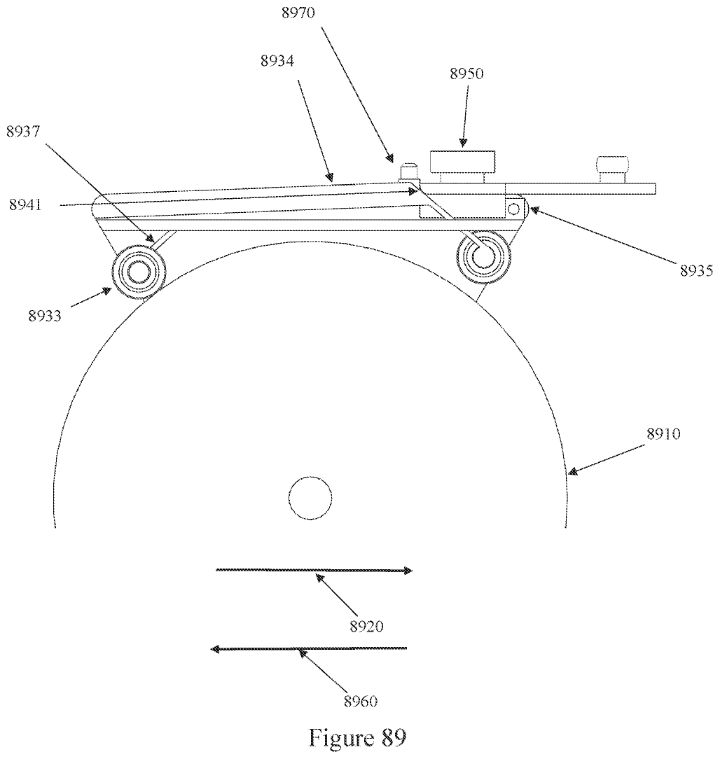

FIG. 87, FIG. 88, and FIG. 89 provide a further example of caster wheel 8700 as provided in FIG. 79, FIG. 84, and FIG. 85 discussions. Caster wheel 8700 may include a brake system 8730 configured to force a wheel 8710 to translate fore and aft with respect to the kingpin 8720 when the vehicle (not shown) transitions from forward to reverse movement or vice versa. Caster wheel 8700 may include a detent mechanism 8740, configured to maintain the wheel 8710 in either the fully forward position (as shown) or the fully rearward position (not shown), and may include one or more ball spring plungers 8741 and one or more grooves 8742 configured to engage with ball spring plunger 8741.

Referring now to FIG. 88 and FIG. 89, FIG. 88 provides a cutaway with wheel 8810 behind kingpin 8850 and configured for travel in the forward direction 8820. FIG. 89 provides a cutaway with wheel 8910 ahead of kingpin 8950 and configured for travel in a reverse direction 8920. A brake mechanism 8830 may include one or more arms 8834 which may be rotatingly connected to a caster frame 8811 at one or more pivots 8812. One or more rollers 8832, 8833 may be connected to arms 8834, 8835 and configured to engage wheel 8810 when the arm 8834 is in a first position, as shown for the right roller 8832. Rollers 8832, 8833 may be configured to disengage from wheel 8810 when arms 8834, 8835 are in a second position, as shown for the left roller 8833. Rollers 8832, 8833 may in include a one-way clutch (not shown) configured to allow rotation in one direction but not the other. Roller 8832 may be configured to rotate freely in a clockwise direction as shown. Roller 8833 may be configured to rotate freely in a counterclockwise direction as shown. Brake mechanism 8830 may include one or more springs (not shown) configured to bias arms 8834, 8835 towards the second position. The springs may be torsion springs located at pivots 8812. Steering arm 8840 may include a cam 8841 configured to engage with arms 8834, 8835 and to force them into the first position. Cam 8841 may be configured to allow arm 8835 to return to the second position when wheel 8810 is at or near the fully rearward position (as shown in FIG. 88) relative to kingpin 8850. Cam 8941 may be configured to allow arm 8834, 8934 to return to the second position when wheel 8910 is at or near the fully forward (as shown in FIG. 89) position relative to kingpin 8950. Arms 8934, 8935 may include a flexure 8937 or spring (not shown) which may provide a more consistent engagement force between rollers 8832, 8833 and wheel 8810.

As configured, when wheel 8810 is substantially displaced from the fully forward or fully rearward positions with respect to kingpin 8850, both rollers 8832, 8833 may be engaged with wheel 8810. As engaged, rollers 8832, 8833 may prevent rotation of wheel 8810 in either direction, and any movement of the trailer (not shown) will cause translation of wheel 8810 with respect to kingpin 8850 towards the position configured for travel in that direction. When wheel 8810 is in the fully rearward position with respect to kingpin 8850 as shown in FIG. 88, roller 8832 may allow wheel 8810 to rotate in a counterclockwise direction as shown, which may allow trailer to move freely in a forward direction 8820. If the trailer were to move in a reverse direction 8860, roller 8832 may prevent rotation of wheel 8810 and cause wheel 8810 to disengage detent mechanism 8870 and translate relative to kingpin 8850 in a forward direction 8820. When wheel 8910 is in the fully rearward position with respect to kingpin 8950 as shown in FIG. 89, roller 8933 may allow wheel 8910 to rotate in a clockwise direction as shown, which may allow trailer to move freely in a reverse direction 8920. If the trailer were to move in a forward direction 8960, roller 8933 may prevent rotation of wheel 8910 and cause wheel 8910 to disengage detent mechanism 8970 and translate relative to kingpin 8950 in a reverse direction 8920.

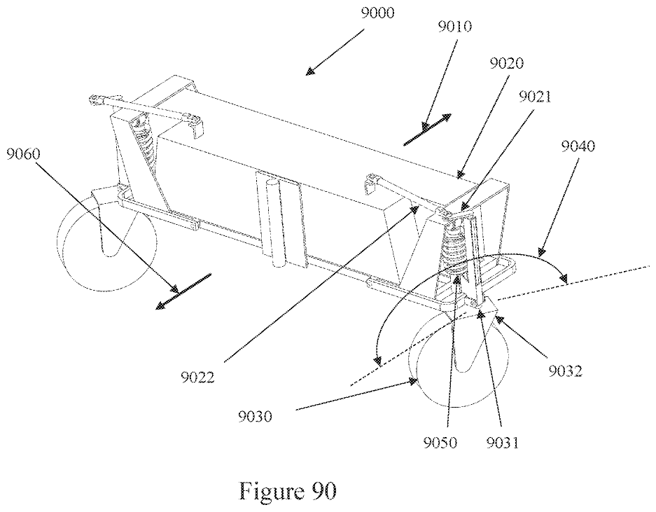

FIG. 90 provides another example of a trailer 9000 traveling in a rearward direction 9010. Trailer 9000 may include a trailer wheel steering system 9020, which may be similar to 7900 provided in the FIG. 79 discussion. In some embodiments, steering arm 9021 and tie rod 9022 may be located such that caster wheel 9030 may be able to rotate through 360 degrees of steering angle 9040 without interfering with suspension system 9050 or any other components of the trailer 9000. Kingpin 9031 may be rigidly connected to caster fork 9032, in contrast to being slidingly connected (as in FIG. 79 discussion). As configured, caster wheel 9030 may be able to rotate the approximately 180 of steering angle 9040 necessary when trailer 9000 transitions between a forward direction of travel 9060 and a rearward direction of travel 9010.

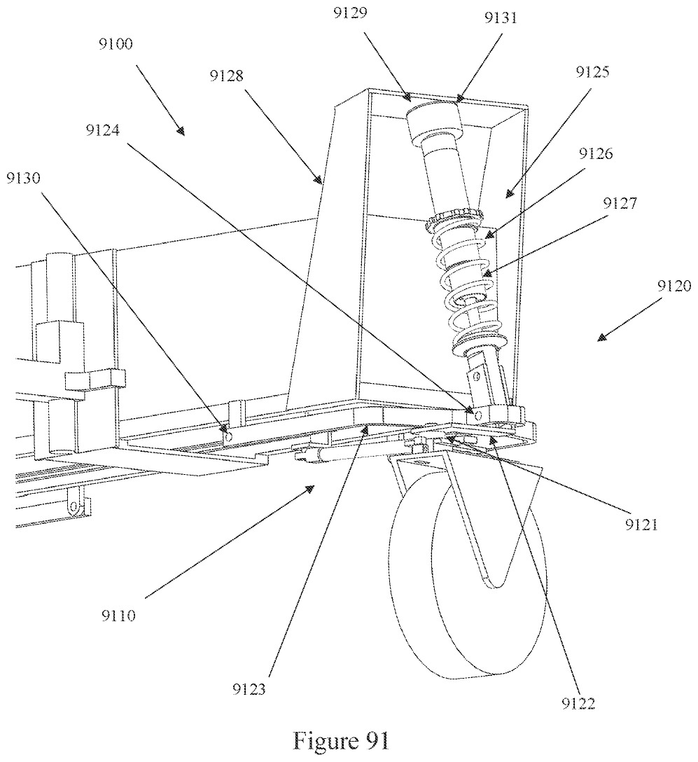

FIG. 91 provides another example of a trailer 9100 with a trailer wheel steering system 9110, as provided in FIG. 79 discussion. In this example, suspension system 9120 is configured similarly to a Macpherson strut suspension system, as is common in automobile front suspensions. Caster kingpin 9121 may be rotatingly connected to a knuckle 9122, which may be rotatingly connected to a control arm 9123 at pivot 9124. Knuckle 9122 may be rigidly connected to a strut 9125. Strut 9125 may include a spring 9126 and may include a damper 9127. Strut 9125 may be compliantly connected to the chassis 9128 at strut mount 9129, for example with an elastomeric bushing 9131. Control arm 9123 may be rotatingly connected to the chassis 9128 at one or more pivots 9130.

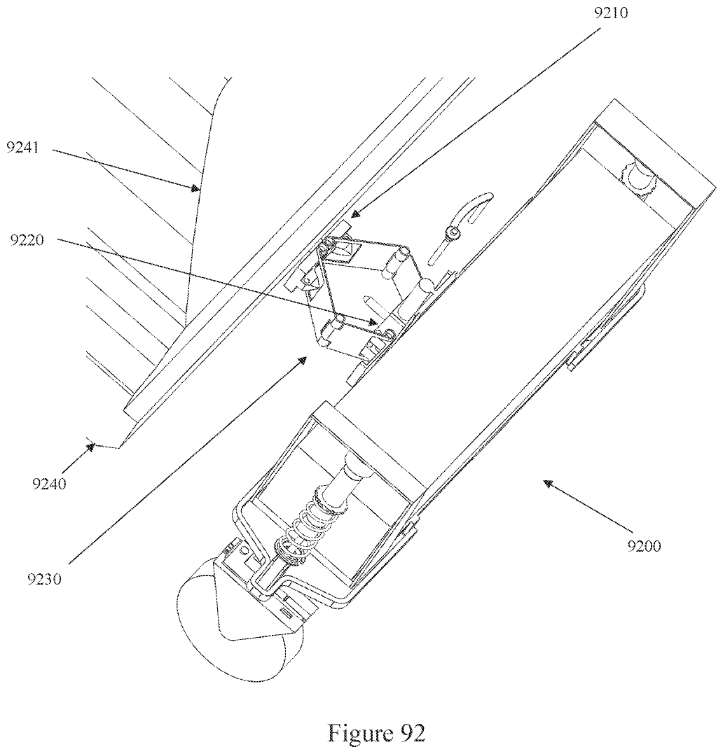

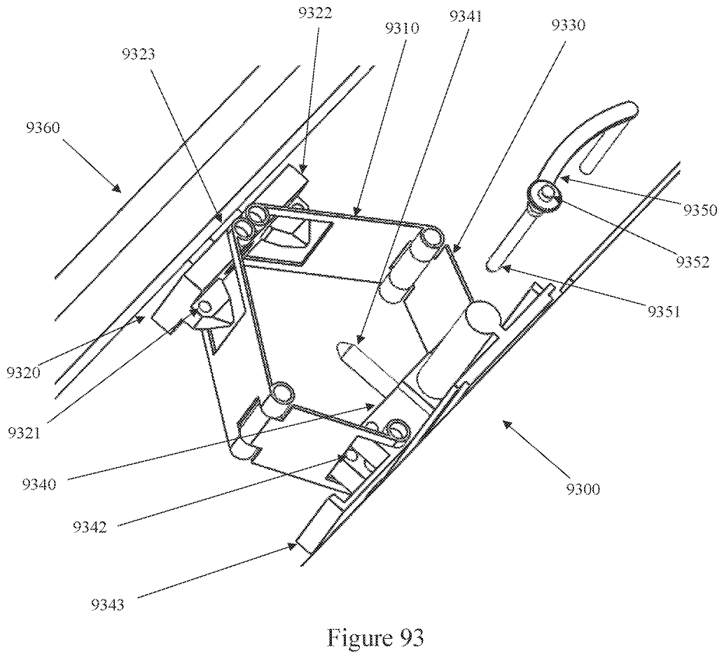

FIG. 92 and FIG. 93 provide another example of a trailer 9200 with a receiver post 9210, as provided in FIG. 82 discussion, and a mount plate 9220 as provided in the FIG. 79, FIG. 80, and FIG. 81 discussion. Receiver post 9210 may be connected to mount plate 9220 by a separation mechanism 9230, which may be configured to enable trailer 9200 to be separated from vehicle 9240, for example for a user to open a rear hatch 9241 or tailgate (not shown), or to gain access to receiver post 9210 or AHS drivetrain components (not shown). Referring now to FIG. 93, one or more forward arms 9310 may be rotatingly connected to receiver post 9320 and may include intermeshed teeth (not shown) configured to cause equal rotation of two forward arms 9310 with respect to receiver post 9320, as is common with scissor jacks used for lifting automobiles. One or more rear arms 9330 may be rotatingly connected to mount plate 9340 and to forward arms 9310. Mount plate 9340 may include an alignment rod 9341 which may be configured to insert into receiver post 9320 when mount plate 9340 is engaged or nearly engaged with receiver post 9322. A lock 9350 may be configured to secure mount plate 9340 to receiver post 9320 by being inserted though one or more mount plate holes 9342 and receiver post holes 9321. Lock 9350 may include one or more retention features 9351 which may be configured to prevent unintended disengagement of lock 9350. Retention features 9351 may be balls as is common in quick-release pins. Lock 9350 may include a release 9352 which may be configured to free the retention features 9351 when activated by a user, which may enable disengagement of lock 9350. Receiver post 9320 may include a flange 9322 which may be rotatingly connected to a receiver protrusion 9323, as provided in the FIG. 82 discussion. Mount plate 9340 may include one or more stops 9343, which may be configured to limit the rotation of rear arms 9330, which may limit the misalignment of trailer 9300 with vehicle 9360. As configured, trailer 9300 may be easily separated from vehicle 9360 without excessive pitch and may be easily aligned and re-engaged.

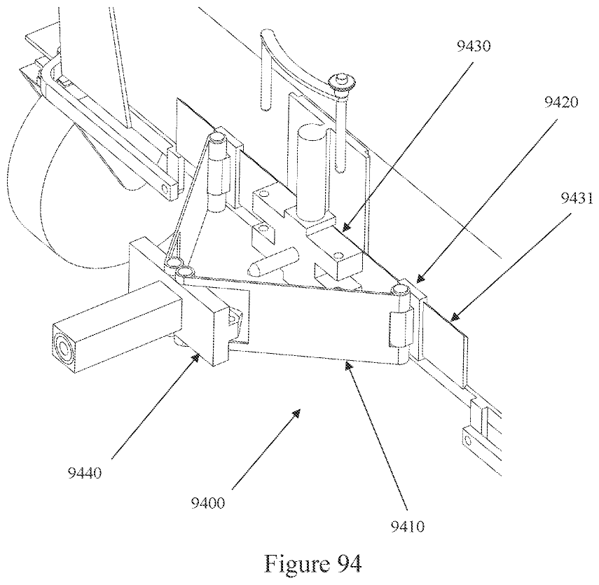

FIG. 94 provides another example of a separation mechanism 9400, which may include one or more arms 9410 and one or more linear bearing carriages 9420. Arms 9410 may be rotatingly connected to linear bearing carriages 9420. Linear bearing carriages 9420 may be slidingly connected to one or more linear bearing rails 9431 of mount plate 9430. As configured, as mount plate 9430 is separated from a receiver post 9440, linear bearing carriages 9420 may translate transversely relative to mount plate 9430 and pitch orientation of mount plate 9430 to receiver post 9440 may be maintained. Separation mechanism 9400 may include two arms 9410, which may have intermeshing teeth (not shown), as provided in FIG. 93 discussion, which may cause equal rotation of the two arms 9410 relative to receiver post 9440, which may result in maintaining yaw orientation of mount plate 9430 to receiver post 9440. Linear bearing carriages 9420 and linear bearing rails 9431 may be of the dovetail type as shown, or any other type of linear bearing.

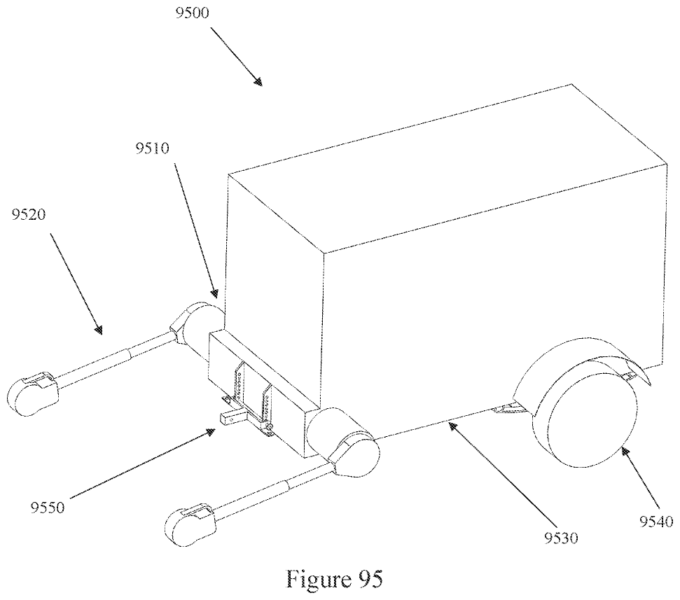

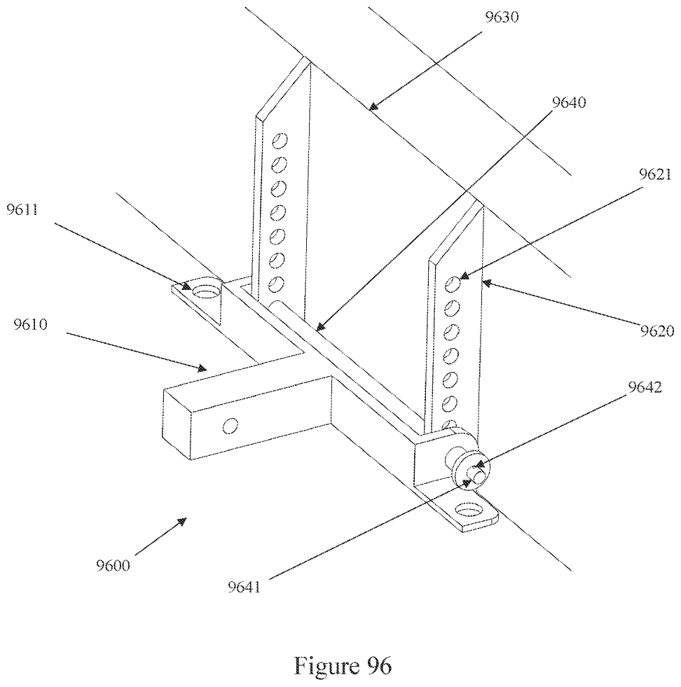

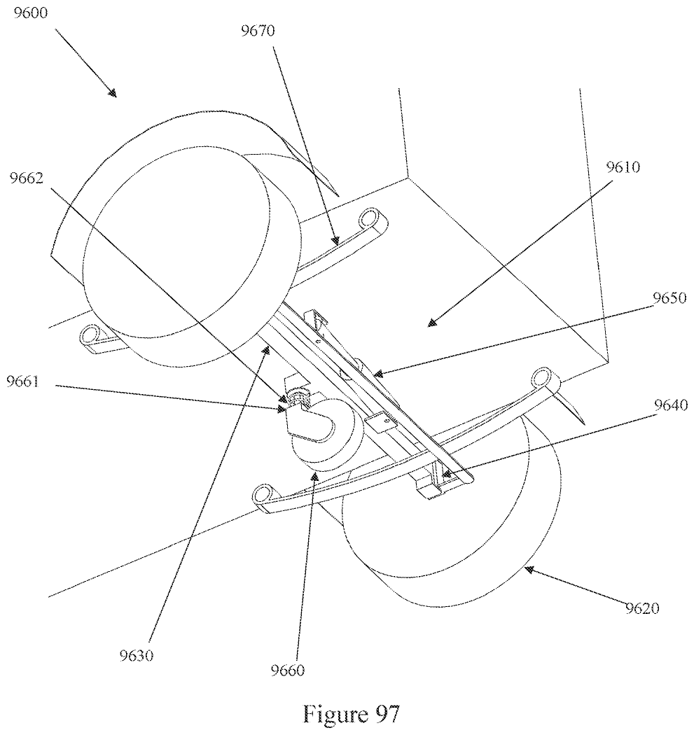

Referring now to FIG. 95, FIG. 96, and FIG. 97, FIG. 95 provides another example of an AHS 9500, configured to accommodate cargo, e.g., a trailer. AHS 9500 may include a rear drive 9510 and a drivetrain 9520 of any type, configuration, or embodiment described herein. AHS 9500 may include a housing 9530, which may include an energy storage device (not shown), and/or a power conversion device controller (not shown), and/or a charger (not shown) for the energy storage device. AHS 9500 may include one or more wheels 9540, configured to support a portion or the entirety of the weight of AHS 9500 and any cargo. AHS 9500 may include a mounting assembly 9550 configured to connect AHS 9500 to a vehicle (not shown). AHS 9500 may include a tongue jack (not shown) to support the front of AHS 9500 when not connected to a vehicle, and to raise or lower it to the appropriate height for connection to and disconnection from a vehicle. Rear drive 9510 may include an electrical connector (not shown) configured to carry provide electrical energy for trailer lights (not shown) and/or trailer brakes (not shown) from the vehicle.

FIG. 96 provides further detail with mounting assembly 9600. Mounting assembly may include a receiver post 9610 configured to be rigidly connected to a trailer hitch receiver (not shown) of a vehicle (not shown). Receiver post 9610 may include one or more holes 9611 for connecting trailer chains (not shown). Mounting assembly 9600 may include one or more protrusions 9620 which may be rigidly connected to rear drive 9630 and may be configured to interface with receiver post 9610. Pin 9640 may be configured to be insertable through protrusions 9620 and receiver post 9610 and may prevent separation. Pin 9640 may be of the quick-release type, and may include one or more balls (not shown), which may prevent retraction of pin 9640 once inserted. Pin 9640 may include a button 9641, which may be configured to release balls 9641 and thereby allow retraction of pin 9640. Button 9641 may include a hole 9642 configured to receive a cotter pin (not shown), or other type of pin, which may prevent unintended depression of button 9641. Pin 9640 and receiver post 9610 may be rotationally connectable to protrusions 9620 at a plurality of vertical positions, for example with multiple sets of holes 9621. As configured, AHS 9500 may be connectable to a vehicle in an optimal vertical position, and varying pitch angles of AHS 9500 relative to the vehicle encountered when traversing varied terrain may be accommodated.

In some embodiments, receiver post 9610 may have sufficient transverse width to prevent relative yaw of AHS 9500 relative to the vehicle and to sufficiently distribute yaw forces. Referring to FIG. 97, in order to prevent AHS 9700 from experiencing tire scrub and from transmitting excessive yaw forces to the vehicle (not shown), AHS 9700 may include a trailer wheel steering system 9710, such as provided in the FIG. 76, FIG. 77, and FIG. 78 discussions. Wheels 9720 may be rotationally connected to axle 9730 by knuckles 9740. The steering angle (not shown) of wheels 9720 may be imparted by actuator 9750. The required steering angle to minimize tire scrub may be determined by caster wheel 9760, which may include a rotary encoder 9761 or other device for measuring its yaw angle. Caster wheel 9760 may pressed against the ground or road surface by a spring 9762, which may exert significantly less force than suspension springs 9770. It should be appreciated that methods of determining an optimal steering angle and of steering the wheels previously described may also be utilized in this embodiment.

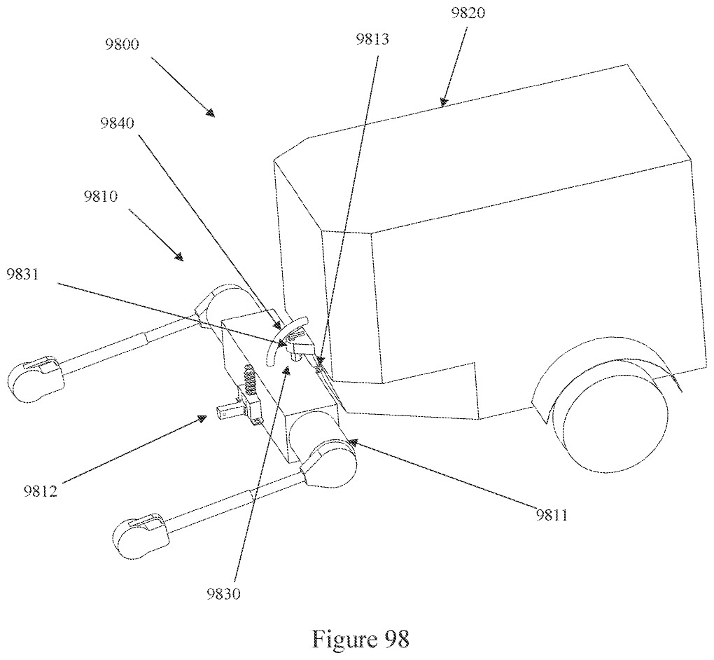

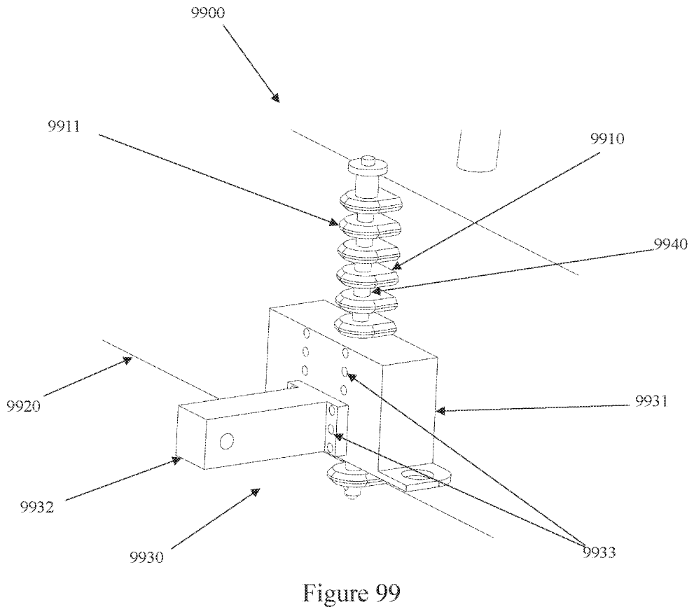

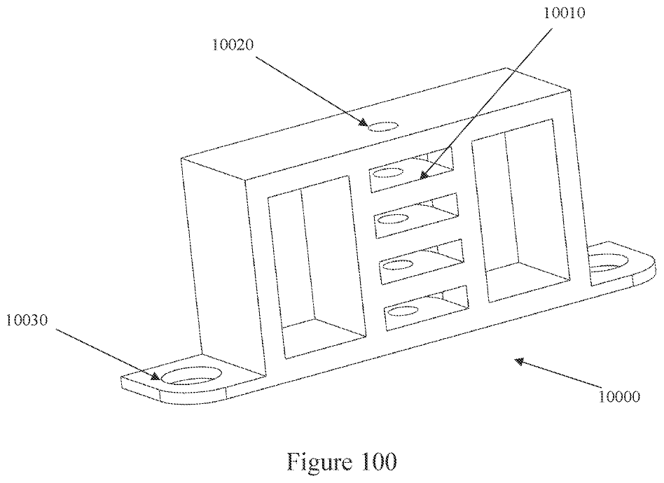

Referring now to FIG. 98, FIG. 99, and FIG. 100, FIG. 98 provides another exemplary AHS 9800. In this example, rear drive 9810 may be configured to be rigidly connected to a vehicle (not shown). A trailer assembly 9820 may be connected to rear drive 9810 such that relative yaw and pitch are allowed, as it typical of a trailer connection to a vehicle. Trailer assembly 9820 may include an energy storage device (not shown), and/or a power conversion device controller (not shown), and/or a charger (not shown) for the power conversion device. Rear drive 9810 may include one or more power conversion devices 9811, an energy storage device (not shown), and/or a power conversion device controller (not shown), and/or a charger (not shown) for the energy storage device. Trailer assembly 9820 may be connected to rear drive 9810 with a connection assembly 9830. Connection assembly may include a hitch ball (not shown) and a trailer connector 9831, as is typical of automotive trailers. Trailer assembly 9820 may be connected to rear drive 9810 by an electrical conduit 9840, which may be configured to transmit electrical power between them. Rear drive 9810 may include a mounting assembly 9812 configured to rigidly connect rear drive 9810 to a vehicle. Rear drive 9810 may include one or more chain connectors 9813 configured to connect rear drive 9810 to trailer assembly 9820 with one or more chains (not shown), as is typical with automotive trailers. AHS 9800 may include a tongue jack (not shown), as previously described.

FIG. 99 provides detail of a mounting assembly 9900, which may include one or more protrusions 9910 rigidly connected to a rear drive 9920. Mounting assembly 9900 may include a hitch assembly 9930 which may be configured to be rigidly connected to a trailer hitch receiver (not shown). Hitch assembly 9930 may include a block 9931 which may interface with protrusions 9910 at a plurality of vertical positions. Protrusions 9910 may include a lead-in feature 9911 to aid in alignment and engagement with block 9931. A pin 9940, as provided in the FIG. 96 discussion, may be configured to secure block 9931 to rear drive 9920. Hitch assembly 9930 may include a hitch post 9932, which may be configured to be inserted into a trailer hitch receiver. Receiver post 9932 may be configured to be connected to block 9931 at a plurality of vertical positions, for example with a plurality of screws (not show) and holes 9933.

FIG. 100 provides a rear isometric view of block 10000, which may include one or more slots 10010 configured to interface with protrusions 9910. Block 10000 may include one or more holes 10020 configured to interface with pin 9940. Block 10000 may include one or more holes 9930 configured to interface with trailer chains (not shown). Block 10000 may be of sufficient transverse width to transmit yaw forces from rear drive 9920 to a trailer hitch receiver (not shown) and may have sufficient vertical height to transmit pitch forces from rear drive 9920 to a trailer hitch receiver (not shown).

As configured, hitch assembly 9930 may be rigidly connectable to a vehicle (not shown) with block 9931 located in an optimal or desired vertical position. Rear drive 9920 may be rigidly connectable and disconnectable to hitch assembly 9930, and therefore to the vehicle (not shown), at an ideal or desired vertical position.

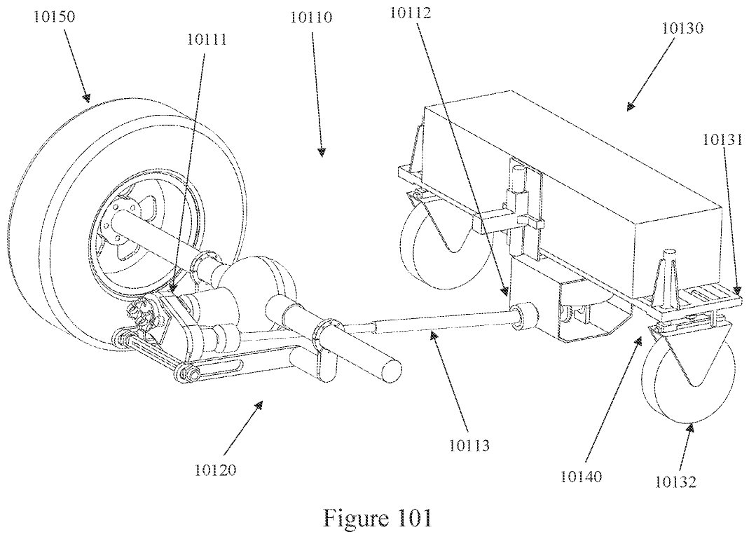

FIG. 101 provides an exemplary embodiment of an AHS 10110, an axle clamp assembly 10120, and a trailer 10130 with a trailer wheel steering system 10140. AHS 10110 may include a power splitter 10111 which may be configured as provided in the FIG. 8 discussion. Power splitter 10111 may be connected to axle clamp assembly 10120, as provided in the FIG. 23 discussion. AHS may include a rear drive 10112. Rear drive 10112 may be configured as provided in the FIG. 32 discussion and may be rigidly connected to a frame 10131 of trailer 10130. One or more driveshafts 10113 may transmit power between power splitter 10111 and rear drive 10112. Trailer wheel steering system 10140 may be configured as provided in the FIG. 79, FIG. 80, FIG. 81, and FIG. 82 discussions. As configured, AHS 10110 may provide propulsion and braking to a vehicle 10150, where the majority of the weight of AHS 10110 may be borne by trailer 10130, the majority of cornering forces on AHS 10110 may be borne by trailer wheels 10132, and modified driving technique, such as when maneuvering while reversing, may not be required of a user.

FIG. 99 provides an exemplary embodiment of an AHS 10210 and a trailer 10220 with a trailer wheel steering system 10230. AHS 10210 may include one or more swing arms 10211, which may be configured as provided in the FIG. 49 discussion. AHS 10210 may include a rear drive 10212, which may include one or more power conversion devices 10213. Power conversion devices 10213 may be transversely positionable relative to trailer 10220 to accommodate vehicles of varying width. Trailer wheel steering system 10230 may be configured as provided in the FIG. 79, FIG. 80, FIG. 81, and FIG. 82 discussions. Trailer 10220 may include an energy storage device (not shown), which may include the counterweight described in the FIG. 79 discussion. As configured, AHS 10210 may provide propulsion and braking to a vehicle 10240, where the majority of the weight of AHS 10210 may be borne by trailer 10220, the majority of cornering forces on AHS 12110 may be borne by trailer wheels 10221, and modified driving technique, such as when maneuvering while reversing, may not be required of a user.

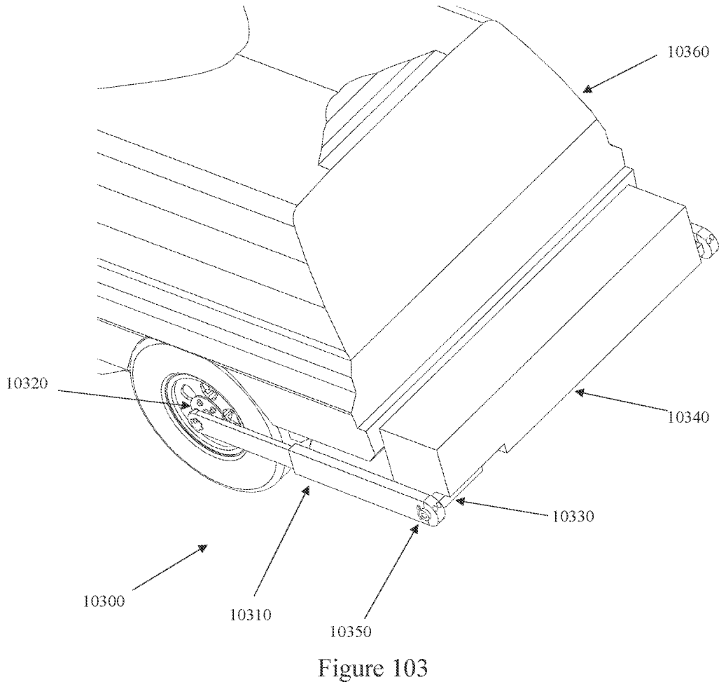

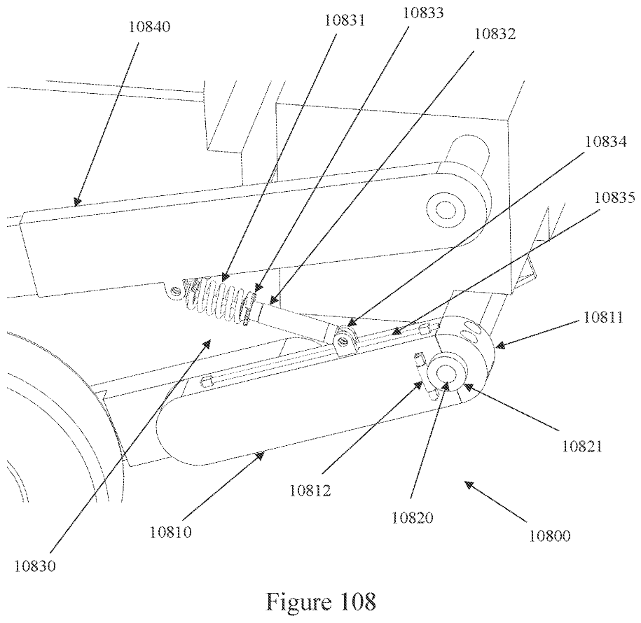

FIG. 103 provides another example of a supplemental suspension system (SSS) 10300. SSS 10300 may include one or more swing arms 10310 which may connect to a wheel plate 10320 and a spring 10330. Swing arm 10310 may be extensible to accommodate vehicles of varying geometry and suspension articulation, for example by telescoping as shown. Swing arm 10310 may include an adjustment mechanism 10350 configured as provided in the FIG. 108 discussion, which may allow a user to adjust the nominal pitch angle and spring force exerted by swing arm 10310. Spring 10330 may be connected to a rear chassis 10340 and may be transversely positionable to accommodate vehicles of varying width. Spring 10330 may be a torsion spring as shown. Rear chassis 10340 may include an energy source (not shown) configured to provide electrical power for an electric vehicle 10360. Rear chassis 10340 may be configured to accommodate cargo (not shown). Rear chassis 10340 may include a rear drive (not shown) of an AHS (not shown).

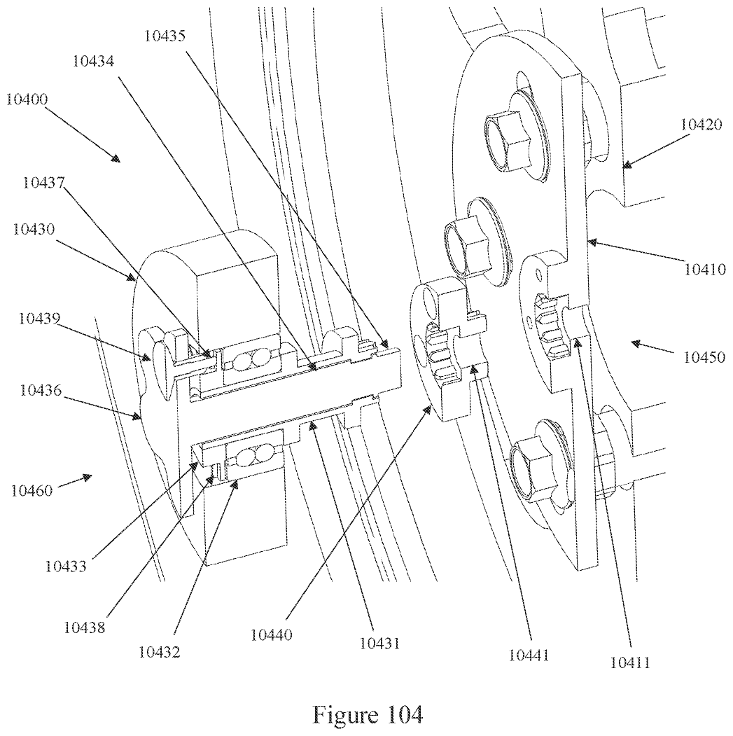

FIG. 104 provides a blown-up cutaway of a portion of an SSS 10400 including a wheel-side coupling 10450 and a drive-side coupling 10460. As shown, a wheel plate 10410 may connect to a vehicle wheel 10420 as provided in the FIG. 57 and FIG. 58 discussions. SSS 10400 may include one or more spacers 10440 to accommodate wheels 10420 of varying offset (not shown). Spacers 10440 may be configured so that multiple spacers can be stacked together. A swing arm 10430 may include a spindle 10431, which may be configured to engage with a spacer 10411 or a wheel plate 10410. Spindle 10431 may be connected to swing arm 10430 by a bearing 10432, which may accommodate rotation of the spindle 10431 relative to the swing arm 10430 and may be a spherical bearing to allow misalignment of swing arm 10430 and the wheel 10420 due to toe and caster, for example. Spindle 10431 may be secured to bearing 10432 with a spindle clamp 10433, which may be configured to rotate with spindle 10431 when wheel 10420 is rotating. Draw bar 10434 may be configured to secure spindle 10431 to spacer 10440 or wheel plate 10420. Draw bar may include a male thread 10435 configured to engage with a female thread 10441 of spacer 10440 or a female thread 10411 of wheel plate 10410. Draw bar 10434 may include a knob 10436 configured to allow a user to rotate draw bar 10434. Draw bar 10434 may include a lock pin 10437 which may engage with one or more pockets 10438 in spindle clamp 10433 when in a first position as shown and may thereby prevent unintended rotation of draw bar 10434. When in a second position (not shown), lock pin 10437 may allow rotation of draw bar 10434. Lock pin 10437 may be moved from the first position to the second position by pulling a lock knob 10439. Lock pin may be maintained in the second position by rotating lock knob 10439 a portion of a turn. Lock pin may be moved from the second position to the first position by a spring (not shown) after undoing the rotation. It is understood that draw bar 10434 may be any type of engagement member typically used to connect two objects together.

In some embodiments, an auxiliary trailer hitch receiver (not shown) may be included in any system disclosed herein that occupies or obscures a vehicle's trailer hitch receiver. The auxiliary trailer hitch receiver (not shown) may be configured to allow a trailer hitch to be connected to any vehicle so equipped.

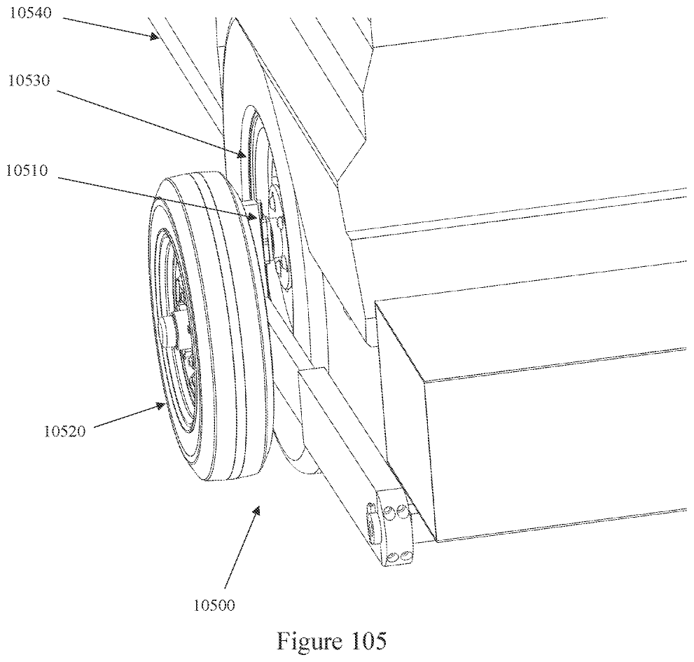

FIG. 105 provides another exemplary SSS 10500. SSS 10500 may include a wheel coupling 10510, which may be configured to connect wheel 10520 to vehicle wheel 10530 and may prevent transverse movement of the wheel 10520 relative to the vehicle 10540 when subjected to cornering forces.

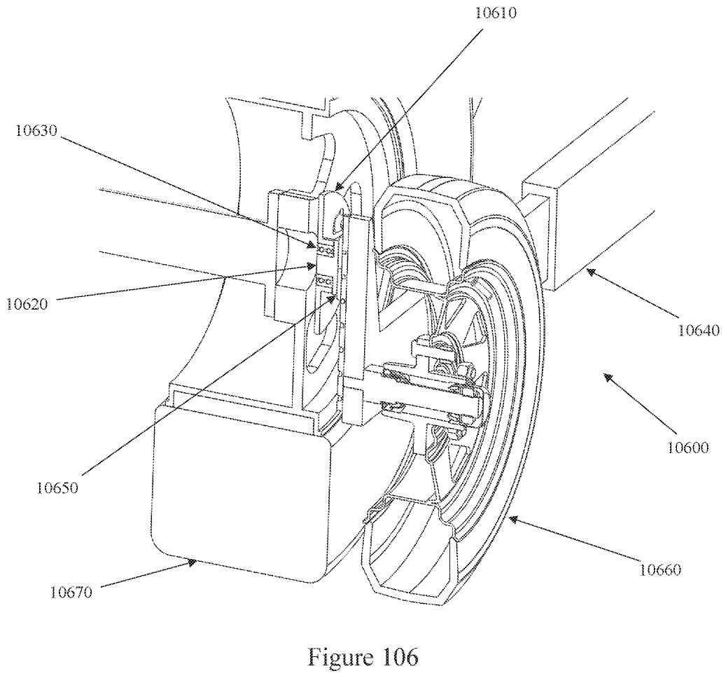

FIG. 106 provides detail of an SSS 10600. SSS 10600 may include a lug nut plate 10610 as provided in the FIG. 57 discussion. Wheel coupling 10620 may be connected to lug nut plate 10610 by one or more bearings 10630. Wheel coupling 10620 may be connected to swing arm 10640 by one or more linear bearings 10650 which may be configured to transmit lateral forces from wheel 10660 to vehicle wheel 10670 while allowing relative vertical movement of wheel 10660 relative to vehicle wheel 10670.

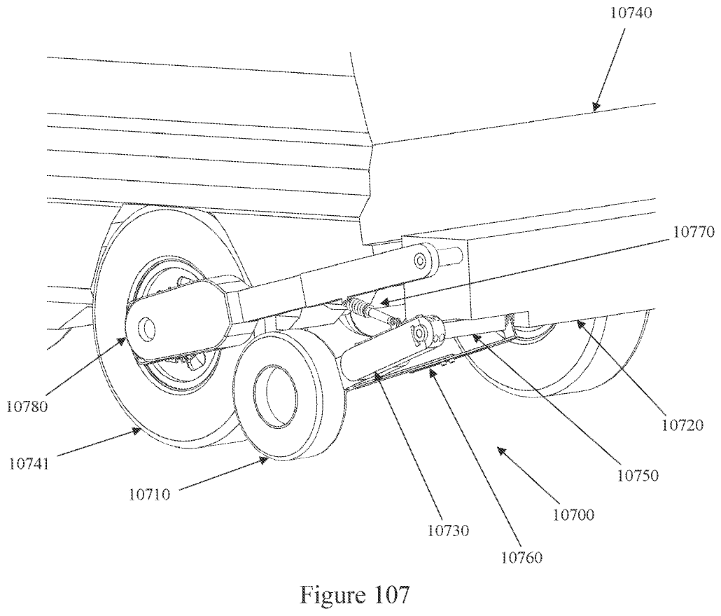

FIG. 107 provides a rear quarter view of a further example a supplemental suspension system (SSS) 10700. SSS 10700 may include one or more wheels 10710 which may be connected to a rear chassis 10720 by one or more swing arms 10730. Rear chassis 10720 may include a rear drive (not shown) or batteries (not shown) or other electronics (not shown). Swing arm 10730 may be extensible which may allow wheel 10710 to be positioned as close to the rear wheel 10741 of the vehicle as possible, which may reduce tire scrub when the vehicle 10740 turns. Spring force may be provided by a torsion axle 10750 as is commonly used in trailers. Torsion axle 10750 may be transversely positionable to accommodate vehicles of varying width. SSS 10700 may also include a control link 10760 which may reduce transverse movement of wheel 10710 under cornering forces. Control link 10760 may be extensible to accommodate the extensibility of swing arm 10730.

As configured, SSS 10700 may support the weight of AHS components and may support cornering forces exerted on AHS components, thereby reducing additional load on the vehicle's suspension and adverse effects on vehicle handling.

SSS 10700 may include a spring assembly 10770 between swing arm 10730 and an AHS swing arm 10780. Spring assembly 10770 may support all or a portion of the weight of the AHS swing arm 10780.

FIG. 108 provides additional detail of supplemental suspension system 10800 (SSS). In SSS 10800, swing arm 10810 may be connected to torsion axle 10820 with a clamp 10811 which may allow rotation of swing arm 10810 about torsion axle 10820 when loose, but prevent rotation when tightened, for example with one or more screws (not shown). A worm gear 10812 may be rotationally connected to swing arm 10810 and may interface with a worm wheel 10821 which may be rigidly connected to torsion axle 10820. As configured, to set the nominal preload of the SSS 10800, clamp 10811 may be loosened and worm gear 10812 may be turned until normal vehicle ride height (not shown) is restored, and then clamp 10811 may be tightened.

Spring assembly 10830 may include a spring 10831, which may be a coil spring as shown. Spring 10831 may be a torsion spring (not shown) or leaf spring (not shown), or the like. Spring assembly 10830 may include a shock absorber 10832. Spring 10831 and shock absorber 10832 may be arranged in a coil-over configuration as shown. Spring 10831 may be connected to shock absorber 10832 by an adjustment mechanism 10833 which may allow adjustment of nominal spring compression, as is common in some vehicle suspensions. Spring assembly 10830 may be connected to swing arm 10810 at a bracket 10834. Bracket 1334 may be positionable along swing arm 10810 in a substantially longitudinal direction by lead screw 10835, such that both the nominal spring compression and angle of resulting force are changed by turning of lead screw 10835. As configured, turning lead screw 13335 may allow the nominal torque on swing arm 10840 to be adjustable such that any increase in apparent unsprung weight of the vehicle's suspension due to the weight of swing arm 10840 is substantially reduced or eliminated.

In another example of an SSS (not shown), spring assembly 10770 may be connected to AHS swing arm 10780 and rear chassis 10730. Spring assembly 10770 may include a compression spring 10831 as shown, or a torsion spring (not shown) or leaf spring (not shown), or the like.

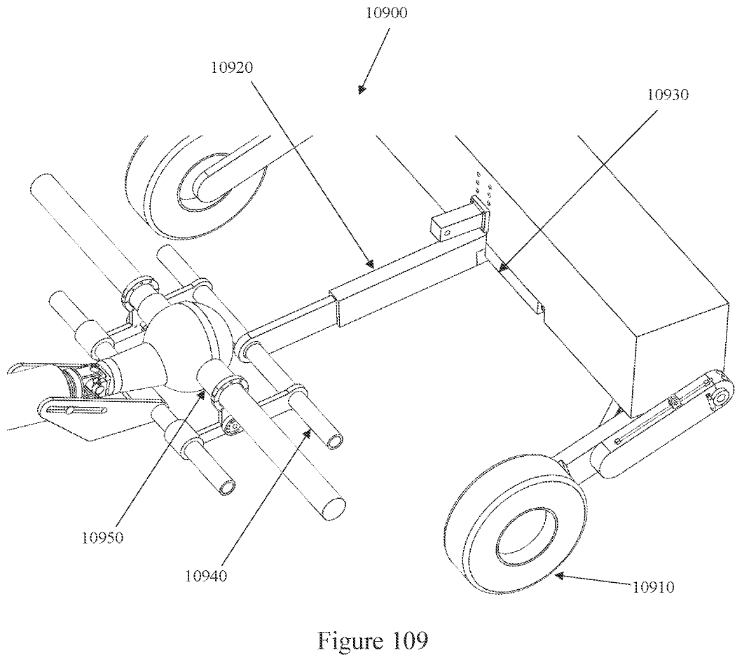

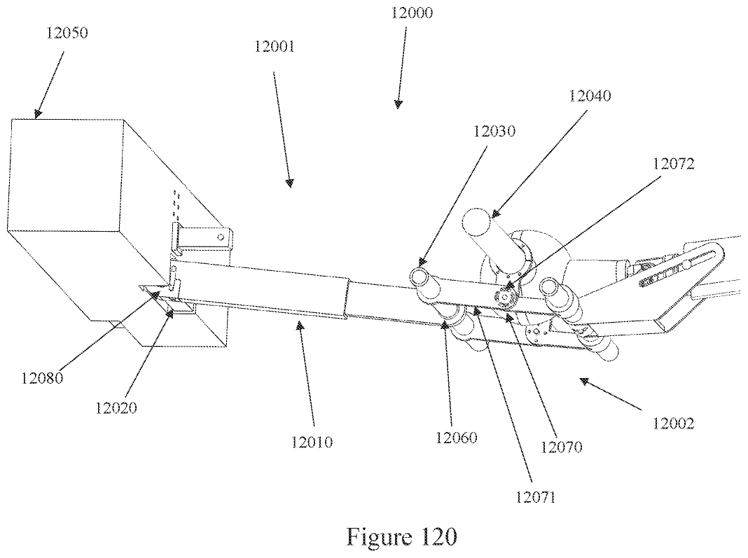

FIG. 109 provides another example of an AHS, SSS, and axle clamp assembly 10900. As shown, one or more wheels 10910 may be configured to support a portion or the entirety of the weight of the AHS, SSS, and axle clamp assembly 10900, as provided in the FIG. 107 discussion. A suspension arm 10920 and a torsion axle 10930 may be configured as provided in the FIG. 120 discussion, except that the force exerted on transverse bar 10940 may be in a substantially upward direction. As configured, AHS/SSS may substantially negate additional loads on the vehicle suspension (not shown) and may substantially negate detrimental effects of additional unsprung weight, as provided in the FIG. 107 discussion. For example, as described, the wheels 10910 support the weight of any load at the back, and the suspension arm 10920 supports the weight of any load on the axle 10950.

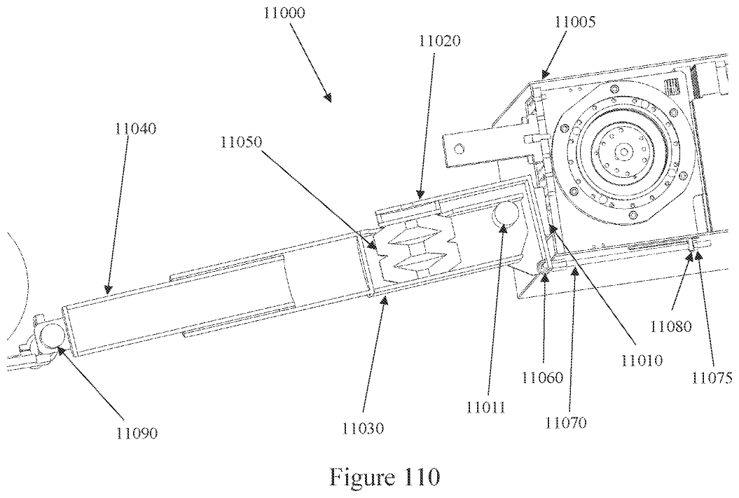

FIG. 110 provides an isometric cutaway view of an SSS 11000. As shown, bracket 11010 may be rigidly connected to a rear drive 11005. A spring anchor 11020 and/or a rear arm 11030 may be rotatingly connected to a bracket 11010 at a pivot 11011. A spring 11050 may be configured to exert force on a spring perch 11020 and rear arm 11030 and may be an elastomeric spring as shown, or any other common spring type such as a metal coil spring (not shown) or leaf spring (not shown), or the like. In an alternative embodiment, spring 11050 may be a torsion spring and may be configured to exert a torque on spring perch 11020 and rear arm 11030. In some embodiments, a front arm 11040 may be slidingly and rotatingly connected to rear arm 11030 and rotatingly connected to a transverse bar 11090. As configured, SSS 11000 may exert a substantially downward force on the transverse bar and a substantially upward force on rear drive 11005 as previously described. Sliding of front arm 11040 with respect to rear arm 11030 may accommodate vehicles of varying geometry as well as longitudinal movement of transverse bar 11090 as the vehicle's suspension (not shown) articulates. Rotation of front arm 11040 with respect to rear arm 11030 may accommodate roll of transverse bar 11090 as the vehicle's suspension articulates.

In some embodiments, preload rod 11070 may be connected to spring perch 11020 at pivot 11060, which may be a spherical joint as shown. A preload nut 11075 may be threaded onto preload rod 11070 and may engage with a preload anchor 11080. As configured, turning of preload nut 11075 may cause spring perch 11020 to rotate about pivot 11011 and change the nominal compression of spring 11050 and therefore the force exerted. As configured, vehicles of varying geometry and rear drives 11005 of varying weight may be accommodated.

FIG. 111 provides an axle clamp assembly 11190 and a supplemental suspension system 11100 (SSS), which may reduce suspension sag and/or detriments to suspension dynamics due to the mass of AHS components or cargo. As shown, a spring system 11110 may be able to transfer a substantially vertical force between the vehicle's axle 11120 and a rear anchor 11130. In this embodiment, rear anchor 11130 is a receiver post (shown as 3060 in FIG. 30). It is understood that rear anchor 11130 may be a hitch receiver (not shown), or any other part of the rear drive chassis (shown as 3010 in FIG. 30). Transverse bar 11140 may be rigidly connected to one or more axle clamps 11150. Stabilizer 11160 may be rigidly connectable to transverse bar 11140 in a plurality of vertical positions to minimize any reduction in ground clearance. Extension arm 11170 may be rotationally and slidingly connected to either stabilizer 11160 as shown, or transverse bar 11140. One or more slots 11171 may interface with features (not shown) of stabilizer 11160 and/or transverse bar 11140 to allow transmission of substantially vertical forces while allowing relative longitudinal movement when the suspension articulates. One or more screws 11180 may be rigidly connected to a stabilizer 11160 and may be in contact with a differential housing 11121. As configured, downward forces on axle clamps 11150 may be transferred by stabilizer 11160 and screw 11180 to differential housing 11121 such that any tendency for axle clamps 11150 to rotate about axle 11120 may be reduced. An extension arm 11170 may be rigidly connectable to spring system 11110 in a plurality of positions to accommodate vehicles of varying dimension. Spring system 11110 may include a spring 11111, a spring base 11112, a spring arm 11113, and a jack screw 11114. Spring arm 11113 may be rotationally connected to spring base 11112 at a pivot 11115. Spring base 11112 may be rotationally connected to rear anchor 11130, or any other part of rear drive (not shown), at one or more holes 11116. A plurality of holes 11116, or slots (not shown), may allow spring system 11110 to be placed in a plurality of positions to provide clearance for vehicle components, such as a spare tire (not shown) or the exhaust system (not shown). Jack screw 11114 may be threaded into spring base 11112 such that when advanced against rear anchor 11130, hitch receiver (not shown), or the vehicle chassis (not shown), spring 11111 may be compressed between spring base 11112 and spring arm 11113. In so doing, the nominal amount of force imparted by SSS 11100 on the vehicle can be adjusted. Spring 11111 may be a coil spring, an elastomeric spring, a torsion spring, an elastomeric torsion spring, or the like.

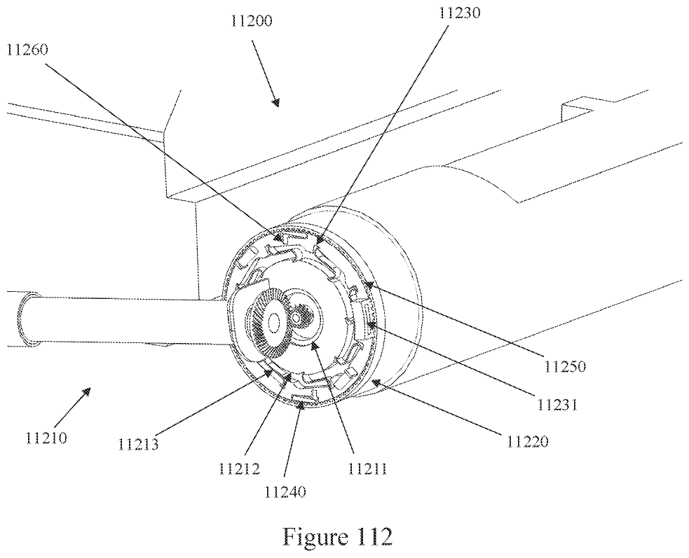

FIG. 112 provides an isometric view of a further embodiment of an AHS 11200. As shown, a swing arm 11210 may include a drive shaft (not shown) and may be rotationally connected to a nacelle 11220 at pivot 11211. Swing arm 11210 may include a disk 11212 which may be connected to nacelle 11220 via one or more springs 11213. Springs 11213 may be leaf springs as shown, or compression springs, tension springs, torsion springs (not shown), or the like. Springs 11213 may be anchored to nacelle 11220 at a preload ring 11230, which may be rotationally connected to nacelle 11220. As configured, swing arm 11210 may function as a supplemental suspension system (SSS) as described above, and an SSS as described herein need not be combined with an AHS. For example, the spring mechanism (including the swing arm described in FIG. 112) may be mounted to a rear chassis connected to the rear of a vehicle. The nominal amount of spring force may be adjustable by the rotation of preload ring 11230 relative to disk 11212. One or more pawls 11240 may engage with a plurality of teeth 11250 which may provide a ratcheting action as preload ring 11230 is rotated. Pawls 11240 may be biased to engage with teeth 11250 by one or more springs 11260, which may be compression springs as shown, or leaf springs, tension springs, torsion springs (not shown), or the like. Preload ring 11230 may include a feature 11231 configured to engage with a tool (not shown), which may allow a user to apply additional leverage to preload ring 11230 when rotating it. The tool may be a flat or round bar.

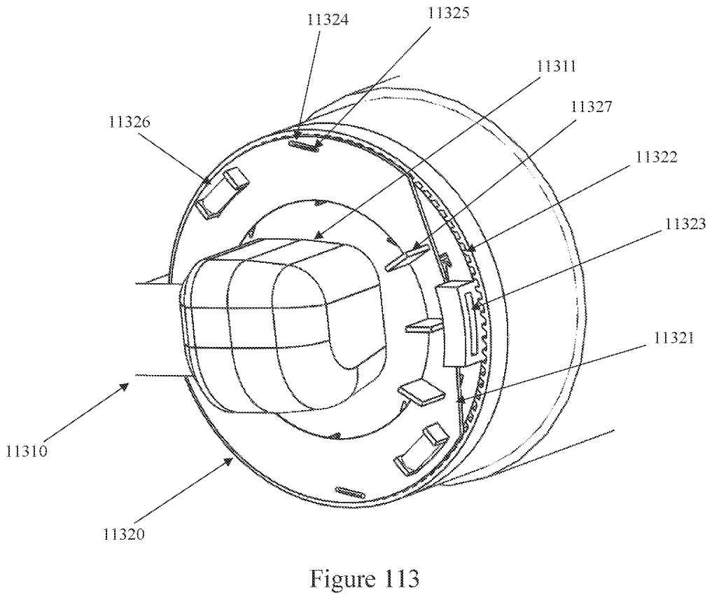

FIG. 113 provides an isometric view of a further embodiment of a swing arm 11310 and a nacelle 11320, described in the FIG. 112 discussion. Swing arm 11310 may include a gearbox 11311 that may contain lubrication and exclude dust, moisture, and other contaminants from the gears (not shown) within. Nacelle 11320 may include a release ring 11321 which may disengage pawls (not shown) from one or more teeth 11322 when rotated relative to a preload ring 11323. Release ring 11321 may include one or more cam features 11324 which may engage with one or more protrusions 11325 of pawls (not shown) to cause disengagement of pawls (not shown) from teeth 11322. Nacelle 11320 may include one or more springs 11326 which may bias release ring 11321 towards a position which may bias pawls (not shown) to engage with teeth 11322. Springs 11326 may be compression springs as shown or may be tension springs, leaf springs, torsion springs, or the like. Release ring 11321 may include one or more grips 11327 which may allow a user to more easily rotate release ring 11321.

As configured, the nominal spring force exerted by swing arm 11210, 11310 may be increased to substantially negate the weight of hybrid system components by a user inserting a tool (not shown) into preload ring 11231, 11323 and rotating it counterclockwise, for example. Spring force may be released by a user rotating release ring 11321 to disengage pawls 11240 and then rotating preload ring 11231, 11323 clockwise.

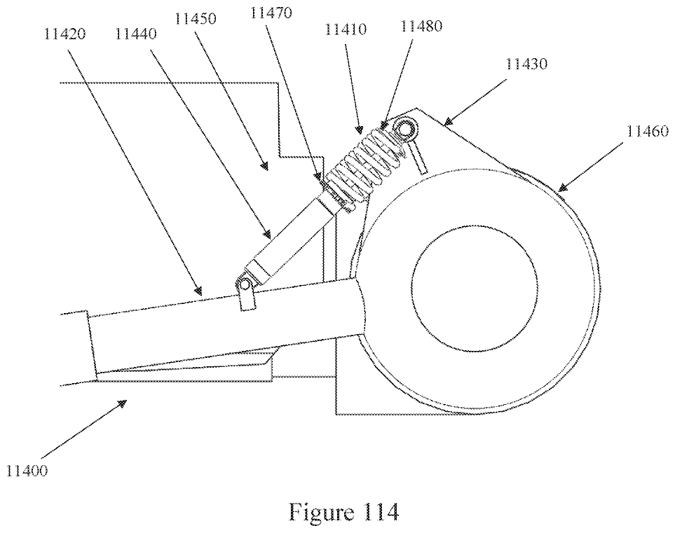

FIG. 114 provides a side view of another embodiment of a swing arm 11400 that provides the function of a supplemental suspension system described in FIG. 112 and FIG. 113. In this embodiment, spring force is provided by a compression spring 11410 acting between a torque tube 11420 and a preload ring 11430. Swing arm 11400 may include a shock absorber 11440 to provide suspension damping. Spring 11410 and shock absorber 11440 may be integrated into a coil-over unit 11450. Nominal spring force may be adjustable by rotating preload ring 11430 relative to a nacelle 11460, as described above. Alternatively, nominal spring force may be adjusted by moving a preload nut 11470 relative to a spring perch 11480. Preload nut 11470 may be threaded onto shock absorber 11440 such that rotation of preload nut 11470 may cause axial motion relative to spring perch 11480.

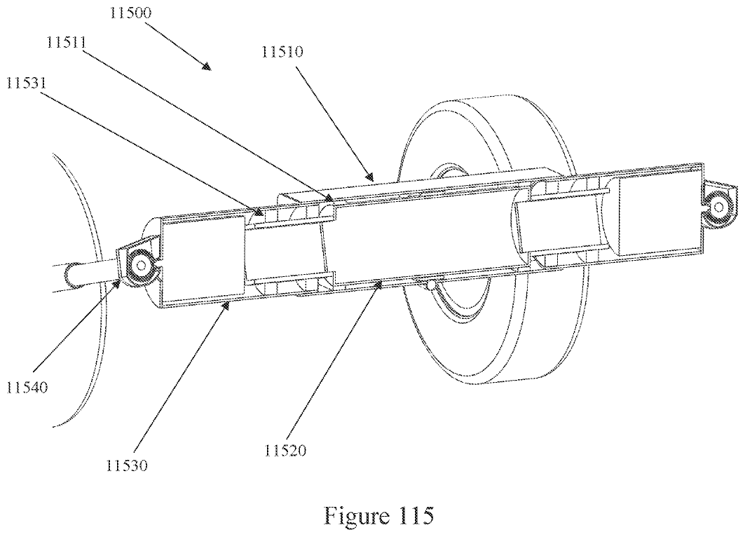

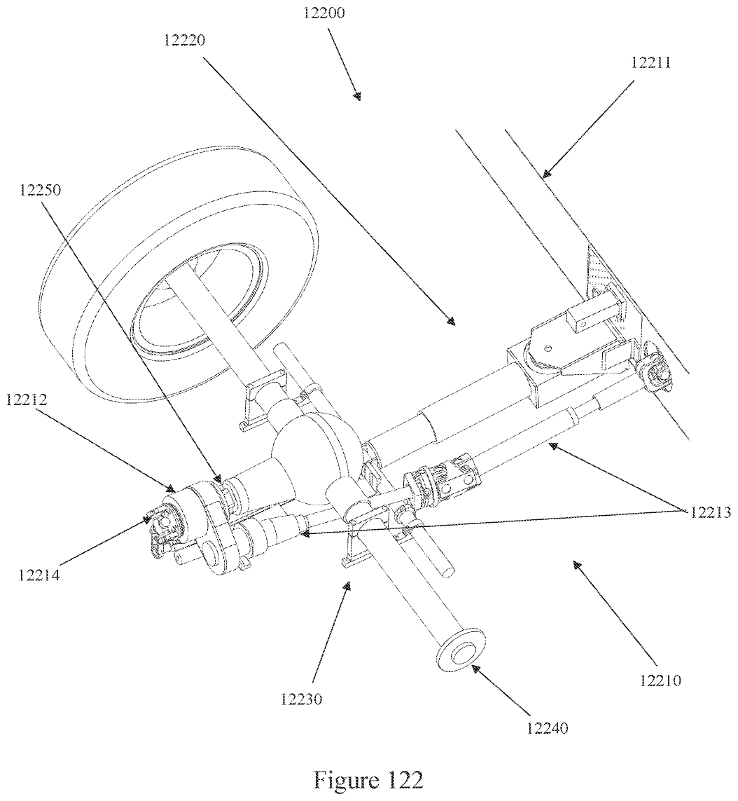

FIG. 115 provides an isometric cutaway of an exemplary embodiment of a rear drive 11500, previously shown in FIG. 122. Rear drive 11500 may include a chassis 11510, a central structure 11520, and one or more nacelles. 11530. Nacelles 11530 may be slidingly connected to central structure 11520 at one or more bearings 11531. Bearings 11531 may rotationally couple nacelle 11530 to central structure 11520 via a square cross section as shown, or by a spline, keyway, other non-circular shapes, or any other common methods (not shown). Central structure 11520 may be rotationally connected to chassis 11510 at one or more chassis bearings 11511. One or more swing arms 11540 may be rigidly connected to nacelles 11530. As configured, central structure 11520, one or more nacelles 11530, and one or more swing arms 11540 may rotate together relative to chassis 11510. One or more swing arms 11540 may be rigidly connected to nacelles 11530.

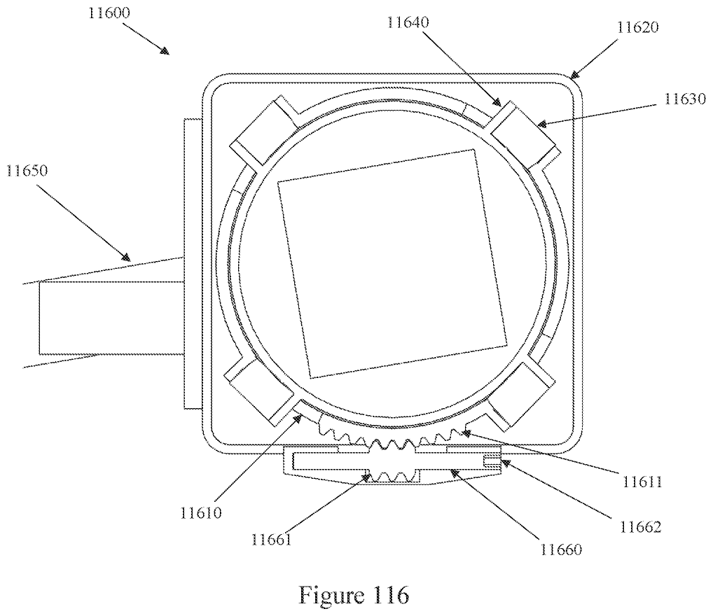

FIG. 116 provides a side cutaway view of rear drive 11600. As shown, preload ring 11610 may be rotationally connected to a chassis 11620. One or more springs 11630 may be connected to preload ring 11610 and a central structure 11640. As configured, a swing arm 11650 may provide the function of a supplemental suspension system described above. The nominal spring force provided may be adjustable by rotating preload ring 11610 relative to chassis 11620. Preload ring 11610 may include one or more teeth 11611 that may engage with a helix 11661 of a shaft 11660, as in a worm gear. Shaft 11660 may be rotationally connected to chassis 11620. As configured, rotation of shaft 11660 may cause rotation of preload ring 11610, which may adjust the nominal spring force exerted by one or 2 swing arms 11650. Shaft 11660 may include a feature 11662 that may allow a user to engage a tool to increase torque applied to shaft 11660. Feature 11662 may be an internal or external hex, for example. Shaft 11660 may alternatively include a knob or handle (not shown) for increasing torque applied by user.

Central structure 11640 may be hollow as shown, or at least partially hollow, which may provide space inside for other hybrid system components (not shown), such as electronics or cooling system components. Alternatively, the size of central structure 11640 may be minimized, which may provide space between it and chassis 11620 for other hybrid system components.

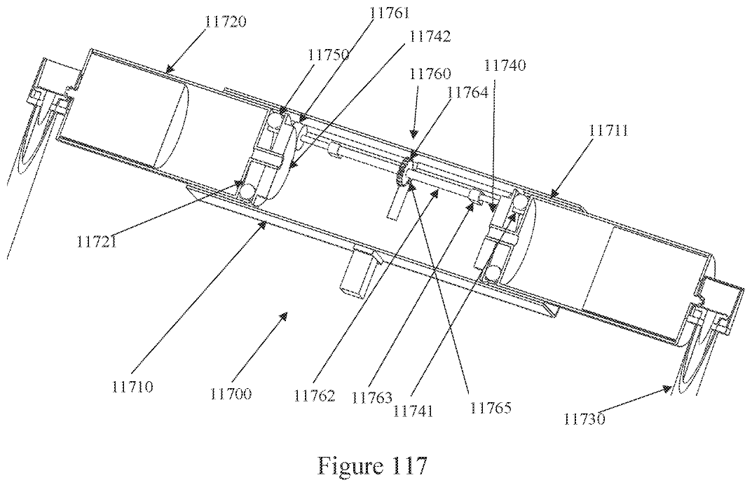

FIG. 117 provides an isometric cutaway of another embodiment of a rear drive 11700, shown in FIG. 115. Rear drive 11700 may include a chassis 11710 and one or more nacelles 11720. One or more swing arms 11730 may be rigidly connected to one or more nacelles 11720. Nacelles 11720 may be slidably and rotationally connected to chassis 11710 by one or more bearings 11711. One or more preload disks 11740 may rotationally connect to nacelles 11720. Preload disks 11740 may include one or more tabs 11741. Nacelles 11720 may include on or more vanes 11721. One or more springs 11750 may connect nacelles 11720 to preload disks 11740. Springs 11750 may be compression springs as shown, or tension springs, leaf springs, torsion springs, or the like. As configured, swing arm 11730 may provide the function of a supplemental suspension system, described above. In some embodiments, the nominal spring force provided may be adjustable by rotating preload disk 11740 relative to chassis 11710. Rear drive 11700 may include an adjustment mechanism 11760 for rotating preload disk 11740 relative to chassis 11710. Adjustment mechanism 11760 may include one or more outboard gears 11761 that may interface with a preload disk gear 11742. Outboard gears 11761 may be rigidly connected to a shaft 11762. Shaft 11762 may be telescoping to allow outboard gears 11761 to move inward and outward with nacelles 11720. Shaft 11762 may be supported by one or more shaft bearings 11763. An inner gear 11764 may be rigidly connected to shaft 11762 and may interface with a worm gear 11765. Worm gear 11765 may be rigidly connected to a shaft (not shown), as provided in the FIG. 116 discussion, which may enable a user to turn worm gear 11765. As configured, the nominal spring force provided may be adjustable by a user rotating worm gear 11765, which may rotate inner gear 11764, which may rotate shaft 11762, which may rotate outboard gears 11761, which may rotate preload disks 11740. In an alternative embodiment, shaft 11762 may engage preload disk 11740 via a belt and pulleys (not shown) or a chain and sprockets (not shown).

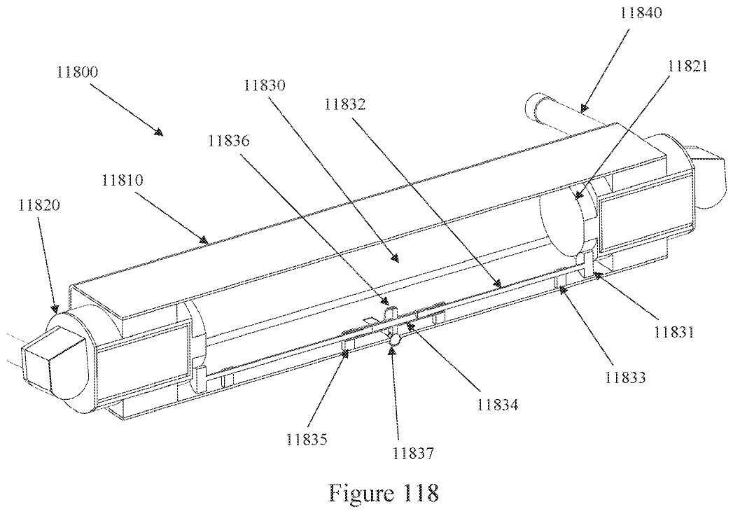

FIG. 118 provides an isometric cutaway of an alternative configuration of a rear drive 11800, shown in FIG. 117. Rear drive 11800 may include a chassis 11810, one or more nacelles 11820, and a spring mechanism 11830. One or more swing arms 11840 may be rigidly connected to the one or more nacelles 11820. Nacelle 11820 may include a nacelle gear 11821 that may interface with an outboard gear 11831 of spring mechanism 11830. One or more outboard gears 11831 may be rigidly connected to one or more torsion bars 11832. Torsion bars 11832 may be supported by one or more torsion bearings 11833. Torsion bars 11832 may be slidably connected to an anchor 11834 to accommodate inward and outward movement of nacelles 11820. Torsion bars 11832 may be rotationally coupled to anchor 11834. As configured, when nacelles 11820 rotate relative to chassis 11810, torsion bars 11832 may twist and provide a restoring torque to nacelles 11820, in a manner similar to a typical automotive torsion bar suspension and may provide the function of a supplemental suspension system, described above. Torsion bars 11832 may be slidingly connected and rotationally coupled to anchor 11834 via an external spline (not shown) on torsion bar 11832 and an internal spline (not shown) in anchor 11834. In an alternative configuration, torsion bars 11832 and nacelles 11820 may be connected by a belt and pulleys (not shown) or a chain and sprockets (not shown).

The nominal spring force provided may be adjustable by rotating anchor 11834 relative to chassis 11810. Anchor 11834 may be supported by one or more anchor bearings 11835. Inner gear 11836 may be rigidly connected to anchor 11834 and may interface with worm gear (not shown) and shaft 11837. As provided in the FIG. 116 discussion, rotation of worm gear (not shown) and shaft 11837 may cause rotation of inner gear 11836, which may cause rotation of anchor 11834, which may increase or decrease the nominal spring force provided by torsion bars 11832.

It is understood that a swing arm 11840 configured as described herein is not limited to applications in conjunction with an AHS, but rather may also be of use independently for improving the load-carrying ability of a vehicle.

It is understood that an SSS as described herein may be of benefit to any vehicle carrying a load of substantial weight, such as: cargo in a cargo area, pickup bed, or trunk; a range extending generator, fuel cell, or battery connected to a trailer hitch receiver; cargo or other accessories connected to a trailer hitch receiver; components of an AHS, such as a battery pack, connected to a trailer hitch receiver; or the tongue weight of a trailer.

It is understood that the combination of any example of an SSS with any example of an AHS described herein is within the scope of the disclosure.

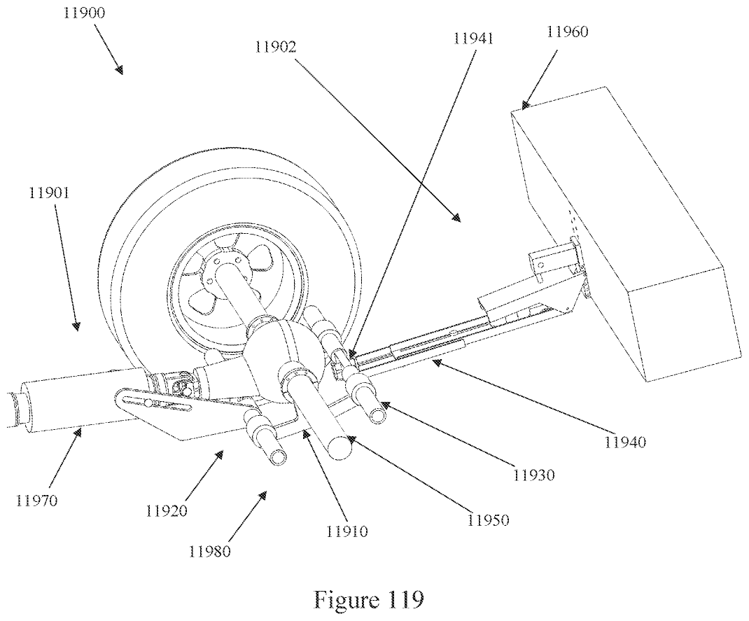

FIG. 119 provides another example of an AHS 11901, SSS 11902 and axle clamp assembly 11980. Referring also to FIG. 111 and FIG. 33, axle clamps 11910 may be configured to support both a linkage 11920 and a transverse bar 11930. Transverse bar 11930 may be slidably and rotationally connected to a pin 11941 of an extension arm 11940 to accommodate roll and longitudinal movement of an axle 11950 relative to a rear chassis 11960 as it articulates. Rear chassis 11960 may include an energy storage device (not shown), such as batteries, and/or a controller (not shown) for a power conversion device 11970, and/or a charger (not shown) for an energy storage device.

FIG. 120 provides another example of an AHS 12000, SSS 12001, and axle clamp assembly 12002. Also referring to FIG. 107, a suspension arm 12010 may be connected to a torsion axle 12020, which may provide a substantially downward force on a transverse bar 12030. Suspension arm 12010 may be extensible, for example by telescoping as shown, to accommodate longitudinal movement of an axle 12040 relative to a rear drive 12050. Suspension arm 12010 may be connected to transverse bar 12030 at a spherical joint 12060, which may be configured to accommodate relative pitch and roll between them. An axle clamp 12070 may include a rearward portion 12071, which may be rigidly connectable at a plurality of pitch angles, for example, by one or more slots 12072 and screws (not shown). Suspension arm 12010 may include a mechanism 12080 configured to adjust the nominal pitch angle and force, for example as provided in the FIG. 108 discussion.

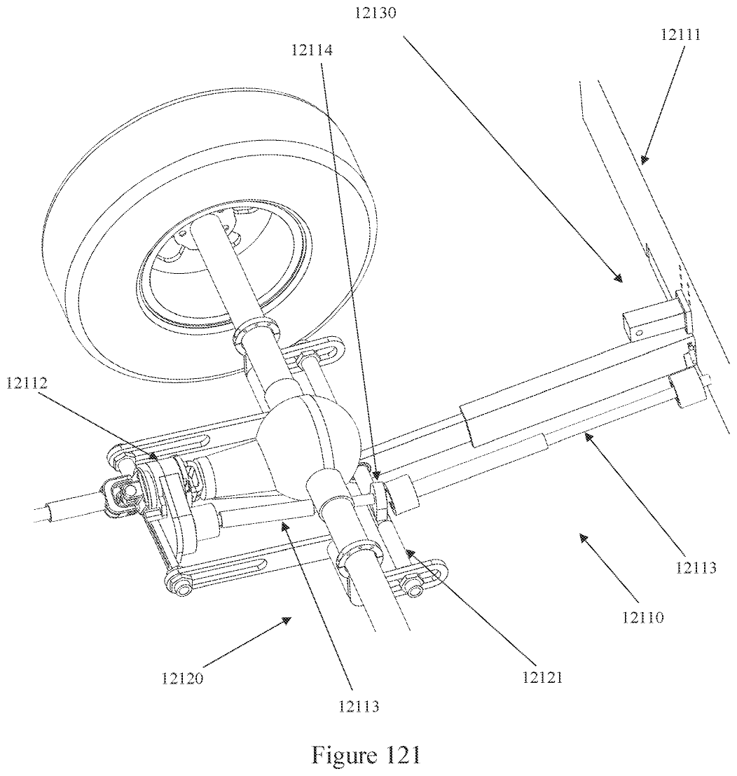

FIG. 121 provide another embodiment of an AHS 12110, axle clamp assembly 12120, and an SSS 12130. AHS 12110 may include a rear drive 12111, which may or may not include an energy storage device (not shown), and may include a power splitter 12112, which may be configured, as provided in the FIG. 8 discussion. Power splitter 12112 may be connected to axle clamp assembly 12120 as provided in FIG. 23 discussion. SSS 12130 may be configured as provided in FIG. 120 discussion and may connect to a rear transverse bar 12121. One or more driveshafts 12113 may transmit power between a power splitter 12112 and rear drive 12111. The one or more driveshafts 12113 may be supported by a bearing 12114, which may be rotatingly connected to a rear transverse bar 12121.

FIG. 122 provides a top isometric view of a vehicle axle 12240 and a system 12200 which includes an AHS 12210, an SSS 12220, and an axle clamp assembly 12230. AHS 12210 may include a rear drive 12211, one or more driveshafts 12213, a power splitter 12212 (as provided in FIG. 121 discussion), a differential input assembly 12250, and a u-joint interface 12214. U-joint interface 12214 may be configured to engage with the vehicle's driveshaft (not shown) which may be connected to the vehicle's engine (not shown), transfer case (not shown), or transmission (not shown). AHS 12210 may be configured to engage with the vehicle's driveshaft, e.g., after it has been shortened to accommodate the length of power splitter 12212. In some embodiments, the vehicle's driveshaft (not shown) may be shorted by cutting out a section (not shown) of the tubular portion (not shown) and welding it back together.

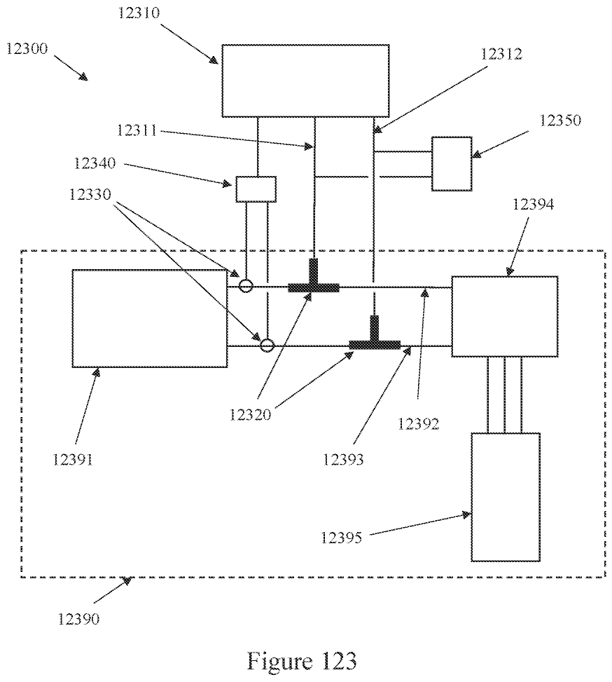

FIG. 123 provide a block diagram of a range extender 12300 for an electric vehicle 12390. In some embodiments, range extender 12300 may include a power source 12310, which may have a positive electrical output 12311 and a negative electrical output 12312, which may be connected to a battery positive line 12392 and a battery negative line 12393 of a vehicle's traction battery 12391 at one or more splices 12320. Power source 12310 may be configured to supply electrical power to a vehicle's motor controller 12394 (also known as an inverter), which may then transmit the power to a vehicle's traction motor 12395. Range extender 12300 may include one or more current sensors 12330, which may be connected to battery positive line 12392 and battery negative line 12393 between battery 12391 and splices 12320 and which may communicate a measurement of the magnitude and direction of current flowing into or out of battery 12391 to a controller 12340. Controller 12340 may be configured to vary the output of power source 12310 using feedback from current sensors 12330 such that the state of charge of battery 12391 can be controlled, for example by preventing any net change in the state of charge. Controller 12340 may be configured to receive input from a user, for example, a command to maximize output of power source 12310 to increase the state of charge of battery 12391, as may be desirable in anticipation of a large and sustained power draw from traction motor 12395. Range extender 12300 may optionally include a power buffer 12350, which may be connected to positive electrical output 12311 and a negative electrical output 12312 and may be configured to provide a faster response to transient current demands than power source 12310 may be capable of.

Power source 12310 may be a fuel cell (not shown), a battery pack (not shown), an electrical generator (not shown) which may be turned by an engine (not shown), or any other common source of mobile electrical power. Current sensors 12330 may be of the current clamp, sense resistor, or any other common type. Power buffer 12350 may be a battery or capacitor, for example.

As configured, range extender 12300 may be installable on an existing electric vehicle, either inside the vehicle, in the bed of a pickup truck, on a trailer hitch receiver, on a conventional trailer connected to the vehicle, or on a self-steering trailer, as previously described, connected to the vehicle.

Range extender 12300 may optionally include an inverter (not shown) configured to receive electrical power from the power source 12310 and configured to deliver alternating current electrical power to external loads.

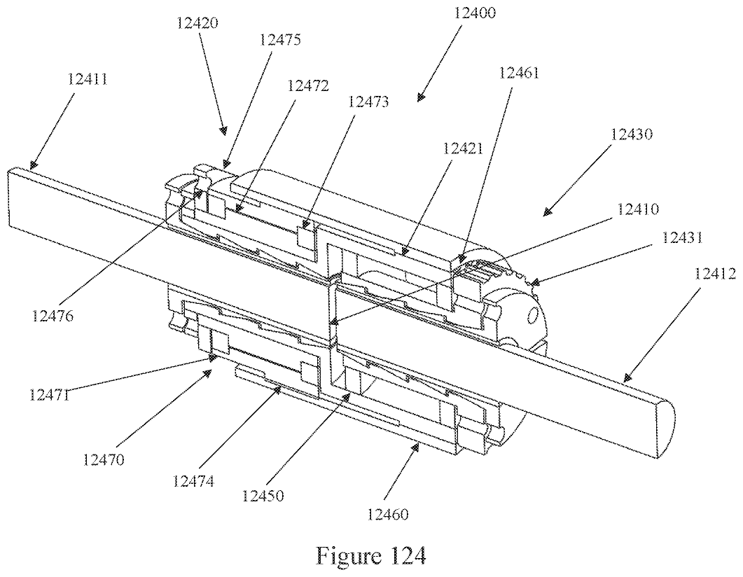

As is appreciated, some vehicles risk transmission damage if the vehicle is propelled for significant distance with the transmission in neutral and the engine not running. An alternative for vehicles with independent suspension on driven wheels is to install an axle-disconnect 12400, shown in an isometric cutaway in FIG. 124, for each wheel. As shown, a vehicle's axle 12410 may be cut such that an inboard end 12411 is no longer connected to an outboard end 12412. Axle-disconnect 12400 may include an inboard portion 12420 which may be rigidly connected to the inboard end 12411 of axle 12410, and an outboard portion 12430 which may be rigidly connected to the outboard end 12412 of axle 12410. An inner portion 12420 may be rotationally connected to an outboard portion 12430 by one or more bearings 12450. Bearings 12450 may keep inboard end 12411 of axle 12410 aligned with outboard end 12412. In some embodiments, axle-disconnect 12400 may include a sliding clutch 12460, which may be slidably connected to inboard portion 12420 by one or more internal splines 12461 and one or more external splines 12421. When sliding clutch 12460 is in a first position as shown, internal splines 12461 of sliding clutch 12460 may be disengaged from external splines 12431 of outboard portion 12430. As configured, relative rotation of inboard portion 12420 to outboard portion 12430 may be allowed, which may allow the vehicle's wheels (not shown) to turn without causing rotation of the vehicle's transmission, transaxle, or differential (not shown). When sliding clutch 12460 is in a second position (not shown) internal splines 12461 of sliding clutch 12460 may engage multiple external splines 12421 of inboard portion 12420 and external splines 12431 of outboard portion 12430. As configured, torque may be transmitted between inboard end 12411 and outboard end 12412 of axle 12410, which may allow normal vehicle operation. Internal splines 12461 of sliding clutch 12460 and external splines 12431 of outboard portion 12430 may include tapered ends (not shown) to aid alignment during engagement. Sliding clutch 12460 may include a synchronizer (not shown), as is common in automotive manual transmissions, which may provide smoother engagement of sliding clutch 12460 with outboard portion 12430. Inboard portion 12420 may include an actuator 12470 which may move sliding clutch 12460 between the first and second positions described above. In some embodiments, actuator 12470 may be an electric motor. Actuator 12470 may include an external rotor 12471 which may be rotationally connected to an internal stator 12472 by one or more motor bearings 12473. Stator 12472 may be rigidly connected to outboard portion 12430. Rotor 12471 may engage with sliding clutch 12460 at a threaded interface 12474 such that rotation of rotor 12471 relative to stator 12472 may cause axial movement of sliding clutch 12460 between the first and second positions described above. Electrical power and data signals may be communicated to and from actuator 12470 by a slip ring 12475, which may allow the communicating wires (not shown) to remain stationary with respect to the vehicle (not shown) while axle 12410 rotates. Slip ring 12475 may include a feature 12476, such as a hole as shown, that may allow slip ring 12475 to be connected to portion of the vehicle's chassis (not shown), such as a lower control arm (not shown), such that rotation of the wires (not shown) relative to the chassis (not shown) is prevented. The connection between slip ring 12475 and the chassis (not shown) may be a cable tie, string, cable, metal band, or any other suitable device (not shown). Axle disconnect 12400 may include or more switches or sensors (not shown) which may detect when sliding clutch 12460 is in the first position, second position, or both. Actuator 12470 may include an encoder (not shown) or resolver (not shown), which may be used to determine the position of sliding clutch 12460.

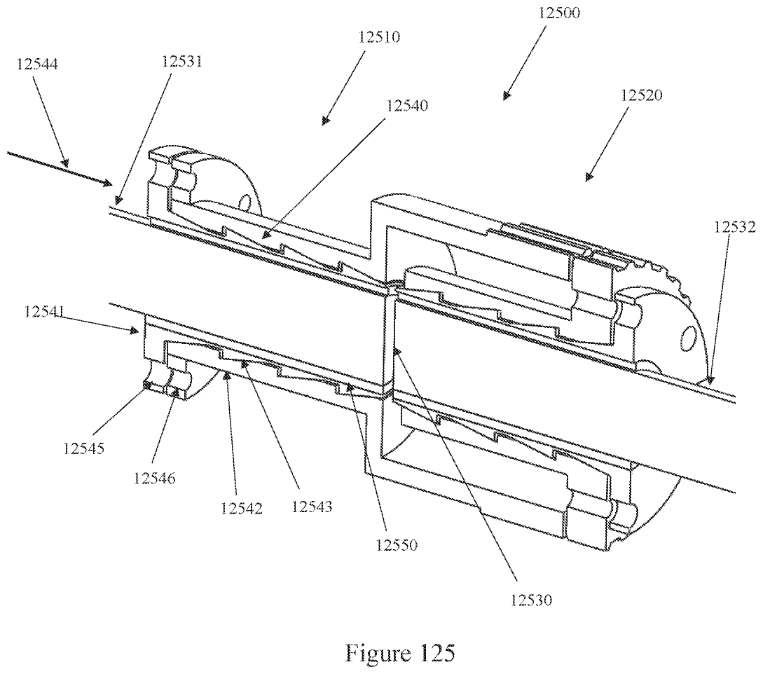

FIG. 125 provides an isometric cutaway of a subset of components of axle-disconnect 12500. As shown, an inboard portion 12510 and an outboard portion 12520 may be rigidly connected to an inboard end 12531 and an outboard end 12532, respectively, of axle 12530 via one or more hub-shaft couplings 12540, such as described by U.S. Pat. No. 2,669,471A. Hub-shaft coupling 12540 may include an inner sleeve 12541 and an outer sleeve 12542, which may have one or more conical interfaces 12543. Axial movement of inner sleeve 12541 relative to outer sleeve 12542 in a first direction 12544 may cause an inward compression of inner sleeve 12541 due to forces imparted at conical interfaces 12543. Inner sleeve 12541 may be circumferentially discontinuous which may reduce or eliminate hoop stresses, which may increase the inward compressive force. Conical interfaces 12543 may be integrated into inner sleeve 12541 and outer sleeve 12542 as shown or may be separate parts (not shown). Relative axial movement of inner sleeve 12541 to outer sleeve 12542 may be caused by one or more screws (not shown) passing through one or more holes 12545 of inner sleeve 12541 and threaded into one or more holes 12546 of outer sleeve 12542. It is understood that hub to shaft connections using conical interfaces are a common method of connecting such components and a variety of different configurations are widely used and are within the scope of the current disclosure. One or more shims 12550 may be placed between axle 12530 and inner sleeve 12541. Shims 12550 may be configured in a variety of thicknesses so that axles 12530 of varying diameters may be accommodated by a single inner sleeve 12541. Shims 12550 may be circumferentially discontinuous, which may increase the compressive force exerted by inner sleeve 12541 on axle 12530. Shims 12550 may be made from a soft metal, such as aluminum or a copper alloy such as brass or bronze. Shims 12550 and/or inner sleeve 12541 may include features (not shown) configured to result in a more positive engagement with axle 12530 and increase torque transmitting ability. Such features may be ribs, knurls, dimples, or the like.

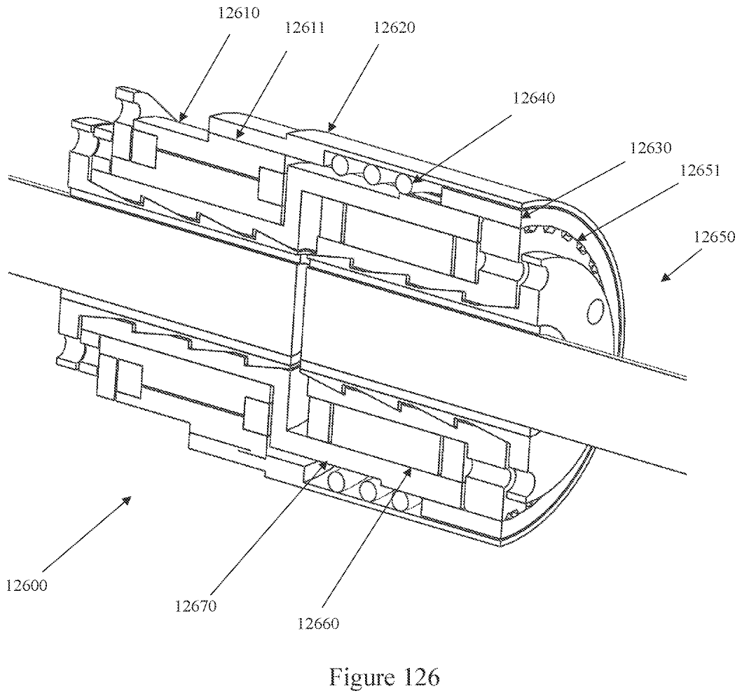

FIG. 126 provides an isometric cutaway of a further embodiment of an axle-disconnect 12600. In this embodiment, actuator 12610 may have a threaded interface 12611 with a slider 12620, which may be slidably connected to sliding clutch 12630. Slider 12620 may be axially connected to sliding clutch 12630 by a spring 12640. As configured, when slider 12620 is moved axially by actuator 12610, it may compress or extend a spring 12640 and may exert a force on sliding clutch 12630. This may enable sliding clutch 12630 to engage or disengage with one or more splines 12651 of an outboard portion 12650 when torque transmission and speed differential between outboard portion 12650 and an inboard portion 12670 is negligible. It is understood that this is functionally similar to the locking hubs on the front axles of many four wheel drive vehicles. Axle-disconnect 12600 may include a one-way clutch 12660 between inboard portion 12670 and outboard portion 12650. One-way clutch 12660 may allow outboard portion 12650 to rotate in a direction that consistent with forward motion of the vehicle without causing rotation of inboard portion 12670. One-way clutch 12660 may transmit torque from inboard portion 12670 to outboard portion 12650 when inboard portion 12670 rotates in a direction consistent with forward motion of the vehicle. One-way clutch 12660 may be of a roller, sprag, axial-pawl, or similar type. As configured, when transitioning from propelling the vehicle with the AHS (not shown) to propelling the vehicle (not shown) with the vehicle's engine (not shown), for example when the battery (not shown) of the AHS (not shown) is depleted, as engine speed increases the rotational speed of inboard portion 12670 relative to outboard portion 12650 will increase until becoming equal, at which point one-way clutch 12660 will cause the speed of inboard portion 12670 to remain equal to outboard portion 12650. Once equal speed has been established, sliding clutch 12630 can smoothly engage with one or more splines 12651. One-way clutch 12660 may also enable hybrid operation of a vehicle (not shown) whereby power is supplied by both the AHS (not shown) and the vehicle's engine (not shown).

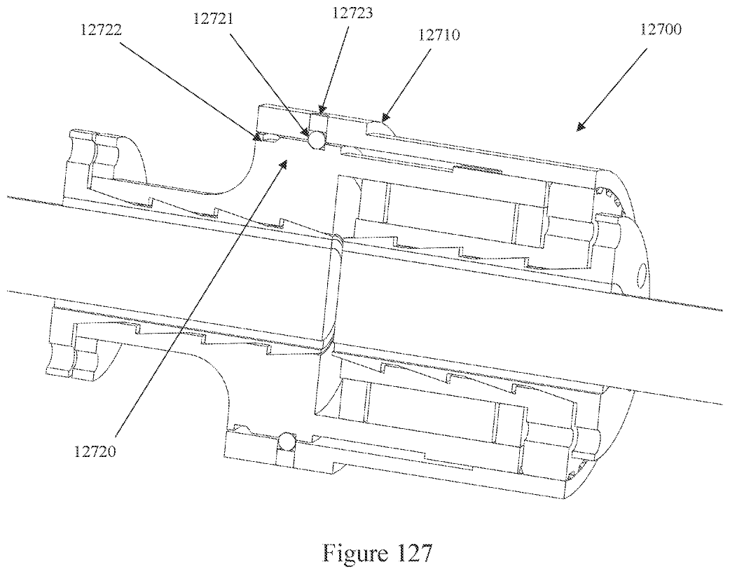

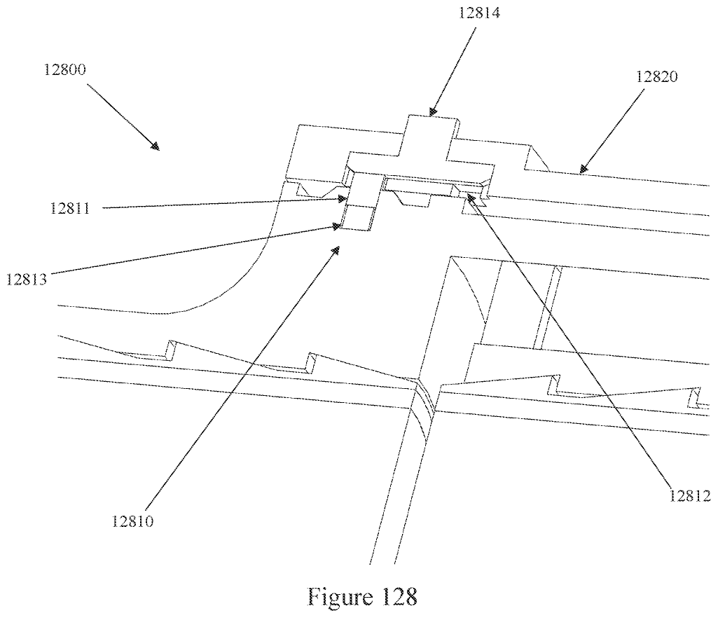

Referring now to FIG. 127 and FIG. 128, FIG. 127 provides a cutaway view of a further example of an axle disconnect 12700, as provided in FIG. 124 discussion. As shown, a sliding clutch 12710 may be configured to be moved between a first position and a second position (as shown) by a user. One or more detent mechanisms 12720 may provide retention of sliding clutch 12710 in the first and/or second position and may provide tactile feedback to a user when the first and/or second positions are achieved. Detent mechanism 12420 may include a ball 12721 which may engage with one or more pockets 12722, which may correspond to the first and/or second positions of sliding clutch 12710. Ball 12721 may be acted upon by a spring 12723. As configured, axle disconnect 12700 may enable an AHS (not shown) to propel a vehicle (not shown) without back-driving the conventional drivetrain. When back-driving the conventional drivetrain is desirable, for example, when wishing to engine-brake while driving in hilly terrain, a user may stop the vehicle (not shown) and move sliding clutch 12710 to the second position as shown.

FIG. 128 provides a cutaway of a different portion of axle disconnect 12800, which may include one or more lock mechanisms 12810. Lock mechanism 12810 may be configured to prevent unintended movement of a sliding clutch 12820 when it is in a first and/or second position. Lock mechanism 12810 may include a pin 12811, which may engage with one or more pockets 12812 in sliding clutch 12820 to prevent movement, which may correspond with the first and/or second positions of sliding clutch 12820. Pin 12811 may be biased towards engagement with pockets 12812 by a spring 12813. Pin 12811 may be configured to be further biased toward engagement with pockets 12812 by centrifugal force when axle disconnect 12800 is rotating. A button 12814 may be configured to move pin 12811 towards the centerline (not shown) of axle disconnect 12800 when depressed by a user, such that pin 12811 may disengage from pockets 12812 and movement of sliding clutch 12820 may be initiated or allowed. A second lock mechanism (not shown) may be located opposite the first lock mechanism 12810 such that first button 12814 and a second button (not shown) may be depressible by squeezing together in a user's hand.

In another embodiment of an AHS, the power splitter described in FIG. 9, FIG. 44, and FIG. 17, or the coaxial drive described in FIG. 34 and FIG. 45, may be configured such that the clutch, when in generator mode position, may transmit power from the vehicle's engine, transmission, or transfer case to the power conversion device, which may be an electric motor. The electric motor may be configured to operate as a generator under such conditions without locomotion of the vehicle. The electric motor may be configured to provide electrical energy to the battery for the purpose of charging the battery, and/or to one or more electrical outlets configured to provide electrical energy to external devices. This electrical energy may be of alternating current and may be of a voltage and frequency typical of household electricity, for example 50-60 Hertz and 110-240 Volts. The AHS may include a bi-directional charger, as is used in electric vehicles, that may be configured to supply electrical power to the energy storage device from an external source and configured to supply electrical power to an external load from the energy storage advice. In another embodiment, the AHS may include an inverter (separate from a charger), that may be configured to supply electrical power to an external load, e.g., a corded power tool, from the energy storage advice.

In some embodiments of an AHS presented herein, a rear drive may not include a power conversion device. In such instances, it is understood that a rear unit including at least an energy storage device may be connected to a vehicle as provided with respect to the rear drive, and that any components described herein may interface with the rear unit as provided with respect to the rear drive.

It should be understood that the dimensions and/or values disclosed herein are not strictly limited to the exact numerical dimension and/or values recited. Instead, unless otherwise specified, each such dimension and/or value is intended to mean both the recited dimension and/or value and a functionally equivalent range surrounding that dimension and/or value. For example, a dimension disclosed as “12 inches” is intended to mean “about 12 inches”.

The components and parts described and illustrated herein that may be represented as single, contiguous parts are not to be understood as being limited to single, contiguous parts. Instead, a component may include multiple parts joined together by common methods such as bolting, screwing, welding, brazing, bonding with adhesive, or any other common means of joinery. Such joinery may be necessary or desirable for the purposes of assembly, cost reduction, or weight reduction.

Every document cited herein, including any cross-referenced or related patent or application is hereby incorporated herein by reference in its entirety unless expressly excluded or otherwise limited. The citation of any document is not an admission that it is relevant art with respect to any invention disclosed or claimed herein or that it alone, or in any combination with any reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

It should be appreciated that a number of different configurations are provided for a number of systems. It is within the scope of this disclosure to combine any number of configurations with one another and substitute or combine any number of components from each system with each other. Thus, it should be appreciated that while some details may be presented in one system or configuration, they are equally application to other systems or configurations, and that they have merely been provided in their context as an example.

As used throughout the disclosure, the term “spring” is generally understood to mean any resilient member. The term “linkage” is generally understood to mean a member connecting two or more components. The term “anti-rotation member” may be used interchangeably with a linkage when the linkage prevents rotation. The term “fix” is generally understood to mean setting the indicated location and/or orientation of an element and preventing it from changing. The term “support” is generally understood to mean setting the location and/or orientation of an element and providing opposition to external forces. As used throughout the disclosure, the terms “transmission,” “gear set,” and “gearbox” may be used interchangeably and generally understood to mean a power-transmitting device that may be configured to increase torque or force, decrease torque or force, or change the direction of power transmission. The terms “differential pinion,” “differential input,” “differential input shaft,” and “differential pinion shaft” may be used interchangeably and generally understood to mean the portion of a vehicle differential into which input power is supplied by the vehicle drivetrain, e.g. a driveshaft. The term “frame” as applied to a vehicle is generally understood to mean the frame, body, or unibody of a vehicle.

### FURTHER NON-LIMITING DESCRIPTION OF THE DISCLOSURE

The following paragraphs constitute a further non-limiting description of the disclosure in a form suitable for appending to the claim section if later desired.
1. A system comprising:
at least one energy storage device configured to store power for a vehicle having at least one differential pinion and at least one axle tube;
at least one power conversion device;
at least one power conversion controller configured to regulate power flow between the at least one energy storage device and the at least one power conversion device;
an input device configured to receive input from a user and configured to translate the input into instructions for the power conversion controller; and
a drivetrain configured to transmit power between the at least one power conversion device and the vehicle's at least one differential pinion and configured to connect to the vehicle's axle tube.
2. The system of embodiment 1, further comprising a rear drive, wherein the rear drive comprises the at least one power conversion device.
3. The system of embodiment 2, wherein the drivetrain comprises:
a driveshaft configured to transmit power between the rear drive and a parallel shaft assembly, wherein the parallel shaft assembly is configured to transmit power to a chain in communication with the parallel shaft assembly;
a differential input assembly configured to transmit power between the chain and the vehicle's differential pinion; and
an axle clamp assembly configured to connect the parallel shaft assembly to the vehicle's axle tube.
4. The system of embodiment 3, wherein the vehicle comprises a differential yoke, wherein the differential input assembly comprises a chain sprocket and at least one yoke element, wherein the chain sprocket is configured to transmit power between the chain and the at least one yoke element, and the at least one yoke element is configured to engage with the differential yoke and transmit power between the differential input assembly and the differential yoke, wherein the differential yoke is of varying geometry
5. The system of embodiment 4, wherein the vehicle comprises a driveshaft with a universal joint, wherein the differential input assembly comprises a universal joint member configured to engage with the universal joint and transmit power between the driveshaft and the differential input assembly, wherein the universal joint is of varying geometry.
6. The system of embodiment 2, wherein the drivetrain comprises:
at least one driveshaft;
a power splitter configured to transmit power between the rear drive and the vehicle's differential pinion; and
an axle clamp assembly configured to connect the power splitter to the vehicle's axle tube, wherein the driveshaft is configured to transmit power between the rear drive and the power splitter.
7. The system of embodiment 1, wherein the vehicle further comprises a driveshaft having a forward portion and a rearward portion and wherein the drivetrain comprises:
a coaxial drive unit comprising the at least one power conversion device and a housing, the coaxial drive unit configured to be installed between the forward portion and rearward portion of the vehicle's driveshaft, and wherein the coaxial drive unit is configured to be parallel to and aligned with the forward and rearward portion of the driveshaft; and
an anti-rotation linkage configured to minimize rotation of the housing of the coaxial drive unit, wherein the anti-rotation linkage is in communication with an axle clamp assembly.
8. The system of embodiment 7, wherein the axle clamp assembly is configured to connect to the vehicle's axle tube.
9. The system of embodiment 1, further comprising a power unit, wherein the power unit comprises the at least one power conversion device and the drivetrain, and wherein the power unit is configured to be connected to the vehicle's differential pinion and an axle clamp assembly.
10. The system of embodiment 9, wherein the axle clamp assembly is configured to connect to the vehicle's axle tube.
11. The system of embodiment 2, wherein the drivetrain comprises an axle clamp assembly configured to connect the rear drive to the vehicle's axle tube.
12. The system of embodiment 2, wherein the vehicle further comprises a rear frame section and wherein the rear drive is configured to be connected to the rear frame section.
13. The system of embodiment 12, wherein the vehicle further comprises a trailer hitch receiver connected to the rear frame section, wherein the rear drive is configured to connect to the trailer hitch receiver.
14. The system of embodiment 8 wherein the axle clamp assembly comprises at least one axle clamp configured to connect to the axle tube in a plurality of locations; and
at least one transverse bar configured to connect to the axle clamp and the anti-rotation linkage.
15. The system of embodiment 7, wherein the anti-rotation linkage comprises a sliding mechanism configured to minimize rotation of the housing and to allow the housing to be positioned at varying angles of pitch.
16. The system of embodiment 7, wherein the coaxial drive unit comprises:
an input shaft located proximate to the forward portion of the driveshaft;
an outer flange configured to be connected to the forward portion of the driveshaft; and
an inner flange configured to be connected to the outer flange and the input shaft.
17. The system of embodiment 7, wherein the coaxial drive unit comprises:
an output shaft located proximate to the rearward portion of the driveshaft;
an outer flange configured to be connected to the rearward portion of the driveshaft; and
an inner flange configured to be connected to the outer flange and the output shaft.
18. The system of embodiment 7, wherein the coaxial drive unit comprises:
an input shaft configured to transmit power between the forward portion of the driveshaft and the coaxial drive unit;
an output shaft configured to transmit power between the rearward portion of the driveshaft and the coaxial drive unit; and
a coaxial shaft configured to transmit power between the at least one power conversion device and the coaxial drive unit, wherein the coaxial shaft is at least partially hollow.
19. The system of embodiment 7, wherein the coaxial drive unit comprises a transmission configured to increase the torque output of the at least one power conversion device.
20. The system of embodiment 19, wherein the transmission further comprises an epicyclic gear set.
21. The system of embodiment 18, wherein the coaxial drive unit further comprises a clutch, the clutch configured to transmit power between the input shaft and the output shaft when in a first state and configured to transmit power between the coaxial shaft and the output shaft when in second state.
22. The system of embodiment 18, wherein the coaxial drive unit comprises:
a transmission configured to increase the torque output of the coaxial shaft; and
a clutch configured to transmit power between the input shaft and the output shaft when in a first state; and configured to transmit power between the transmission output and the output shaft when in second state.
23. The system of embodiment 21, wherein the clutch is configured to transmit power between the output shaft and the input shaft, between the input shaft and the coaxial shaft, and between the coaxial shaft and the output shaft when in a third state.
24. The system of embodiment 23, wherein the first state, second state, and third state may be selected from the group of states consisting of electric mode, engine mode, and hybrid mode.
25. The system of embodiment 21, wherein the clutch is configured to be connected to the at least one power conversion device when in a neutral state.
26. The system of embodiment 25, wherein the coaxial drive unit comprises a first speed sensor configured to provide a measurement of the rotational velocity of the input shaft and a second speed sensor configured to provide a measurement of the rotational velocity of the output shaft.
27. The system of embodiment 25, wherein the coaxial drive unit is configured to match the rotational velocity of the clutch to either the input shaft or the output shaft when in a neutral state.
28. The system of embodiment 21, wherein the clutch is configured to transmit power between the input shaft and the power conversion device when in a generator state.
29. The system of embodiment 28, wherein the coaxial drive unit is configured to receive rotational energy from the forward portion of the driveshaft, convert the rotational energy into electrical energy, and provide the electrical energy to the at least one energy storage device when in the generator state.
30. The system of embodiment 7, wherein the coaxial drive unit comprises a one-way clutch configured to transmit torque from the forward portion of the driveshaft to the rearward portion of the driveshaft and prevent transmission of torque from the rearward portion of the driveshaft to the forward portion of the driveshaft.
31. The system of embodiment 21, wherein the clutch comprises an actuator configured to transition the clutch between the first and second states.
32. The system of embodiment 31, wherein the clutch comprises a lead screw, a lead nut, and a shift fork in communication with the actuator and wherein the shift fork is configured to transition the clutch between two or more states.
33. The system of embodiment 21, wherein the clutch comprises a sliding clutch configured to engage with at least one of the input shaft, the output shaft, and the coaxial shaft.
34. The system of embodiment 22, wherein the clutch comprises a sliding clutch configured to engage with at least one of the input shaft, the output shaft, and an output of the transmission.
35. The system of embodiment 33 wherein:
the input shaft comprises one or more splines;
the output shaft comprises one or more splines;
the coaxial shaft comprises one or more splines; and
the sliding clutch comprises one or more splines configured to engage with the splines of the input shaft, output shaft, and coaxial shaft.
36. The system of embodiment 34 wherein:
the input shaft comprises one or more splines;
the output shaft comprises one or more splines;
the transmission output comprises one or more splines; and
the sliding clutch comprises one or more splines configured to engage with the splines of the input shaft, output shaft, and a transmission output.
37. The system of embodiment 7, wherein the at least one power conversion device comprises one or more electric motors, each having a shaft.
38. The system of embodiment 37, comprising more than one electric motor, wherein the electric motors are stacked axially.
39. The system of embodiment 37, comprising more than one axial flux motor, wherein the electric motors are stacked axially.
40. The system of embodiment 38, wherein the electric motors each comprise a rotor, and the rotors are all connected to a single motor shaft.
41. The system of embodiment 7, wherein the coaxial drive unit comprises:
a shaft configured to transmit power between the forward portion of the driveshaft and the rearward portion of the driveshaft; and
a coaxial shaft configured to transmit power from the at least one power conversion device to the common shaft,
wherein the coaxial shaft is at least partially hollow.
42. The system of embodiment 7, wherein the coaxial drive unit comprises:
a common shaft configured to transmit power between the forward portion of the driveshaft and the rearward portion of the driveshaft;
a coaxial shaft configured to transmit power between the at least one power conversion device and the transmission;
wherein the transmission is configured to transmit power between the at least one power conversion device and the common shaft and wherein the coaxial shaft is at least partially hollow.
43. The system of embodiment 2, wherein the drivetrain further comprises a power splitter configured to transmit power between the rear drive and the differential pinion.
44. The system of embodiment 43, wherein the vehicle comprises a drive shaft and the power splitter is configured to transmit power between the vehicle's driveshaft and the differential pinion.
45. The system of embodiment 44, wherein the power splitter comprises a clutch configured to transmit power between the vehicle's driveshaft and the differential pinion when in a first state and transmit power between the rear drive and the differential pinion when in a second state.
46. The system of embodiment 44, wherein the power splitter further comprises:
a front shaft configured to transmit power between the vehicle's driveshaft and the power splitter;
a rear shaft configured to transmit power between the power splitter and the differential pinion; and
a hybrid shaft configured to transmit power between the rear drive and the power splitter.
47. The system of embodiment 46, wherein the front shaft is parallel to and aligned with the rear shaft, and the hybrid shaft is parallel to and offset from the front shaft and rear shaft.
48. The system of embodiment 47, wherein the power splitter comprises a chain configured to transmit power between the hybrid shaft and the rear shaft.
49. The system of embodiment 47, wherein the power splitter comprises a belt configured to transmit power between the hybrid shaft and the rear shaft.
50. The system of embodiment 47, wherein the power splitter comprises a plurality of gears configured to transmit power between the hybrid shaft and the rear shaft.
51. The system of embodiment 45, wherein the clutch is configured to transmit power between the rear drive and the differential pinion, between the differential pinion and the vehicle's driveshaft, and between the vehicle's driveshaft and the differential pinion when in a third state.
52. The system of embodiment 46, wherein the power splitter is configured to transmit power between the clutch and the hybrid shaft when in a neutral state.
53. The system of embodiment 52, wherein the power splitter is configured to match the rotational velocity of the clutch to either the front shaft or the rear shaft.
54. The system of embodiment 46, wherein the clutch is configured to transmit power between the front shaft and the hybrid shaft when in a generator state.
55. The system of embodiment 54, wherein the at least one power conversion device is configured to receive rotational energy from the vehicle's driveshaft, convert the rotational energy into electrical energy, and transmit electrical energy to the at least one energy storage device.
56. The system of embodiment 44, wherein the power splitter comprises a one-way clutch configured to transmit torque from the vehicle's drive shaft to the differential pinion and configured to prevent the transmission of torque from the differential pinion to the vehicle's driveshaft.
57. The system of embodiment 43, wherein the drivetrain further comprises a differential input assembly configured to connect the power splitter to the differential pinion and configured to minimize pitch and yaw of the power splitter.
58. The system of embodiment 57, wherein the vehicle further comprises a differential pinion yoke, and wherein the differential input assembly comprises at least one yoke block configured to be connected to the vehicle's differential pinion yoke.
59. The system of embodiment 58, wherein the differential pinion yoke comprises a yoke centerline, and wherein the at least one yoke block is positionable at varying distances from the yoke centerline.
60. The system of embodiment 58, wherein the differential input assembly comprises at least one shim configured to connect the at least one yoke block to the differential pinion yoke, wherein the differential pinion yoke has a diameter of varying sizes.
61. The system of embodiment 58, further comprising a plate having a centerline, the plate configured to slidingly engage with the at least one yoke block.
62. The system of embodiment 61, further comprising an alignment device configured to align the centerline of the plate with the centerline of the differential pinion yoke.
63. The system of embodiment 62, wherein the plate is configured to connect to the power splitter via fasteners.
64. The system of embodiment 57, wherein the differential input assembly comprises a flange configured to connect the differential input assembly to the power splitter.
65. The system of embodiment 64, wherein the differential input assembly comprises at least one fastener configured to connect the differential input assembly to the power splitter and wherein the fasteners are accessible to a user.
66. The system of embodiment 64, wherein the vehicle further comprises a differential pinion flange with a screw hole pattern, wherein the differential input assembly flange is configured to connect to the differential pinion flange and wherein the differential input assembly flange is configured to accommodate screw hole patterns of varying geometry.
67. The system of embodiment 66, wherein the differential input assembly flange comprises:
one or more radially oriented slots; and
one or more clamps configured to be positionable at a plurality of radial positions, wherein the slots and clamps are configured to be alignable with screw hole patterns of varying geometry.
68. The system of embodiment 64, wherein the vehicle further comprises a differential pinion flange having a centerline and a pilot feature, and wherein the differential input assembly flange comprises one or more pilot features configured to:
connect to the differential pinion flange;
accommodate differential pinion flange pilot features of varying dimensions; and
align the centerline of the differential input assembly flange with the centerline of the differential pinion.
69. The system of embodiment 68, wherein the differential input assembly comprises an adjustment mechanism configured to position the differential pinion flange pilot features at equal distance from the flange centerline.
70. The system of embodiment 44, wherein the vehicle further comprises a driveshaft with a flange having a centerline, and wherein the drivetrain further comprises a driveshaft interface flange configured to connect the power splitter to the vehicle's driveshaft.
71. The system of embodiment 70, wherein the vehicle further comprises a driveshaft flange with a screw hole pattern, wherein the driveshaft interface flange is configured to connect to the driveshaft flange and wherein the driveshaft interface flange is configured to accommodate screw hole patterns of varying geometry.
72. The system of embodiment 70, wherein the driveshaft interface flange comprises:
one or more radially oriented slots; and
one or more clamps configured to be positionable at a plurality of radial positions, wherein the slots and clamps are configured to be alignable with screw hole patterns of varying geometry.
73. The system of embodiment 70, wherein the vehicle's driveshaft flange has a pilot feature, and wherein the driveshaft interface flange comprises one or more pilot features configured to:
connect to the driveshaft flange;
accommodate driveshaft flange pilot features of varying dimensions; and
align the centerline of the driveshaft interface flange with the centerline of the driveshaft flange.
74. The system of embodiment 73, wherein the driveshaft interface flange comprises an adjustment mechanism configured to position the driveshaft interface flange pilot features at equal distance from the flange centerline.
75. The system of embodiment 44, wherein the vehicle driveshaft comprises a universal joint having a centerline, and wherein the drivetrain further comprises a universal joint interface configured to connect the power splitter to the vehicle's driveshaft.
76. The system of embodiment 75, wherein the universal joint interface comprises at least one saddle configured to connect to the vehicle's universal joint and configured to be positionable at varying distances from the vehicle's universal joint centerline.
77. The system of embodiment 76, wherein the universal joint interface comprises at least one shim configured to connect the at least one saddle to the vehicle universal joint, wherein the vehicle universal joint has a diameter of varying sizes.
78. The system of embodiment 76, wherein the universal joint interface comprises two or more saddles, further comprising an adjustment mechanism configured to position the two or more saddles equidistantly from the universal joint centerline.
79. The system of embodiment 43, wherein the vehicle comprises a driveshaft having a forward portion and a rearward portion, wherein the power splitter is configured to be installed between the forward portion and the rearward portion, the system further comprising an anti-rotation linkage configured to minimize roll of the power splitter and configured to connect to the at least one axle tube.
80. The system of embodiment 43, wherein the drivetrain further comprises an axle clamp assembly configured to fix the roll angle of the power splitter and wherein the axle clamp assembly is connected to the vehicle's axle tube.
81. The system of embodiment 80, wherein the axle clamp assembly further comprises an anti-rotation linkage configured to connect to the power splitter and to fix the roll angle of power splitter, wherein the anti-rotation linkage is configured to accommodate varying dimensions between the vehicle's axle tube and the power splitter.
82. The system of embodiment 80, wherein the axle clamp assembly comprises at least one axle clamp configured to connect to the vehicle's axle tube in a plurality of locations.
83. The system of embodiment 82, wherein the axle clamp assembly comprises:
at least one transverse bar configured to connect to the at least one axle clamp, and an anti-rotation linkage configured to fix the roll angle of the power splitter.
84. The system of embodiment 82, wherein the drivetrain further comprises:
at least one drive shaft configured to transmit power between the rear drive and the power splitter;
at least one bearing block configured to support the at least one driveshaft; and
at least one transverse bar configured to connect to the axle clamp and the bearing block.
85. The system of embodiment 84, wherein the drivetrain comprises:
a rear drive shaft connected to the rear drive;
a front driveshaft connected to the power splitter; and
a constant velocity joint connected to the rear driveshaft and front driveshaft.
86. The system of embodiment 45, wherein the clutch comprise an actuator configured to transition the clutch between one or more states.
87. The system of embodiment 86, wherein the clutch actuator comprises an electric motor.
88. The system of embodiment 45, wherein the clutch comprises a bell crank configured to transition the clutch between one or more states.
89. The system of embodiment 45, wherein the clutch comprises a sliding clutch and a shift fork, the shift fork being configured to move the sliding clutch between one or more states.
90. The system of embodiment 89, wherein the clutch comprise a synchronizer configured to ensure engagement of the rear drive to the differential pinion.
91. The system of embodiment 89, wherein the clutch comprises a synchronizer configured to ensure engagement of the vehicle's driveshaft to the differential pinion.
92. The system of embodiment 2, wherein the drivetrain comprises at least one drive shaft configured to transmit power between the rear drive and the vehicle's differential pinion, the driveshaft being oriented in a substantially longitudinal orientation.
93. The system of embodiment 92, wherein the rear drive comprises a transmission configured to increase the torque output of the at least one power conversion device and configured to transmit power between the at least one power conversion device and the driveshaft.
94. The system of embodiment 93, wherein the transmission comprises an output axis of rotation and the driveshaft comprises an input centerline, and wherein the transmission output axis of rotation is alignable with the driveshaft input centerline by a user.
95. The system of embodiment 2, wherein the at least one power conversion device is oriented in a substantially transverse orientation.
96. The system of embodiment 2, wherein the at least one power conversion device is oriented in a substantially longitudinal orientation.
97. The system of embodiment 2, wherein the at least one power conversion device is oriented in a substantially vertical orientation.
98. The system of embodiment 93, wherein the transmission comprises a plurality of gears.
99. The system of embodiment 93, wherein the transmission comprises at least one chain and a plurality of chain sprockets.
100. The system of embodiment 93, wherein the transmission comprises at least one belt and a plurality of belt sprockets.
101. The system of embodiment 2, wherein the rear drive is configured to be connected to the vehicle at a plurality of vertical positions vertical.
102. The system of embodiment 2, wherein the rear drive is configured to be connected to the vehicle at a plurality of transverse positions.
103. The system of embodiment 11, wherein the axle clamp assembly comprises:
at least one axle clamp configured to connect to the axle tube in a plurality of locations; and
at least one transverse bar configured to connect the rear drive to the axle tube at a plurality of locations.
104. The system of embodiment 11, wherein the axle clamp assembly comprises:
at least one axle clamp configured to connect to the axle tube in a plurality of locations; and
at least one transverse bar configured to connect the rear drive to the axle tube with a plurality of pitch orientations.
105. The system of embodiment 11, wherein the rear drive is located proximate to and behind the axle tube.
106. The system of embodiment 105, wherein the at least one power conversion device is oriented vertically and wherein the drivetrain comprises:
a transmission configured to increase the torque output of the at least one power conversion device; and
at least one driveshaft configured to transmit power between the transmission and the vehicle's differential pinion.
107. The system of embodiment 9, wherein the vehicle comprises a driveshaft and the power unit is configured to transmit power between the driveshaft and the differential pinion.
108. The system of embodiment 9, wherein the at least one power conversion device is oriented vertically.
109. The system of embodiment 107, wherein the power unit comprises a one-way clutch configured to transmit torque from the driveshaft to the differential pinion and configured to prevent transmission of torque from the differential pinion to the driveshaft.
110. The system of embodiment 9, wherein the power unit comprises a transmission configured to increase the torque output of the at least one power conversion device.
111. The system of embodiment 9, wherein the vehicle comprises a differential pinion yoke and the power unit comprises a differential input assembly configured to connect the power unit to the differential pinion yoke.
112. The system of embodiment 9, wherein the vehicle comprises a differential pinion flange and the power unit comprises a differential input assembly flange configured to connect the power unit to the differential pinion flange.
113. The system of embodiment 9, wherein the vehicle driveshaft comprises a driveshaft flange and the power unit comprises a driveshaft interface flange configured to connect the driveshaft flange to the power unit.
114. The system of embodiment 9, wherein the vehicle driveshaft comprises a universal joint and the power unit comprises a universal joint interface configured to connect the driveshaft flange to the power unit, wherein the universal joint interface comprises at least one saddle.
115. The system of embodiment 9, wherein the axle clamp assembly comprises a plate configured to protect the power unit from impact with external objects.
116. The system of embodiment 9, wherein the power unit comprises a housing and wherein the power unit is oriented in a substantially longitudinal orientation and aligned with the differential pinion.
117. The system of embodiment 116, wherein the vehicle comprises a rearward portion of a driveshaft connected to the differential pinion, and wherein the power unit is configured to connect to the rearward portion of the driveshaft.
118. The system of embodiment 116, wherein the at least one power conversion device comprises a motor shaft and the power unit comprises a transmission configured to increase torque output of the at least one power conversion device and an output shaft connected to the transmission.
119. The system of embodiment 118, wherein the output shaft is parallel to and aligned with the motor shaft.
120. The system of embodiment 116, wherein the axle clamp assembly comprises an anti-rotation linkage configured to minimize rotation of the power unit housing.
121. The system of embodiment 176, wherein the coaxial drive unit housing is configured to engage with the anti-rotation linkage at a plurality of longitudinal locations.
122. The system of embodiment 176, wherein the anti-rotation linkage is configured to engage with vehicle's frame at a plurality of longitudinal locations.
123. The system of embodiment 176, wherein the anti-rotation linkage is configured to engage with the housing at a plurality of vertical distances from the vehicle's frame.
124. The system of embodiment 1, wherein the vehicle comprises a footwell and an accelerator pedal, and wherein the input device comprises a throttle pedal.
125. The system of embodiment 124, wherein the throttle pedal is located to the right of the accelerator pedal.
126. The system of embodiment 125, wherein the throttle pedal is configured to be depressed from a first position to a second position by a user without depressing the accelerator pedal.
127. The system of embodiment 126, wherein the throttle pedal is configured to be depressed from the second position to a third position by a user while simultaneously depressing the accelerator from a first position to a second position.
128. The system of embodiment 124, wherein the throttle pedal is configured to be mounted to the footwell in a plurality of locations.
129. The system of embodiment 124, wherein the throttle pedal is configured to be mounted to the accelerator pedal in a plurality of locations.
130. The system of embodiment 129, comprising a spring configured to return the throttle pedal to a resting position.
131. The system of embodiment 130, comprising a spring anchor configured to transmit the force exerted by the throttle pedal on the spring to the footwell.
132. The system of embodiment 131, wherein the throttle pedal is configured to have the nominal spring force exerted by the spring on the throttle pedal adjusted by a user.
133. The system of embodiment 124, wherein the throttle pedal further comprises a throttle position sensor configured to communicate the position of the throttle to the power conversion controller.
134. The system of embodiment 1, further comprising a climate control system including at least one thermal exchanger, wherein the thermal exchanger is configured to exchange thermal energy with a surrounding fluid.
135. The system of embodiment 134, wherein the vehicle comprises a heater core, and wherein the thermal exchanger is configured to be connected to the heater core and to exchange thermal energy with air passing through the heater core.
136. The system of embodiment 134, wherein the vehicle comprises a cooling system, a coolant, a heater core supply line, and a heater core return line, the system further comprising a thermal exchanger configured to exchange thermal energy with the coolant and a pump configured to receive coolant from the heater core return line and deliver coolant to the thermal exchanger and the heater core.
137. The system of embodiment 136, further comprising a one-way valve configured to prevent coolant delivered from the pump from being delivered to the vehicle's cooling system.
138. The system of embodiment 136, further comprising a one-way valve configured to prevent coolant delivered from the vehicle's cooling system from bypassing the heater core.
139. The system of embodiment 134, wherein the vehicle comprises climate control ducting, the system comprising a blower and a thermal exchanger, wherein the blower is configured to deliver air to the thermal exchanger and the climate control ducting.
140. The system of embodiment 139, further comprising a one-way valve configured to prevent air from the climate control ducting from being delivered to the blower.
141. The system of embodiment 134, wherein the thermal exchanger comprises a resistive heater configured to receive electrical power.
142. The system of embodiment 134, wherein the thermal exchanger comprises a heat pump configured to receive thermal energy from the surrounding fluid and deliver thermal energy to the surrounding fluid.
143. The system of embodiment 134, wherein the thermal exchanger comprises a fired heater configured to combust a combustible fuel.
144. The system of embodiment 1, wherein the vehicle comprises an engine, the system comprising an engine defeat system configured to prevent the vehicle's engine from starting.
145. The system of embodiment 144, wherein the vehicle comprises a communication configured to start the engine, the system comprising at least one switching device configured to interrupt the communication.
146. The system of embodiment 145, wherein the vehicle further comprises a starter motor and a communication configured to activate the start motor, and wherein the switching device is configured to interrupt the starter motor communication.
147. The system of embodiment 145, wherein the vehicle further comprises an ignition circuit and a communication configured to activate the ignition circuit, wherein the switching device is configured to interrupt the ignition circuit communication.
148. The system of embodiment 145, wherein the vehicle further comprises a fuel system and a communication configured to activate the fuel system, wherein the switching device is configured to interrupt the fuel system communication.
149. The system of embodiment 145, wherein the at least one switching devices comprises at least one relay.
150. The system of embodiment 145, the system further comprising at least one overcurrent protection device.
151. The system of embodiment 150, wherein the overcurrent protection device comprises a fuse.
152. The system of embodiment 150, wherein the vehicle communication comprises an overcurrent protection device, and wherein the engine defeat system is configured to replace the communication overcurrent protection device.
153. The system of embodiment 1, further comprising a control system comprising at least one processor configured to provide instructions to the system.
154. The system of embodiment 153, wherein the vehicle comprises an electrical system, and wherein the control system comprises a DC-to-DC converter configured to transmit power from the at least one energy storage device to the vehicle's electrical system.
155. The system of embodiment 153, wherein the control system comprises a charger configured to supply energy to the at least one energy storage device from an external source.
156. The system of embodiment 153, wherein the vehicle comprises a brake vacuum system, and wherein the control system comprises a vacuum pump configured to maintain vacuum in the brake vacuum system.
157. The system of embodiment 153, wherein the vehicle comprises a hydraulic steering system, and wherein the control system comprises a hydraulic pump configured to supply hydraulic fluid to the hydraulic steering system.
158. The system of embodiment 153, wherein the vehicle comprises a transmission lubrication system, and wherein the control system comprises a lubrication pump configured to deliver lubricant to the transmission lubrication system.
159. The system of embodiment 153, wherein the vehicle comprises a brake pedal, and wherein the control system comprises at least one brake light configured to illuminate when the brake pedal is depressed.
160. The system of embodiment 153, wherein the control system comprises at least one brake light configured to illuminate when the at least one power conversion device provides a decelerative force on the vehicle.
161. The system of embodiment 153, wherein the control system comprises a user interface configured to accept input from a user and provide information to the user.
162. The system of embodiment 153, wherein the control system comprises a stop interface configured to be engaged by a user and configured to interrupt delivery of power from the energy storage device when engaged by the user.
163. The system of embodiment 153, wherein the control system comprises a system controller configured to communicate with and control the control system.
164. The system of embodiment 153, wherein the control system comprises at least one electrical switching device configured to regulate power flow to the control system.
165. The system of embodiment 164, wherein the at least one electrical switching device comprises at least one relay.
166. The system of embodiment 1, further comprising:
a trailer frame configured to carry the at least one energy storage device;
at least one wheel connected to the trailer frame;
a steering mechanism configured to exert a steering torque on the at least one wheel, and configured to align the direction of rotation of the at least one wheel with the direction of travel of the at least one wheel;
wherein the trailer frame is configured to connect to the vehicle and configured to minimize relative yaw between the vehicle and the trailer frame.
167. The system of embodiment 1, further comprising a trailer, wherein the trailer includes the at least one energy storage device and is configured to be connected to the vehicle.
168. The system of embodiment 1, wherein the vehicle comprises a rear frame section, the system further comprising a rear unit comprising the at least one energy storage device and configured to connect to the rear frame section.
169. The system of embodiment 168, wherein the vehicle comprises a trailer hitch receiver connected to the rear frame section, wherein the rear unit is configured to connect to the trailer hitch receiver.
170. The system of embodiment 168, wherein the vehicle comprises a pickup truck bed, wherein the rear unit is configured to reside in the pickup truck bed.
171. The system of embodiment 1, further comprising an inverter configured to receive electrical power from the at least one energy storage device and provide electrical power to one or more external loads.
172. The system of embodiment 171, wherein the electrical power received by the inverter is direct current and the electrical power provided by the inverter is alternating current.
173. The system of embodiment 171, further comprising a bi-directional charger configured to receive electrical power from an external source and provide electrical power to the at least one energy storage device.
174. The system of embodiment 173, wherein the bi-directional charger comprises the inverter.
175. A system comprising:
at least one energy storage device configured to store power for a vehicle having a front differential pinion and a frame;
at least one power conversion device;
a power conversion controller configured to regulate power flow between the at least one energy storage device and the at least one power conversion device;
an input device configured to receive input from a user and configured to translate the input into instructions for the power conversion controller; and
a drivetrain configured to transmit power between the at least one power conversion device and the vehicle's front differential pinion and configured to connect to the vehicle's frame.
176. The system of embodiment 175, wherein the vehicle further comprises a driveshaft having a forward portion and a rearward portion and wherein the drivetrain comprises:
a coaxial drive unit comprising the at least one power conversion device and a housing, the coaxial drive unit configured to be installed between the forward portion and rearward portion of the vehicle's driveshaft such that the coaxial drive unit is parallel to and aligned with the forward and rearward portion of the driveshaft; and
an anti-rotation linkage configured to minimize rotation of the housing of the coaxial drive unit, wherein the anti-rotation linkage is in communication with the vehicle's frame.
177. A system comprising:
at least one energy storage device configured to store power for a vehicle having one or more wheels;
at least one swing arm, wherein the at least one swing arm comprises at least one power conversion device configured to transmit power between the one or more wheels and the at least one energy storage device;
at least one power conversion controller configured to regulate power flow between the at least one energy storage device and the at least one power conversion device; and
an input device configured to receive input from a user and configured to translate the input into instructions for the power conversion controller.
178. The system of embodiment 177, wherein the at least one swing arm comprises a transmission configured to increase the torque output of the at least one power conversion device.
179. The system of embodiment 178, wherein the at least one swing arm comprises a clutch configured to transmit power between the at least one swing arm and at least one wheel when in a first state and configured to interrupt power transmission between the at least one swing arm and at least one wheel when in a second state.
180. The system of embodiment 177, wherein the at least one power conversion device is oriented in a longitudinal orientation.
181. The system of embodiment 178, wherein the transmission comprises at least one chain and a plurality of chain sprockets.
182. The system of embodiment 178, wherein the transmission comprises at least one belt and a plurality of belt pulleys.
183. The system of embodiment 178, wherein the transmission comprises a plurality of gears.
184. The system of embodiment 177, wherein the at least one power conversion device is an electric motor
185. The system of embodiment 177, wherein the at least one power conversion device is an axial flux motor.
186. The system of embodiment 179, wherein the clutch comprises:
an output shaft with an input portion and an output portion; and
a sliding clutch configured to transmit power between the input portion and the output portion of the output shaft, wherein the input portion is configured to transmit power between the at least one power conversion device and the sliding clutch, and wherein the output portion is configured to transmit power between the sliding clutch and the one or more vehicle wheels.
187. The system of embodiment 186, wherein the at least one power conversion device is configured to match the rotational velocity of the input portion to the output portion when the clutch transitions to a different state.
188. A system comprising:
at least one energy storage device configured to store power for a vehicle having one or more wheels;
at least one power conversion device;
at least one swing arm, wherein the at least one swing arm is configured to transmit power between the one or more wheels and the at least one energy storage device;
at least one power conversion controller configured to regulate power flow between the at least one energy storage device and the at least one power conversion device;
an input device configured to receive input from a user and configured to translate the input into instructions for the power conversion controller, and one or more clutches configured to transmit power between the at least one swing arm and at least one wheel when in a first position and configured to interrupt power transmission between the at least one swing arm and at least one wheel when in a second position.
189. The system of embodiment 188, wherein a single clutch is paired with a single swing arm and a single wheel.
190. A system comprising:
at least one energy storage device configured to store power for a vehicle having one or more wheels;
at least one power conversion device;
at least one swing arm, wherein the at least one swing arm is configured to transmit power between the one or more wheels and the at least one energy storage device;
at least one power conversion controller configured to regulate power flow between the at least one energy storage device and the at least one power conversion device;
an input device configured to receive input from a user and configured to translate the input into instructions for the power conversion controller;
a drive-side coupling configured transmit power between the at least one swing arm and a wheel-side coupling, the drive-side coupling comprising at least one attachment mechanism located thereon; and
a wheel-side coupling configured to transmit power between the drive-side coupling and a vehicle wheel, the wheel-side coupling comprising at least one attachment mechanism located thereon.
191. The system of embodiment 190, wherein the drive-side coupling and wheel-side coupling are configured to be disconnected by a user.
192. The system of embodiment 190, wherein wheel-side attachment mechanism comprises a lug nut plate configured to attach a coupling plate to one or more lug nuts, wherein the coupling plate is configured to be connected to the drive-side coupling and the lug nut is configured to attach a wheel to the vehicle.
193. The system of embodiment 190, wherein the wheel-side attachment mechanism comprises one or more engagement features configured to be connected to the drive-side coupling, the one or more engagement features being located proximate to an outer edge of the wheel-side coupling.
194. The system of embodiment 190, wherein the wheel-side attachment mechanism comprises a coupling plate configured to transmit power between the swing arm the wheel-side coupling.
195. The system of embodiment 194, wherein the drive-side attachment mechanism comprises a retention mechanism configured to prevent separation of drive-side coupling from wheel-side coupling when in a first state and configured to allow separation and connection of drive-side coupling from wheel-side coupling when in a second state.
196. The system of embodiment 195, wherein the retention mechanism comprises a retention ring configured to prevent separation of drive-side coupling from wheel-side coupling when in a first position, and to allow separation and connection of drive-side coupling from wheel-side coupling when in a second position, wherein the retention ring is rotatingly connected the coupling plate.
197. The system of embodiment 196, wherein the wheel-side attachment mechanism comprises a locking mechanism configured to prevent movement of retention ring between the first position and the second position.
198. The system of embodiment 197, wherein the locking mechanism comprises a lock ring configured to prevent movement of retention ring from the first position to the second position when lock ring is in a first position, the lock ring being rotatingly connected to the retention ring.
199. The system of embodiment 198, wherein the lock ring is configured to allow movement of the retention ring between the first position and the second position when the lock ring is in the second position.
200. The system of embodiment 198, wherein the lock ring is configured to allow movement of the retention ring between the first position and the second position when the lock ring is in a third position.
201. The system of embodiment 196, wherein the retention ring comprises one or more protrusions configured to be engaged by the user when rotating the retention ring between the first and second positions.
202. The system of embodiment 198, wherein the lock ring comprises one or more protrusions configured to be engaged by the user when rotating the lock ring between the first and second positions.
203. The system of embodiment 202, wherein the protrusions of the lock ring are configured to be rotated by the user simultaneously with rotation of the protrusions of the engagement ring by the user.
204. The system of embodiment 195, wherein the drive-side attachment mechanism comprises at least one lock configured to engage with the wheel-side coupling when in a first position and configured to disengage from the wheel-side coupling when in a second position.
205. The system of embodiment 195, wherein the at least one lock is connected to a shaft and is configured to be moved between the first position and the second position when the shaft is rotated by the user.
206. The system of embodiment 205, wherein the shaft is configured to pass through the swing arm and includes an outer end configured to be engaged by the user.
207. The system of embodiment 205, wherein the shaft comprises at least one cam feature configured to engage with the at least one lock, wherein the cam feature is configured to move the at least one lock between the first and second positions when the shaft is rotated.
208. The system of embodiment 192, wherein the wheel-side coupling comprises at least one spacer configured to position the wheel-side coupling further from the vehicle wheel.
209. The system of embodiment 190, wherein the wheel-side coupling comprises alignment features and wherein the drive-side coupling comprises alignment features configured to align the attachment mechanism of the drive-side coupling with the attachment mechanism of the wheel-side coupling during engagement of the swing arm to the wheel-side coupling.
210. The system of 190, wherein the input device comprises a throttle pedal.
211. The system of embodiment 190, further comprising a climate control system including at least one thermal exchanger, wherein the thermal exchanger is configured to exchange thermal energy with a surrounding fluid.
212. The system of embodiment 190, wherein the vehicle comprises an engine, the system comprising an engine defeat system configured to prevent the vehicle's engine from starting.
213. The system of embodiment 190, further comprising a control system comprising at least on processor configured to provide instructions to the system.
214. The system of embodiment 190, further comprising:
a trailer frame configured to carry the energy storage device;
at least one wheel connected to the trailer frame;
a steering mechanism configured to exert a steering torque on the at least one wheel, and configured to align the direction of rotation of the at least one wheel with the direction of travel of the at least one wheel;
wherein the trailer frame is configured to connect to the vehicle and configured to minimize relative yaw between the vehicle and the trailer frame.
215. The system of embodiment 190, further comprising a trailer, wherein the trailer includes the at least one energy storage device and is configured to be connected to the vehicle.
216. The system of embodiment 190, wherein the vehicle comprises a rear frame section, the system further comprising a rear unit comprising the at least one energy storage device and configured to connect to the rear frame section.
217. The system of embodiment 216, wherein the vehicle comprises a trailer hitch receiver connected to the rear frame section, wherein the rear unit is configured to connect to the trailer hitch receiver.
218. The system of embodiment 216, wherein the vehicle comprises a pickup truck bed, wherein the rear unit is configured to reside in the pickup truck bed.
219. A system comprising:
at least one energy storage device configured to store power for a vehicle having one or more wheels;
a left swing arm and a right swing arm configured to transmit power between the one or more wheels and a power conversion device;
a rear drive comprising a power conversion device, the power conversion device being configured to transmit power between the at least one energy storage device and a differential;
a differential configured to divide power flow between the left swing arm and right swing arm;
at least one power conversion controller configured to regulate power flow between the at least one energy storage device and the power conversion device; and
an input device configured to receive input from a user and configured to translate the input into instructions for the power conversion controller,
wherein the power conversion device and differential are parallel to and aligned with each other.
220. The system of embodiment 219, wherein the power conversion device comprises a shaft, wherein the shaft is at least partially hollow.
221. The system of embodiment 220, wherein the rear unit comprises at least one axle configured to transmit power from the differential to a swing arm, wherein the at least one axle is configured to be positioned at least partially inside the shaft of the power conversion device.
222. The system of embodiment 221, wherein the rear unit comprises a left axle and a right axle, wherein the left axle and the right axle are configured to transmit power from the differential to the left swing arm and right swing arm, respectively.
223. The system of embodiment 222, wherein the left axle and right axle are extensible.
224. The system of embodiment 219, wherein the rear unit comprises a transmission configured to increase torque output of the energy conversion device.
225. The system of embodiment 224, wherein the transmission comprises an epicyclic gear set.
226. A system comprising:
at least one energy storage device configured to store power for a vehicle having at least one rear axle;
at least one wheel configured to be substantially aligned with the rear axle of the vehicle and configured to provide traction against a ground surface;
at least one power conversion device configured to transmit power between the at least one wheel and the at least one energy storage device;
at least one power conversion controller configured to regulate power flow between the at least one energy storage device and the at least one power conversion device; and
an input device configured to receive input from a user and configured to translate the input into instructions for the power conversion controller.
227. The system of embodiment 226, further comprising a supplemental suspension configured to increase the force between the at least one wheel and a ground surface, and to allow substantially vertical translations of the at least one wheel, wherein the at least one wheel comprises a rim and a cavity within the rim.
228. The system of embodiment 227, wherein the supplemental suspension system exerts a nominal force against the ground surface and the supplemental suspension system is configured to allow a user to adjust the magnitude of the nominal force.
229. The system of embodiment 227, wherein the vehicle comprises a rear frame section, the system further comprising a rear chassis configured to be connected to the rear frame section.
230. The system of embodiment 229, comprising at least one swing arm configured to connect the at least one wheel to the rear chassis.
231. The system of embodiment 230, comprising a left swing arm, a right swing arm, and a beam, the beam being configured to connect the left swing arm to the right swing arm.
232. The system of embodiment 231, wherein the beam is configured to transmit transverse forces between the left swing arm and the right swing arm.
233. The system of embodiment 231, further comprising a suspension arm configured to connect to the beam and the rear chassis and to transmit force from the supplemental suspension system to the beam.
234. The system of embodiment 233, wherein the suspension arm is extensible.
235. The system of embodiment 230, wherein the swing arm is extensible.
236. The system of embodiment 233, wherein the beam is configured to be connected to the suspension arm with the suspension arm oriented in a plurality of pitch angles.
237. The system of embodiment 229, wherein the vehicle comprises a trailer hitch receiver, wherein the rear chassis is configured to be connected to the trailer hitch receiver.
238. The system of embodiment 237 wherein the rear chassis comprises the at least one energy storage device.
239. The system of 230, wherein the at least one swing arm is rotatingly connected to the rear chassis.
240. The system of embodiment 239, wherein the at least one swing arm is configured to transmit force from the supplemental suspension system to the at least one wheel.
241. The system of embodiment 240, wherein the supplemental suspension system is configured to be connected to the swing arm with the swing arm oriented in a plurality of pitch angles.
242. The system of embodiment 230, wherein the vehicle comprises a centerline, wherein the at least one swing arm is configured to be positionable at a plurality of distances from the vehicle centerline.
243. The system of embodiment 229, wherein the rear chassis is configured to be connected to the vehicle frame at a plurality of vertical positions.
244. The system of embodiment 230, further comprising at least one wheel-side coupling configured connect to the at least one vehicle wheel and to transmit transverse forces between the at least one vehicle wheel and the at least one system wheel.
245. The system of embodiment 244, wherein the at least one wheel-side coupling comprises a roller configured to engage with the at least one system wheel at a plurality of vertical and longitudinal positions and to transmit transverse forces between the at least one system wheel and the at least one wheel-side coupling.
246. The system of embodiment 245, wherein the at least one system wheel comprises a cover, wherein the cover comprises at least one smooth surface configured to engage with the roller.
247. The system of embodiment 246, wherein the roller comprises a spherical ball configured to roll transversely and vertically against the cover.
248. The system of embodiment 229, wherein the swing arm comprises a transmission configured to increase the torque output of the at least one power conversion device and transmit power between the at least one power conversion device and the at least one system wheel.
249. The system of embodiment 229, wherein the at least one swing arm comprises at least one power conversion device.
250. The system of embodiment 229, wherein the at least one swing arm comprises a clutch configured to transmit power between the at least one power conversion device and the at least one system wheel when in a first state, and to interrupt transmission of power between the at least one power conversion device and the at least one system wheel when in a second state.
251. The system of embodiment 248, wherein the transmission comprises at least one chain and a plurality of chain sprockets.
252. The system of embodiment 248, wherein the transmission comprises at least one belt and a plurality of belt pulleys.
253. The system of embodiment 248, wherein the transmission comprises a plurality of gears.
254. The system of embodiment 248, wherein the transmission comprises an epicyclic gear set.
255. The system of embodiment 249, wherein the at least one power conversion device is an electric motor.
256. The system of embodiment 249, wherein the at least one power conversion device in an axial flux motor.
257. The system of embodiment 249, wherein the at least one power conversion device is oriented transversely.
258. The system of embodiment 250, wherein the clutch is parallel to and aligned with the at least one system wheel.
259. The system of embodiment 250, wherein the clutch is at least partially inside the cavity.
260. The system of embodiment 249, wherein the at least one power conversion device is at least partially inside the cavity.
261. The system of embodiment 248, wherein the transmission is least partially inside the cavity.
262. The system of embodiment 244, wherein the wheel-side coupling comprises a linear bearing configured to:
engage with the at least one system wheel;
transmit transverse forces between the at least one vehicle wheel and the at least one system wheel; and
provide vertical translation of the at least one system wheel with respect to the at least one vehicle wheel.
263. The system of embodiment 262, wherein the wheel-side coupling comprises a bearing configured to enable the at least one vehicle wheel to rotate with respect to the linear bearing and to transmit transverse forces between the wheel-side coupling and the linear bearing.
264. The system of embodiment 230, wherein the rear chassis comprises the at least one power conversion device and the at least one swing arm comprises a transmission, wherein the transmission is configured to transmit power between the at least one power conversion device and the system wheel.
265. The system of embodiment 264, wherein the rear chassis comprises at least one transmission configured to increase the torque output of the at least one power conversion device.
266. The system of embodiment 226, wherein the vehicle comprises a pickup truck bed, wherein the at least one energy storage device is configured to be positioned in the pickup truck bed.
267. The system of embodiment 226, wherein the input device comprises a throttle pedal.
268. The system of embodiment 226, further comprising a climate control system including at least one thermal exchanger, wherein the thermal exchanger is configured to exchange thermal energy with a surrounding fluid.
269. The system of embodiment 226, wherein the vehicle comprises an engine, the system comprising an engine defeat system configured to prevent the vehicle's engine from starting.
270. The system of embodiment 226, further comprising a control system comprising at least one processor configured to provide instructions to the system.
271. A system comprising:
a power source configured to provide electrical energy to a vehicle having a traction battery;
at least one sensor configured to take a current measurement at the vehicle's traction battery and configured to communicate the current measurement to a controller, wherein the controller is configured to vary the electrical energy provided by the power source.
272. The system of embodiment 271, wherein the current measurement includes the magnitude and direction of current at the vehicle's traction battery.
273. The system of embodiment 271, wherein the vehicle comprises a traction motor and a motor controller, wherein the power source is configured to deliver electrical between the vehicle's traction batter and the vehicle's motor controller.
274. The system of embodiment 271, wherein the traction battery comprises a state of charge, wherein the controller is configured to maintain the state of charge of the traction battery.
275. The system of embodiment 271, further comprising a user interface configured to communicate with a user and configured to command a rate of energy provided to the traction battery.
276. The system of embodiment 271, further comprising a power buffer configured to increase the power deliverable to the vehicle for transient power demands.
277. The system of embodiment 271, wherein the power source comprises and engine and an electrical generator, wherein the engine is configured to combust a fuel and configured to provide rotational power to the electrical generator.
278. The system of embodiment 271, wherein the power source comprises a fuel cell configured to produce electricity from a fuel and an oxidizer.
279. The system of embodiment 271, wherein the power source comprises at least one battery.
280. The system of embodiment 276, wherein the power buffer comprises a capacitor.
281. The system of embodiment 276, wherein the power buffer comprises a battery.
282. The system of embodiment 271, wherein the system is configured to provide electrical power to one or more external loads.
283. The system of embodiment 282, wherein the electrical power provided by the system is alternating current.
284. The system of embodiment 282, further comprising an inverted configured to provide alternating current for one or more external loads.
285. A system comprising:
a trailer frame configured to carry a load for a vehicle;
at least one wheel connected to the trailer frame; and
a steering mechanism configured to exert a steering torque on the at least one wheel, and configured to align the direction of rotation of the at least one wheel with the direction of travel of the at least one wheel;
wherein the trailer frame is configured to connect to the vehicle and configured to minimize relative yaw between the vehicle and the trailer frame.
286. The system of embodiment 285, further comprising an actuator configured to exert a steering torque on the at least one wheel.
287. The system of embodiment 286, wherein the actuator is configured to provide a steering angle to the at least one wheel.
288. The system of embodiment 287, further comprising a left wheel speed sensor and a right wheel speed sensor configured to measure the rotational speed of the left and right wheel respectively, wherein the steering mechanism is configured to determine the steering angle using the measurements of the left wheel and right wheel rotational speed.
289. The system of embodiment 287, further comprising a caster wheel and a caster wheel angle sensor configured to measure the steering angle of the caster wheel, wherein the steering mechanism is configured to determine the steering angle using the measurement of the caster wheel steering angle as an input.
290. The system of embodiment 286, wherein the at least one wheel is a caster wheel and the steering mechanism is configured to exert a steering torque opposing at least a portion of the steering torque exerted by a ground surface on the at least one wheel.
291. The system of embodiment 290, further comprising an actuator configured to exert steering torque on the at least one caster wheel and to allow the at least one caster wheel to rotate through a steering angle of 360 degrees.
292. The system of embodiment 291, wherein the steering mechanism comprises at least one belt and a plurality of pulleys configured to exert steering torque on the at least one caster wheel.
293. The system of embodiment 291, wherein the steering mechanism comprises at least one chain and a plurality of chain sprockets configured to exert steering torque on the at least one caster wheel.
294. The system of embodiment 291, wherein the actuator comprises an electric motor.
295. The system of embodiment 291, wherein the steering mechanism comprises a transmission configured to increase the torque output of the actuator.
296. The system of embodiment 295, wherein the transmission comprises a plurality of gears.
297. The system of embodiment 290, wherein the steering mechanism comprises at least one accelerometer configured to measure transverse acceleration, wherein the steering mechanism is configured to determine the steering torque using the transverse acceleration as an input.
298. The system of embodiment 290, wherein the steering mechanism comprises a damping device configured to reduce unstable oscillations of the at least one caster wheel.
299. The system of embodiment 285, wherein the at least one wheel is at least one caster wheel, the system further comprising a counterweight in communication with the at least one caster wheel and configured to exert the steering torque on the at least one caster wheel.
300. The system of embodiment 299, wherein the counterweight is slidingly connected to the trailer frame and configured to translate transversely.
301. The system of embodiment 299, wherein the at least one caster wheel comprises a steering arm, wherein the steering mechanism comprises at least one connection member configured to connect the counterweight to the caster wheel steering arm.
302. The system of embodiment 301, wherein the steering mechanism is configured to allow the at least one caster wheel to rotate through 360 degrees of a steering angle.
303. The system of embodiment 301, wherein the at least one caster wheel comprises a wheel axis and a kingpin, wherein:
the kingpin is configured to allow the at least one caster wheel to rotate through a steering angle;
the kingpin is slidingly connected to the at least one caster wheel;
the kingpin can slide between a first position ahead of the wheel axis and a second position behind the wheel axis; and
the steering arm is connected to the kingpin.
304. The system of embodiment 303, wherein the steering mechanism comprises a brake mechanism configured to prevent forward rotation of the at least one caster wheel about the wheel axis when the kingpin is not in the first position and configured to prevent rearward rotation when the kingpin is not in the second position.
305. The system of embodiment 304, wherein the at least one caster wheel comprises a detent mechanism configured to provide a retaining force to bias the kingpin towards remaining in the first position when in the first position and to bias the kingpin towards remaining in the second position when in the second position.
306. The system of embodiment 304, wherein the brake mechanism comprises a first roller configured to engage with the at least one caster wheel when the kingpin is not in the first position, and wherein the roller comprises a one-way clutch configured to prevent forward rotation of the at least one caster wheel.
307. The system of embodiment 304, wherein the brake mechanism comprises a second roller configured to engage with the at least one caster wheel when the kingpin is not in the second position, and wherein the roller comprises a one-way clutch configured to prevent rearward rotation of the at least one caster wheel.
308. The system of embodiment 303, wherein the steering mechanism comprises at least one or more stops configured to limit the steering angle of the at least one caster wheel.
309. The system of embodiment 285, wherein the at least one wheel comprises a kingpin configured to allow the at least one wheel to rotate through a steering angle, the system further comprising a suspension system comprising at least one resilient member, configured to allow vertical translation of the at least one wheel and to support a least a portion of mass of the system.
310. The system of embodiment 309, wherein the kingpin is configured to:
connect to the trailer frame, wherein the trailer frame includes at least one bearing configured to support the kingpin;
translate vertically; and
rotate through the steering angle.
311. The system of embodiment 309, wherein the suspension system comprises a subframe connected to the trailer frame by the at least one resilient member, and the kingpin is connected to the subframe.
312. The system of embodiment 314, wherein the at least one resilient member comprises at least one leaf spring.
313. The system of embodiment 312, wherein the at least one leaf spring is oriented transversely.
314. The system of embodiment 309, wherein the suspension system further comprises a knuckle, a control arm, and a strut, wherein:
the control arm is rotatingly connected to the trailer frame;
the knuckle is rotatingly connected to the control arm;
the strut is connected to the knuckle and configured to exert a substantially downward force on the knuckle;
the trailer frame is connected to the strut; and
the kingpin is rotatingly connected to the knuckle.
315. The system of embodiment 314, further comprising a steering mechanism, wherein the steering mechanism includes:
a counterweight slidingly connected to the trailer frame and configured to exert a steering torque on the at least one wheel;
a steering arm connected to the kingpin; and
a connection member connecting the counterweight to the steering arm, wherein the steering mechanism is configured to allow the at least one wheel to rotate through at least 360 degrees of steering angle.
316. The system of embodiment 285, further comprising at least one damper configured to dissipate kinetic energy from vertical motion of the at least one wheel.
317. The system of embodiment 299, wherein the counterweight comprises a pivot and is rotatingly connected to the trailer frame at the pivot, the pivot being located proximate to the front of the trailer.
318. The system of embodiment 317, wherein the trailer frame comprises a rear frame section, and wherein the counterweight comprises at least one bearing configured to:
engage the rear frame section;
allow rotation of the counterweight; and
support a portion of the counterweight's weight.
319. The system of embodiment 285, wherein the vehicle comprises a hitch receiver, wherein the trailer frame comprises a hitch interface configured to connect to the hitch receiver and configured to minimize relative yaw between the trailer frame and the vehicle.
320. The system of embodiment 319, wherein the hitch interface is configured to minimize relative pitch between the trailer frame and the vehicle.
321. The system of embodiment 319, wherein the hitch interface is configured to allow relative pitch between the trailer frame and the vehicle.
322. The system of embodiment 319, wherein the hitch interface is configured to minimize relative roll between the trailer frame and the vehicle.
323. The system of embodiment 319, wherein the hitch interface is configured to allow relative roll between the trailer frame and the vehicle.
324. The system of embodiment 319, wherein the hitch interface is configured to minimize relative vertical translation between the trailer frame and the vehicle.
325. The system of embodiment 319, wherein the hitch interface is configured to allow relative vertical translation between the trailer frame and the vehicle.
326. The system of embodiment 319, wherein the hitch interface is configured to connect the trailer frame to the vehicle in a plurality of vertical locations.
327. The system of embodiment 325, wherein the hitch interface comprises at least one linear bearing configured to allow relative vertical translation between the trailer frame and the vehicle.
328. The system of embodiment 325, wherein the hitch interface comprises a four-bar mechanism configured to allow relative vertical translation between the trailer frame and the vehicle.
329. The system of embodiment 285, further comprising a separation mechanism configured to allow space between the trailer frame and the vehicle while the trailing frame is connected to the vehicle.
330. The system of embodiment 329, wherein the separation mechanism comprises at least one arm configured to connect the trailer frame to the vehicle.
331. The system of embodiment 329, wherein the separation mechanism comprises at least one alignment feature configured to align the trailer frame to the vehicle.
332. The system of embodiment 329, wherein the separation mechanism comprises at least one lock feature configured to prevent separation of the trailer frame from the vehicle.
333. A system comprising:
a rear anchor configured to connect to a rear frame section of a vehicle;
at least one resilient member configured to exert a substantially upward force on the rear anchor; and
a preload adjustment mechanism configured to enable a user to adjust the upward force exerted by the resilient member on the rear anchor.
334. The system of embodiment 333, wherein the resilient member comprises a spring.
335. The system of embodiment 333, wherein the vehicle comprises at least one wheel, the system further comprising at least one swing arm configured to:
connect to the rear anchor;
connect to at least one wheel of the vehicle; and
transmit the force exerted by the resilient member to the at least one wheel.
336. The system of embodiment 335, wherein the at least one swing arm is extensible.
337. The system of embodiment 335, wherein the at least one swing arm is configured to be positioned at a plurality of transverse positions.
338. The system of embodiment 335, further comprising at least one wheel-side coupling configured to be connected to the vehicle wheel and to connect the at least one swing arm to the at least one wheel.
339. The system of embodiment 338, wherein the at least one swing arm comprises a drive-side coupling configured to connect the swing arm to the wheel-side coupling.
340. The system of embodiment 339, wherein the drive-side coupling comprises a spindle configured to connect the drive-side coupling to the wheel-side coupling and configured to allow rotation of the wheel relative to the swing arm.
341. The system of embodiment 340, wherein the drive-side coupling comprises an engagement member configured to connect the spindle to the wheel-side coupling and to release the spindle from the wheel-side coupling.
342. The system of embodiment 341, wherein the drive-side coupling comprises a lock configured to prevent the engagement member from releasing the spindle from the wheel-side coupling.
343. The system of embodiment 339, wherein the drive-side coupling comprises at least one spacer configured to position the drive-side coupling at a plurality of transverse positions relative to wheel-side coupling.
344. The system of embodiment 333, comprising at least one swing arm and at least one wheel connected to the at least one swing arm, wherein the swing arm is configured to transmit force from the at least one resilient member to the at least one wheel, and the at least one wheel is configured to transmit force from the at least one swing arm to a ground surface.
345. The system of embodiment 344, wherein the vehicle comprises at least one wheel, and wherein the at least one swing arm is configured to connect to the at least one vehicle wheel.
346. The system of embodiment 345, the system further comprising a bearing configured to connect the at least one swing arm to the at least one wheel and configured to allow rotation of the at least one wheel relative to the swing arm.
347. The system of embodiment 345, further comprising a linear bearing configured to connect the at least one swing arm to the at least one wheel and configured to allow vertical translation of the at least one swing arm relative to the at least one vehicle wheel.
348. The system of embodiment 335, wherein the at least one swing arm is rotatingly connected to the rear anchor.
349. The system of embodiment 348, wherein the rear anchor comprises the at least one resilient member and at least one spring perch, and wherein the at least one resilient member is configured to exert a downward torque on the at least one swing arm and a counter torque on the at least one spring perch.
350. The system of embodiment 349, wherein the at least one spring perch is configured to be positionable at a plurality of positions, and wherein each position exerts a different torque on the at least one swing arm.
351. The system of embodiment 350, wherein the rear anchor comprises a lock configured to:
prevent movement of the spring perch when in a first position;
allow movement of the spring perch when in a second position;
be moved from the first position to the second position by a user; and
return to the first position when not acted upon by the user.
352. The system of embodiment 350, comprising a spring perch adjustment mechanism, a left swing arm and a right swing arm, wherein the spring perch adjustment mechanism is configured to adjust the torque on the left swing arm and the right swing arm.
353. The system of embodiment 333, wherein the vehicle comprises at least one axle tube, the system comprising a rear arm configured to transmit force from the at least one resilient member to the at least one axle tube.
354. The system of embodiment 353, comprising an axle clamp assembly configured to connect to the at least one axle clamp and the rear arm.
355. The system of embodiment 354. wherein the axle clamp assembly comprises at least one axle clamp configured to connect to the at least one axle tube in a plurality of locations.
356. The system of embodiment 355. wherein the axle clamp assembly comprises at least one transverse bar configured to connect to the at least one axle clamp and the rear arm.
357. The system of embodiment 353, wherein the rear arm is extensible.
358. The system of embodiment 353, further comprising a spring perch configured to engage with the at least one resilient member and configured to adjust a nominal force exerted by the at least one resilient member.
359. The system of embodiment 353, wherein the rear arm is configured to allow relative roll of the at least one axle tube and the rear anchor.
360. The system of embodiment 353, wherein the rear arm is configured to allow relative longitudinal translations between the at least one axle tube and the rear anchor.
361. The system of embodiment 333, further comprising at least one damper configured to dissipate kinetic energy from the system.
362. A system for connecting at least one auxiliary component to a vehicle having at least one axle tube, the system comprising:
at least one axle clamp; and
at least one transverse bar configured to connect to the at least one axle clamp,
wherein the axle clamp is configured to connect to the at least one axle tube of the vehicle in a plurality of locations.
363. The system of embodiment 362, further comprising a forward transverse bar and a rearward transverse bar, wherein the at least one axle clamp includes a forward arm configured to connect to the forward transverse bar and a rearward arm configured to connect to the rearward transverse bar.
364. The system of embodiment 363, wherein the forward arm and the rearward arm each have a pitch angle and wherein the forward arm and rearward arm are configured to have their pitch angles adjusted independently by a user.
365. The system of embodiment 363, where in the forward arm and the rearward arm are configured to be positioned at different transverse locations from each other.
366. The system of embodiment 362, wherein the at least one axle clamp is configured to position the at least one transverse bar at a plurality of longitudinal positions.
367. The system of embodiment 362, wherein the vehicle comprises a differential housing with a forward end, the system further comprising a member configured to engage with the forward end and configured to minimize pitch of the system.
368. A system comprising:
an inboard portion configured to connect to a vehicle having at least one axle that is split into an inboard end and an outboard end, wherein the inboard portion is connected to the inboard end of the axle;
an outboard portion configured to connect to the outboard end of the vehicle's axle;
at least one bearing configured to align the inboard portion and the outboard portion and configured to allow relative rotation of the inboard portion and the outboard portion; and
a sliding clutch configured to transmit torque between the inboard portion and the outboard portion when in a first position and configured to interrupt torque when in a second position.
369. The system of embodiment 368, comprising an actuator configured to move the sliding clutch between the first position and the second position.
370. The system of embodiment 369, comprising a slip ring configured to deliver electrical power to the actuator and configured to allow the actuator to rotate.
371. The system of embodiment 368, wherein the sliding clutch comprises internal splines, the inboard portion comprises external splines, and the outboard portion comprises external splines, wherein the sliding clutch internal splines are configured to engage with the outboard portion external splines and the inboard portion external splines.
372. The system of embodiment 368 further comprising:
at least one inner sleeve;
at least one inner conical interface;
at least one outer sleeve; and
at least one outer conical interface,
wherein the at least one inner sleeve is configured to be inserted into the at least one outer sleeve, and the at least one inner conical interface is configured to engage the axle and the at least one outer conical interface when the inner sleeve is inserted into the outer sleeve.
373. The system of embodiment 369, comprising a spring configured to:
engage the actuator and the sliding clutch;
store energy from the actuator; and
move the sliding clutch between the first position and second position when the force required to move the sliding clutch is less than the force exerted by the spring.
374. The system of embodiment 368, wherein the sliding clutch is configured to be moved between the first position and the second position by a user.
375. The system of embodiment 374, comprising a detent mechanism configured to provide a retaining force to bias the sliding clutch towards remaining in the first position when in the first position and to bias the sliding clutch towards remaining in the second position when in the second position.
376. The system of embodiment 374, comprising a lock mechanism configured to:
retain the sliding clutch in the first position;
retain the sliding clutch in the second position;
allow movement of sliding clutch when engaged by a user.

1. A system comprising:
at least one energy storage device configured to store power for a vehicle having at least one differential pinion and at least one axle tube;
at least one power conversion device;
at least one power conversion controller configured to regulate power flow between the at least one energy storage device and the at least one power conversion device;
an input device configured to receive input from a user and configured to translate the input into instructions for the power conversion controller; and
a drivetrain configured to transmit power between the at least one power conversion device and the vehicle's at least one differential pinion and configured to connect to the vehicle's axle tube.

2. A system comprising:
at least one energy storage device configured to store power for a vehicle having a front differential pinion and a frame;
at least one power conversion device;
a power conversion controller configured to regulate power flow between the at least one energy storage device and the at least one power conversion device;
an input device configured to receive input from a user and configured to translate the input into instructions for the power conversion controller; and
a drivetrain configured to transmit power between the at least one power conversion device and the vehicle's front differential pinion and configured to connect to the vehicle's frame.

3. A system comprising:
at least one energy storage device configured to store power for a vehicle having one or more wheels;
at least one swing arm, wherein the at least one swing arm comprises at least one power conversion device configured to transmit power between the one or more wheels and the at least one energy storage device;
at least one power conversion controller configured to regulate power flow between the at least one energy storage device and the at least one power conversion device; and
an input device configured to receive input from a user and configured to translate the input into instructions for the power conversion controller.

4. A system comprising:
at least one energy storage device configured to store power for a vehicle having one or more wheels;
at least one power conversion device;
at least one swing arm, wherein the at least one swing arm is configured to transmit power between the one or more wheels and the at least one energy storage device;
at least one power conversion controller configured to regulate power flow between the at least one energy storage device and the at least one power conversion device;
an input device configured to receive input from a user and configured to translate the input into instructions for the power conversion controller, and
one or more clutches configured to transmit power between the at least one swing arm and at least one wheel when in a first position and configured to interrupt power transmission between the at least one swing arm and at least one wheel when in a second position.

5. A system comprising:
at least one energy storage device configured to store power for a vehicle having one or more wheels;
at least one power conversion device;
at least one swing arm, wherein the at least one swing arm is configured to transmit power between the one or more wheels and the at least one energy storage device;
at least one power conversion controller configured to regulate power flow between the at least one energy storage device and the at least one power conversion device;
an input device configured to receive input from a user and configured to translate the input into instructions for the power conversion controller;
a drive-side coupling configured transmit power between the at least one swing arm and a wheel-side coupling, the drive-side coupling comprising at least one attachment mechanism located thereon; and
a wheel-side coupling configured to transmit power between the drive-side coupling and a vehicle wheel, the wheel-side coupling comprising at least one attachment mechanism located thereon.

6. A system comprising:
at least one energy storage device configured to store power for a vehicle having one or more wheels;
a left swing arm and a right swing arm configured to transmit power between the one or more wheels and a power conversion device;
a rear drive comprising a power conversion device, the power conversion device being configured to transmit power between the at least one energy storage device and a differential;
a differential configured to divide power flow between the left swing arm and right swing arm;
at least one power conversion controller configured to regulate power flow between the at least one energy storage device and the power conversion device; and
an input device configured to receive input from a user and configured to translate the input into instructions for the power conversion controller,
wherein the power conversion device and differential are parallel to and aligned with each other.

7. A system comprising:
at least one energy storage device configured to store power for a vehicle having at least one rear axle;
at least one wheel configured to be substantially aligned with the rear axle of the vehicle and configured to provide traction against a ground surface;
at least one power conversion device configured to transmit power between the at least one wheel and the at least one energy storage device;
at least one power conversion controller configured to regulate power flow between the at least one energy storage device and the at least one power conversion device; and
an input device configured to receive input from a user and configured to translate the input into instructions for the power conversion controller.

8. A system comprising:
a power source configured to provide electrical energy to a vehicle having a traction battery;
at least one sensor configured to take a current measurement at the vehicle's traction battery and configured to communicate the current measurement to a controller, wherein the controller is configured to vary the electrical energy provided by the power source.

9. A system comprising:
a trailer frame configured to carry a load for a vehicle;
at least one wheel connected to the trailer frame; and
a steering mechanism configured to exert a steering torque on the at least one wheel, and configured to align the direction of rotation of the at least one wheel with the direction of travel of the at least one wheel;
wherein the trailer frame is configured to connect to the vehicle and configured to minimize relative yaw between the vehicle and the trailer frame.

10. A system comprising:
a rear anchor configured to connect to a rear frame section of a vehicle;
at least one resilient member configured to exert a substantially upward force on the rear anchor; and
a preload adjustment mechanism configured to enable a user to adjust the upward force exerted by the resilient member on the rear anchor.

11. A system for connecting at least one auxiliary component to a vehicle having at least one axle tube, the system comprising:
at least one axle clamp; and
at least one transverse bar configured to connect to the at least one axle clamp,
wherein the axle clamp is configured to connect to the at least one axle tube of the vehicle in a plurality of locations.

12. A system comprising:
an inboard portion configured to connect to a vehicle having at least one axle that is split into an inboard end and an outboard end, wherein the inboard portion is connected to the inboard end of the axle;
an outboard portion configured to connect to the outboard end of the vehicle's axle;
at least one bearing configured to align the inboard portion and the outboard portion and configured to allow relative rotation of the inboard portion and the outboard portion; and
a sliding clutch configured to transmit torque between the inboard portion and the outboard portion when in a first position and configured to interrupt torque when in a second position.

13. (canceled)
